(19) United States
(12) Patent Application Publication
(10) Pub. No.: US 2023/0055525 A1
(43) Pub. Date: Feb. 23, 2023

(54) MULTI-MODAL ROUTING ENGINE AND PROCESSING ARCHITECTURE FOR ORCHESTRATION OF VARIABLE LENDING INTEREST TERMS USING CRYPTOCURRENCY COLLATERAL

(71) Applicant: New York Digital Investment Group LLC, New York, NY (US)

(72) Inventors: Patrick Sells, New York, NY (US); Yan Zhao Lee, New York, NY (US)

(73) Assignee: New York Digital Investment Group LLC, New York, NY (US)

(21) Appl. No.: 17/977,891

(22) Filed: Oct. 31, 2022

Related U.S. Application Data
(63) Continuation of application No. 17/969,553, filed on Oct. 19, 2022.
Application No. 17/969,553 is a continuation-in-part of application No. 17/512,980, filed on Oct. 28, 2021.
Application No. 17/512,980 is a continuation of application No. PCT/US2021/071000, filed on Jul. 27, 2021.
(60) Provisional application No. 63/057,079, filed on Jul. 27, 2020.
(60) Provisional application No. 63/290,862, filed on Dec. 17, 2021.

(51) Int. Cl. G06Q 40/02

(52) U.S. Cl. CPC G06Q 40/025; G06Q 2220/00

(57) ABSTRACT

An integration system for a system of platforms includes an orchestration platform, a blockchain transactional platform, a digital transactional platform, a merchant system, a user trust platform, and one or more user devices connected to each other and a distributed ledger and/or a secondary mesh network via one or more networks. The blockchain transactional platform performs accesses and performs actions on the distributed ledger and/or the secondary mesh network. The digital transactional platform maintains transactional data indicative of an amount of first-domain value correlated to a user. The blockchain transactional platform maintains blockchain transactional data indicative of an amount of second-domain value correlated to the user. The orchestration platform manages data exchange, synthesis, fusion, analysis, and transformation between the components of the system, including the orchestration of variable lending interest terms using cryptocurrency collateral.

### CROSS-REFERENCE TO RELATED APPLICATIONS

This application is a Continuation of U.S. patent application Ser. No. 17/969,553 filed Oct. 19, 2022, which is a Continuation-in-Part of U.S. patent application Ser. No. 17/512,980 filed Oct. 28, 2021, which is a continuation of PCT/US2021/071000 filed Jul. 27, 2021, which claims priority to U.S. Provisional Patent Application No. 63/057,079 filed Jul. 27, 2020. U.S. patent application Ser. No. 17/969,553 also claims priority to U.S. Provisional Application No. 63/290,862, filed Dec. 17, 2021. Each of the foregoing patent applications is incorporated by reference in its entirety for all purposes.

### FIELD

The present disclosure relates to integration systems for managing networked computer platforms and, more particularly, to integration systems for orchestrating data exchange, synthesis, fusion, analysis, and transformation between platforms of a system of platforms.

### BACKGROUND

Conventional enterprise blockchain-based media exchange platforms and financial information exchange and processing platforms each employ unique data handling, exchange, and processing standards necessitated by the unique requirements of their unique system architectures. Accordingly, conventional blockchain-based media exchange platforms are often not be able to seamlessly or automatically exchange data or send information between one another and financial information exchange and processing platforms. Furthermore, conventional merchant platforms similarly often lack interoperability between blockchain-based media exchange platforms and/or financial information exchange and processing platforms. Therefore, there is a need for an orchestration platform that serves as an integration system suitable for orchestrating automated data exchange, synthesis, fusion, analysis, and transformation between disparate platforms such as the conventional blockchain-based media exchange platforms, financial information exchange and processing platforms, and merchant platforms.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An integration system for a platform of platforms, includes a digital transactional platform including a transactional database including transactional data indicative of an amount of first-domain value correlated to a user, and a digital transactional programming interface configured to provide access to the transactional database. The integration system includes a blockchain transactional platform including a blockchain transactional database including blockchain transactional data indicative of an amount of second-domain value correlated to the user, and a blockchain transactional programming interface configured to provide access to the blockchain transactional database. The integration system includes an orchestration platform including an orchestration module, an analysis module, and an orchestration platform programming interface configured to provide access to the orchestration module.

The orchestration module is configured to, in response to a first input specifying a first amount access the transactional database through the digital transactional programming interface to retrieve the transactional data, access the blockchain transactional database through the blockchain transactional programming interface to retrieve the blockchain transactional data, generate a feature vector for the analysis module based on the transactional data and the blockchain transactional data, input the feature vector into the analysis module, and based on an output set from the analysis module, generate first data indicating a first portion of the first amount corresponding to first-domain value and second data indicating a second portion of the first amount corresponding to second-domain value.

In other features, the orchestration module is configured to generate a user interface element on a user interface, monitor the user interface element to determine if the user selects the user interface element, and in response to the user selecting the user interface element, generate the first input. In other features, the blockchain transactional module is configured to access and parse a cryptocurrency wallet address on a distributed ledger to generate blockchain transactional data, and send the generated blockchain transactional data to the blockchain transactional programming interface. In other features, the blockchain transactional module is configured to access and parse a cryptocurrency wallet address on a secondary mesh network to generate blockchain transactional data, and send the generated blockchain transactional data to the blockchain transactional programming interface.

In other features, the analysis module is configured to access and parse a cryptocurrency wallet address on a distributed ledger to generate blockchain transactional data. In other features, the analysis module is configured to access and parse a cryptocurrency wallet address on a secondary mesh network to generate blockchain transactional data. In other features, the analysis module is configured to generate the output set by inputting the feature vectors into a trained machine learning model. In other features, the analysis module is configured to generate an output payload based on the first data and the second data. In other features, the analysis module is configured to generate a second user interface element on the user interface and transform the second user interface element according to the first data and the second data. In other features, the integration system includes a user device having a display. The user device is configured to access the user interface.

A computer-implemented method of automatically managing networked computer platforms, includes receiving a first input at an orchestration module, the first input specifying a first amount, the orchestration module forming a part of an orchestration platform including the orchestration module, an analysis module, and an orchestration platform programming interface configured to provide access to the orchestration module. The method includes, in response to the orchestration module receiving the first input, accessing, at the orchestration module, a transactional database through a digital transactional programming interface to retrieve transactional data, the transactional database and the digital transactional programming interface forming a part of a digital transactional platform, the transactional database including transactional data indicative of an amount of first-domain value correlated to a user, the digital transactional programming interface configured to provide access to the transactional database.

The method includes accessing a blockchain transactional database through a blockchain transactional programming interface to retrieve blockchain transactional data, the blockchain transactional database and the blockchain transactional programming interface forming a part of a blockchain transactional platform, the blockchain transactional database including blockchain transactional data indicative of an amount of second-domain value correlated to the user, the blockchain transactional programming interface configured to provide access to the blockchain transactional database. The method includes generating a feature vector for the analysis module based on the transactional data and the blockchain transactional data, inputting the feature vector into the analysis module, and, based on an output set from the analysis module, generating first data indicating a first portion of the first amount corresponding to the first-domain value and second data indicating a second portion of the first amount corresponding to the second domain value.

In other features, the method includes generating, at the orchestration module, a user interface element on a user interface, monitoring the user interface element to determine if the user selects the user interface element, and, in response to the user selecting the user interface element, generating the first input. In other features, the method includes accessing, at the blockchain transactional module, a cryptocurrency wallet address on a distributed ledger, parsing data from the cryptocurrency wallet address to generate blockchain transactional data, and sending the generated blockchain transactional data from the blockchain transactional module to the blockchain transactional programming interface.

In other features, the method includes accessing, at the blockchain transactional module, a cryptocurrency wallet address on a secondary mesh network to generate blockchain transactional data, parsing data from the cryptocurrency wallet address to generate blockchain transactional data, and sending the generated blockchain transactional data from the blockchain transactional module to the blockchain transactional programming interface. In other features, the method includes accessing and parsing, at the analysis module, a cryptocurrency wallet address on a distributed ledger to generate blockchain transactional data.

In other features, the method includes accessing and parsing, at the analysis module, a cryptocurrency wallet address on a secondary mesh network to generate blockchain transactional data. In other features, the method includes generating, at the analysis module, the output set by inputting the feature vectors into a trained machine learning model. In other features, the method includes generating, at the analysis module, an output payload based on the first data and the second data. In other features, the method includes generating, at the analysis module, a second user interface element on the user interface and transforming the second user interface element according to the first data and the second data. In other features, the method includes accessing, at a user device having a display, the user interface.

An integration system for a platform of platforms, includes a digital transactional platform including a digital transactional module, a transactional database including transactional data indicative of an amount of first-domain value correlated to a user and financial rewards data correlated to the user, and a digital transactional programming interface configured to provide access to the digital transactional module and the transactional database. The integration system includes a blockchain transactional platform including a blockchain transactional module, a blockchain transactional database including blockchain transactional data indicative of an amount of second-domain value correlated to the user, and a blockchain transactional programming interface configured to provide access to the blockchain transactional module and the blockchain transactional database.

The integration system includes an orchestration platform including an orchestration module, an analysis module, and an orchestration platform programming interface configured to provide access to the orchestration module. The orchestration module is configured to access the transactional database through the digital transactional programming interface to retrieve the transactional data and the financial rewards data, access the blockchain transactional database through the blockchain transactional programming interface to retrieve the blockchain transactional data, provide the transactional data, financial rewards data, and blockchain transactional data to the analysis module to determine a digital transfer allocation, generate a digital transfer allocation payload based on the digital transfer allocation, and send the digital transfer allocation payload to the digital transactional programming interface and the blockchain transactional programming interface.

The digital transactional programming interface is configured to, in response to receiving the digital transfer allocation payload, instruct the digital transactional module to modify the financial rewards data. The blockchain transactional programming interface is configured to, in response to receiving the digital transfer allocation payload, instruct the blockchain transactional module to initiate a transfer of second-domain value to the user. In other features, the orchestration module is configured to generate a user interface element on a user interface, monitor the user interface element to determine if the user selects the user interface element, and, in response to the user selecting the user interface element, access the transactional database through the digital transactional programming interface to retrieve the transactional data and the financial rewards data.

In other features, the blockchain transactional module is configured to access and parse a cryptocurrency wallet address on a distributed ledger to generate blockchain transactional data, and send the generated blockchain transactional data to the blockchain transactional programming interface. In other features, the blockchain transactional module is configured to access and parse a cryptocurrency wallet address on a secondary mesh network to generate blockchain transactional data, and send the generated blockchain transactional data to the blockchain transactional programming interface. In other features, the orchestration module is configured to access and parse a cryptocurrency wallet address on a distributed ledger to generate blockchain transactional data. In other features, the orchestration module is configured to access and parse a cryptocurrency wallet address on a secondary mesh network to generate blockchain transactional data.

In other features, the orchestration module is configured determine the digital transfer allocation by inputting the transactional data, financial rewards data, and blockchain transactional data into a trained machine learning model. In other features, the trained machine learning model is a neural network. In other features, the blockchain transactional programming interface is configured to, in response to receiving the digital transfer allocation payload, instruct the blockchain transactional module to initiate a transfer of second-domain value to a cryptocurrency wallet address associated with the user. In other features, the integration system includes a user device having a display. The user device is configured to access the user interface.

A computer-implemented method of automatically managing networked computer platforms, includes accessing, from an orchestration module, a transactional database through a digital transactional programming interface to retrieve transactional data and financial rewards data. The orchestration module is part of an orchestration platform, the orchestration platform including an analysis module, and an orchestration platform programming interface configured to provide access to the orchestration module. The transactional database and the digital transactional programming interface are part of a digital transactional platform, the transactional database includes the transactional data indicative of an amount of first-domain value correlated to a user and financial rewards data correlated to the user, and the digital transactional programming interface is configured to provide access to the digital transactional module and the transactional database.

The method includes accessing a blockchain transactional database through a blockchain transactional programming interface to retrieve blockchain transactional data. The blockchain transactional database and the blockchain transactional programming interface are part of a blockchain transactional platform, the blockchain transactional platform includes a blockchain transactional module, the blockchain transactional database includes the blockchain transactional data that indicates an amount of second-domain value correlated to the user, and the blockchain transactional programming interface is configured to provide access to the blockchain transactional module and the blockchain transactional database.

The method includes providing the transactional data, financial rewards data, and blockchain transactional data to the analysis module to determine a digital transfer allocation, generating a digital transfer allocation payload based on the digital transfer allocation, sending the digital transfer allocation payload to the digital transactional programming interface and the blockchain transactional programming interface, receiving the digital transfer allocation payload at the digital transactional programming interface, and, in response to receiving the digital transfer allocation payload at the digital transactional programming interface: instructing the digital transactional module to modify the financial rewards data, and instructing the blockchain transactional module to initiate a transfer of second-domain value to the user.

In other features, the method includes generating, at the orchestration module, a user interface element on a user interface, monitoring the user interface element to determine if the user selects the user interface element, and, in response to the user selecting the user interface element, accessing the transactional database through the digital transactional programming interface to retrieve the transactional data and the financial rewards data. In other features, the method includes accessing, at the blockchain transactional module, a cryptocurrency wallet address on a distributed ledger to generate blockchain transactional data, parsing data from the cryptocurrency wallet address to generate blockchain transactional data, and sending the generated blockchain transactional data to the blockchain transactional programming interface.

In other features, the method includes accessing, at the blockchain transactional module, a cryptocurrency wallet address on a secondary mesh network to generate blockchain transactional data, parsing data from the cryptocurrency wallet address to generate blockchain transactional data, and sending the generated blockchain transactional data to the blockchain transactional programming interface. In other features, the method includes accessing, at the orchestration module, a cryptocurrency wallet address on a distributed ledger and parsing data from the cryptocurrency wallet address to generate blockchain transactional data. In other features, the method includes accessing, at the orchestration module, a cryptocurrency wallet address on a secondary mesh network and parsing data from the cryptocurrency wallet address to generate blockchain transactional data.

In other features, the method includes determining, at the orchestration module, the digital transfer allocation by inputting the transactional data, financial rewards data, and blockchain transactional data into a trained machine learning model. In other features, the trained machine learning model is a neural network. In other features, the method includes receiving the digital transfer allocation payload at the blockchain transactional programming interface, and, in response to receiving the digital transfer allocation payload at the blockchain transactional programming interface, instructing the blockchain transactional module to initiate a transfer of second-domain value to a cryptocurrency wallet address associated with the user. In other features, the method includes accessing, at a user device having a display, the user interface.

An integration system for a platform of platforms, includes a digital transactional platform including a transactional database including transactional data indicative of a deposit of first-domain value into an account correlated to a user, and a digital transactional programming interface configured to provide access to the transactional database. The integration system includes a blockchain transactional platform including a blockchain transactional module, and a blockchain transactional programming interface configured to provide access to the blockchain transactional module. The integration system includes an orchestration platform including an orchestration module, a rules database including a rule correlated to the user, a data services module configured to generate second-domain value market data, and an orchestration platform programming interface configured to provide access to the orchestration module.

The orchestration module is configured to access the transactional database through the digital transactional programming interface to retrieve the transactional data, determine a second-domain value purchase order based on the transactional data and the rule, generate a second-domain value purchase order payload based on the second-domain value purchase order, and send the second-domain value purchase order payload to the blockchain transactional programming interface. The blockchain transactional programming interface is configured to, in response to receiving the second-domain value purchase order payload, automatically initiate a second-domain value purchase for the user.

In other features, the orchestration module is configured to generate a user interface element on a user interface, monitor the user interface element to determine if the user selects the user interface element, and, in response to the user selecting the user interface element, access the transactional database through the digital transactional programming interface to retrieve the transactional data. In other features, the data services module is configured to access and parse data from a distributed ledger to generate the second-domain value market data. In other features, the data services module is configured to access and parse data from a secondary mesh network to generate the second-domain value market data.

In other features, the rule relates to a financial risk tolerance of the user. In other features, the orchestration module is configured to generate the second-domain value purchase payload only if the orchestration module determines that the second-domain value purchase order is consistent with the rule. In other features, the orchestration module is configured to generate the second-domain value purchase payload only if the orchestration module determines that the second-domain value market data is consistent with the rule. In other features, the blockchain transactional programming interface is configured to record the second-domain value purchase order payload to a cryptocurrency wallet address associated with the user.

In other features, the blockchain transactional programming interface is configured to record the second-domain value purchase order payload to a cryptocurrency wallet address associated with the user on a distributed ledger. In other features, the blockchain transactional programming interface is configured to record the second-domain value purchase order payload to a cryptocurrency wallet address associated with the user on a secondary mesh network.

A computer-implemented method of automatically managing networked computer platforms, includes accessing, from an orchestration platform, a transactional database thorough a digital transactional programming interface to retrieve transactional data. The transactional database and the digital transactional programming interface are part of a digital transactional platform, the transactional database includes the transactional data indicative of a deposit of first-domain value into an account correlated to a user, and the digital transactional programming interface is configured to provide access to the transactional database. The method includes determining a second-domain value purchase order based on the transactional data and a rule correlated to a user. The rule is stored in a rules database, the rules database is part of an orchestration platform that includes an orchestration module, a data services module configured to generate second-domain value market data, and an orchestration platform programming interface configured to provide access to the orchestration module.

The method includes generating a second-domain value purchase order payload based on the second-domain value purchase order, sending the second-domain value purchase order payload to a blockchain transactional programming interface. The blockchain transactional programming interface is part of a blockchain transactional platform that includes a blockchain transactional module, and the blockchain transactional programming interface is configured to provide access to the blockchain transactional module. The method includes receiving the second-domain value purchase order payload at the blockchain transactional programming interface, and, in response to receiving the second-domain value purchase order payload at the transactional programming interface, automatically initiating a second-domain value purchase for the user.

In other features, the method includes generating, at the orchestration module, a user interface element on a user interface, monitoring the user interface element to determine if the user selects the user interface element, and, in response to the user selecting the user interface element, accessing the transactional database through the digital transactional programming interface to retrieve the transactional data. In other features, the method includes accessing, at the data services module, data from a distributed ledger, and parsing the data from the distributed ledger to generate the second-domain value market data. In other features, the method includes accessing, at the data services module, data from a secondary mesh network, and parsing the data from the secondary mesh network to generate the second-domain value market data. In other features, the rule relates to a financial risk tolerance of the user.

In other features, the method includes determining, at the orchestration module, whether the second-domain value purchase order is consistent with the rule, and generating, at the orchestration module, the second-domain value purchase payload only if the orchestration module determines that the second-domain value purchase order is consistent with the rule. In other features, the method includes determining, at the orchestration module, whether the second-domain value purchase order is consistent with the rule, and generating, at the orchestration module, the second-domain value purchase payload only if the orchestration module determines that the second-domain value market data is consistent with the rule.

In other features, the method includes recording, from the blockchain transactional programming interface, the second-domain value purchase order payload to a cryptocurrency wallet address associated with the user. In other features, the method includes recording, from the blockchain transactional programming interface, the second-domain value purchase order payload to a cryptocurrency wallet address associated with the user on a distributed ledger. In other features, the method includes recording, from the blockchain transactional programming interface, the second-domain value purchase order payload to a cryptocurrency wallet address associated with the user on a secondary mesh network.

An integration system for a platform of platforms, includes a digital transactional platform including a transactional database including transactional data indicative of an amount of first-domain value correlated to a user, and a digital transactional programming interface configured to provide access to the transactional database. The system includes a blockchain transactional platform including a blockchain transactional module, a blockchain transactional database including blockchain transactional data indicative of an amount of second-domain value correlated to the user, and a blockchain transactional programming interface configured to provide access to the blockchain transactional module and the blockchain transactional database. The system includes an orchestration platform including an orchestration module, a data store including one or more rules correlated to the user and behavioral data, and an orchestration platform programming interface configured to provide access to the orchestration module.

The orchestration module is configured to access the transactional database through the digital transactional programming interface to retrieve the transactional data, access the blockchain transactional database through the blockchain transactional programming interface to retrieve the blockchain transactional data, determine a second-domain value conversion order based on the transactional data, the blockchain transactional data, the one or more rules, and the behavioral data, generate a second-domain value conversion order payload based on the second-domain value conversion order, and send the second-domain value conversion order payload to the blockchain transactional programming interface. The blockchain transactional programming interface is configured to, in response to receiving the second-domain value conversion order payload, automatically initiate a second-domain value conversion for the user.

In other features, the orchestration module is configured to generate a user interface element on a user interface, monitor the user interface element to determine if the user selects the user interface element, and in response to the user selecting the user interface element, access the transactional database through the digital transactional programming interface to retrieve the transactional data. In other features, the blockchain transactional module is configured to access and parse a cryptocurrency wallet address on a distributed ledger to generate blockchain transactional data and send the generated blockchain transactional data to the blockchain transactional programming interface. In other features, the blockchain transactional module is configured to access and parse a cryptocurrency wallet address on a secondary mesh network to generate blockchain transactional data and send the generated blockchain transactional data to the blockchain transactional programming interface.

In other features, the orchestration module is configured to access and parse a cryptocurrency wallet address to generate blockchain transactional data. In other features, the orchestration module is configured to access and parse a cryptocurrency wallet address on a distributed ledger to generate blockchain transactional data. In other features, the orchestration module is configured to access and parse a cryptocurrency wallet address on a secondary mesh network to generate blockchain transactional data. In other features, the orchestration module is configured to determine the second-domain value conversion order by inputting the transactional data, the blockchain transactional data, the one or more rules, and the behavioral data into a trained machine learning model. In other features, the trained machine learning model is a neural network. In other features, the system includes a user device having a display. The user device is configured to access the user interface.

A computer-implemented method of automatically managing networked computer platforms, includes accessing, from an orchestration module, a transactional database thorough a digital transactional programming interface to retrieve transactional data. The orchestration module is part of an orchestration platform, the orchestration platform includes a data store and an orchestration platform programming interface, the data store includes one or more rules correlated to a user and behavioral data, and the orchestration platform programming interface is configured to provide access to the orchestration module, and the digital transactional programming interface and the transactional database are parts of a digital transactional platform, the transactional database includes the transactional data which is indicative of an amount of first-domain value correlated to a user, and the digital transactional programming interface is configured to provide access to the transactional database.

The method includes accessing a blockchain transactional database through a blockchain transactional programming interface to retrieve blockchain transactional data. The blockchain transactional database and the blockchain transactional programming interface are parts of a blockchain transactional platform, the blockchain transactional platform includes a blockchain transactional module, the blockchain transactional database includes the blockchain transactional data, the blockchain transactional data is indicative of an amount of second-domain value correlated to the user, and the blockchain transactional programming interface is configured to provide access to the blockchain transactional module and the blockchain transactional database.

The method includes determining a second-domain value conversion order based on the transactional data, the blockchain transactional data, the one or more rules, and the behavioral data, generating a second-domain value conversion order payload based on the second-domain value conversion order, sending the second-domain value conversion order payload to the blockchain transactional programming interface, receiving the second-domain value conversion order payload at the blockchain transactional programming interface, and, in response to receiving the blockchain transactional programming interface, automatically initiating a second-domain value conversion for the user.

In other features, the method includes generating, at the orchestration module, a user interface element on a user interface, monitoring the user interface element to determine if the user selects the user interface element, and, in response to the user selecting the user interface element, accessing the transactional database through the digital transactional programming interface to retrieve the transactional data. In other features, the method includes accessing, from the blockchain transactional module, a cryptocurrency wallet address on a distributed ledger, parsing data from the cryptocurrency wallet address to generate blockchain transactional data, and sending the generated blockchain transactional data to the blockchain transactional programming interface.

In other features, the method includes accessing, from the blockchain transactional module, a cryptocurrency wallet address on a secondary mesh network, parsing data from the cryptocurrency wallet address to generate blockchain transactional data, and sending the generated blockchain transactional data to the blockchain transactional programming interface. In other features, the method includes accessing, from the orchestration module, a cryptocurrency wallet and parsing data from the cryptocurrency wallet to generate blockchain transactional data. In other features, the method includes accessing, from the orchestration module, a cryptocurrency wallet on a distributed ledger and parsing data from the cryptocurrency wallet to generate blockchain transactional data.

In other features, the method includes accessing, from the orchestration module, a cryptocurrency wallet on a secondary mesh network and parsing data from the cryptocurrency wallet to generate blockchain transactional data. In other features, the method includes determining, at the orchestration module, the second-domain value conversion order by inputting the transactional data, the blockchain transactional data, the one or more rules, and the behavioral data into a trained machine learning model. In other features, the trained machine learning model is a neural network. In other features, the method includes accessing, at a user device having a display, the user interface.

An integration system for a platform of platforms, includes a digital transactional platform including a transactional database including transactional data indicative of an amount of first-domain value correlated to a user, and a digital transactional programming interface configured to provide access to the transactional database. The system includes a blockchain transactional platform including a blockchain transactional module, a blockchain transactional database including blockchain transactional data indicative of an amount of second-domain value correlated to the user, and a blockchain transactional programming interface configured to provide access to the blockchain transactional module and the blockchain transactional database.

The system includes an orchestration platform including an orchestration module, a data store including one or more rules correlated to a digital wallet associated with the user, and an orchestration platform programming interface configured to provide access to the orchestration module. The orchestration module is configured to access the transactional database through the digital transactional programming interface to retrieve the transactional data, access the blockchain transactional database through the blockchain transactional programming interface to retrieve the blockchain transactional data, and determine a candidate second-domain value based on the transactional data, the blockchain transactional data, and the one or more rules.

In other features, the orchestration module is configured to generate a user interface element on a user interface, monitor the user interface element to determine if the user selects the user interface element, and, in response to the user selecting the user interface element, access the transactional database through the digital transactional programming interface to retrieve the transactional data. In other features, the blockchain transactional module is configured to access and parse a cryptocurrency wallet address on a distributed ledger to generate blockchain transactional data and send the generated blockchain transactional data to the blockchain transactional programming interface. In other features, the blockchain transactional module is configured to access and parse a cryptocurrency wallet address on a secondary mesh network to generate blockchain transactional data and send the generated blockchain transactional data to the blockchain transactional programming interface.

In other features, the orchestration module is configured to access and parse a cryptocurrency wallet address to generate blockchain transactional data. In other features, the orchestration module is configured to access and parse a cryptocurrency wallet address on a distributed ledger to generate blockchain transactional data. In other features, the orchestration module is configured to access and parse a cryptocurrency wallet address on a secondary mesh network to generate blockchain transactional data. In other features, the orchestration module is configured to determine the candidate second-domain value by inputting the transactional data, the blockchain transactional data, and the one or more rules into a trained machine learning model. In other features, the trained machine learning model is a neural network. In other features, the system includes a user device having a display. The user device is configured to access the user interface.

A computer-implemented method of automatically managing networked computer platforms, includes accessing, at an orchestration module, a transactional database through a digital transactional programming interface to retrieve transactional data. The orchestration module is part of an orchestration platform, the orchestration platform includes a data store and an orchestration platform programming interface, the data store includes one or more rules correlated to a digital wallet associated with a user, and the orchestration platform programming interface is configured to provide access to the orchestration module, and the transactional database and the transactional programming interface are parts of an digital transactional platform, the transactional database includes the transactional data, the transactional data is indicative of an amount of first-domain value correlated to the user, and the digital transactional programming interface is configured to provide access to the transactional database.

The method includes accessing a blockchain transactional database through a blockchain transactional programming interface to retrieve blockchain transactional data. The blockchain transactional database and the blockchain transactional programming interface are parts of a blockchain transactional platform, the blockchain transactional platform includes a blockchain transactional module, the blockchain transactional database includes the blockchain transactional data, the blockchain transactional data indicates an amount of second-domain value correlated to the user, and the blockchain transactional programming interface is configured to provide access to the blockchain transactional module and the blockchain transactional database. The method includes determining a candidate second-domain value based on the transactional data, the blockchain transactional data, and the one or more rules.

In other features, the method includes generating, at an orchestration module, a user interface element on a user interface, monitoring the user interface element to determine if the user selects the user interface element, and, in response to the user selecting the user interface element, accessing the transactional database through the digital transactional programming interface to retrieve the transactional data. In other features, the method includes accessing, from the blockchain transactional module, a cryptocurrency wallet address on a distributed ledger, parsing data from the cryptocurrency wallet address to generate blockchain transactional data, and sending the generated blockchain transactional data to the blockchain transactional programming interface.

In other features, the method includes accessing, from the blockchain transactional module, a cryptocurrency wallet address on a secondary mesh network, parsing data from the cryptocurrency wallet address to generate blockchain transactional data, and sending the generated blockchain transactional data to the blockchain transactional programming interface. In other features, the method includes accessing, from the orchestration module, a cryptocurrency wallet address and parsing data from the cryptocurrency wallet address to generate blockchain transactional data.

In other features, the method includes accessing, from the orchestration module, a cryptocurrency wallet address on a distributed ledger and parsing data from the cryptocurrency wallet address to generate blockchain transactional data. In other features, the method includes accessing, from the orchestration module, a cryptocurrency wallet address on a secondary mesh network and parsing data from the cryptocurrency wallet address to generate blockchain transactional data. In other features, the method includes determining, at the orchestration module, the candidate second-domain value by inputting the transactional data, the blockchain transactional data, and the one or more rules into a trained machine learning model. In other features, the trained machine learning model is a neural network. In other features, the method includes accessing, at a user device having a display, the user interface.

An integration system for a platform of platforms, includes a digital transactional platform including a transactional database including transactional data indicative of an amount of first-domain value correlated to a user, a trading module configured to monitor a first-domain value price, and a digital transactional programming interface configured to provide access to the transactional database and the trading module. The system includes a blockchain transactional platform including a blockchain transactional database including blockchain transactional data indicative of an amount of second-domain value correlated to the user, and a blockchain transactional programming interface configured to provide access to the blockchain transactional database.

The system includes an orchestration platform including an orchestration module, an analysis module, and an orchestration platform programming interface configured to provide access to the orchestration module and the analysis module. The orchestration module is configured to access the transactional database through the digital transactional programming interface to retrieve the transactional data and the monitored first-domain value price, access the blockchain transactional database through the blockchain transactional programming interface to retrieve the blockchain transactional data, and provide the transactional data, the monitored first-domain value price, and the blockchain transactional data to the analysis module to generate a trading strategy.

In other features, the orchestration module is configured to generate a first user interface element on a user interface, monitor the first user interface element to determine if the user selects the user interface element, and, in response to the user selecting the first user interface element, access the transactional database through the digital transactional programming interface to retrieve the transactional data and the monitored first-domain value price. In other features, the orchestration module is configured to generate an output payload based on the trading strategy. In other features, the orchestration module is configured to generate a second user interface element based on the output payload. The second user interface element displays the trading strategy to the user. In other features, the orchestration module is configured to generate a third user interface element, monitor the third user interface element to determine if the user selects the third user interface element, and, in response to the user selecting the third user interface element, generate an execution payload based on the trading strategy.

In other features, the orchestration module is configured to send the execution payload to the transactional programming interface. In other features, the transactional programming interface is configured to receive the execution payload and, in response to receiving the execution payload, the transactional programming interface is configured to automatically initiate an order for first-domain value assets based on the execution payload. In other features, the orchestration module is configured to send the execution payload to the blockchain transactional programming interface. In other features, the blockchain transactional programming interface is configured to receive the execution payload and, in response to receiving the execution payload, the blockchain transactional programming interface is configured to automatically initiate an order for second-domain value assets based on the execution payload. In other features, the system includes a user device having a display. The user device is configured to access the user interface.

A computer-implemented method of automatically managing networked computer platforms, includes accessing, from an orchestration module, a transactional database thorough a digital transactional programming interface to retrieve transactional data and a monitored first-domain value price. The orchestration module is part of an orchestration platform, the orchestration platform includes an analysis module and an orchestration platform programming interface, and the orchestration platform programming interface is configured to provide access to the orchestration module and the analysis module, and the transactional database and the digital transactional programming interface are parts of a digital transactional platform, the digital transactional platform includes a trading module configured to monitor a first-domain value price, the transactional database includes the transactional data, the transactional data indicates an amount of first-domain value correlated to a user, and the digital transactional programming interface is configured to provide access to the transactional database and the trading module.

The method includes accessing a blockchain transactional database through a blockchain transactional programming interface to retrieve blockchain transactional data. The blockchain transactional database and the blockchain transactional programming interface are parts of a blockchain transactional platform, the blockchain transactional database includes the blockchain transactional data, the blockchain transactional data is indicative of an amount of second-domain value correlated to the user, and the blockchain transactional programming interface is configured to provide access to the blockchain transactional database. The method includes accessing the blockchain transactional database through the blockchain transactional programming interface to retrieve the blockchain transactional data and providing the transactional data, the monitored first-domain value price, and the blockchain transactional data to the analysis module to generate a trading strategy.

In other features, the method includes generating, at the orchestration module, a first user interface element on a user interface, monitoring the first user interface element to determine if the user selects the user interface element, and, in response to the user selecting the first user interface element, accessing the transactional database through the digital transactional programming interface to retrieve the transactional data and the monitored first-domain value price. In other features, the method includes generating, at the orchestration module, an output payload based on the trading strategy. In other features, the method includes generating, at the orchestration module, a second user interface element based on the output payload. The second user interface element displays the trading strategy to the user.

In other features, the method includes generating, at the orchestration module, a third user interface element, monitoring the third user interface element to determine if the user selects the third user interface element, and, in response to the user selecting the third user interface element, generating an execution payload based on the trading strategy. In other features, the method includes sending, from the orchestration module, the execution payload to the transactional programming interface. In other features, the method includes receiving, at the transactional programming interface, the execution payload and, in response to receiving the execution payload at the transactional programming interface, automatically initiating an order for first-domain value assets based on the execution payload.

In other features, the method includes sending, from the orchestration module, the execution payload to the blockchain transactional programming interface. In other features, the method includes receiving, at the blockchain transactional programming interface, the execution payload and, in response to receiving the execution payload at the blockchain transactional programming interface, automatically initiating an order for second-domain value assets based on the execution payload. In other features, the method includes accessing, at a user device having a display, the user interface.

An integration system for a platform of platforms, includes a digital transactional platform including a transactional database including transactional data indicative of first-domain value correlated to a user, a digital transactional module configured to trade first-domain value, and a digital transactional platform interface configured to provide access to the transactional database and the digital transactional module. The system includes a blockchain transactional platform including a blockchain transactional database including blockchain transactional data indicative of an amount of second-domain value correlated to the user, a blockchain transactional module configured to trade second-domain value, and a blockchain transactional programming interface configured to provide access to the blockchain transactional module and the blockchain transactional programming interface.

The system includes an orchestration platform including an orchestration module, an analysis module a data store, and an orchestration programming interface. The orchestration module is configured to access the transactional database using the digital transactional programming interface to retrieve transactional data, access the blockchain transactional database using the blockchain transactional programming interface to retrieve blockchain transactional data, provide the transactional data, blockchain transactional data, and data from the data store to the analysis module to generate an interest allocation strategy, generate a trade order based on the interest allocation strategy, send the trade order to the digital transactional platform programming interface and the blockchain transactional programming interface, in response to the digital transactional programming interface receiving the trade order, direct the digital transactional module to initiate a first-domain value trade based on the trade order, and, in response to the blockchain transactional programming interface receiving the trade order, direct the blockchain transactional module to initiate a second-domain value trade based on the trade order.

In other features, the orchestration module is configured to generate a user interface element on a user interface, monitor the user interface element to determine if the user selects the user interface element, and, in response to the user selecting the user interface element, access the transactional database through the digital transactional programming interface to retrieve the transactional data. In other features, the blockchain transactional module is configured to access and parse a cryptocurrency wallet address on a distributed ledger to generate blockchain transactional data and send the generated blockchain transactional data to the blockchain transactional programming interface. In other features, the blockchain transactional module is configured to access and parse a cryptocurrency wallet address on a secondary mesh network to generate blockchain transactional data and send the generated blockchain transactional data to the blockchain transactional programming interface.

In other features, the orchestration module is configured to access and parse a cryptocurrency wallet address to generate blockchain transactional data. In other features, the orchestration module is configured to access and parse a cryptocurrency wallet address on a distributed ledger to generate blockchain transactional data. In other features, the orchestration module is configured to access and parse a cryptocurrency wallet address on a secondary mesh network to generate blockchain transactional data. In other features, the orchestration module is configured to generate the interest allocation strategy by inputting the transactional data, the blockchain transactional data, and data from the data store into a trained machine learning model. In other features, the trained machine learning model is a neural network. In other features, the system includes a user device having a display. The user device is configured to access the user interface.

A computer-implemented method of automatically managing networked computer platforms, includes accessing, at an orchestration module, a transactional database using a digital transactional programming interface to retrieve transactional data. The orchestration module is part of an orchestration platform, and the orchestration platform includes an analysis module, a data store, and an orchestration programming interface, and the transactional database and the digital transactional programming interface are parts of a digital transactional platform, the digital transactional platform includes a digital transactional module, the transactional database includes the transactional data that is indicative of first-domain value correlated to a user, the digital transactional module is configured to trade first-domain value, and the digital transactional platform interface is configured to provide access to the transactional database and the digital transactional module.

The method includes accessing a blockchain transactional database using a blockchain transactional programming interface to retrieve blockchain transactional data. The blockchain transactional database and the blockchain transactional programming interface are parts of a blockchain transactional platform, the blockchain transactional platform includes a blockchain transactional module, the blockchain transactional database includes the blockchain transactional data indicative of second-domain value correlated to the user, the blockchain transactional module is configured to trade second-domain value, and the blockchain transactional programming interface is configured to provide access to the blockchain transactional module and the blockchain transactional programming interface.

The method includes providing the transactional data, blockchain transactional data, and data from the data store to the analysis module to generate an interest allocation strategy, generating a trade order based on the interest allocation strategy, sending the trade order to the digital transactional platform programming interface and the blockchain transactional programming interface, receiving the trade order at the digital transactional programming interface, and, in response to the digital transactional programming interface receiving the trade order, directing the digital transactional module to initiate a first-domain value trade based on the trade order. The method includes receiving the trade order at the blockchain transactional programming interface, and, in response to the blockchain transactional programming interface receiving the trade order, directing the blockchain transactional module to initiate a second-domain value trade based on the trade order.

In other features, the method includes generating, at an orchestration module, a user interface element on a user interface, monitoring the user interface element to determine if the user selects the user interface element, and, in response to the user selecting the user interface element, accessing the transactional database through the digital transactional programming interface to retrieve the transactional data. In other features, the method includes accessing, from the blockchain transactional module, a cryptocurrency wallet address on a distributed ledger, parsing data from the cryptocurrency wallet address to generate blockchain transactional data, and sending the generated blockchain transactional data to the blockchain transactional programming interface.

In other features, the method includes accessing, from the blockchain transactional module, a cryptocurrency wallet address on a secondary mesh network, parsing data from the cryptocurrency wallet address to generate blockchain transactional data, and sending the generated blockchain transactional data to the blockchain transactional programming interface. In other features, the method includes accessing, from the orchestration module, a cryptocurrency wallet address and parsing data from the cryptocurrency wallet address to generate blockchain transactional data.

In other features, the method includes accessing, from the orchestration module, a cryptocurrency wallet address on a distributed ledger and parsing data from the cryptocurrency wallet address to generate blockchain transactional data. In other features, the method includes accessing, from the orchestration module, a cryptocurrency wallet address on a secondary mesh network and parsing data from the cryptocurrency wallet address to generate blockchain transactional data. In other features, the method includes generating, at the orchestration module, the interest allocation strategy by inputting the transactional data, the blockchain transactional data, and data from the data store into a trained machine learning model. In other features, the trained machine learning model is a neural network. In other features, the method includes accessing, at a user device having a display, the user interface.

An integration system for a platform of platforms, includes a user trust platform including a user trust database including user trust data correlated to a loan associated with a user, at least one rule related to financial risk tolerance, and second-domain value market datum, a user trust module configured to periodically recalculate the user trust data and a digital transfer amount and save the recalculated user trust data and the digital transfer amount to the user trust database, and a user trust programming interface configured to provide access to the user trust database and the user trust module. The system includes a blockchain transactional platform including a blockchain transactional database including blockchain transactional data indicative of an amount of second-domain value related to the user, a blockchain transactional module, and a blockchain transactional programming interface configured to provide access to the blockchain transactional database and the blockchain transactional module.

The system includes an orchestration platform including an orchestrating module, and an orchestration platform programming interface configured to provide access to the orchestration module. The orchestration module is configured to retrieve the recalculated user trust data and the digital transfer amount from the user trust database via the user trust programming interface, retrieve the blockchain transactional data from the blockchain transactional database via the blockchain transactional programming interface, generate a payload based on the recalculated user trust data, the digital transfer amount, and the blockchain transactional data, and send the payload to the blockchain transactional programming interface. In response to receiving the payload, the blockchain transactional programming interface is configured to instruct the blockchain transactional module to initiate a digital transfer to the loan associated with the user.

In other features, the orchestration module is configured to determine whether the blockchain transactional data is consistent with the at least one rule from the user trust database and, in response to determining that the blockchain transactional data is consistent with the at least one rule from the user trust database, generate the payload based on the recalculated user trust data, the digital transfer amount, and the blockchain transactional data. In other features, the orchestration module is configured to generate a user interface element on a user interface, monitor the user interface element to determine if the user selects the user interface element, and, in response to the user selecting the user interface element, retrieve the recalculated user trust data and the digital transfer amount from the user trust database via the user trust programming interface. In other features, the blockchain transactional module is configured to access and parse a cryptocurrency wallet address on a distributed ledger to generate blockchain transactional data and send the generated blockchain transactional data to the blockchain transactional programming interface.

In other features, the blockchain transactional module is configured to access and parse a cryptocurrency wallet address on a secondary mesh network to generate blockchain transactional data and send the generated blockchain transactional data to the blockchain transactional programming interface. In other features, the orchestration module is configured to access and parse a cryptocurrency wallet address to generate blockchain transactional data. In other features, the orchestration module is configured to access and parse a cryptocurrency wallet address on a distributed ledger to generate blockchain transactional data. In other features, the orchestration module is configured to access and parse a cryptocurrency wallet address on a secondary mesh network to generate blockchain transactional data. In other features, the orchestration module is configured to generate the payload by inputting the recalculated user trust data, digital transfer amount, and blockchain transactional data into a trained machine learning model. In other features, the trained machine learning model is a neural network.

A computer-implemented method of automatically managing networked computer platforms, includes retrieving, at an orchestration module, recalculated user trust data and a digital transfer amount from a user trust database via a user trust programming interface. The orchestration module is part of an orchestration platform, the orchestration platform includes an orchestration platform programming interface, and the orchestration platform programming interface is configured to provide access to the orchestration module, and the user trust database and the user trust programming interface are parts of a user trust platform, the user trust platform includes a user trust module, the user trust database includes user trust data correlated to a loan associated with a user, at least one rule related to financial risk tolerance, and second-domain value market datum, the user trust module is configured to periodically recalculate the user trust data and the digital transfer amount and save the recalculated user trust data and the digital transfer amount to the user trust database, and the user trust programming interface is configured to provide access to the user trust database and the user trust module.

The method includes retrieving blockchain transactional data from a blockchain transactional database via a blockchain transactional programming interface. The blockchain transactional database and the blockchain transactional programming interface are parts of a blockchain transactional platform, the blockchain transactional platform includes a blockchain transactional module, the blockchain transactional database includes the blockchain transactional data indicative of an amount of second-domain value related to the user, and the blockchain transactional programming interface is configured to provide access to the blockchain transactional database and the blockchain transactional module.

The method includes retrieving the blockchain transactional data from the blockchain transactional database via the blockchain transactional programming interface, generating a payload based on the recalculated user trust data, the digital transfer amount, and the blockchain transactional data, sending the payload to the blockchain transactional programming interface, receiving the payload at the blockchain transactional programming interface, and, in response to receiving the payload at the blockchain transactional programming interface, instructing the blockchain transactional module to initiate a digital transfer to the loan associated with the user.

In other features, the method includes determining, at the orchestration module, whether the blockchain transactional data is consistent with the at least one rule from the user trust database and, in response to determining that the blockchain transactional data is consistent with the at least one rule from the user trust database, generating the payload based on the recalculated user trust data, the digital transfer amount, and the blockchain transactional data. In other features, the method includes generating, at an orchestration module, a user interface element on a user interface, monitoring the user interface element to determine if the user selects the user interface element, and, in response to the user selecting the user interface element, retrieving, at the orchestration module, recalculated user trust data and the digital transfer amount from the user trust database via the user trust programming interface. In other features, the method includes accessing, from the blockchain transactional module, a cryptocurrency wallet address on a distributed ledger, parsing data from the cryptocurrency wallet address to generate blockchain transactional data, and sending the generated blockchain transactional data to the blockchain transactional programming interface.

In other features, the method includes accessing, from the blockchain transactional module, a cryptocurrency wallet address on a secondary mesh network, parsing data from the cryptocurrency wallet address to generate blockchain transactional data, and sending the generated blockchain transactional data to the blockchain transactional programming interface. In other features, the method includes accessing, from the orchestration module, a cryptocurrency wallet address and parsing data from the cryptocurrency wallet address to generate blockchain transactional data. In other features, the method includes accessing, from the orchestration module, a cryptocurrency wallet address on a distributed ledger and parsing data from the cryptocurrency wallet address to generate blockchain transactional data. In other features, the method includes accessing, from the orchestration module, a cryptocurrency wallet address on a secondary mesh network and parsing data from the cryptocurrency wallet address to generate blockchain transactional data. In other features, the method includes generating, at the orchestration module, the payload by inputting the recalculated user trust data, the digital transfer amount, and the blockchain transactional data into a trained machine learning model. In other features, the trained machine learning model is a neural network.

An integration system for a platform of platforms, includes a user trust platform including a user trust database including a line of credit associated with a user, a user trust module configured to adjust the line of credit, and a user trust programming interface configured to provide access to the user trust database and the user trust module. The system includes a digital transactional platform including a transactional database including transactional data indicative of an amount of first-domain value correlated to the user, and a digital transactional programming interface configured to provide access to the transactional database. The system includes a blockchain transactional platform including a blockchain transactional database including blockchain transactional data indicative of an amount of second-domain value correlated to the user, and a blockchain transactional programming interface configured to provide access to the blockchain transactional database.

The system includes an orchestration platform including an orchestration module, and an orchestration platform programming interface configured to provide access to the orchestration module. The orchestration module is configured to retrieve transactional data from the transactional database through the digital transactional programming interface, retrieve blockchain transactional data from the blockchain transactional database through the blockchain transactional programming interface, and send the transactional data and the blockchain transactional data to the user trust programming interface. The user trust module is configured to retrieve the transactional data and the blockchain transactional data from the user trust programming interface, and adjust the line of credit in the user trust database based on the transactional data and the blockchain transactional data.

In other features, the orchestration module is configured to generate a user interface element on a user interface, monitor the user interface element to determine if the user selects the user interface element, and in response to the user selecting the user interface element, retrieve transactional data from the transactional database through the digital transactional programming interface. In other features, the blockchain transactional module is configured to access and parse a cryptocurrency wallet address on a distributed ledger to generate blockchain transactional data and send the generated blockchain transactional data to the blockchain transactional programming interface. In other features, the blockchain transactional module is configured to access and parse a cryptocurrency wallet address on a secondary mesh network to generate blockchain transactional data and send the generated blockchain transactional data to the blockchain transactional programming interface.

In other features, the orchestration module is configured to access and parse a cryptocurrency wallet address to generate blockchain transactional data. In other features, the orchestration module is configured to access and parse a cryptocurrency wallet address on a distributed ledger to generate blockchain transactional data. In other features, the orchestration module is configured to access and parse a cryptocurrency wallet address on a secondary mesh network to generate blockchain transactional data. In other features, the user trust module is configured to generate a second user interface element based on the adjusted line of credit. In other features, the system includes a user device having a display. The user device is configured to access the user interface. In other features, the user device is configured to access the second user interface element and output the second user interface element to the display.

A computer-implemented method of automatically managing networked computer platforms, includes receiving, at an orchestration module, transactional data from a transactional database through a digital transactional programming interface. The orchestration module is part of an orchestration platform, the orchestration platform includes an orchestration platform programming interface, and the orchestration platform programming interface is configured to provide access to the orchestration module, and the transactional database and the digital transactional programming interface are parts of a digital transactional platform, the transactional database includes transactional data indicative of an amount of first-domain value correlated to a user, and the digital transactional programming interface is configured to provide access to the transactional database.

The method includes retrieving blockchain transactional data from a blockchain transactional database through a blockchain transactional programming interface. The blockchain transactional database and the blockchain transactional programming interface are parts of a blockchain transactional platform, the blockchain transactional database includes the blockchain transactional data, the blockchain transactional data is indicative of an amount of second-domain value correlated to the user, and the blockchain transactional programming interface is configured to provide access to the blockchain transactional database.

The method includes sending the transactional data and the blockchain transactional data to a user trust programming interface. The user trust programming interface is part of a user trust platform, the user trust platform includes a user trust database and a user trust module, the user trust database includes a line of credit associated with a user, the user trust module is configured to adjust the line of credit, and the user trust programming interface is configured to provide access to the user trust database and the user trust module. The method includes retrieving, at the user trust module, the transactional data and the blockchain transactional data from the user trust programming interface and adjusting the line of credit in the user trust database based on the transactional data and the blockchain transactional data.

In other features, the method includes generating, at an orchestration module, a user interface element on a user interface, monitoring the user interface element to determine if the user selects the user interface element, and, in response to the user selecting the user interface element, receiving, at the orchestration module, transactional data from the transactional database through the digital transactional programming interface. In other features, the method includes accessing, from the blockchain transactional module, a cryptocurrency wallet address on a distributed ledger, parsing data from the cryptocurrency wallet address to generate blockchain transactional data, and sending the generated blockchain transactional data to the blockchain transactional programming interface.

In other features, the method includes accessing, from the blockchain transactional module, a cryptocurrency wallet address on a secondary mesh network, parsing data from the cryptocurrency wallet address to generate blockchain transactional data, and sending the generated blockchain transactional data to the blockchain transactional programming interface. In other features, the method includes accessing, from the orchestration module, a cryptocurrency wallet address, parsing data from the cryptocurrency wallet address to generate blockchain transactional data. In other features, the method includes accessing, from the orchestration module, a cryptocurrency wallet address on a distributed ledger and parsing data from the cryptocurrency wallet address to generate blockchain transactional data.

In other features, the method includes accessing, from the orchestration module, a cryptocurrency wallet address on a secondary mesh network and parsing data from the cryptocurrency wallet address to generate blockchain transactional data. In other features, the method includes generating, at the user trust module, a second user interface element based on the adjusted line of credit. In other features, the method includes accessing, at a user device having a display, the user interface. In other features, the method includes accessing, at the user device, the second user interface element and outputting, to the display of the user device, the second user interface element.

A system for automatically orchestrating data exchanges between multiple computer platforms according to machine learning, the system includes a user trust platform including a user trust database including user trust data associated with a user, and a user trust programming interface configured to provide access to the user trust database. The system includes a digital transactional platform including a transactional database including transactional data indicative of an amount of first-domain value correlated to the user, and a digital transactional programming interface configured to provide access to the transactional database. The system includes a blockchain transactional platform including a blockchain transactional database including blockchain transactional data indicative of an amount of second-domain value correlated to the user, and a blockchain transactional programming interface configured to provide access to the blockchain transactional database.

The system includes an orchestration platform including an orchestration module, a machine learning model, and an orchestration platform programming interface configured to provide access to the orchestration module. The orchestration module is configured to retrieve user trust data from the user trust database through the user trust programming interface, retrieve transactional data from the transactional database through the digital transactional programming interface, retrieve blockchain transactional data from the blockchain transactional database through the blockchain transactional programming interface, and provide the user trust data, transactional data, and blockchain transactional data to the machine learning model to generate financial metrics associated with the user.

In other features, the orchestration module is configured to generate a user interface element on a user interface, monitor the user interface element to determine if the user selects the user interface element, and, in response to the user selecting the user interface element, retrieve user trust data from the user trust database through the user trust programming interface. In other features, the blockchain transactional module is configured to access and parse a cryptocurrency wallet address on a distributed ledger to generate blockchain transactional data and send the generated blockchain transactional data to the blockchain transactional programming interface. In other features, the blockchain transactional module is configured to access and parse a cryptocurrency wallet address on a secondary mesh network to generate blockchain transactional data and send the generated blockchain transactional data to the blockchain transactional programming interface.

In other features, the orchestration module is configured to access and parse a cryptocurrency wallet address to generate blockchain transactional data. In other features, the orchestration module is configured to access and parse a cryptocurrency wallet address on a distributed ledger to generate blockchain transactional data. In other features, the orchestration module is configured to access and parse a cryptocurrency wallet address on a secondary mesh network to generate blockchain transactional data. In other features, the orchestration module is configured to generate a second user interface element based on the financial metrics. In other features, the system includes a user device having a display. The user device is configured to access the user interface. In other features, the machine learning model is a neural network.

A computer-implemented method of automatically managing networked computer platforms, includes retrieving, at an orchestration module, user trust data from a user trust database through a user trust programming interface. The orchestration module is part of an orchestration platform, the orchestration platform includes a machine learning model and an orchestration platform programming interface, and the orchestration platform programming interface is configured to provide access to the orchestration module, and the user trust database and the user trust programming interface are parts of a user trust platform, the user trust database includes user trust data associated with a user, and the user trust programming interface is configured to provide access to the user trust database. The method includes retrieving transactional data from a transactional database through a digital transactional programming interface. The transactional database and the digital transactional programming interface are parts of a digital transactional platform, the transactional database includes the transactional data, the transactional data indicates an amount of first-domain value correlated to the user, and the digital transactional programming interface is configured to provide access to the transactional database.

The method includes retrieving blockchain transactional data from the blockchain transactional database through the blockchain transactional programming interface. The blockchain transactional database and the blockchain transactional programming interface are parts of a blockchain transactional platform, the blockchain transactional database includes the blockchain transactional data, the blockchain transactional data indicates an amount of second-domain value correlated to the user, and the blockchain transactional database is configured to provide access to the blockchain transactional database. The method includes providing the user trust data, transactional data, and blockchain transactional data to the machine learning model to generate financial metrics associated with the user.

In other features, the method includes generating, at an orchestration module, a user interface element on a user interface, monitoring the user interface element to determine if the user selects the user interface element, and, in response to the user selecting the user interface element, retrieving, at the orchestration module, user trust data from the user trust database through the user trust programming interface. In other features, the method includes accessing, from the blockchain transactional module, a cryptocurrency wallet address on a distributed ledger, parsing data from the cryptocurrency wallet address to generate blockchain transactional data, and sending the generated blockchain transactional data to the blockchain transactional programming interface.

In other features, the method includes accessing, from the blockchain transactional module, a cryptocurrency wallet address on a secondary mesh network, parsing data from the cryptocurrency wallet address to generate blockchain transactional data, and sending the generated blockchain transactional data to the blockchain transactional programming interface. In other features, the method includes accessing, from the orchestration module, a cryptocurrency wallet address and parsing data from the cryptocurrency wallet address to generate blockchain transactional data. In other features, the method includes accessing, from the orchestration module, a cryptocurrency wallet address on a distributed ledger and parsing data from the cryptocurrency wallet address to generate blockchain transactional data.

In other features, the method includes accessing, from the orchestration module, a cryptocurrency wallet address on a secondary mesh network and parsing data from the cryptocurrency wallet address to generate blockchain transactional data. In other features, the method includes generating, at the orchestration module, a second user interface element based on the financial metrics. In other features, the method includes accessing, at a user device having a display, the user interface. In other features, the machine learning model is a neural network.

An integration system for a platform of platforms, includes a user trust platform including a user trust database including user trust data associated with a user, and a user trust programming interface configured to provide access to the user trust database. The system includes a digital transactional platform including a transactional database including transactional data indicative of an amount of first-domain value correlated to the user, and a digital transactional programming interface configured to provide access to the transactional database. The system includes a blockchain transactional platform including a blockchain transactional database including blockchain transactional data indicative of an amount of second-domain value correlated to the user, and a blockchain transactional programming interface configured to provide access to the blockchain transactional database.

The system includes an orchestration platform including an orchestration module, an analysis module, a data services module configured to determine and store second-domain value price volatility data, and an orchestration platform programming interface configured to provide access to the orchestration module. The orchestration module is configured to retrieve user trust data from the user trust database through the user trust programming interface, retrieve transactional data from the transactional database through the digital transactional programming interface, retrieve blockchain transactional data from the blockchain transactional database through the blockchain transactional programming interface, and provide the user trust data, the transactional data, the blockchain transactional data, and the second-domain value price volatility data to the analysis module to generate: (i) a portion of the second-domain value correlated to the user to reserve as collateral for a loan, (ii) a percentage for a first financial option, and (iii) a percentage for a second financial option.

In other features, the orchestration module is configured to generate a user interface element on a user interface, monitor the user interface element to determine if the user selects the user interface element, and, in response to the user selecting the user interface element, retrieve user trust data from the user trust database through the user trust programming interface. In other features, the blockchain transactional module is configured to access and parse a cryptocurrency wallet address on a distributed ledger to generate blockchain transactional data and send the generated blockchain transactional data to the blockchain transactional programming interface. In other features, the blockchain transactional module is configured to access and parse a cryptocurrency wallet address on a secondary mesh network to generate blockchain transactional data and send the generated blockchain transactional data to the blockchain transactional programming interface.

In other features, the orchestration module is configured to access and parse a cryptocurrency wallet address to generate blockchain transactional data. In other features, the orchestration module is configured to access and parse a cryptocurrency wallet address on a distributed ledger to generate blockchain transactional data. In other features, the orchestration module is configured to access and parse a cryptocurrency wallet address on a secondary mesh network to generate blockchain transactional data. In other features, the analysis module is configured to generate input vectors from the user trust data, the transactional data, the blockchain transactional data, and the second-domain value price volatility data and provide the input vectors to a trained machine learning model to generate: (i) the portion of the second-domain value correlated to the user to reserve as collateral for the loan, (ii) the percentage for the first financial option, and (iii) the percentage for the second financial option.

In other features, the trained machine learning model is a neural network. In other features, the orchestration module is configured to generate a second user interface element based on the portion of the second-domain value correlated to the user to reserve as collateral for the loan, generate a third user interface element based on the percentage for the first financial option, and generate a fourth user interface element based on the percentage for the second financial option.

A computer-implemented method of automatically managing networked computer platforms, includes retrieving, at an orchestration module, user trust data from a user trust database through a user trust programming interface. The orchestration module is part of an orchestration platform, the orchestration platform includes an analysis module, a data services module, and an orchestration platform programming interface, the data services module is configured to determine and store second-domain value price volatility data, and the orchestration platform programming interface is configured to provide access to the orchestration module, and the user trust database and the user trust programming interface are parts of a user trust platform, the user trust database includes the user trust data, the user trust data is associated with a user, and the user trust programming interface is configured to provide access to the user trust database.

The method includes retrieving transactional data from a transactional database through a digital transactional programming interface. The transactional database and the digital transactional programming interface are parts of a digital transactional platform, the transactional database includes the transactional data, the transactional data indicates an amount of first-domain value correlated to the user, and the digital transactional programming interface is configured to provide access to the transactional database. The method includes retrieving blockchain transactional data from the blockchain transactional database through the blockchain transactional programming interface.

The blockchain transactional database and the blockchain transactional programming interface are parts of a blockchain transactional platform, the blockchain transactional database includes the blockchain transactional data, the blockchain transactional data indicates an amount of second-domain value correlated to the user, and the blockchain transactional programming interface is configured to provide access to the blockchain transactional database. The method includes providing the user trust data, the transactional data, the blockchain transactional data, and the second-domain value price volatility data to the analysis module to generate: (i) a portion of the second-domain value correlated to the user to reserve as collateral for a loan, (ii) a percentage for a first financial option, and (iii) a percentage for a second financial option.

In other features, the method includes generating, at an orchestration module, a user interface element on a user interface, monitoring the user interface element to determine if the user selects the user interface element, and, in response to the user selecting the user interface element, retrieving, at the orchestration module, user trust data from the user trust database through the user trust programming interface. In other features, the method includes accessing, from the blockchain transactional module, a cryptocurrency wallet address on a distributed ledger, parsing data from the cryptocurrency wallet address to generate blockchain transactional data, and sending the generated blockchain transactional data to the blockchain transactional programming interface.

In other features, the method includes accessing, from the blockchain transactional module, a cryptocurrency wallet address on a secondary mesh network, parsing data from the cryptocurrency wallet address to generate blockchain transactional data, and sending the generated blockchain transactional data to the blockchain transactional programming interface. In other features, the method includes accessing, from the orchestration module, a cryptocurrency wallet address and parsing data from the cryptocurrency wallet address to generate blockchain transactional data. In other features, the method includes accessing, from the orchestration module, a cryptocurrency wallet address on a distributed ledger and parsing data from the cryptocurrency wallet address to generate blockchain transactional data.

In other features, the method includes accessing, from the orchestration module, a cryptocurrency wallet address on a secondary mesh network and parsing data from the cryptocurrency wallet address to generate blockchain transactional data. In other features, the method includes generating, at the analysis module, input vectors from the user trust data, the transactional data, the blockchain transactional data, and the second-domain value price volatility data and providing the input vectors to a trained machine learning model to generate: (i) the portion of the second-domain value correlated to the user to reserve as collateral for the loan, (ii) the percentage for the first financial option, and (iii) the percentage for the second financial option.

In other features, the trained machine learning model is a neural network. In other features, the method includes generating, at the orchestration module, a second user interface element based on the portion of the second-domain value correlated to the user to reserve as collateral for the loan, generating, at the orchestration module, a third user interface element based on the percentage for the first financial option, and generating, at the orchestration module, a fourth user interface element based on the percentage for the second financial option.

An integration system for a platform of platforms, includes a user trust platform including a user trust database including user trust data associated with a user, and a user trust programming interface configured to provide access to the user trust database. The system includes a digital transactional platform including a transactional database including transactional data indicative of an amount of first-domain value correlated to the user, and a digital transactional programming interface configured to provide access to the transactional database. The system includes a blockchain transactional platform including a blockchain transactional database including blockchain transactional data indicative of an amount of second-domain value correlated to the user, and a blockchain transactional programming interface configured to provide access to the blockchain transactional database.

The system includes an orchestration platform including an orchestration module, an analysis module, and an orchestration platform programming interface configured to provide access to the orchestration module. The orchestration module is configured to retrieve user trust data from the user trust database through the user trust programming interface, retrieve transactional data from the transactional database through the digital transactional programming interface, retrieve blockchain transactional data from the blockchain transactional database through the blockchain transactional programming interface, and provide the user trust data, the transactional data, and the blockchain transactional data to the analysis module to generate: (i) a portion of the second-domain value correlated to the user to reserve as collateral for a loan, (ii) an interest rate for the loan, and (iii) a portion of the reserved collateral to provide to a lending service provider.

In other features, the orchestration module is configured to generate a user interface element on a user interface, monitor the user interface element to determine if the user selects the user interface element, and, in response to the user selecting the user interface element, retrieve user trust data from the user trust database through the user trust programming interface. In other features, the blockchain transactional module is configured to access and parse a cryptocurrency wallet address on a distributed ledger to generate blockchain transactional data and send the generated blockchain transactional data to the blockchain transactional programming interface. In other features, the blockchain transactional module is configured to access and parse a cryptocurrency wallet address on a secondary mesh network to generate blockchain transactional data and send the generated blockchain transactional data to the blockchain transactional programming interface.

In other features, the orchestration module is configured to access and parse a cryptocurrency wallet address to generate blockchain transactional data. In other features, the orchestration module is configured to access and parse a cryptocurrency wallet address on a distributed ledger to generate blockchain transactional data. In other features, the orchestration module is configured to access and parse a cryptocurrency wallet address on a secondary mesh network to generate blockchain transactional data. In other features, the analysis module is configured to generate input vectors from the user trust data, the transactional data, and the blockchain transactional data and provide the input vectors to a trained machine learning model to generate: (i) the portion of the second-domain value correlated to the user to reserve as collateral for the loan, (ii) the interest rate for the loan, and (iii) the portion of the reserved collateral to provide to the lending service provider.

In other features, the trained machine learning model is a neural network. In other features, the orchestration module is configured to generate a second user interface element based on the portion of the second-domain value correlated to the user to reserve as collateral for the loan, generate a third user interface element based on the interest rate for the loan, and generate a fourth user interface element based on the portion of the reserved collateral to provide to the lending service provider.

A computer-implemented method of automatically managing networked computer platforms, includes retrieving, at an orchestration module, user trust data from a user trust database through a user trust programming interface. The orchestration module is part of an orchestration platform, the orchestration platform includes an analysis module, and the orchestration platform programming interface is configured to provide access to the orchestration module, and the user trust database and the user trust programming interface are parts of a user trust platform, the user trust database includes the user trust data, the user trust data is associated with a user, and the user trust programming interface is configured to provide access to the user trust database.

The method includes retrieving transactional data from a transactional database through a digital transactional programming interface. The transactional database and the digital transactional programming interface are parts of a digital transactional platform, the transactional database includes the transactional data, the transactional data indicates an amount of first-domain value correlated to the user, and the digital transactional programming interface is configured to provide access to the transactional database. The method includes retrieving blockchain transactional data from the blockchain transactional database through the blockchain transactional programming interface.

The blockchain transactional database and the blockchain transactional programming interface are parts of a blockchain transactional platform, the blockchain transactional database includes the blockchain transactional data, the blockchain transactional data indicates an amount of second-domain value correlated to the user, and the blockchain transactional programming interface is configured to provide access to the blockchain transactional database. The method includes providing the user trust data, the transactional data, and the blockchain transactional data to the analysis module to generate: (i) a portion of the second-domain value correlated to the user to reserve as collateral for a loan, (ii) an interest rate for the loan, and (iii) a portion of the reserved collateral to provide to a lending service provider.

In other features, the method includes generating, at an orchestration module, a user interface element on a user interface, monitoring the user interface element to determine if the user selects the user interface element, and, in response to the user selecting the user interface element, retrieving, at the orchestration module, user trust data from the user trust database through the user trust programming interface. In other features, the method includes accessing, from the blockchain transactional module, a cryptocurrency wallet address on a distributed ledger, parsing data from the cryptocurrency wallet address to generate blockchain transactional data, and sending the generated blockchain transactional data to the blockchain transactional programming interface.

In other features, the method includes accessing, from the blockchain transactional module, a cryptocurrency wallet address on a secondary mesh network, parsing data from the cryptocurrency wallet address to generate blockchain transactional data, and sending the generated blockchain transactional data to the blockchain transactional programming interface. In other features, the method includes accessing, from the orchestration module, a cryptocurrency wallet address and parsing data from the cryptocurrency wallet address to generate blockchain transactional data. In other features, the method includes accessing, from the orchestration module, a cryptocurrency wallet address on a distributed ledger and parsing data from the cryptocurrency wallet address to generate blockchain transactional data.

In other features, the method includes accessing, from the orchestration module, a cryptocurrency wallet address on a secondary mesh network and parsing data from the cryptocurrency wallet address to generate blockchain transactional data. In other features, the method includes generating, at the analysis module, input vectors from the user trust data, the transactional data, and the blockchain transactional data and providing the input vectors to a trained machine learning model to generate: (i) the portion of the second-domain value correlated to the user to reserve as collateral for the loan, (ii) the interest rate for the loan, and (iii) the portion of the reserved collateral to provide to the lending service provider.

In other features, the trained machine learning model is a neural network. In other features, the method includes generating, at the orchestration module, a second user interface element based on the portion of the second-domain value correlated to the user to reserve as collateral for the loan, generating, at the orchestration module, a third user interface element based on the interest rate for the loan, and generating, at the orchestration module, a fourth user interface element based on the portion of the reserved collateral to provide to the lending service provider.

An integration system for a platform of platforms, includes a user trust platform including a user trust database including user trust data associated with a user, and a user trust programming interface configured to provide access to the user trust database. The system includes a digital transactional platform including a transactional database including transactional data indicative of an amount of first-domain value correlated to the user, and a digital transactional programming interface configured to provide access to the transactional database. The system includes a blockchain transactional platform including a blockchain transactional database including blockchain transactional data indicative of an amount of second-domain value correlated to the user, and a blockchain transactional programming interface configured to provide access to the blockchain transactional database.

The system includes an orchestration platform including an orchestration module, an analysis module, a data services module configured to determine and store second-domain value pricing data, and an orchestration platform programming interface configured to provide access to the orchestration module. The orchestration module is configured to retrieve user trust data from the user trust database through the user trust programming interface, retrieve transactional data from the transactional database through the digital transactional programming interface, retrieve blockchain transactional data from the blockchain transactional database through the blockchain transactional programming interface, and provide the user trust data, the transactional data, the blockchain transactional data, and the second-domain value pricing data to the analysis module to generate: (i) a portion of the second-domain value correlated to the user to reserve as collateral for a loan, and (ii) a variable interest rate for the loan.

In other features, the orchestration module is configured to generate a user interface element on a user interface, monitor the user interface element to determine if the user selects the user interface element, and, in response to the user selecting the user interface element, retrieve user trust data from the user trust database through the user trust programming interface. In other features, the blockchain transactional module is configured to access and parse a cryptocurrency wallet address on a distributed ledger to generate blockchain transactional data and send the generated blockchain transactional data to the blockchain transactional programming interface.

In other features, the blockchain transactional module is configured to access and parse a cryptocurrency wallet address on a secondary mesh network to generate blockchain transactional data and send the generated blockchain transactional data to the blockchain transactional programming interface. In other features, the orchestration module is configured to access and parse a cryptocurrency wallet address to generate blockchain transactional data. In other features, the orchestration module is configured to access and parse a cryptocurrency wallet address on a distributed ledger to generate blockchain transactional data.

In other features, the orchestration module is configured to access and parse a cryptocurrency wallet address on a secondary mesh network to generate blockchain transactional data. In other features, the analysis module is configured to generate input vectors from the user trust data, the transactional data, the blockchain transactional data, and the second-domain value pricing data and provide the input vectors to a trained machine learning model to generate: (i) the portion of the second-domain value correlated to the user to reserve as collateral for the loan, and (ii) the variable interest rate for the loan. In other features, the trained machine learning model is a neural network. In other features, the orchestration module is configured to generate a second user interface element based on the portion of the second-domain value correlated to the user to reserve as collateral for the loan and generate a third user interface element based on the variable interest rate for the loan.

A computer-implemented method of automatically managing networked computer platforms, includes retrieving, at an orchestration module, user trust data from a user trust database through a user trust programming interface. The orchestration module is part of an orchestration platform, the orchestration platform includes an analysis module, a data services module, and an orchestration platform programming interface, the data services module is configured to determine and store second-domain value price volatility data, and the orchestration platform programming interface is configured to provide access to the orchestration module, and the user trust database and the user trust programming interface are parts of a user trust platform, the user trust database includes the user trust data, the user trust data is associated with a user, and the user trust programming interface is configured to provide access to the user trust database.

The method includes retrieving transactional data from a transactional database through a digital transactional programming interface. The transactional database and the digital transactional programming interface are parts of a digital transactional platform, the transactional database includes the transactional data, the transactional data indicates an amount of first-domain value correlated to the user, and the digital transactional programming interface is configured to provide access to the transactional database. The method includes retrieving blockchain transactional data from the blockchain transactional database through the blockchain transactional programming interface.

The blockchain transactional database and the blockchain transactional programming interface are parts of a blockchain transactional platform, the blockchain transactional database includes the blockchain transactional data, the blockchain transactional data indicates an amount of second-domain value correlated to the user, and the blockchain transactional programming interface is configured to provide access to the blockchain transactional database. The method includes providing the user trust data, the transactional data, the blockchain transactional data, and the second-domain value price volatility data to the analysis module to generate: (i) a portion of the second-domain value correlated to the user to reserve as collateral for a loan, (ii) a variable interest rate for the loan.

In other features, the method includes generating, at an orchestration module, a user interface element on a user interface, monitoring the user interface element to determine if the user selects the user interface element, and, in response to the user selecting the user interface element, retrieving, at the orchestration module, user trust data from the user trust database through the user trust programming interface. In other features, the method includes accessing, from the blockchain transactional module, a cryptocurrency wallet address on a distributed ledger, parsing data from the cryptocurrency wallet address to generate blockchain transactional data, and sending the generated blockchain transactional data to the blockchain transactional programming interface.

In other features, the method includes accessing, from the blockchain transactional module, a cryptocurrency wallet address on a secondary mesh network, parsing data from the cryptocurrency wallet address to generate blockchain transactional data, and sending the generated blockchain transactional data to the blockchain transactional programming interface. In other features, the method includes accessing, from the orchestration module, a cryptocurrency wallet address and parsing data from the cryptocurrency wallet address to generate blockchain transactional data. In other features, the method includes accessing, from the orchestration module, a cryptocurrency wallet address on a distributed ledger and parsing data from the cryptocurrency wallet address to generate blockchain transactional data.

In other features, the method includes accessing, from the orchestration module, a cryptocurrency wallet address on a secondary mesh network and parsing data from the cryptocurrency wallet address to generate blockchain transactional data. In other features, the method includes generating, at the analysis module, input vectors from the user trust data, the transactional data, the blockchain transactional data, and the second-domain value price volatility data and providing the input vectors to a trained machine learning model to generate: (i) the portion of the second-domain value correlated to the user to reserve as collateral for the loan, (ii) the variable interest rate for the loan. In other features, the trained machine learning model is a neural network. In other features, the method includes generating, at the orchestration module, a second user interface element based on the portion of the second-domain value correlated to the user to reserve as collateral for the loan and generating, at the orchestration module, a third user interface element based on the variable interest rate for the loan.

An integration system for a platform of platforms, includes a user trust platform including a user trust database including user trust data associated with a user, and a user trust programming interface configured to provide access to the user trust database. The system includes a digital transactional platform including a transactional database including transactional data indicative of an amount of first-domain value correlated to the user, and a digital transactional programming interface configured to provide access to the transactional database. The system includes a blockchain transactional platform including a blockchain transactional database including blockchain transactional data indicative of an amount of second-domain value correlated to the user, and a blockchain transactional programming interface configured to provide access to the blockchain transactional database.

The system includes an orchestration platform including an orchestration module, an analysis module, a data services module configured to determine and store second-domain value pricing data, and an orchestration platform programming interface configured to provide access to the orchestration module. The orchestration module is configured to retrieve user trust data from the user trust database through the user trust programming interface, retrieve transactional data from the transactional database through the digital transactional programming interface, retrieve blockchain transactional data from the blockchain transactional database through the blockchain transactional programming interface, and provide the user trust data, the transactional data, the blockchain transactional data, and the second-domain value pricing data to the analysis module to generate a variable interest rate for a loan.

In other features, the orchestration module is configured to generate a user interface element on a user interface, monitor the user interface element to determine if the user selects the user interface element, and, in response to the user selecting the user interface element, retrieve user trust data from the user trust database through the user trust programming interface. In other features, the blockchain transactional module is configured to access and parse a cryptocurrency wallet address on a distributed ledger to generate blockchain transactional data and send the generated blockchain transactional data to the blockchain transactional programming interface. In other features, the blockchain transactional module is configured to access and parse a cryptocurrency wallet address on a secondary mesh network to generate blockchain transactional data and send the generated blockchain transactional data to the blockchain transactional programming interface.

In other features, the orchestration module is configured to access and parse a cryptocurrency wallet address to generate blockchain transactional data. In other features, the orchestration module is configured to access and parse a cryptocurrency wallet address on a distributed ledger to generate blockchain transactional data. In other features, the orchestration module is configured to access and parse a cryptocurrency wallet address on a secondary mesh network to generate blockchain transactional data. In other features, the analysis module is configured to generate input vectors from the user trust data, the transactional data, the blockchain transactional data, and the second-domain value pricing data and provide the input vectors to a trained machine learning model to generate the variable interest rate for the loan. In other features, the trained machine learning model is a neural network. In other features, the orchestration module is configured to generate a second user interface element based on the variable interest rate for the loan.

A computer-implemented method of automatically managing networked computer platforms, includes retrieving, at an orchestration module, user trust data from a user trust database through a user trust programming interface. The orchestration module is part of an orchestration platform, the orchestration platform includes an analysis module, a data services module, and an orchestration platform programming interface, the data services module is configured to determine and store second-domain value price volatility data, and the orchestration platform programming interface is configured to provide access to the orchestration module, and the user trust database and the user trust programming interface are parts of a user trust platform, the user trust database includes the user trust data, the user trust data is associated with a user, and the user trust programming interface is configured to provide access to the user trust database.

The method includes retrieving transactional data from a transactional database through a digital transactional programming interface. The transactional database and the digital transactional programming interface are parts of a digital transactional platform, the transactional database includes the transactional data, the transactional data indicates an amount of first-domain value correlated to the user, and the digital transactional programming interface is configured to provide access to the transactional database. The method includes retrieving blockchain transactional data from the blockchain transactional database through the blockchain transactional programming interface.

The blockchain transactional database and the blockchain transactional programming interface are parts of a blockchain transactional platform, the blockchain transactional database includes the blockchain transactional data, the blockchain transactional data indicates an amount of second-domain value correlated to the user, and the blockchain transactional programming interface is configured to provide access to the blockchain transactional database. The method includes providing the user trust data, the transactional data, the blockchain transactional data, and the second-domain value price volatility data to the analysis module to generate a variable interest rate for a loan.

In other features, the method includes generating, at an orchestration module, a user interface element on a user interface, monitoring the user interface element to determine if the user selects the user interface element, and, in response to the user selecting the user interface element, retrieving, at the orchestration module, user trust data from the user trust database through the user trust programming interface. In other features, the method includes accessing, from the blockchain transactional module, a cryptocurrency wallet address on a distributed ledger, parsing data from the cryptocurrency wallet address to generate blockchain transactional data, and sending the generated blockchain transactional data to the blockchain transactional programming interface.

In other features, the method includes accessing, from the blockchain transactional module, a cryptocurrency wallet address on a secondary mesh network, parsing data from the cryptocurrency wallet address to generate blockchain transactional data, and sending the generated blockchain transactional data to the blockchain transactional programming interface. In other features, the method includes accessing, from the orchestration module, a cryptocurrency wallet address and parsing data from the cryptocurrency wallet address to generate blockchain transactional data. In other features, the method includes accessing, from the orchestration module, a cryptocurrency wallet address on a distributed ledger and parsing data from the cryptocurrency wallet address to generate blockchain transactional data.

In other features, the method includes accessing, from the orchestration module, a cryptocurrency wallet address on a secondary mesh network and parsing data from the cryptocurrency wallet address to generate blockchain transactional data. In other features, the method includes generating, at the analysis module, input vectors from the user trust data, the transactional data, the blockchain transactional data, and the second-domain value price volatility data and providing the input vectors to a trained machine learning model to generate the variable interest rate for the loan. In other features, the trained machine learning model is a neural network. In other features, the method includes generating, at the orchestration module, a second user interface element based on the variable interest rate for the loan.

An integration system for a platform of platforms, includes a user trust platform, including a user trust database including user trust data correlated to a loan associated with a user, the user trust data including a loan amount and an amortization table, a user trust module configured to update the user trust data, and a user trust programming interface configured to provide access to the user trust database and the user trust module. The system includes a blockchain transactional platform including a blockchain transactional database including blockchain transactional data indicative of an amount of second-domain value related to the user, a blockchain transactional module configured to make and receive second-domain value digital transfers for the user, and a blockchain transactional programming interface configured to provide access to the blockchain transactional database and the blockchain transactional module.

The system includes an orchestration platform including an orchestration module, and an orchestration platform programming interface. The orchestration module is configured to receive the user trust data from the user trust database via the user trust programming interface, receive the blockchain transactional data from the blockchain transactional database via the blockchain transactional programming interface, parse the blockchain transactional data and the user trust data to determine if the amount of second-domain value related to the user is sufficient to cover a loan digital transfer, and, in response to determining that the amount of second-domain value related to the user is sufficient to cover the loan digital transfer, generate a payload. The orchestration module is configured to send the payload to the blockchain transactional programming interface and, in response to receiving the payload, the blockchain transactional programming interface is configured to initiate a second-domain value digital transfer from the user to a lending service provider.

The user trust module is configured to monitor for the second-domain value digital transfer from the user to the lending service provider, and in response to detecting the second-domain value digital transfer from the user to the lending service provider, (i) update the loan amount according to a market price of the second-domain value digital transfer, and (ii) update the amortization table according to the market price of the second-domain value digital transfer. In other features, the orchestration module is configured to generate a user interface element on a user interface, monitor the user interface element to determine if the user selects the user interface element, and, in response to the user selecting the user interface element, receive the user trust data from the user trust database via the user trust programming interface.

In other features, the blockchain transactional module is configured to access and parse a cryptocurrency wallet address on a distributed ledger to generate blockchain transactional data and send the generated blockchain transactional data to the blockchain transactional programming interface. In other features, the blockchain transactional module is configured to access and parse a cryptocurrency wallet address on a secondary mesh network to generate blockchain transactional data and send the generated blockchain transactional data to the blockchain transactional programming interface. In other features, the orchestration module is configured to access and parse a cryptocurrency wallet address to generate blockchain transactional data.

In other features, the orchestration module is configured to access and parse a cryptocurrency wallet address on a distributed ledger to generate blockchain transactional data. In other features, the orchestration module is configured to access and parse a cryptocurrency wallet address on a secondary mesh network to generate blockchain transactional data. In other features, in response to determining that the amount of second-domain value related to the user is not sufficient to cover the loan digital transfer, the orchestration platform is configured to generate an alert. In other features, the alert is a second user interface element. The system includes a user device having a display. The user device is configured to access the user interface.

A computer-implemented method of automatically managing networked computer platforms, includes receiving, at an orchestration module, user trust data from a user trust database via a user trust programming interface. The orchestration module is part of an orchestration platform, and the orchestration platform includes an orchestration platform programming interface, and the user trust database and the user trust programming interface are parts of a user trust platform, the user trust platform includes a user trust module, the user trust database includes user trust data, the user trust data is correlated to a loan associated with a user, the user trust data includes a loan amount and an amortization table, the user trust module is configured to update the user trust data, and the user trust programming interface is configured to provide access to the user trust database and the user trust module.

The method includes receiving blockchain transactional data from a blockchain transactional database via a blockchain transactional programming interface. The blockchain transactional database and the blockchain transactional programming interface are parts of a blockchain transactional platform, the blockchain transactional platform includes a blockchain transactional module, the blockchain transactional database includes the blockchain transactional data, the blockchain transactional data indicates an amount of second-domain value related to the user, the blockchain transactional module is configured to make and receive second-domain value digital transfers for the user, and the blockchain transactional programming interface is configured to provide access to the blockchain transactional database and the blockchain transactional module.

The method includes parsing the blockchain transactional data and the user trust data to determine if the amount of second-domain value related to the user is sufficient to cover a loan digital transfer, in response to determining that the amount of second-domain value related to the user is sufficient to cover the loan digital transfer, generating a payload, sending the payload to the blockchain transactional programming interface, receiving the payload at the blockchain transactional programming interface, in response to receiving the payload at the blockchain transactional programming interface, initiating a second-domain value digital transfer from the user to a lending service provider, and monitoring, at the user trust module, for the second-domain value digital transfer from the user to the lending service provider.

The method includes, in response to detecting the second-domain value digital transfer from the user to the lending service provider: updating the loan amount according to a market price of the second-domain value digital transfer and updating the amortization table according to the market price of the second-domain value digital transfer.

In other features, the method includes generating, at an orchestration module, a user interface element on a user interface, monitoring the user interface element to determine if the user selects the user interface element, and, in response to the user selecting the user interface element, receiving, at the orchestration module, user trust data from the user trust database via the user trust programming interface. In other features, the method includes accessing, from the blockchain transactional module, a cryptocurrency wallet address on a distributed ledger, parsing data from the cryptocurrency wallet address to generate blockchain transactional data, and sending the generated blockchain transactional data to the blockchain transactional programming interface.

In other features, the method includes accessing, from the blockchain transactional module, a cryptocurrency wallet address on a secondary mesh network, parsing data from the cryptocurrency wallet address to generate blockchain transactional data, and sending the generated blockchain transactional data to the blockchain transactional programming interface. In other features, the method includes accessing, from the orchestration module, a cryptocurrency wallet address and parsing data from the cryptocurrency wallet address to generate blockchain transactional data. In other features, the method includes accessing, from the orchestration module, a cryptocurrency wallet address on a distributed ledger and parsing data from the cryptocurrency wallet address to generate blockchain transactional data.

In other features, the method includes accessing, from the orchestration module, a cryptocurrency wallet address on a secondary mesh network and parsing data from the cryptocurrency wallet address to generate blockchain transactional data. In other features, the method includes, in response to determining that the amount of second-domain value related to the user is not sufficient to cover the loan digital transfer, generating an alert at the orchestration platform. In other features, the alert is a second user interface element. In other features, the method includes accessing, at a user device having a display, the user interface.

Further areas of applicability of the present disclosure will become apparent from the detailed description, the claims, and the drawings. The detailed description and specific examples are intended for purposes of illustration only and are not intended to limit the scope of the disclosure.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIGS. 1A and 1B together form a block diagram of an example implementation of an analysis module that may form a part of some embodiments of an integration system for a system of platforms.

FIG. 2 is a block diagram of some examples of an integration system for a system of platforms.

FIG. 3 is a block diagram of a system of platforms with some examples of an orchestration platform shown in detail.

FIG. 4 is a block diagram of a system of platforms with some examples of a digital transactional platform shown in detail.

FIG. 5 is a block diagram of a system of platforms with some examples of a user trust platform shown in detail.

FIG. 6 is a block diagram of the system of platforms with some examples of a blockchain transactional platform shown in detail.

FIG. 7 is a flowchart of an example process for automatically orchestrating the transmission, reception, and processing of digital payloads between components of the system of platforms.

FIG. 8 is a flowchart of an example process for automatically orchestrating the transmission, reception, and processing of digital payloads between components of the system of platforms.

FIG. 9 is a flowchart of an example process for automatically orchestrating the transmission, reception, and processing of digital payloads between components of the system of platforms.

FIG. 10 is a flowchart of an example process for automatically orchestrating the transmission, reception, and processing of digital payloads between components of the system of platforms.

FIG. 11 is a flowchart of an example process for automatically orchestrating the transmission, reception, and processing of digital payloads between components of the system of platforms.

FIG. 12 is a flowchart of an example process for automatically orchestrating the transmission, reception, and processing of digital payloads between components of the system of platforms.

FIG. 13 is a flowchart of an example process for automatically orchestrating the transmission, reception, and processing of digital payloads between components of the system of platforms.

FIG. 14 is a flowchart of an example process for automatically orchestrating the transmission, reception, and processing of digital payloads between components of the system of platforms.

FIG. 15 is a flowchart of an example process for automatically orchestrating the transmission, reception, and processing of digital payloads between components of the system of platforms.

FIG. 16 is a flowchart of an example process for automatically orchestrating the transmission, reception, and processing of digital payloads between components of the system of platforms.

FIG. 17 is a flowchart of an example process for automatically orchestrating the transmission, reception, and processing of digital payloads between components of the system of platforms.

FIG. 18 is a flowchart of an example process for automatically orchestrating the transmission, reception, and processing of digital payloads between components of the system of platforms.

FIG. 19 is a flowchart of an example process for automatically orchestrating the transmission, reception, and processing of digital payloads between components of the system of platforms.

FIG. 20 is a flowchart of an example process for automatically orchestrating the transmission, reception, and processing of digital payloads between components of the system of platforms.

FIG. 21 is a flowchart of an example process for automatically orchestrating the transmission, reception, and processing of digital payloads between components of the system of platforms.

FIG. 22 is a block diagram showing the cryptocurrency payment and distribution platform in relation to the markets of cryptocurrency, traditional financial service providers, insurance, and merchants.

FIG. 23 is a block diagram of an exemplary system for secure storage of cryptocurrency.

FIG. 24 is a block diagram of an exemplary cryptocurrency system.

FIG. 25 is a block diagram of an exemplary computing device in a cryptocurrency payment and distribution platform.

FIG. 26 is a block diagram showing an example cryptocurrency vault storing offline devices.

FIG. 27 is a block diagram showing an example of the system infrastructure for a payment system according to an example embodiment.

FIG. 28 is a block diagram shows an example database structure storing information by various entities to facilitate a transaction.

FIG. 29 shows an example flow chart for account creation using the cryptocurrency payment and distribution platform.

FIG. 30 shows an example flow chart for algorithms to transmit various data inputs and API calls in coordination with the cryptocurrency payment and distribution platform.

FIG. 31 shows an example flow chart for a payment transaction using the cryptocurrency payment and distribution platform.

FIG. 32 is a block diagram showing machine learning based processes incorporated in the cryptocurrency payment and distribution platform.

FIG. 33 shows an example flow chart for paying for a transaction using a cryptocurrency accrued in the form of a reward.

FIG. 34 shows an example flow chart in which a machine learning model can be used to determine how much cryptocurrency may be used for a given transaction.

FIG. 35 shows an example flow chart for optimizing balances between cryptocurrency and fiat money using the cryptocurrency payment and distribution platform.

FIG. 36 is block diagram showing example processes including algorithms to provide availability of fiat and/or cryptocurrency to facilitate a transaction.

FIG. 37 shows an example user interface for an application of a client device capable of interacting with the cryptocurrency payment and distribution platform.

FIG. 38 shows an example user interface for making a payment using the cryptocurrency payment and distribution platform.

FIG. 39 shows an example user interface for providing a user of the cryptocurrency payment and distribution platform with an option for adding fiat currency or cryptocurrency to the user's account or wallet.

FIG. 40 shows an example user interface for providing a user of the cryptocurrency payment and distribution platform with an option for funding the user's accounts.

FIG. 41 is a flow chart depicting an example of a customer onboarding process for creating a platform account for loyalty-based cryptocurrency rewards.

FIG. 42 is a flow chart depicting an example of an order process associated with a platform account for loyalty-based cryptocurrency rewards.

FIG. 43 is a flow chart depicting an example of a redemption process within a platform account for loyalty-based cryptocurrency rewards.

FIG. 44 is a flow chart depicting an example of calculating expiration of rewards within a platform account for loyalty-based cryptocurrency rewards.

FIG. 45 is a top view showing of a mobile device showing a user interface of a mobile application associated with a platform account for loyalty-based cryptocurrency rewards.

FIG. 46 is a top view showing of a mobile device showing an example of a user interface of a mobile application associated with a platform account for loyalty-based cryptocurrency rewards, showing rewards balance data.

FIG. 47 is a top view showing of a mobile device showing an example of a user interface of a mobile application associated with a platform account for loyalty-based cryptocurrency rewards, showing cryptocurrency valuation of an account balance.

FIG. 48 is a top view showing of a mobile device showing an example of a user interface of a mobile application associated with a platform account for loyalty-based cryptocurrency rewards, showing amounts awarded to a customer's account.

FIG. 49 is a top view showing of a mobile device showing an example of a user interface of a mobile application associated with a platform account for loyalty-based cryptocurrency rewards, showing the presentation of account options.

FIG. 50 is a flow chart depicting an example of a reconciliation process within a platform 2200 account for loyalty-based cryptocurrency rewards.

FIG. 51 is a flow chart depicting an example of entities and facilities participating in the operation of a platform account for loyalty-based cryptocurrency rewards.

FIG. 52 is a flow chart depicting an example of a digital asset backed peer-to-peer lending process. The process may be facilitated, for example, by the platform using a database structure similar to the database structure to create a yield product.

FIG. 53 is a block diagram showing an example of an insurance system associated with the platform.

FIG. 54 is a block diagram of an example of a cryptocurrency micro transaction system 5400 associated with the platform.

FIG. 55 shows an example of a main user interface for use with the payment infrastructure platform.

FIG. 56 shows an example of a bank account user interface for a user to create a bank account within the consumer application.

FIG. 57 shows an example of a payment authentication user interface for the user to authenticate a payment within the consumer application.

FIG. 58 shows an example of a trading user interface of the consumer application 5420.

FIG. 59 shows an example of a trade confirmation user interface of the consumer application.

FIG. 60 shows an example of a payment route user interface of the consumer application.

FIG. 61 shows an example of a donation user interface of the website interface.

FIG. 62 shows an example of a scan code user interface.

FIG. 63 is a block diagram of an example of a cryptocurrency intermediary transaction system.

FIG. 64 is a block diagram of an example of a cryptocurrency know your customer (KYC) system.

In the drawings, reference numbers may be reused to identify similar and/or identical elements.

### DETAILED DESCRIPTION

### Analysis Module

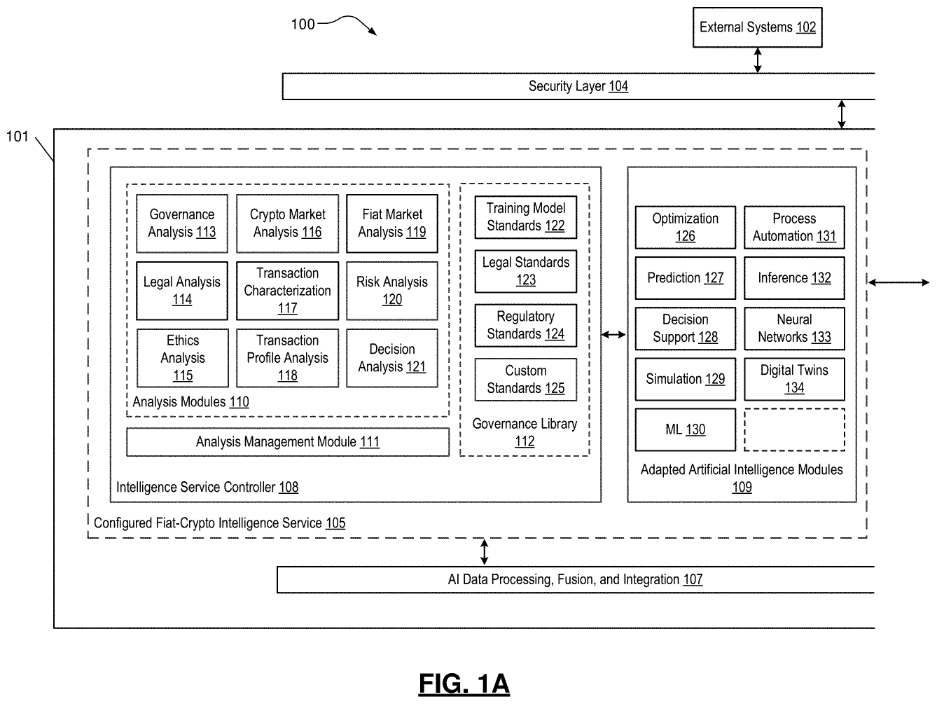

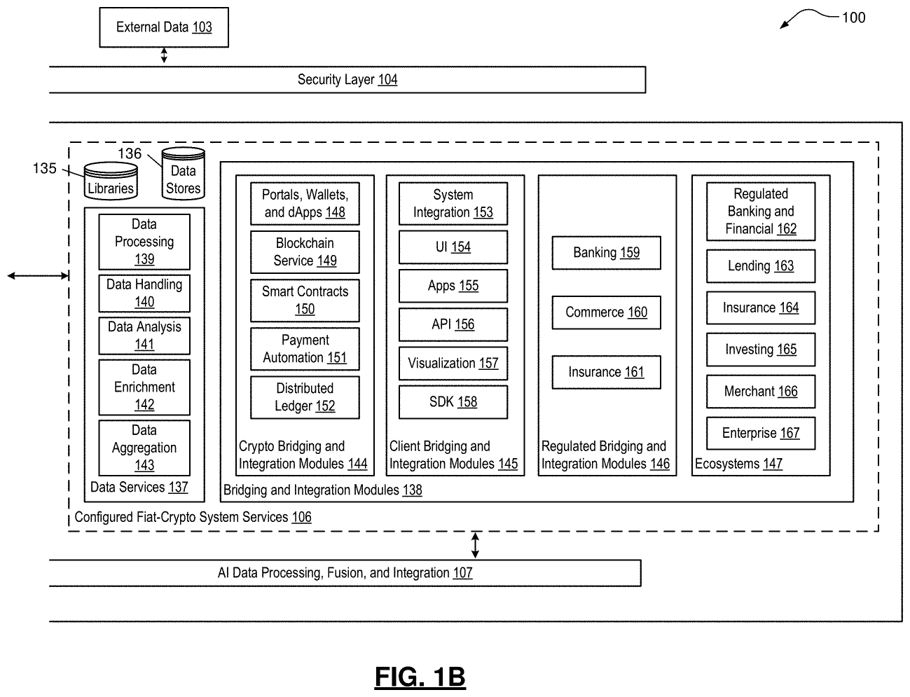

FIGS. 1A and 1B (collectively FIG. 1) are block diagrams of an example implementation of an analysis module 101 that may form a part of some embodiments of an integration system for a system of platforms 100. External systems 102 of the system of platforms 100 may access the analysis module 101 through a security layer 104. The security layer 104 may be configured to provide secured access between the analysis module 101 and the external systems 102 only when an external system 102 presents valid credentials, which are authenticated by the security layer 104. If the external system 102 does not present valid credentials, the security layer 104 denies communications between the external system 102 and the analysis module 101. In various implementations, the security layer 104 may facilitate the analysis module 101 to read and write to external data sources 103. In various implementations, the analysis module 101 may include a configured fiat-crypto intelligence service module 105, a configured fiat-crypto system services module 106, and an artificial intelligence (AI) data processing, fusion, and integration module 107.

In various implementations, the configured fiat-crypto intelligence service module 105 may include an intelligence service controller module 108 and adapted artificial intelligence modules 109. In various implementations, the intelligence service controller modules 108 may include analysis modules 110, an analysis management module 111, and a governance library 112. The analysis modules 110 may include a governance analysis module 113, a legal analysis module 114, an ethics analysis module 115, a crypto market analysis module 116, a transaction characterization module 117, a transaction profile analysis module 118, a fiat market analysis module 119, a risk analysis module 120, and a decision analysis module 121. The governance analysis module 113 may analyze components of the system of platforms 100 by tracking financial transactions, managing performance and control data, tracking and managing transactions for compliance, tracking and managing operations, and tracking and managing financial disclosures.

The legal analysis module 114 may analyze components of the system of platforms 100 (and interactions between components) for compliance with various federal and state laws, regulations, and rules governing financial institutions. The ethics analysis module 115 analyzes components of the system of platforms 100 (and interactions between components) for compliance with ethical rules governing financial institutions. The crypto market analysis module 116 analyzes blockchains and cryptocurrency markets and exchanges based on pricing metrics, news, and performance data (such as technical data). In various implementations the crypto market analysis module 116 performs technical analysis on blockchains and cryptocurrency markets and exchanges by analyzing price movements and trading volumes over specific periods of time to calculate metrics such as relative strength and/or moving averages, and/or performs regressions on market data to determine relationships between variables. In various implementations, the crypto market analysis module 116 uses mathematical indicators to evaluate statistical trends to predict price direction in the crypto market, such as by analyzing past price changes and volume data to predict future price changes.

The transaction characterization module 117 classifies transactions performed by the components of the system of platforms 100 (and transactions between components), classifying each transaction into one or more categories. The transaction profile analysis module 118 monitors transactions between the components of the system of platforms 100 for each transaction or group of transactions, or for each user or group of users. In various implementations, the transaction profile analysis module 118 monitors transactions within each transaction or group of transactions (or for each user or group of users) to determine whether the monitored transaction fits the generated profile. In various implementations, if the monitored transaction does not fit the generated profile, the transaction profile analysis module 118 may generate an alert and/or halt the monitored transaction.

The fiat market analysis module 119 analyzes fiat currency markets based on market data, news, and technical data. In various implementations, the fiat market analysis module 119 performs technical analysis, such as by analyzing price movements and trading volume over specific periods of time to calculate relative strength and/or moving averages, and/or performs regressions. In various implementations, the fiat market analysis module 119 uses mathematical indicators to evaluate statistical trends to predict price direction in the fiat currency market, such as by analyzing past price changes and volume data to predict future price changes. The decision analysis module 121 automatically models the outcomes of various decisions and/or actions make or taken by the various components of the system of platforms 100. In various implementations, the decision analysis module 121 automatically determines optimal courses of action for the components of the system of platforms 100 and optimal outcomes based on various courses of actions. The analysis management module 111 determines which module or modules of the analysis modules 110 to invoke based on a request.

In various implementations, the governance library 112 includes a training model standards library 122, a legal standards library 123, a regulatory standards library 124, and a custom standards library 125. The training model standards library 122 contains data governing the training of each of the various machine learning models of the analysis module 101. The legal standards library 123 contains rules related to federal and state laws that are suitable for use by the analysis modules 110. The regulatory standards library 124 contains rules related to federal and state regulations and rules that are suitable for use by the analysis modules 110. The custom standards library 125 contains custom rules set by users that are suitable for use by the analysis modules 110.

In various implementations, the adapted artificial intelligence modules 109 may include an optimization module 126, a prediction module 127, a decision support module 128, a simulation module 129, a machine learning (ML) module 130, a process automation module 131, an inference module 132, a neural networks module 133, and a digital twins module 134. The optimization module 126 may enable the analysis module 101 to solve optimization problems according to bracketing algorithms (such as the Fibonacci search, golden-section search, and bisection method algorithms), local descent algorithms (such as the line search algorithm), and/or first order algorithms (such as the gradient descent, momentum, AdaGrad, RMSProp, and Adam algorithms). The prediction module 127 may enable the analysis module 101 to make predictions using classification models, clustering models, forecast models, outliers models, time series models, logistic regression, random forest models, generalized linear models, gradient boosted models, K-means algorithms, and/or Prophet algorithms.

The decision support module 128 may enable and run decision support systems (DSSs), which may be used to manage large volumes of data. In various implementations, DSSs may perform simulations of decision-making procedures taken by the components of the system of platforms 100 to determine optimal courses of action, gather and analyze data, and inform overall decision making as to course of action for the components of the system of platforms 100. The simulation module 129 may be used to generate synthetic input vectors for training machine learning models (for example, as in generative adversarial networks).

The machine learning module 130 may enable and run linear regression models, logistic regression modules, decision true models, support vector machine algorithms, Naïve Bayes algorithms, K-nearest neighbor algorithms, random forest algorithms, dimensionality reduction algorithms, gradient boosting algorithms, and/or AdaBoost algorithms. The process automation module 131 may automate any of the processes performed by components of the system of platforms 100. The inference module 132 may use a trained machine learning model to infer a result using real-world data as inputs.

The neural networks module 133 may enable and run convolutional neural networks, long short term memory (LSTM) networks, recurrent neural networks, generative adversarial networks, radial basis function networks, multilayer perceptrons, self-organizing maps, deep belief networks, restricted Boltzmann machines, and autoencoders. The digital twins module 134 may create virtual representations of components of the system of platforms 100 that serve as the real-time digital counterparts of the real components. Simulations may be performed on the digital counterparts to allow users to understand how the system is performing in the present, as well as to allow users to understand how the system will perform under hypothetical conditions or in the future.

In various implementations, the configured fiat-crypto system services module 106 includes libraries 135, one or more data stores 136, a data services module 137, and bridging and integration modules 138. In various implementations, the libraries 135 may be a collection of non-volatile resources used by modules and applications of the configured fiat-crypto system services module 106. In various implementations, the data stores 136 may be shared volatile or non-volatile computer readable storage media on which the components of the configured fiat-crypto system services, fiat-crypto intelligence services module 105, and/or AI data procession, fusion, and integration module 107 may be stored or may use.

In various implementations, the data services module 137 includes a data processing module 139, a data handling module 140, a data analysis module 141, a data enrichment module 142, and a data aggregation module 143. The data processing module 139 processes data that the configured fiat-crypto system services module 106 receives from various components of the system of platforms 100. The data handling module 140 handles data that the configured fiat-crypto system services module 106 receives from various components of the system of platforms 100. The data analysis module 141 performs analysis on data that the configured fiat-crypto system services module 106 receives from various components of the system of platforms 100. The data aggregation module 143 aggregates data that the configured fiat-crypto system services module 106 receives from various components of the system of platforms 100.

In various implementations, the bridging and integration modules 138 includes crypto bridging and integration modules 144, client bridging and integration modules 145, regulated bridging and integration modules 146, and ecosystems modules 147. In various implementations, the crypto bridging and integration modules 144 includes portals, wallets, and distributed apps (dApps) module 148, a blockchain service module 149 a smart contracts module 150, a payment automation module 151, and a distributed ledger module 152. The portals, wallets, and dApps module 148 bridges components of the analysis module 101 with external portals, wallets, and decentralized apps. The blockchain service module 149 bridges components of the analysis module 101 with external blockchain services. The smart contracts module 150 bridges components of the analysis module with external payment automation applications. The payment automation module 151 bridges components of the analysis module 101 with external payment automation applications. The distributed ledger module 152 bridges components of the analysis module 101 with external payment automation applications.

In various implementations, the client bridging and integration modules 145 include a system integration module 153, a user interface (UI) module 154, an applications library 155, an application programming interface (API) module 156, a visualization module 157, and a software development kit (SDK) module 158. The system integration module 153 performs system integration functions between components of the analysis module 101 and external devices. The user interface module 154 generates and outputs user interfaces accessible by components of the system of platforms 100. The applications library 155 contains applications that may be accessed by external systems through the API. The applications may interface with other components of the analysis module 101 and/or the other components of the system of platforms 100. The API module 156 facilitates communications between the applications and modules of the analysis module 101 and external systems 102, such as the various components of the system of platforms 100. The visualization module 157 generates visual models that may be stored and/or output to the user interface module 154 (and subsequently rendered on the user interface). The SDK module 158 contains a collection of software development tools suitable for creating and modifying applications, such as those of the applications library 150.

In various implementations, the regulated bridging and integration modules 146 includes a banking module 159, a commerce module 160, and an insurance module 161. The banking module 159 facilitates communication between applications and modules of the analysis module 101 and external banking systems. The commerce module 160 facilitates communication between applications and modules of the analysis module 101 and external commerce systems. The insurance module 161 facilitates communication between applications and modules of the analysis module 101 and external insurance systems.

In various implementations, the ecosystems modules 147 include a regulated banking and financial module 162, a lending module 163, an insurance module 164, an investing module 165, a merchant module 166, and an enterprise module 167. The regulated banking and financial module 162 facilitations communications between applications and modules of the analysis module 101 and external regulated banking and financial ecosystems. The lending module 163 facilitations communications between applications and modules of the analysis module 101 and external lending ecosystems. The insurance module 164 facilitates communications between applications and modules of the analysis module 101 and external insurance ecosystems. The investing module 165 facilitates communications between applications and modules of the analysis module 101 and external insurance ecosystems. The merchant module 166 facilitates communications between applications and modules of the analysis module 101 and external merchant ecosystems. The enterprise module 167 facilitates communications between applications and modules of the analysis module 101 and external enterprise ecosystems.

In various implementations, the analysis modules 110, analysis management module 111, and the governance library 112 may communicate with each other. In various implementations, the intelligence service controller 108 may communicate with the adapted artificial intelligence modules 109. In various implementations, the libraries 135, data stores 136, data services modules 137, and bridging and integration modules 138 may communicate with each other. In various implementations, the configured fiat-crypto intelligence service module 105, configured fiat-crypto system services module 106, and AI data processing, fusion, and integration module 107 may communicate with each other.

### System of Platforms

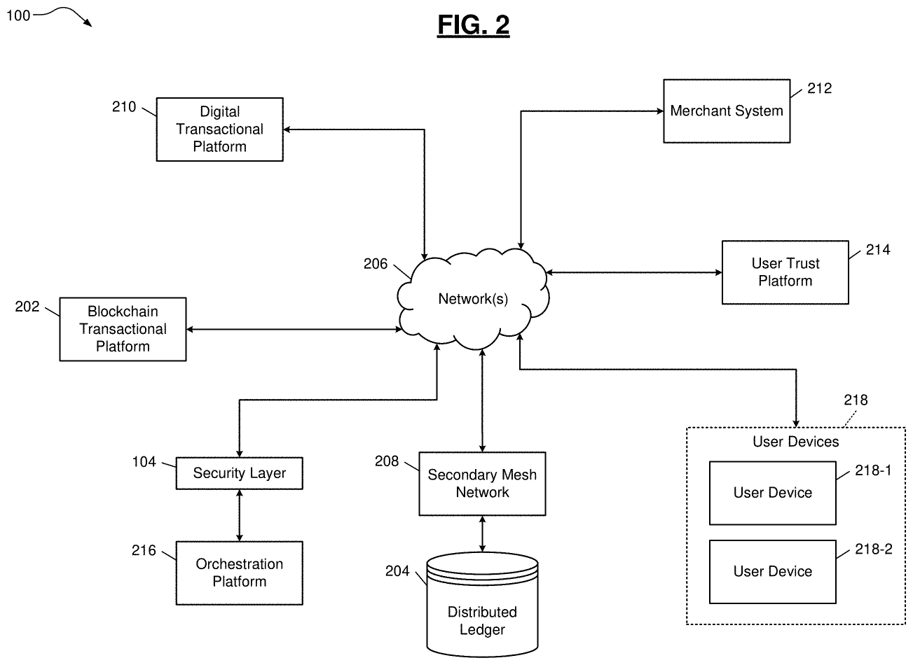

FIG. 2 is a block diagram of some examples of an integration system for a system of platforms 100. As illustrated in FIG. 2, the system of platforms 100 may include a blockchain-based media exchange platform, such as a blockchain transactional platform 202. In various implementations, the blockchain transactional platform 202 may be configured to allow users to buy, store, and trade different blockchain-based assets (such as cryptocurrencies), trade digital assets, access decentralized crypto apps, and/or buy and sell non-fungible tokens. In various implementations, the blockchain transactional platform 202 may access a blockchain 204 through one or more networks, such as network 206. In various implementations, the blockchain 204 may be a cryptocurrency public ledger, such as the Bitcoin blockchain. In various implementations, the blockchain transactional platform 202 may access the blockchain 204 directly through the network 206. In various implementations, the blockchain transactional platform 202 may access a secondary mesh network 208 layered on top of the blockchain 204.

In various implementations, the secondary mesh network 208 may be a payment protocol layered on top of the blockchain 204. The secondary mesh network 208 may improve the performance of applications relying on the values stored in the blockchain 204 by facilitating transactions outside of the blockchain 204. By facilitating transactions outside of the blockchain 204, the secondary mesh network 208 may reduce the overall computational burden—and attendant energy consumption—associated with performing transactions on the blockchain 204 network.

In various implementations, the secondary mesh network 208 may include a peer-to-peer system for making payments of cryptocurrency through a network of bidirectional payment channels that do not directly delegate custody of funds on the blockchain 204. For example, the secondary mesh network 208 may leverage smart contracts to create one or more payment channels between one or more users off the blockchain 204. The payment channels may occur on top of or outside of the blockchain 204. Each payment channel may have its own ledger, and once a payment channel is open, users may make any number of transactions on the payment channel. Payments on each payment channel is recorded on the payment channel's ledger, away from the main blockchain 204. Each party may close the payment channel at will. When the payment channel is closed, the payment channel may broadcast a final version of the payment channel's ledger, which may then be settled on the blockchain 204. In various implementations, the secondary mesh network 208 may be the Lightning Network, which is layered on top of the Bitcoin blockchain.

As illustrated in FIG. 2, the system of platforms 100 may include a digital transactional platform 210. The digital transactional platform 210 may include core banking software, which may provide the digital infrastructure to build, deploy, and administer financial products. In various implementations, the digital transactional platform 210 handles financial transactions such as fiat currency processing and accounting. In various implementations, the digital transactional platform 210 may provide real-time bank account and transactional processing, enable online payment processing, enable online (e.g., remote) deposits of financial instruments, allow for customer self-service, and provide an interface for the customer to interact remotely with support personnel.

The system of platforms may also include a merchant system 212. The merchant system 212 may allow merchants and/or businesses to process and complete credit and debit card transactions. In various implementations, the merchant system 212 securely transmits data so that money from a customer's issuing bank can be digitally transferred to a merchant's account. As shown in FIG. 2, the system of platforms 100 may also include a user trust platform 214. In various implementations, the user trust platform 214 may be a loan management system, and configured to verify a borrower's identity, employment and/or salary information, credit score, and banking history (e.g., through the digital transactional platform 210). In various implementations, the user trust platform 214 may facilitate a loan originator's processing of a loan application, underwriting process, credit review and decision making, quality control, and loan funding. In various implementations, the user trust platform 214 may contain databases with loan information for borrowers.

As illustrated in FIG. 2, the system of platforms 100 may include an orchestration platform 216. The orchestration platform 216 may access the network 206 through security layer 104. In various implementations, the orchestration platform 216 may access the blockchain transactional platform 202, digital transactional platform 210, merchant system 212, and/or the user trust platform 214 through the network 206. As will be discussed in detail later, in various implementations, the orchestration platform 216 orchestrates data routing and exchange between the components of the system of platforms 100. In various implementations, the orchestration platform receives data from the blockchain transactional platform 202, distributed ledger 204, secondary mesh network 208, digital transactional platform 210, merchant system 212, user trust platform 214, and/or one or more user devices 218 (such as user device 218-1 and/or user device 218-2), and automatically performs synthesis, fusion, analysis, and transformation operations on the data.

In various implementations, the user devices 218 may access the orchestration platform 216 (for example, through the security layer 104), the blockchain transactional platform 202, the distributed ledger 204, the secondary mesh network 208, the digital transactional platform 210, the merchant system 212, the user trust platform 214, and/or other user devices 218 through the network 206. In various implementations, the blockchain transactional platform 202, the distributed ledger 204, the secondary mesh network 208, the digital transactional platform 210, the merchant system 212, the user trust platform 214, and/or other user devices 218 may access the user device 218 through the network 206.

### Orchestration Platform

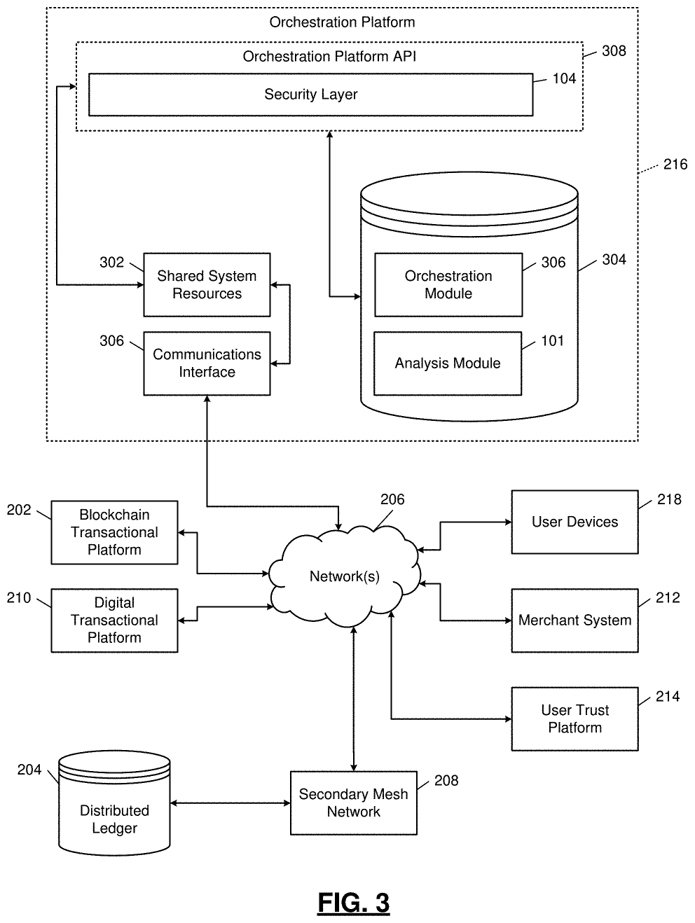

FIG. 3 is a block diagram of the system of platforms 100 with some examples of the orchestration platform 216 shown in detail. As illustrated in FIG. 3, the orchestration platform 216 may include shared system resources 302. In various implementations, the shared system resources 302 may include one or more processors, volatile or non-volatile computer memory (such as random access memory), system storage (such as non-transitory computer-readable storage media), and one or more system buses connecting the components. In various implementations, the orchestration platform 216 may include a non-transitory computer-readable storage medium 304. In various implementations, the non-transitory computer-readable storage medium 304 may include an orchestration module 306 and/or the analysis module 101. The shared system resources 302 may be operatively coupled to the non-transitory computer-readable storage medium 304 and a communications interface 306.

In various implementations, the shared system resources 302 may access the network 206 through the communications interface 306. In various implementations, the shared system resources 302 may access the various components of the system of platforms 100 through the communications interface 306 and the network 206. In various implementations, the components of the system of platforms 100 may access the non-transitory computer-readable storage medium 304 through the communications interface 306, the shared system resources 302, and an orchestration platform API 308. In various implementations, the orchestration platform API 308 may include the security layer 104.

### Digital Transactional Platform

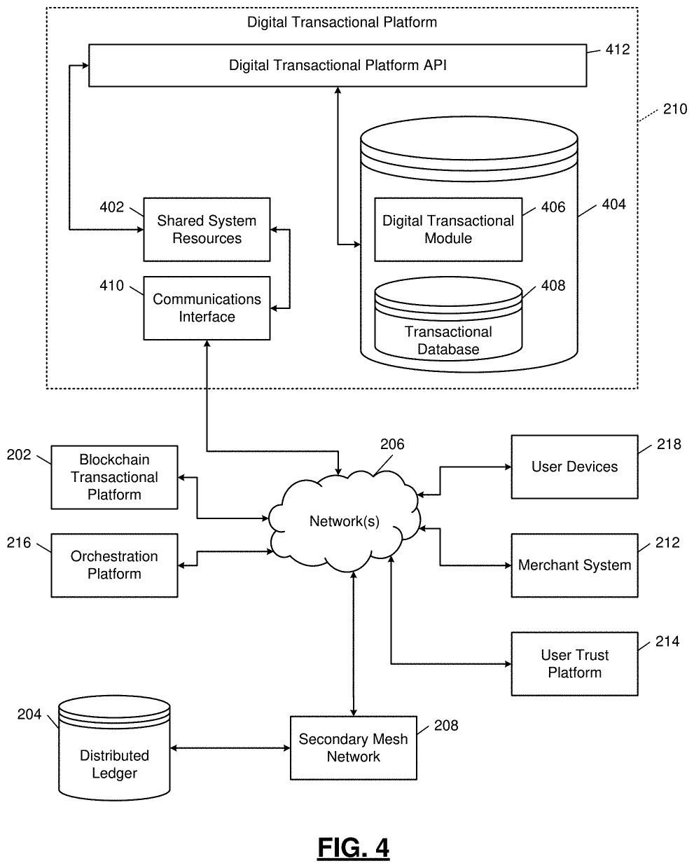

FIG. 4 is a block diagram of the system of platforms 100 with some examples of the digital transactional platform 210 shown in detail. As illustrated in FIG. 4, the digital transactional platform 210 may include shared system resources 402. In various implementations, the shared system resources 402 may include one or more processors, volatile or non-volatile computer memory (such as random access memory), system storage (such as non-transitory computer-readable storage media), and or more system buses connecting the components. In various implementations, the digital transactional platform 210 may include a non-transitory computer-readable storage medium 404. In various implementations, the non-transitory computer-readable storage medium 404 may include a digital transactional module 406 and a transactional database 408. The shared system resources 402 may be operatively coupled to the non-transitory computer-readable storage medium 404 and a communications interface 410.

In various implementations, the shared system resources 402 may access the network 206 through the communications interface 410. In various implementations, the shared system resources 402 may access the various components of the system of platforms 100 through the communications interface 410 and the network 206. In various implementations, the components of the system of platforms 100 may access the non-transitory computer-readable storage medium 404 through the communications interface 410, the shared system resources 402, and a digital transactional platform API 412.

### User Trust Platform

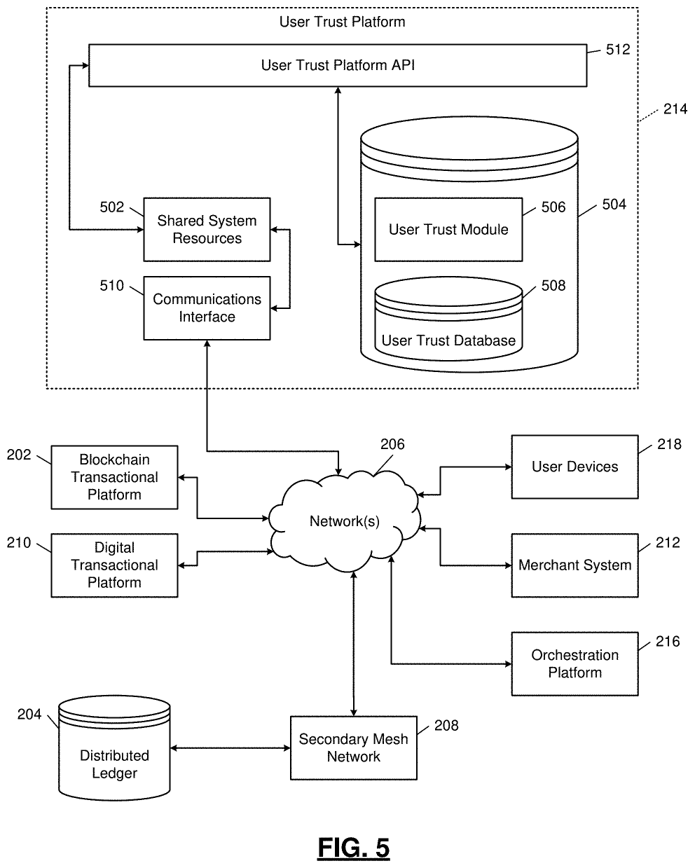

FIG. 5 is a block diagram of the system of platforms 100 with some examples of the user trust platform 214 shown in detail. As illustrated in FIG. 5, the user trust platform 214 may include shared system resources 402. In various implementations, the shared system resources 502 may include one or more processors, volatile or non-volatile computer memory (such as random access memory), system storage (such as non-transitory computer-readable storage media), and or more system buses connecting the components. In various implementations, the user trust platform 214 may include a non-transitory computer-readable storage medium 504. In various implementations, the non-transitory computer-readable storage medium 504 may include a user trust module 506 and a user trust database 508. The shared system resources 502 may be operatively coupled to the non-transitory computer-readable storage medium 504 and a communications interface 510.

In various implementations, the shared system resources 502 may access the network 206 through the communications interface 510. In various implementations, the shared system resources 502 may access the various components of the system of platforms 100 through the communications interface 510 and the network 206. In various implementations, the components of the system of platforms 100 may access the non-transitory computer-readable storage medium 504 through the communications interface 510, the shared system resources 502, and a digital transactional platform API 512.

### Blockchain Transactional Platform

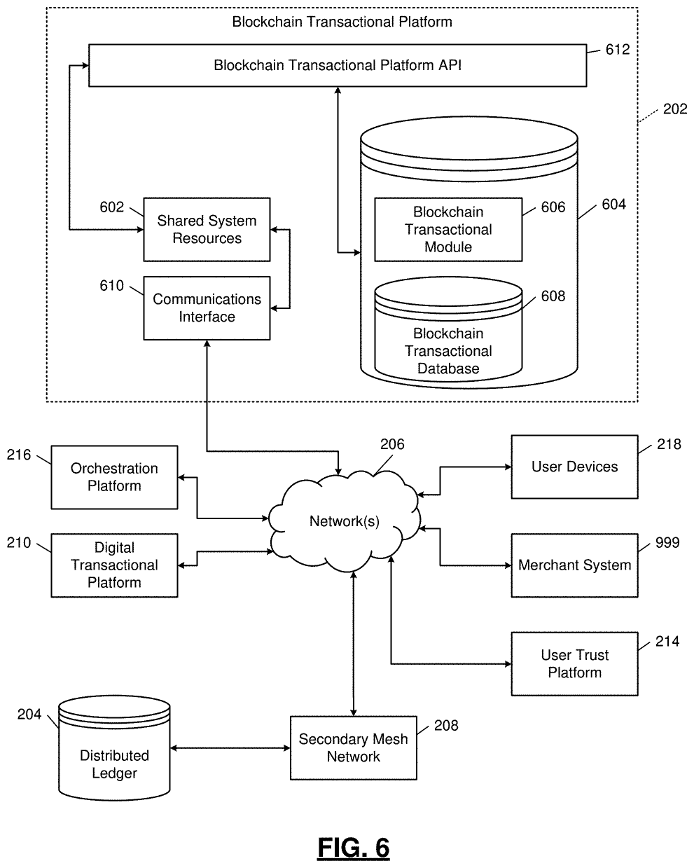

FIG. 6 is a block diagram of the system of platforms 100 with some examples of the blockchain transactional platform 202 shown in detail. As illustrated in FIG. 6, the blockchain transactional platform 202 may include shared system resources 602. In various implementations, the shared system resources 602 may include one or more processors, volatile or non-volatile computer memory (such as random access memory), system storage (such as non-transitory computer-readable storage media), and or more system buses connecting the components. In various implementations, the blockchain transactional platform 202 may include a non-transitory computer-readable storage medium 604. In various implementations, the non-transitory computer-readable storage medium 604 may include a blockchain transactional module 606 and a blockchain transactional database 608. The shared system resources 602 may be operatively coupled to the non-transitory computer-readable storage medium 604 and a communications interface 610.

In various implementations, the shared system resources 602 may access the network 206 through the communications interface 610. In various implementations, the shared system resources 602 may access the various components of the system of platforms 100 through the communications interface 610 and the network 206. In various implementations, the components of the system of platforms 100 may access the non-transitory computer-readable storage medium 604 through the communications interface 610, the shared system resources 602, and a digital transactional platform API 612.

In various implementations, the blockchain transactional module 606 may access the distributed ledger 204 and/or the secondary mesh network 208 via the blockchain transactional platform API 612, the shared system resources 602, the communications interface 610, and the network 206. In various implementations, the blockchain transactional module 606 may determine blockchain transactional data by accessing the distributed ledger 204 and/or the secondary mesh network 208. In various implementations, the blockchain transactional module 606 may access the distributed ledger 204 and parse a cryptocurrency wallet address associated with the user to determine and generate the blockchain transactional data. In various implementations, the blockchain transactional module 606 may access the secondary mesh network 208 and parse a cryptocurrency wallet associated with the user to determine and generate the blockchain transactional data.

### Flowcharts

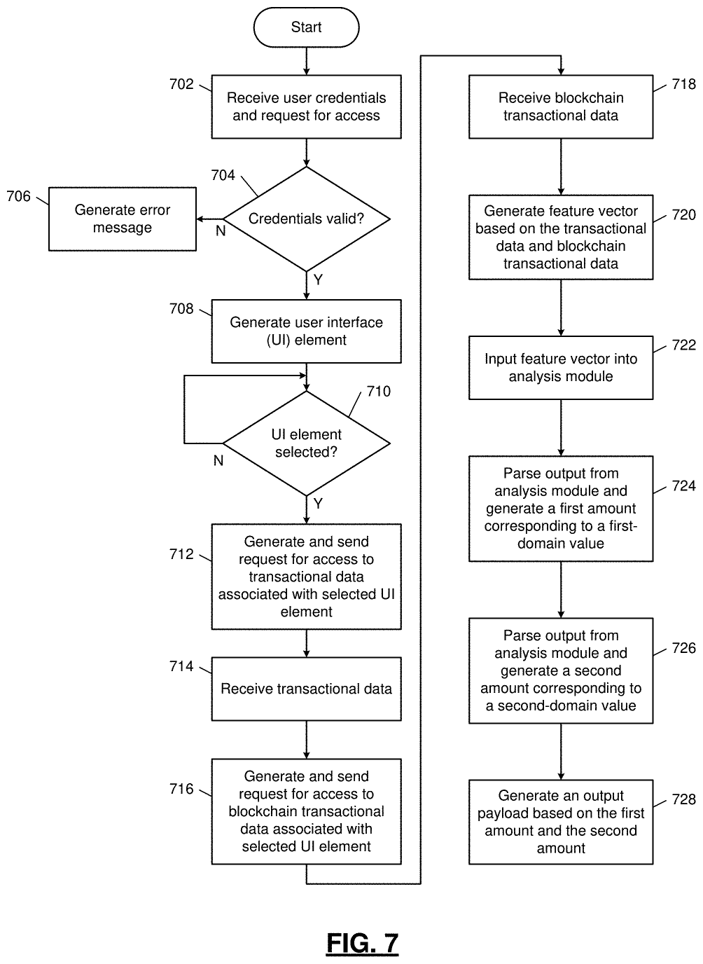

FIG. 7 is a flowchart of an example process for automatically orchestrating the transmission, reception, and processing of digital payloads between components of the system of platforms 100. At 702, the user device 218 sends user credentials and a request for access to the orchestration platform API 308. The user credentials and the request for access are sent to the security layer 104 of the orchestration platform API 308. Control proceeds to 704. At 704, the security layer 104 parses the user credentials and determines whether the credentials are valid for access. If at 704, the security layer 104 determines that the user credentials are not valid and do not grant access to components of the system of platforms 100, control proceeds to 706, where the analysis module 101 and/or the orchestration module 306 generate an error message. In various implementations, the error message is generated on a user interface, which may be accessed by the user device 218 and output to a screen of the user device 218.

If at 704, the security layer 104 determines that the user credentials are valid and grant access to one or more components of the system of platforms 100, control proceeds to 708. At 708, the analysis module 101 and/or the orchestration module 306 generates a user interface element. In various implementations, the user interface element corresponds to operations that may be performed using and/or data that may be accessed through the one or more components of the system of platforms 100 that the user credential provides valid access to. In various implementations, the user interface element may be accessed through and displayed on the user device 218. Control proceeds to 710.

At 710, the orchestration module 306 and/or the analysis module 101 determines whether the user interface element has been selected. For example, the user interface element may be selected by the user touching the user interface element as rendered on a touchscreen of the user device 218, or by the user selecting the user interface element rendered on a screen of the user device 218 using a user input device (such as a keyboard and/or mouse). If at 710, the orchestration module 306 and/or the analysis module 101 does not detect that the user interface element has been selected, control proceeds back to 710 to await the selection of the user interface element. If at 710, the orchestration module 306 and/or the analysis module 101 determines that the user interface element has been selected control proceeds to 712.

At 712, the orchestration module 306 and/or the analysis module 101 generates a request for access corresponding to the selected user interface element. In various implementations, the user interface element may correspond to a request for access to transactional data associated with the user, and the request for access may include a request for transactional data associated with the user. In various implementations, the transactional data may include a data payload indicative of a first-domain value stored in the transactional database 408. In various implementations, the first-domain may be denominations of a fiat currency, and the first-domain value may be an amount of fiat currency present in the user's account with a financial institution. In various implementations, the request for access may include the user's credentials. In various implementations, the orchestration module 306 and/or the analysis module 101 may send the request for access to the digital transactional platform API 412 through the orchestration platform API 308, the shared system resources 302, the communications interface 306, the network 206, the communications interface 410, and/or the shared system resources 402.

After receiving the request for access, the digital transactional platform API 412 determines whether the user credentials contained in the request for access grant access to the transactional data. If the digital transactional platform API 412 determines that the user credentials grant access to the transactional data, the digital transactional platform API 412 retrieves the transactional data from the transactional database 408 and sends the retrieved transactional data to the orchestration platform API 308. Control proceeds to 714, where the orchestration platform API 308 receives the transactional data. In various implementations, the orchestration platform API 308 sends the transactional data to the orchestration module 306 and/or the analysis module 101. Control proceeds to 716.

At 716, the orchestration module 306 and/or the analysis module 101 may generate a second request for access associated with the selected user interface element. In various implementations, the user interface element may correspond to a request for access to blockchain transactional data associated with the user, and the second request for access may include a request for transactional data associated with the user. In various implementations, the transactional data may include a data payload indicative of a second-domain value stored on the distributed ledger 204 and/or the secondary mesh network 208. In various implementations, the second-domain may be denominations of a cryptocurrency, and the second-domain value may be an amount of cryptocurrency associated with a user's cryptocurrency wallet address. In various implementations, the second request for access may include the user's credentials.

In various implementations, the orchestration module 306 and/or the analysis module 101 may send the second request for access to the blockchain transactional platform API 612 through the orchestration platform API 308, the shared system resources 302, the communications interface 306, the network 206, the communications interface 610, and/or the shared system resources 602. After receiving the second request for access, the blockchain transactional platform API 612 determines whether the user credentials contained in the request for access grant access to the blockchain transactional data contained in the blockchain transactional database 608. In various implementations, the blockchain transactional data may include the amount of second-domain value associated with the user's cryptocurrency wallet address.

If the digital transactional platform API 612 determines that the user credentials grant access to the blockchain transactional data, the blockchain transactional platform API 612 retrieves the blockchain transactional data from the transactional database 608 and sends the retrieved blockchain transactional data to the orchestration platform API 308. Control proceeds to 714, where the orchestration platform API 308 receives the transactional data. In various implementations, the orchestration platform API 308 sends the transactional data to the orchestration module 306 and/or the analysis module 101. Control proceeds to 718, where the orchestration platform API 308 receives the blockchain transactional data and sends the blockchain transactional data to the orchestration module 306 and/or the analysis module 101.

In various implementations, in addition to or instead of sending the second request for access to the blockchain transactional platform API 612, the orchestration module 306 and/or the analysis module 101 may access the distributed ledger 204 and/or the secondary mesh network 208 directly to determine the blockchain transactional data (e.g., in some examples, the amount of second-domain value associated with the user's cryptocurrency wallet address). After the orchestration module 306 and/or the analysis module 101 receives the blockchain transactional data and/or retrieves the blockchain transactional data, control proceeds to 720.

At 720, the orchestration module 306 and/or the analysis module 101 inputs generates feature vectors based on the transactional data and blockchain transactional data. In various implementations, the orchestration module 306 and/or the analysis module 101 may perform data processing steps such as data standardization and data cleaning to prepare the raw transactional data and blockchain transactional data for input into any of the algorithms and/or models previously discussed with respect to the analysis module 101. Control proceeds to 722. At 722, the orchestration module 306 and/or the analysis module 101 provides the feature vectors to at least one of the previously discussed algorithms and/or models of the analysis module 101. Using the feature vectors, the orchestration module 306 and/or analysis module 101, the at least one algorithm and/or model of the analysis module 101 generates an output. Control proceeds to 724.

At 724, the orchestration module 306 and/or analysis module 101 parses the output and generates a first amount corresponding to a first-domain value. Control proceeds to 726. At 726, the orchestration module 306 and/or analysis module 101 parses the output and generates a second amount corresponding to the second-domain value. In various implementations, the selected user interface element corresponds to a request to determine an optimal allocation of first-domain value and second-domain value for a payment. In various implementations, the first amount corresponds to the amount of first-domain value in the payment, and the second amount corresponds to the amount of second-domain value in the payment. Control proceeds to 726. At 726, the orchestration module 306 and/or the analysis module 101 generates an output payload based on the first amount and the second amount. In various implementations, the blockchain transactional platform 202, the digital transactional platform 210, the merchant system 212, the user trust platform 214, and/or the user devices 218 may access the output payload through the orchestration platform API 308.

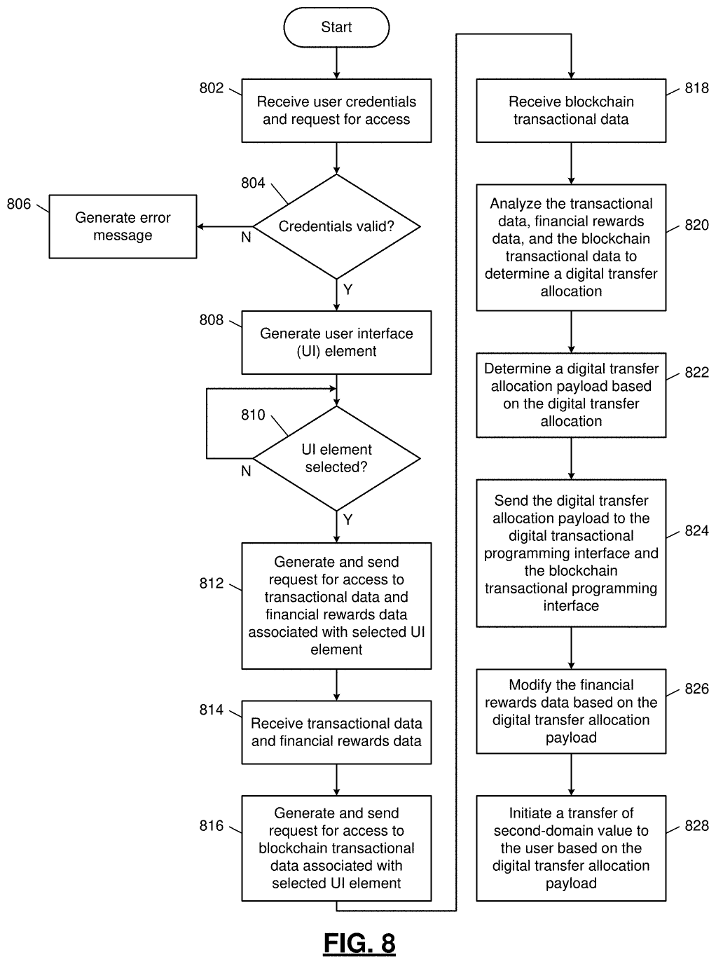

FIG. 8 is a flowchart of an example process for automatically orchestrating the transmission, reception, and processing of digital payloads between components of the system of platforms 100. At 802, the user device 218 sends user credentials and a request for access to the orchestration platform API 308. The user credentials and the request for access are sent to the security layer 104 of the orchestration platform API 308. Control proceeds to 804. At 804, the security layer 104 parses the user credentials and determines whether the credentials are valid for access. If at 804, the security layer 104 determines that the user credentials are not valid and do not grant access to components of the system of platforms 100, control proceeds to 806, where the analysis module 101 and/or the orchestration module 306 generate an error message. In various implementations, the error message is generated on a user interface, which may be accessed by the user device 218 and output to a screen of the user device 218.

If at 804, the security layer 104 determines that the user credentials are valid and grant access to one or more components of the system of platforms 100, control proceeds to 808. At 808, the analysis module 101 and/or the orchestration module 306 generates a user interface element. In various implementations, the user interface element corresponds to operations that may be performed using and/or data that may be accessed through the one or more components of the system of platforms 100 that the user credential provides valid access to. In various implementations, the user interface element may be accessed through and displayed on the user device 218. Control proceeds to 810.

At 810, the orchestration module 306 and/or the analysis module 101 determines whether the user interface element has been selected. For example, the user interface element may be selected by the user touching the user interface element as rendered on a touchscreen of the user device 218, or by the user selecting the user interface element rendered on a screen of the user device 218 using a user input device (such as a keyboard and/or mouse). If at 810, the orchestration module 306 and/or the analysis module 101 does not detect that the user interface element has been selected, control proceeds back to 810 to await the selection of the user interface element. If at 810, the orchestration module 306 and/or the analysis module 101 determines that the user interface element has been selected control proceeds to 812.

At 812, the orchestration module 306 and/or the analysis module 101 generates a request for access corresponding to the selected user interface element. In various implementations, the user interface element may correspond to a request for access to transactional data and financial rewards data associated with the user, and the request for access may include a request for transactional data and financial rewards data associated with the user. In various implementations, the transactional data may include a data payload indicative of a first-domain value stored in the transactional database 408. In various implementations, the first-domain may be denominations of a fiat currency, and the first-domain value may be an amount of fiat currency present in the user's account with a financial institution. In various implementations, the financial rewards data may take the form of numerical values that may be exchanged for first-domain values at a set or variable redemption rate. In various implementations, the request for access may include the user's credentials. In various implementations, the orchestration module 306 and/or the analysis module 101 may send the request for access to the digital transactional platform API 412 through the orchestration platform API 308, the shared system resources 302, the communications interface 306, the network 206, the communications interface 410, and/or the shared system resources 402.

After receiving the request for access, the digital transactional platform API 412 determines whether the user credentials contained in the request for access grant access to the transactional data and financial rewards data. If the digital transactional platform API 412 determines that the user credentials grant access to the transactional data and financial rewards data, the digital transactional platform API 412 retrieves the transactional data and financial rewards data from the transactional database 408 and sends the retrieved transactional data and financial rewards data to the orchestration platform API 308. Control proceeds to 814, where the orchestration platform API 308 receives the transactional data and the financial rewards data. In various implementations, the orchestration platform API 308 sends the transactional data to the orchestration module 306 and/or the analysis module 101. Control proceeds to 816.

At 816, the orchestration module 306 and/or the analysis module 101 may generate a second request for access associated with the selected user interface element. In various implementations, the user interface element may correspond to a request for access to blockchain transactional data associated with the user, and the second request for access may include a request for blockchain transactional data associated with the user. In various implementations, the blockchain transactional data may include a data payload indicative of a second-domain value stored on the distributed ledger 204 and/or the secondary mesh network 208. In various implementations, the second-domain may be denominations of a cryptocurrency, and the second-domain value may be an amount of cryptocurrency associated with a user's cryptocurrency wallet address. In various implementations, the second request for access may include the user's credentials.

In various implementations, the orchestration module 306 and/or the analysis module 101 may send the second request for access to the blockchain transactional platform API 612 through the orchestration platform API 308, the shared system resources 302, the communications interface 306, the network 206, the communications interface 610, and/or the shared system resources 602. After receiving the second request for access, the blockchain transactional platform API 612 determines whether the user credentials contained in the request for access grant access to the blockchain transactional data contained in the blockchain transactional database 608. In various implementations, the blockchain transactional data may include the amount of second-domain value associated with the user's cryptocurrency wallet address.

If the digital transactional platform API 612 determines that the user credentials grant access to the blockchain transactional data, the blockchain transactional platform API 612 retrieves the blockchain transactional data from the transactional database 608 and sends the retrieved blockchain transactional data to the orchestration platform API 308. Control proceeds to 814, where the orchestration platform API 308 receives the transactional data. In various implementations, the orchestration platform API 308 sends the transactional data to the orchestration module 306 and/or the analysis module 101. Control proceeds to 818, where the orchestration platform API 308 receives the blockchain transactional data and sends the blockchain transactional data to the orchestration module 306 and/or the analysis module 101.

In various implementations, in addition to or instead of sending the second request for access to the blockchain transactional platform API 612, the orchestration module 306 and/or the analysis module 101 may access the distributed ledger 204 and/or the secondary mesh network 208 directly to determine the blockchain transactional data (e.g., in some examples, the amount of second-domain value associated with the user's cryptocurrency wallet address). After the orchestration module 306 and/or the analysis module 101 receives the blockchain transactional data and/or retrieves the blockchain transactional data, control proceeds to 820.

At 820, the orchestration module 306 and/or the analysis module 101 analyzes the transactional data, financial rewards data, and the blockchain transactional data to determine a digital transfer allocation. In various implementations, the selected user interface element corresponds to a request for the user to redeem the numerical values of the financial rewards data for second-domain value. In various implementations, the digital transfer allocation is indicative of an amount of second-domain value to be transferred to the user based on the financial rewards data. In various implementations, the orchestration module 306 and/or analysis module 101 may determine the digital transfer allocation based on the input transactional data, financial rewards data, and the blockchain transactional data using any of the algorithms and/or models previous described with respect to the analysis module 101. Control proceeds to 822. At 822, the orchestration module 306 and/or the analysis module 101 packages the digital transfer allocation into a format usable by the other components of the system of platforms 100 and saves the package as a digital transfer allocation payload. Control proceeds to 824.

At 824, the orchestration module 306 and/or the analysis module 101 sends the digital transfer allocation payload to the digital transactional platform API 412 and the blockchain transactional platform API 612 via the orchestration platform API, the shared system resources 302, the communications interface 306, the network 206, the communications interface 410, the shared system resources 402, the communications interface 610, and the shared system resources 602. Control proceeds to 826. At 826, the digital transactional platform API 412 receives the digital transfer allocation payload and instructs the digital transactional module 406 to modify the financial rewards data in the transactional database 408 to reduce the numerical value of the financial rewards data by an amount indicated by the digital transfer allocation payload. Control proceeds to 828. At 828, the blockchain transactional platform API 612 receives the digital transfer allocation payload and instructs the blockchain transactional module 606 to initiate a transfer of second-domain value to the user's cryptocurrency wallet address.

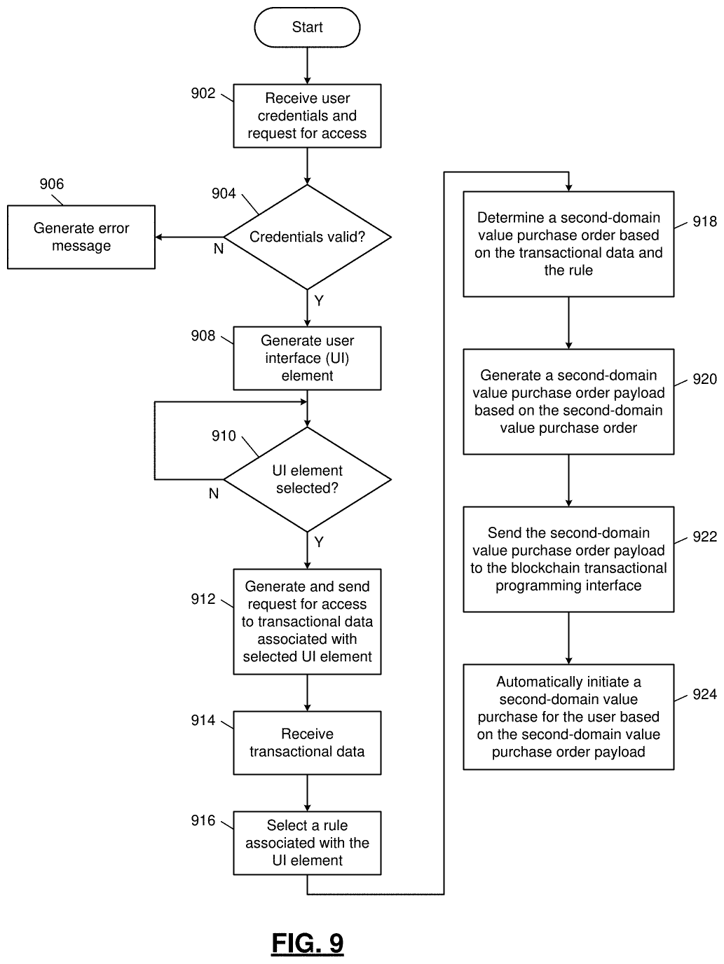

FIG. 9 is a flowchart of an example process for automatically orchestrating the transmission, reception, and processing of digital payloads between components of the system of platforms 100. At 902, the user device 218 sends user credentials and a request for access to the orchestration platform API 308. The user credentials and the request for access are sent to the security layer 104 of the orchestration platform API 308. Control proceeds to 904. At 904, the security layer 104 parses the user credentials and determines whether the credentials are valid for access. If at 904, the security layer 104 determines that the user credentials are not valid and do not grant access to components of the system of platforms 100, control proceeds to 906, where the analysis module 101 and/or the orchestration module 306 generate an error message. In various implementations, the error message is generated on a user interface, which may be accessed by the user device 218 and output to a screen of the user device 218.

If at 904, the security layer 104 determines that the user credentials are valid and grant access to one or more components of the system of platforms 100, control proceeds to 908. At 908, the analysis module 101 and/or the orchestration module 306 generates a user interface element. In various implementations, the user interface element corresponds to operations that may be performed using and/or data that may be accessed through the one or more components of the system of platforms 100 that the user credential provides valid access to. In various implementations, the user interface element may be accessed through and displayed on the user device 218. Control proceeds to 910.

At 910, the orchestration module 306 and/or the analysis module 101 determines whether the user interface element has been selected. For example, the user interface element may be selected by the user touching the user interface element as rendered on a touchscreen of the user device 218, or by the user selecting the user interface element rendered on a screen of the user device 218 using a user input device (such as a keyboard and/or mouse). If at 910, the orchestration module 306 and/or the analysis module 101 does not detect that the user interface element has been selected, control proceeds back to 910 to await the selection of the user interface element. If at 910, the orchestration module 306 and/or the analysis module 101 determines that the user interface element has been selected control proceeds to 912.

At 912, the orchestration module 306 and/or the analysis module 101 generates a request for access corresponding to the selected user interface element. In various implementations, the user interface element may correspond to a request for access to transactional data associated with the user, and the request for access may include a request for transactional data associated with the user. In various implementations, the transactional data may include a data payload indicative of a first-domain value stored in the transactional database 408. In various implementations, the first-domain may be denominations of a fiat currency, and the first-domain value may be an amount of fiat currency present in the user's account with a financial institution. In various implementations, the request for access may include the user's credentials. In various implementations, the orchestration module 306 and/or the analysis module 101 may send the request for access to the digital transactional platform API 412 through the orchestration platform API 308, the shared system resources 302, the communications interface 306, the network 206, the communications interface 410, and/or the shared system resources 402.

After receiving the request for access, the digital transactional platform API 412 determines whether the user credentials contained in the request for access grant access to the transactional data. If the digital transactional platform API 412 determines that the user credentials grant access to the transactional data, the digital transactional platform API 412 retrieves the transactional data from the transactional database 408 and sends the retrieved transactional data to the orchestration platform API 308. Control proceeds to 914, where the orchestration platform API 308 receives the transactional data. In various implementations, the orchestration platform API 308 sends the transactional data to the orchestration module 306 and/or the analysis module 101. Control proceeds to 916.

At 916, the orchestration module 306 and/or the analysis module 101 selects a rule from one of the modules, libraries, and/or data stores of the analysis module 101 associated with the selected user interface element. In various implementations, the selected user interface element may be associated with a request to make an automated second-domain value purchase, and the selected rule corresponds to financial risk tolerance criteria associated with the user. In various implementations, the orchestration module 306 and/or the analysis module 101 requests and receives second-domain value market datum from the blockchain transactional module 606 via the orchestration platform API 308, the shared system resources 302, the communications interface 306, the network 206, the communications interface 610, the shared system resources 602, and the blockchain transactional platform API 612. In various implementations, the orchestration module 306 and/or analysis module 101 retrieve second-domain value market datum from one of its libraries. In various implementations, the orchestration module 306 and/or analysis module 101 may automatically generate and update second-domain value market datum by accessing the distributed ledger 204 and/or the secondary mesh network 208 through the network 206. Control proceeds to 918.

At 918, the orchestration module 306 and/or analysis module 101 determines a second-domain value purchase order based on the transactional data, the second-domain value market datum, and the selected rule. In various implementations, the second-domain value purchase order is calculated based on an amount of first-domain value present in the user's account as indicated by the transactional data, the second-domain value market conditions as indicated by the second-domain value market datum, and whether second-domain value market conditions required by the selected rule are satisfied. In various implementations, the rule is related to the user's financial risk tolerance. In various implementations, the orchestration module 306 and/or analysis module 101 determines whether the second-domain value purchase order is consistent with the rule, and proceeds only if the second-domain value purchase order is consistent with the rule. Control proceeds to 920. At 920, the orchestration module 306 and/or analysis module 101 generates a second-domain value purchase order payload based on the second-domain value purchase order. In various implementations, the second-domain value purchase order payload is packaged in a format usable by the blockchain transactional module 606. Control proceeds to 922.

At 922, the orchestration module 306 and/or the analysis module 101 sends the second-domain value purchase order payload to the blockchain transactional module 606 via the orchestration platform API 308, the shared system resources 302, the communications interface 306, the network 206, the communications interface 610, the shared system resources 602, and the blockchain transactional platform API 612. Control proceeds to 924. At 924, the blockchain transactional module 606 receives the second-domain value purchase order payload and automatically initiates a second-domain value purchase for the user based on the second-domain value purchase order payload. In various implementations, the blockchain transactional module 606 records the second-domain value purchase to the cryptocurrency wallet address of the user via the blockchain transactional platform API 612.

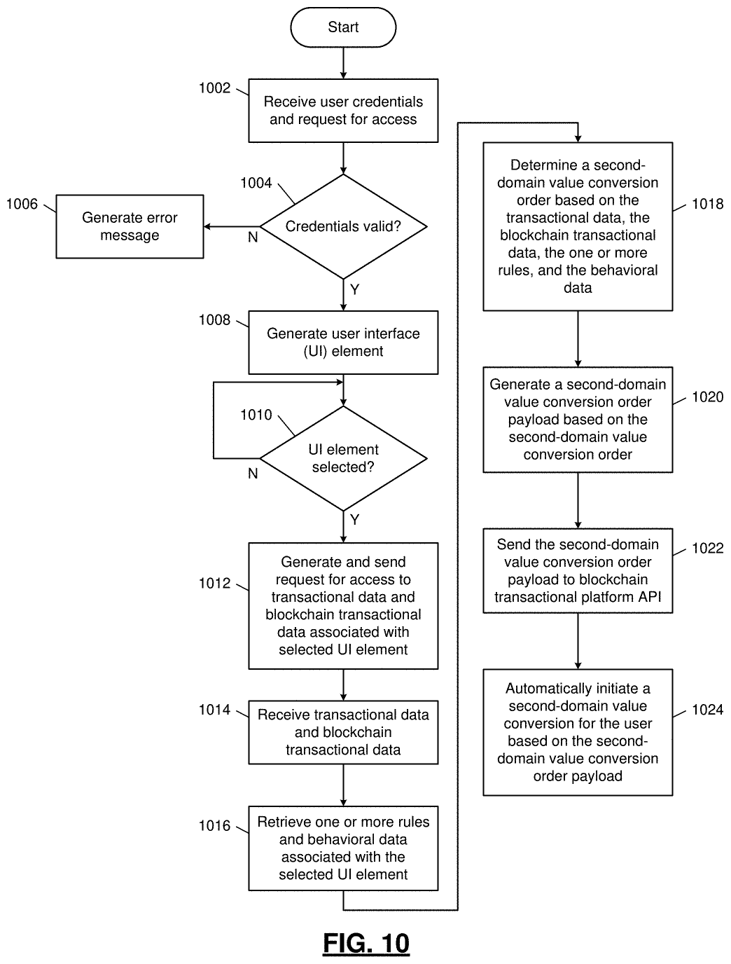

FIG. 10 is a flowchart of an example process for automatically orchestrating the transmission, reception, and processing of digital payloads between components of the system of platforms 100. At 1002, the user device 218 sends user credentials and a request for access to the orchestration platform API 308. The user credentials and the request for access are sent to the security layer 104 of the orchestration platform API 308. Control proceeds to 1004. At 1004, the security layer 104 parses the user credentials and determines whether the credentials are valid for access. If at 1004, the security layer 104 determines that the user credentials are not valid and do not grant access to components of the system of platforms 100, control proceeds to 1006, where the analysis module 101 and/or the orchestration module 306 generate an error message. In various implementations, the error message is generated on a user interface, which may be accessed by the user device 218 and output to a screen of the user device 218.

If at 1004, the security layer 104 determines that the user credentials are valid and grant access to one or more components of the system of platforms 100, control proceeds to 1008. At 1008, the analysis module 101 and/or the orchestration module 306 generates a user interface element. In various implementations, the user interface element corresponds to operations that may be performed using and/or data that may be accessed through the one or more components of the system of platforms 100 that the user credential provides valid access to. In various implementations, the user interface element may be accessed through and displayed on the user device 218. Control proceeds to 1010.

At 1010, the orchestration module 306 and/or the analysis module 101 determines whether the user interface element has been selected. For example, the user interface element may be selected by the user touching the user interface element as rendered on a touchscreen of the user device 218, or by the user selecting the user interface element rendered on a screen of the user device 218 using a user input device (such as a keyboard and/or mouse). If at 1010, the orchestration module 306 and/or the analysis module 101 does not detect that the user interface element has been selected, control proceeds back to 1010 to await the selection of the user interface element. If at 1010, the orchestration module 306 and/or the analysis module 101 determines that the user interface element has been selected control proceeds to 1012.

At 1012, the orchestration module 306 and/or the analysis module 101 generates a request for access corresponding to the selected user interface element. In various implementations, the user interface element may correspond to a request for access to transactional data associated with the user, and the request for access may include a request for transactional data associated with the user. In various implementations, the transactional data may include a data payload indicative of a first-domain value stored in the transactional database 408. In various implementations, the first-domain may be denominations of a fiat currency, and the first-domain value may be an amount of fiat currency present in the user's account with a financial institution. In various implementations, the request for access may include the user's credentials. In various implementations, the orchestration module 306 and/or the analysis module 101 may send the request for access to the digital transactional platform API 412 through the orchestration platform API 308, the shared system resources 302, the communications interface 306, the network 206, the communications interface 410, and/or the shared system resources 402.

The orchestration module 306 and/or the analysis module 101 may generate a second request for access associated with the selected user interface element. In various implementations, the user interface element may correspond to a request for access to blockchain transactional data associated with the user, and the second request for access may include a request for blockchain transactional data associated with the user. In various implementations, the blockchain transactional data may include a data payload indicative of a second-domain value stored on the distributed ledger 204 and/or the secondary mesh network 208. In various implementations, the second-domain may be denominations of a cryptocurrency, and the second-domain value may be an amount of cryptocurrency associated with a user's cryptocurrency wallet address. In various implementations, the second request for access may include the user's credentials. In various implementations, the orchestration module 306 and/or the analysis module 101 may send the second request for access to the blockchain transactional platform API 612 through the orchestration platform API 308, the shared system resources 302, the communications interface 306, the network 206, the communications interface 610, and/or the shared system resources 602. Control proceeds to 1014.

At 1014, after receiving the request for access, the digital transactional platform API 412 determines whether the user credentials contained in the request for access grant access to the transactional data. If the digital transactional platform API 412 determines that the user credentials grant access to the transactional data, the digital transactional platform API 412 retrieves the transactional data from the transactional database 408 and sends the retrieved transactional data to the orchestration platform API 308. The orchestration platform API 308 then receives the transactional data. In various implementations, the orchestration platform API 308 sends the transactional data to the orchestration module 306 and/or the analysis module 101.

After receiving the second request for access, the blockchain transactional platform API 612 determines whether the user credentials contained in the request for access grant access to the blockchain transactional data contained in the blockchain transactional database 608. In various implementations, the blockchain transactional data may include the amount of second-domain value associated with the user's cryptocurrency wallet address. If the digital transactional platform API 612 determines that the user credentials grant access to the blockchain transactional data, the blockchain transactional platform API 612 retrieves the blockchain transactional data from the transactional database 608 and sends the retrieved blockchain transactional data to the orchestration platform API 308. The orchestration platform API 308 then receives the transactional data. In various implementations, the orchestration platform API 308 sends the transactional data to the orchestration module 306 and/or the analysis module 101. The orchestration platform API 308 then receives the blockchain transactional data and sends the blockchain transactional data to the orchestration module 306 and/or the analysis module 101.

In various implementations, in addition to or instead of sending the second request for access to the blockchain transactional platform API 612, the orchestration module 306 and/or the analysis module 101 may access the distributed ledger 204 and/or the secondary mesh network 208 directly to determine the blockchain transactional data (e.g., in some examples, the amount of second-domain value associated with the user's cryptocurrency wallet address). After the orchestration module 306 and/or the analysis module 101 receives the blockchain transactional data and/or retrieves the blockchain transactional data, control proceeds to 1016.

At 1016, the orchestration module 306 and/or the analysis module 101 retrieves one or more rules and/or behavior data associated with the user associated with the selected user interface element from any of the libraries and/or data stores of the analysis module 101. Control proceeds to 1018. At 1018, the orchestration module 306 and/or analysis module 101 determines a second-domain value conversion order based on the transactional data, the blockchain transactional data, the one or more rules, and the behavioral data. In various implementations, the transactional data, the blockchain transactional data, the one or more rules, and the behavioral data may be provided as input vectors to any of the algorithms and/or models of the analysis module 101 to automatically generate the second-domain value conversion order as an output. Control proceeds to 1020.

At 1020, the orchestration module 306 and/or the analysis module 101 generates a second-domain value conversion order payload by repackaging the second-domain value conversion order into a format usable by the blockchain transactional module 606. Control proceeds to 1022. At 1022, the orchestration module 306 and/or the analysis module 101 sends the second-domain value conversion order payload to the blockchain transactional platform API 612 via the orchestration platform API 308, the shared system resources 302, the communications interface 306, the network 206, the communications interface 610, the shared system resources 602, and the blockchain transactional platform API 612. Control proceeds to 1024.

At 1024, after receiving the second-domain value conversion order payload, the blockchain transactional platform API 612 sends instructions to the blockchain transactional module 606 for the blockchain transactional module 606 to automatically initiate a second-domain value conversion for the user based on the second-domain value conversion order payload. In various implementations, the second-domain value conversion includes instructions for the blockchain transactional module 606 to exchange an amount of first-domain value associated with the user for an amount of second-domain value (to be recorded with the user's cryptocurrency wallet address on the secondary mesh network 208 and/or the distributed ledger 204). In various implementations, the second-domain value conversion includes instructions for the blockchain transactional module 606 to exchange an amount of second-domain value associated with the user's cryptocurrency wallet address for an amount of first-domain value associated with the user.

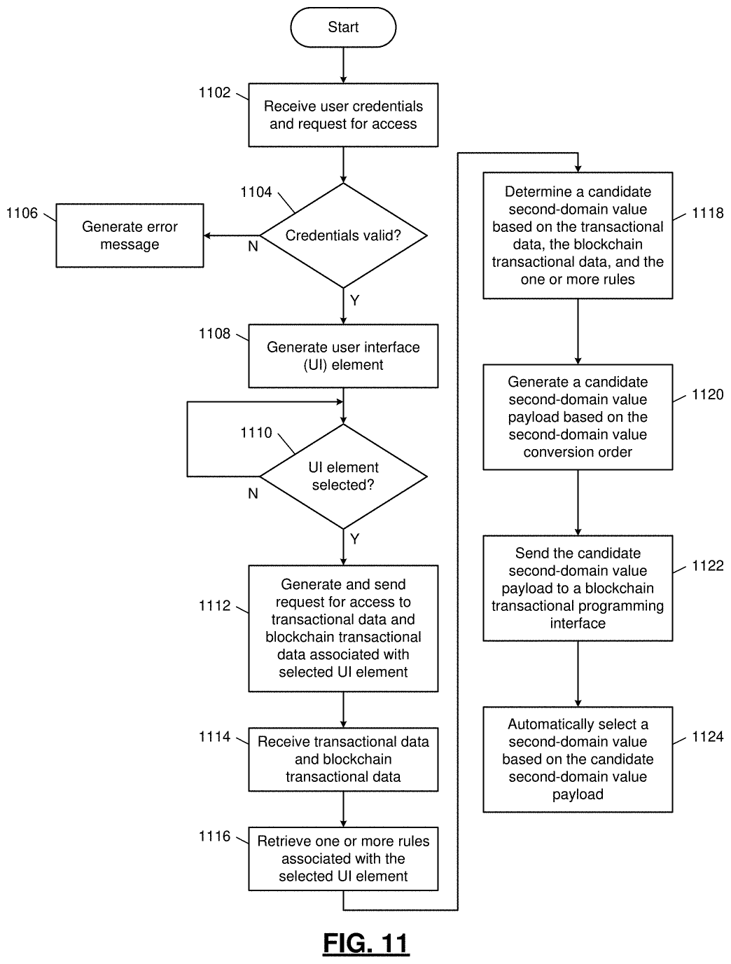

FIG. 11 is a flowchart of an example process for automatically orchestrating the transmission, reception, and processing of digital payloads between components of the system of platforms 100. At 1102, the user device 218 sends user credentials and a request for access to the orchestration platform API 308. The user credentials and the request for access are sent to the security layer 104 of the orchestration platform API 308. Control proceeds to 1104. At 1104, the security layer 104 parses the user credentials and determines whether the credentials are valid for access. If at 1104, the security layer 104 determines that the user credentials are not valid and do not grant access to components of the system of platforms 100, control proceeds to 1106, where the analysis module 101 and/or the orchestration module 306 generate an error message. In various implementations, the error message is generated on a user interface, which may be accessed by the user device 218 and output to a screen of the user device 218.

If at 1104, the security layer 104 determines that the user credentials are valid and grant access to one or more components of the system of platforms 100, control proceeds to 1108. At 1108, the analysis module 101 and/or the orchestration module 306 generates a user interface element. In various implementations, the user interface element corresponds to operations that may be performed using and/or data that may be accessed through the one or more components of the system of platforms 100 that the user credential provides valid access to. In various implementations, the user interface element may be accessed through and displayed on the user device 218. Control proceeds to 1110.

At 1110, the orchestration module 306 and/or the analysis module 101 determines whether the user interface element has been selected. For example, the user interface element may be selected by the user touching the user interface element as rendered on a touchscreen of the user device 218, or by the user selecting the user interface element rendered on a screen of the user device 218 using a user input device (such as a keyboard and/or mouse). If at 1110, the orchestration module 306 and/or the analysis module 101 does not detect that the user interface element has been selected, control proceeds back to 1110 to await the selection of the user interface element. If at 1110, the orchestration module 306 and/or the analysis module 101 determines that the user interface element has been selected control proceeds to 1112.

At 1112, the orchestration module 306 and/or the analysis module 101 generates a request for access corresponding to the selected user interface element. In various implementations, the user interface element may correspond to a request for access to transactional data associated with the user, and the request for access may include a request for transactional data associated with the user. In various implementations, the transactional data may include a data payload indicative of a first-domain value stored in the transactional database 408. In various implementations, the first-domain may be denominations of a fiat currency, and the first-domain value may be an amount of fiat currency present in the user's account with a financial institution. In various implementations, the request for access may include the user's credentials. In various implementations, the orchestration module 306 and/or the analysis module 101 may send the request for access to the digital transactional platform API 412 through the orchestration platform API 308, the shared system resources 302, the communications interface 306, the network 206, the communications interface 410, and/or the shared system resources 402.

The orchestration module 306 and/or the analysis module 101 may generate a second request for access associated with the selected user interface element. In various implementations, the user interface element may correspond to a request for access to blockchain transactional data associated with the user, and the second request for access may include a request for blockchain transactional data associated with the user. In various implementations, the blockchain transactional data may include a data payload indicative of a second-domain value stored on the distributed ledger 204 and/or the secondary mesh network 208. In various implementations, the second-domain may be denominations of a cryptocurrency, and the second-domain value may be an amount of cryptocurrency associated with a user's cryptocurrency wallet address. In various implementations, the second request for access may include the user's credentials. In various implementations, the orchestration module 306 and/or the analysis module 101 may send the second request for access to the blockchain transactional platform API 612 through the orchestration platform API 308, the shared system resources 302, the communications interface 306, the network 206, the communications interface 610, and/or the shared system resources 602. Control proceeds to 1114.

At 1114, after receiving the request for access, the digital transactional platform API 412 determines whether the user credentials contained in the request for access grant access to the transactional data. If the digital transactional platform API 412 determines that the user credentials grant access to the transactional data, the digital transactional platform API 412 retrieves the transactional data from the transactional database 408 and sends the retrieved transactional data to the orchestration platform API 308. The orchestration platform API 308 then receives the transactional data. In various implementations, the orchestration platform API 308 sends the transactional data to the orchestration module 306 and/or the analysis module 101.

After receiving the second request for access, the blockchain transactional platform API 612 determines whether the user credentials contained in the request for access grant access to the blockchain transactional data contained in the blockchain transactional database 608. In various implementations, the blockchain transactional data may include the amount of second-domain value associated with the user's cryptocurrency wallet address. If the digital transactional platform API 612 determines that the user credentials grant access to the blockchain transactional data, the blockchain transactional platform API 612 retrieves the blockchain transactional data from the transactional database 608 and sends the retrieved blockchain transactional data to the orchestration platform API 308. The orchestration platform API 308 then receives the transactional data. In various implementations, the orchestration platform API 308 sends the transactional data to the orchestration module 306 and/or the analysis module 101. The orchestration platform API 308 then receives the blockchain transactional data and sends the blockchain transactional data to the orchestration module 306 and/or the analysis module 101.

In various implementations, in addition to or instead of sending the second request for access to the blockchain transactional platform API 612, the orchestration module 306 and/or the analysis module 101 may access the distributed ledger 204 and/or the secondary mesh network 208 directly to determine the blockchain transactional data (e.g., in some examples, the amount of second-domain value associated with the user's cryptocurrency wallet address). After the orchestration module 306 and/or the analysis module 101 receives the blockchain transactional data and/or retrieves the blockchain transactional data, control proceeds to 1116.

At 1116, the orchestration module 306 and/or the analysis module 101 retrieves one or more rules associated with the user associated with the selected user interface element from any of the libraries and/or data stores of the analysis module 101. In various implementations, the one or more rules may be associated with a cryptocurrency wallet associated with the user. Control proceeds to 1118. At 1118, the orchestration module 306 and/or analysis module 101 determines a candidate second-domain value based on the transactional data, the blockchain transactional data, and the retrieved one or more rules. In various implementations, the transactional data, the blockchain transactional data, and the retrieved one or more rules may be formatted as input vectors and provided to any of the algorithms and/or models previously described with respect to analysis module 101, and the algorithms and/or models of the analysis module 101 may automatically output the candidate second-domain value based on the input vectors. Control proceeds to 1120.

At 1120, the orchestration module 306 and/or the analysis module 101 generates a candidate second-domain value payload by repackaging the candidate second domain value into a format usable by the blockchain transactional module 606. Control proceeds to 1122. At 1122, the orchestration module 306 and/or the analysis module 101 sends the candidate second-domain value payload to the blockchain transactional platform API 612 via the orchestration platform API 308, the shared system resources 302, the communications interface 306, the network 206, the communications interface 610, and the shared system resources 602. Control proceeds to 1124.

At 1124, after receiving the candidate second-domain value payload, the blockchain transactional platform API 612 sends the candidate second-domain value payload to the blockchain transactional module 606, and the blockchain transactional module 606 automatically selects a second-domain value based on the candidate second-domain value payload. In various implementations, the blockchain transactional module 606 may generate and transform a user interface to display the selected second-domain value. In various implementations, the user device 218 may access the user interface displaying the selected second-domain value via the network 206, the communications interface 410, the shared system resources 402, and the digital transactional platform API 412.

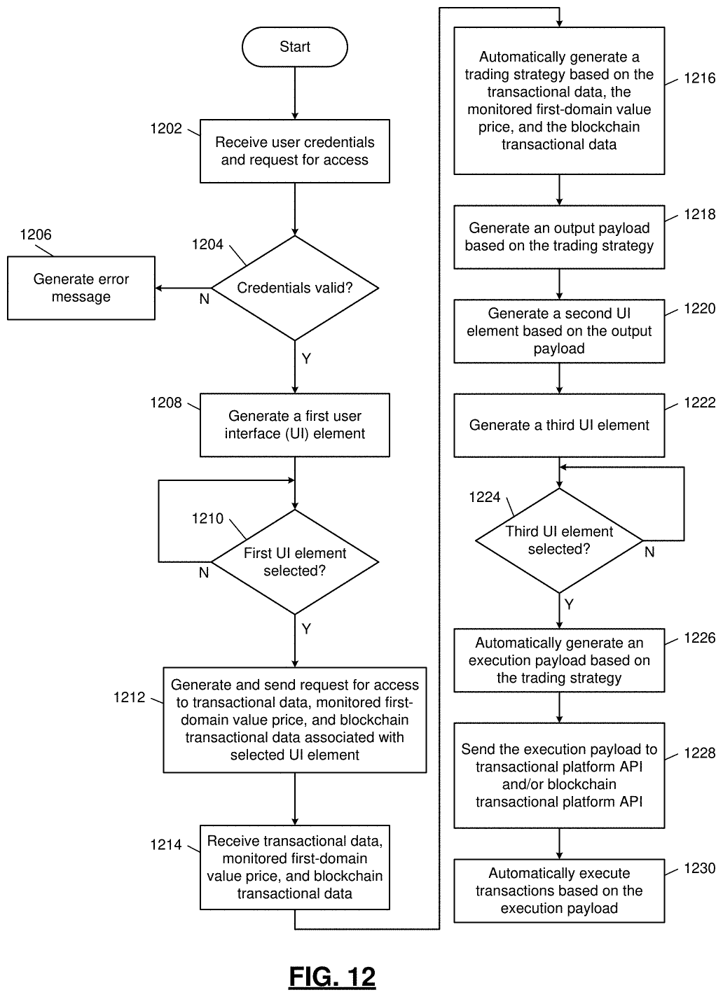

FIG. 12 is a flowchart of an example process for automatically orchestrating the transmission, reception, and processing of digital payloads between components of the system of platforms 100. At 1202, the user device 218 sends user credentials and a request for access to the orchestration platform API 308. The user credentials and the request for access are sent to the security layer 104 of the orchestration platform API 308. Control proceeds to 1204. At 1204, the security layer 104 parses the user credentials and determines whether the credentials are valid for access. If at 1204, the security layer 104 determines that the user credentials are not valid and do not grant access to components of the system of platforms 100, control proceeds to 1206, where the analysis module 101 and/or the orchestration module 306 generate an error message. In various implementations, the error message is generated on a user interface, which may be accessed by the user device 218 and output to a screen of the user device 218.

If at 1204, the security layer 104 determines that the user credentials are valid and grant access to one or more components of the system of platforms 100, control proceeds to 1208. At 1208, the analysis module 101 and/or the orchestration module 306 generates a user interface element. In various implementations, the user interface element corresponds to operations that may be performed using and/or data that may be accessed through the one or more components of the system of platforms 100 that the user credential provides valid access to. In various implementations, the user interface element may be accessed through and displayed on the user device 218. Control proceeds to 1210.

At 1210, the orchestration module 306 and/or the analysis module 101 determines whether the user interface element has been selected. For example, the user interface element may be selected by the user touching the user interface element as rendered on a touchscreen of the user device 218, or by the user selecting the user interface element rendered on a screen of the user device 218 using a user input device (such as a keyboard and/or mouse). If at 1210, the orchestration module 306 and/or the analysis module 101 does not detect that the user interface element has been selected, control proceeds back to 1210 to await the selection of the user interface element. If at 1210, the orchestration module 306 and/or the analysis module 101 determines that the user interface element has been selected control proceeds to 1212.

At 1212, the orchestration module 306 and/or the analysis module 101 generates a request for access corresponding to the selected user interface element. In various implementations, the user interface element may correspond to a request for access to transactional data associated with the user and a monitored first-domain value price, and the request for access may include a request for transactional data associated with the user and for the monitored first-domain value price. In various implementations, the transactional data may include a data payload indicative of a first-domain value stored in the transactional database 408. In various implementations, the first-domain may be denominations of a fiat currency, and the first-domain value may be an amount of fiat currency present in the user's account with a financial institution. In various implementations, the request for access may include the user's credentials. In various implementations, the orchestration module 306 and/or the analysis module 101 may send the request for access to the digital transactional platform API 412 through the orchestration platform API 308, the shared system resources 302, the communications interface 306, the network 206, the communications interface 410, and/or the shared system resources 402.

The orchestration module 306 and/or the analysis module 101 may generate a second request for access associated with the selected user interface element. In various implementations, the user interface element may correspond to a request for access to blockchain transactional data associated with the user, and the second request for access may include a request for blockchain transactional data associated with the user. In various implementations, the blockchain transactional data may include a data payload indicative of a second-domain value stored on the distributed ledger 204 and/or the secondary mesh network 208. In various implementations, the second-domain may be denominations of a cryptocurrency, and the second-domain value may be an amount of cryptocurrency associated with a user's cryptocurrency wallet address. In various implementations, the second request for access may include the user's credentials. In various implementations, the orchestration module 306 and/or the analysis module 101 may send the second request for access to the blockchain transactional platform API 612 through the orchestration platform API 308, the shared system resources 302, the communications interface 306, the network 206, the communications interface 610, and/or the shared system resources 602. Control proceeds to 1214.

At 1214, after receiving the request for access, the digital transactional platform API 412 determines whether the user credentials contained in the request for access grant access to the transactional data. If the digital transactional platform API 412 determines that the user credentials grant access to the transactional data, the digital transactional platform API 412 retrieves the transactional data from the transactional database 408 and sends the retrieved transactional data to the orchestration platform API 308. In various implementations, the digital transaction platform API 421 sends the monitored first-domain price to the orchestration platform API 308. The orchestration platform API 308 then receives the transactional data and the monitored first-domain price. In various implementations, the orchestration platform API 308 sends the transactional data and the monitored first-domain price to the orchestration module 306 and/or the analysis module 101.

After receiving the second request for access, the blockchain transactional platform API 612 determines whether the user credentials contained in the request for access grant access to the blockchain transactional data contained in the blockchain transactional database 608. In various implementations, the blockchain transactional data may include the amount of second-domain value associated with the user's cryptocurrency wallet address. If the digital transactional platform API 612 determines that the user credentials grant access to the blockchain transactional data, the blockchain transactional platform API 612 retrieves the blockchain transactional data from the transactional database 608 and sends the retrieved blockchain transactional data to the orchestration platform API 308. The orchestration platform API 308 then receives the transactional data. In various implementations, the orchestration platform API 308 sends the transactional data to the orchestration module 306 and/or the analysis module 101. The orchestration platform API 308 then receives the blockchain transactional data and sends the blockchain transactional data to the orchestration module 306 and/or the analysis module 101.

In various implementations, the request for access may not include a request for the monitored first-domain value price, and the orchestration module 306 and/or the analysis module 101 may retrieve and/or generate the monitored first-domain price directly based on information retrieved from the network 206. In various implementations, in addition to or instead of sending the second request for access to the blockchain transactional platform API 612, the orchestration module 306 and/or the analysis module 101 may access the distributed ledger 204 and/or the secondary mesh network 208 directly to determine the blockchain transactional data (e.g., in some examples, the amount of second-domain value associated with the user's cryptocurrency wallet address). After the orchestration module 306 and/or the analysis module 101 receives the blockchain transactional data and/or retrieves the blockchain transactional data, control proceeds to 1216.

At 1216, the orchestration module 306 and/or analysis module 101 automatically generates a trading strategy based on the transactional data, the monitored first-domain value price, and the blockchain transactional data. In various implementations, the orchestration module 306 and/or analysis module 101 generates input vectors by processing and packaging the transactional data, the monitored first-domain value price, and the blockchain transactional data into a format suitable for use by the algorithms and/or models of the analysis module 101. The input vectors are then provided to the algorithms and/or models, which automatically generate a trading strategy based on the input vectors. Control proceeds to 1218. At 1218, the orchestration module 306 and/or analysis module 101 generates an output payload based on the trading strategy. Control moves to 1220.

At 1220, the orchestration module 306 and/or the analysis module 101 may generate a second user interface element based on the output payload. In various implementations, the second user interface element may be generated to display the trading strategy to the user. Control proceeds to 122. At 1222, the orchestration module 306 and/or the analysis module 101 may generate a third user interface element. The third user interface element may be selectable by the user. In various implementations, the second and third user interface elements may be accessed through and displayed on the user device 218. Control proceeds to 1224. At 1224, the orchestration module 306 and/or the analysis module 101 determines whether the third user interface element has been selected. If at 1224, the orchestration module 306 and/or the analysis module 101 determines that the third user interface element has been selected, control proceeds to 1226. Otherwise, control proceeds back to 1224 to await selection of the third user interface element.

At 1226, the orchestration module 306 and/or the analysis module 101 automatically generates an execution payload based on the trading strategy. In various implementations, the execution payload contains purchase or sell orders in formats accessible by the digital transactional module 406 and/or the blockchain transactional module 606. Control proceeds to 1228. At 1228, the orchestration module 306 and/or the analysis module 101 automatically sends the execution payload to the digital transactional platform API 412 and/or the blockchain transactional platform API 612. For example, the orchestration module 306 and/or the analysis module 101 may automatically send the execution payload to the digital transactional platform API 412 if the execution payload contains purchase or sell orders for first-domain value assets. The orchestration module 306 and/or the analysis module 101 may automatically send the execution payload to the blockchain transactional platform API 612 if the execution payload contains purchase or sell orders for second-domain value assets.

In various implementations, the orchestration module 306 and/or the analysis module 101 may send the execution payload to the digital transactional platform API 412 via the orchestration platform API 308, the shared system resources 302, the communications interface 306, the network 206, the communications interface 410, and the shared system resources 402. In various implementations, the orchestration module 306 and/or the analysis module 101 may send the execution payload to the blockchain transactional platform API 612 via the orchestration platform API 308, the shared system resources 302, the communications interface 306, the network 206, the communications interface 610, and the shared system resources 602. Control proceeds to 1230.

At 1230, the digital transactional module 406 and/or the blockchain transactional module 606 may automatically execute transactions based on the execution payload. For example, if the digital transactional platform API 412 receives the execution payload, the digital transactional platform API 412 sends the execution payload to the digital transactional module 406, and the digital transactional module 406 initiates a purchase order or a sell order for first-domain value assets based on the execution payload. If the blockchain transactional platform API 612 receives the execution payload, the blockchain transactional platform API 612 sends the execution payload to the blockchain transactional module 606, and the blockchain transactional module 606 automatically initiates a purchase order or a sell order for second-domain value assets based on the execution payload.

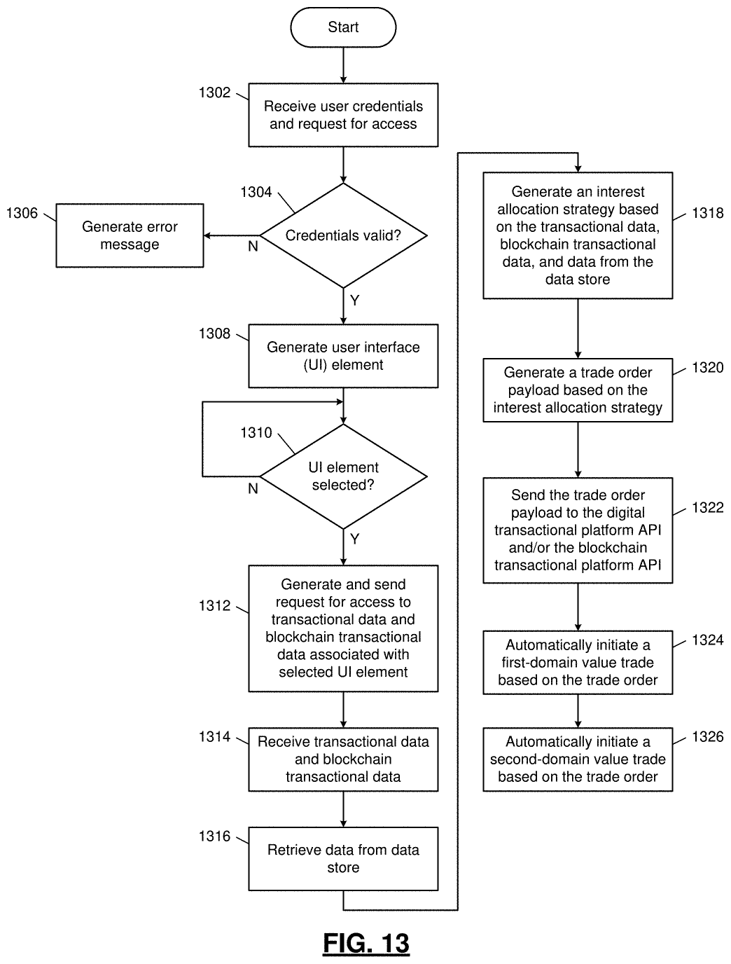

FIG. 13 is a flowchart of an example process for automatically orchestrating the transmission, reception, and processing of digital payloads between components of the system of platforms 100. At 1302, the user device 218 sends user credentials and a request for access to the orchestration platform API 308. The user credentials and the request for access are sent to the security layer 104 of the orchestration platform API 308. Control proceeds to 1304. At 1304, the security layer 104 parses the user credentials and determines whether the credentials are valid for access. If at 1304, the security layer 104 determines that the user credentials are not valid and do not grant access to components of the system of platforms 100, control proceeds to 1306, where the analysis module 101 and/or the orchestration module 306 generate an error message. In various implementations, the error message is generated on a user interface, which may be accessed by the user device 218 and output to a screen of the user device 218.

If at 1304, the security layer 104 determines that the user credentials are valid and grant access to one or more components of the system of platforms 100, control proceeds to 1308. At 1308, the analysis module 101 and/or the orchestration module 306 generates a user interface element. In various implementations, the user interface element corresponds to operations that may be performed using and/or data that may be accessed through the one or more components of the system of platforms 100 that the user credential provides valid access to. In various implementations, the user interface element may be accessed through and displayed on the user device 218. Control proceeds to 1310.

At 1310, the orchestration module 306 and/or the analysis module 101 determines whether the user interface element has been selected. For example, the user interface element may be selected by the user touching the user interface element as rendered on a touchscreen of the user device 218, or by the user selecting the user interface element rendered on a screen of the user device 218 using a user input device (such as a keyboard and/or mouse). If at 1310, the orchestration module 306 and/or the analysis module 101 does not detect that the user interface element has been selected, control proceeds back to 1310 to await the selection of the user interface element. If at 1310, the orchestration module 306 and/or the analysis module 101 determines that the user interface element has been selected control proceeds to 1312.

At 1312, the orchestration module 306 and/or the analysis module 101 generates a request for access corresponding to the selected user interface element. In various implementations, the user interface element may correspond to a request for access to transactional data associated with the user, and the request for access may include a request for transactional data associated with the user. In various implementations, the transactional data may include a data payload indicative of a first-domain value stored in the transactional database 408. In various implementations, the first-domain may be denominations of a fiat currency, and the first-domain value may be an amount of fiat currency present in the user's account with a financial institution. In various implementations, the request for access may include the user's credentials. In various implementations, the orchestration module 306 and/or the analysis module 101 may send the request for access to the digital transactional platform API 412 through the orchestration platform API 308, the shared system resources 302, the communications interface 306, the network 206, the communications interface 410, and/or the shared system resources 402.

The orchestration module 306 and/or the analysis module 101 may generate a second request for access associated with the selected user interface element. In various implementations, the user interface element may correspond to a request for access to blockchain transactional data associated with the user, and the second request for access may include a request for blockchain transactional data associated with the user. In various implementations, the blockchain transactional data may include a data payload indicative of a second-domain value stored on the distributed ledger 204 and/or the secondary mesh network 208. In various implementations, the second-domain may be denominations of a cryptocurrency, and the second-domain value may be an amount of cryptocurrency associated with a user's cryptocurrency wallet address. In various implementations, the second request for access may include the user's credentials. In various implementations, the orchestration module 306 and/or the analysis module 101 may send the second request for access to the blockchain transactional platform API 612 through the orchestration platform API 308, the shared system resources 302, the communications interface 306, the network 206, the communications interface 610, and/or the shared system resources 602. Control proceeds to 1314.

At 1314, after receiving the request for access, the digital transactional platform API 412 determines whether the user credentials contained in the request for access grant access to the transactional data. If the digital transactional platform API 412 determines that the user credentials grant access to the transactional data, the digital transactional platform API 412 retrieves the transactional data from the transactional database 408 and sends the retrieved transactional data to the orchestration platform API 308. The orchestration platform API 308 then receives the transactional data. In various implementations, the orchestration platform API 308 sends the transactional data to the orchestration module 306 and/or the analysis module 101.

After receiving the second request for access, the blockchain transactional platform API 612 determines whether the user credentials contained in the request for access grant access to the blockchain transactional data contained in the blockchain transactional database 608. In various implementations, the blockchain transactional data may include the amount of second-domain value associated with the user's cryptocurrency wallet address. If the digital transactional platform API 612 determines that the user credentials grant access to the blockchain transactional data, the blockchain transactional platform API 612 retrieves the blockchain transactional data from the transactional database 608 and sends the retrieved blockchain transactional data to the orchestration platform API 308. The orchestration platform API 308 then receives the transactional data. In various implementations, the orchestration platform API 308 sends the transactional data to the orchestration module 306 and/or the analysis module 101. The orchestration platform API 308 then receives the blockchain transactional data and sends the blockchain transactional data to the orchestration module 306 and/or the analysis module 101.

In various implementations, in addition to or instead of sending the second request for access to the blockchain transactional platform API 612, the orchestration module 306 and/or the analysis module 101 may access the distributed ledger 204 and/or the secondary mesh network 208 directly to determine the blockchain transactional data (e.g., in some examples, the amount of second-domain value associated with the user's cryptocurrency wallet address). After the orchestration module 306 and/or the analysis module 101 receives the blockchain transactional data and/or retrieves the blockchain transactional data, control proceeds to 1316.

At 1316, the orchestration module 306 and/or the analysis module 101 retrieves data from a data store. For example, the orchestration module 306 and/or the analysis module 101 may retrieve data from any of the libraries and/or data stores previously described. In various implementations, the data may include an overall financial profile of the user. In various implementations the data may include a financial risk profile for the user. In various implementations, the data may include a financial strategy for the user. In various implementations, the data may include one or more trading rules. Control proceeds to 1318. At 1318, the orchestration module 306 and/or analysis module 101 generates an interest allocation strategy based on the transactional data, the blockchain transactional data, and data from the data store. In various implementations, the interest allocation strategy may be an allocation of the user's assets between a first-domain value asset and a second-domain value asset. In various implementations, the orchestration module 306 and/or analysis module 101 may parse and format the transactional data, the blockchain transactional data, and the data from the data store into input vectors for any of the algorithms and/or models previously described with respect to the system of platforms 100. In various implementations, the orchestration module 306 and/or analysis module 101 may provide the input vectors to the algorithms and/or models and automatically generate the interest allocation strategy. Control proceeds to 1320.

At 1320, the orchestration module 306 and/or analysis module 101 generates a trade order payload based on the interest allocation strategy. In various implementations, the orchestration module 306 and/or analysis module 101 may parse and format the interest allocation strategy, generating trade orders for first-domain value assets in a format suitable for the digital transactional module 406, and generating trade orders for second-domain value assets in a format suitable for the blockchain transactional module 606. The orchestration module 306 and/or analysis module 101 may save the generated trade orders as the trade order payload. Control proceeds to 1322.

At 1322, the orchestration module 306 and/or the analysis module 101 sends the trade order payload to the digital transactional platform API 412 and/or the blockchain transactional platform API 612. In various implementations, the orchestration module 306 and/or the analysis module 101 determines whether the trade order payload contains a trade order for the digital transactional module 406. If the trade order payload contains a trade order for the digital transactional module 406, the orchestration module 306 and/or the analysis module 101 automatically sends the trade order payload to the digital transactional module 406. In various implementations, the orchestration module 306 and/or the analysis module 101 determines whether the trade order payload contains a trade order for the blockchain transactional module 606. If the trade order payload contains a trade order for the blockchain transactional module 606, the orchestration module 306 and/or the analysis module 101 automatically sends the trade order payload to the blockchain transactional module 606.

In various implementations, the orchestration module 306 and/or the analysis module 101 may send the trade order payload to the digital transactional module 406 via the orchestration platform API 308, the shared system resources 302, the communications interface 306, the network 206, the communications interface 410, and the shared system resources 402. In various implementations, the orchestration module 306 and/or the analysis module 101 may send the trade order payload to the blockchain transactional module 606 via the orchestration platform API 308, the shared system resources 302, the communications interface 306, the network 206, the communications interface 610, and the shared system resources 602. Control proceeds to 1324.

At 1324, if the digital transactional platform API 412 receives the trade order payload, the digital transactional platform API 412 automatically passes the trade order payload to the digital transactional module 406. After receiving the trade order payload, the digital transactional module 406 automatically parses the trade order payload and initiates a first-domain value trade based on the contents of the trade order payload. In various implementations, the first-domain value trade may purchase or sell first-domain value assets associated with the user. Control proceeds to 1326. At 1326, if the blockchain transactional platform API 612 receives the trade order payload, the blockchain transactional platform API 612 automatically passes the trade order payload to the blockchain transactional module 606. After receiving the trade order payload, the blockchain transactional module 606 automatically parses the trade order payload and initiates a second-domain value trade based on the contents of the trade order payload. In various implementations, the second-domain value trade may purchase or sell second-domain value assets associated with the user (such as cryptocurrency assets associated with the user's cryptocurrency wallet address).

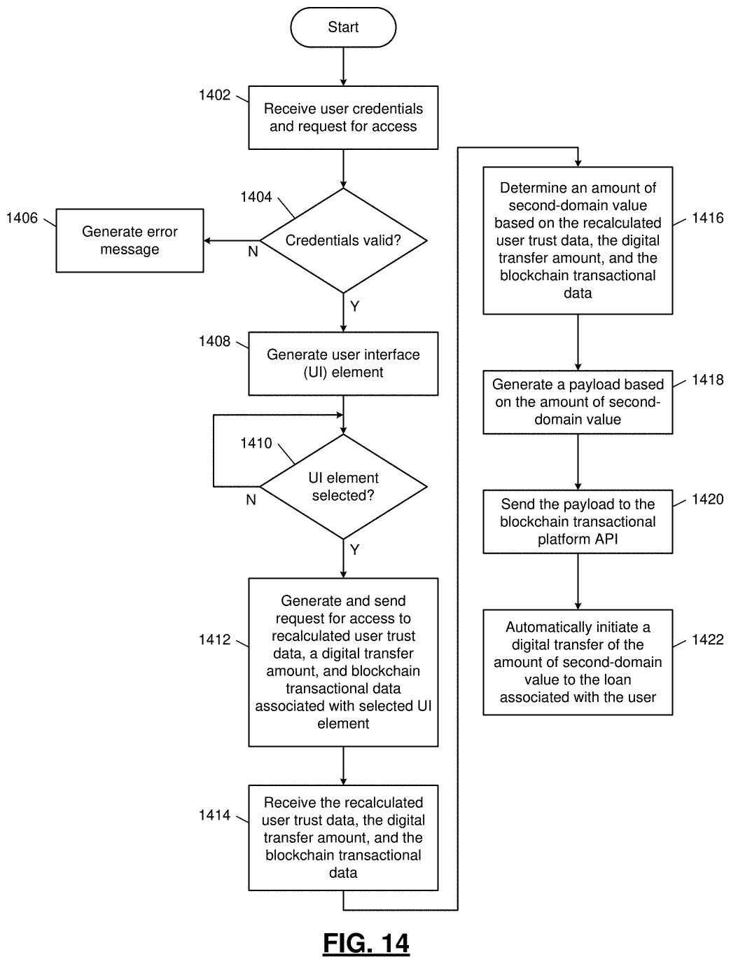

FIG. 14 is a flowchart of an example process for automatically orchestrating the transmission, reception, and processing of digital payloads between components of the system of platforms 100. At 1402, the user device 218 sends user credentials and a request for access to the orchestration platform API 308. The user credentials and the request for access are sent to the security layer 104 of the orchestration platform API 308. Control proceeds to 1404. At 1404, the security layer 104 parses the user credentials and determines whether the credentials are valid for access. If at 1404, the security layer 104 determines that the user credentials are not valid and do not grant access to components of the system of platforms 100, control proceeds to 1406, where the analysis module 101 and/or the orchestration module 306 generate an error message. In various implementations, the error message is generated on a user interface, which may be accessed by the user device 218 and output to a screen of the user device 218.

If at 1404, the security layer 104 determines that the user credentials are valid and grant access to one or more components of the system of platforms 100, control proceeds to 1308. At 1408, the analysis module 101 and/or the orchestration module 306 generates a user interface element. In various implementations, the user interface element corresponds to operations that may be performed using and/or data that may be accessed through the one or more components of the system of platforms 100 that the user credential provides valid access to. In various implementations, the user interface element may be accessed through and displayed on the user device 218. Control proceeds to 1310.

At 1410, the orchestration module 306 and/or the analysis module 101 determines whether the user interface element has been selected. For example, the user interface element may be selected by the user touching the user interface element as rendered on a touchscreen of the user device 218, or by the user selecting the user interface element rendered on a screen of the user device 218 using a user input device (such as a keyboard and/or mouse). If at 1410, the orchestration module 306 and/or the analysis module 101 does not detect that the user interface element has been selected, control proceeds back to 1410 to await the selection of the user interface element. If at 1410, the orchestration module 306 and/or the analysis module 101 determines that the user interface element has been selected control proceeds to 1412.

At 1412, the orchestration module 306 and/or the analysis module 101 generates a request for access corresponding to the selected user interface element. In various implementations, the user interface element may correspond to a request for access to recalculated user trust data and a digital transfer amount associated with the user. In various implementations, the recalculated user trust data may indicate an amount of first-domain value outstanding in a loan associated with the user. In various implementations, the digital transfer amount may indicate an amount of first-domain value required to repay the loan for each payment period. In various implementations, the request for access may include the user's credentials. In various implementations, the orchestration module 306 and/or the analysis module 101 may send the request for access to the user trust platform API 512 through the orchestration platform API 308, the shared system resources 302, the communications interface 306, the network 206, the communications interface 510, and the shared system resources 502.

The orchestration module 306 and/or the analysis module 101 may generate a second request for access associated with the selected user interface element. In various implementations, the user interface element may correspond to a request for access to blockchain transactional data associated with the user, and the second request for access may include a request for blockchain transactional data associated with the user. In various implementations, the blockchain transactional data may include a data payload indicative of a second-domain value stored on the distributed ledger 204 and/or the secondary mesh network 208. In various implementations, the second-domain may be denominations of a cryptocurrency, and the second-domain value may be an amount of cryptocurrency associated with a user's cryptocurrency wallet address. In various implementations, the second request for access may include the user's credentials. In various implementations, the orchestration module 306 and/or the analysis module 101 may send the second request for access to the blockchain transactional platform API 612 through the orchestration platform API 308, the shared system resources 302, the communications interface 306, the network 206, the communications interface 610, and/or the shared system resources 602. Control proceeds to 1414.

At 1414, the orchestration platform API 308 sends the recalculated user trust data, the digital transfer amount, and the blockchain transactional data to the orchestration module 306 and/or the analysis module 101. Control proceeds to 1416. At 1416, the orchestration module 306 and/or analysis module 101 determines an amount of second-domain value based on the recalculated user trust data, the digital transfer amount, and the blockchain transactional data. In various implementations, the amount of second-domain value may be indicative of a loan repayment amount for the loan associated with the user. In various implementations, the blockchain transaction data includes cryptocurrency market data. In various implementations, the orchestration module 306 and/or analysis module 101 may retrieve data from the libraries and data stores of the orchestration module 306 and/or analysis module 101. In various implementations, the retrieved data may include data about the second-domain value (such as cryptocurrency market data) and/or stored rules relating to the lender's financial risk tolerance.

In various implementations, the orchestration module 306 and/or analysis module 101 may parse and package the recalculated user trust data, the digital transfer amount, the blockchain transactional data, and/or the retrieved data into input vectors suitable for any of the algorithms and/or models previously described with respect to the analysis module 101. The orchestration module 306 and/or analysis module 101 may provide the input vectors to any of the algorithms and/or models of the analysis module 101 and automatically determine an amount of second-domain value. Control proceeds to 1418.

In various implementations, the orchestration module 306 and/or analysis module 101 determines whether the stored rules are consistent with the blockchain transactional data. In various implementations, the orchestration module 306 and/or analysis module 101 proceeds to 1418 only if the stored rules are consistent with the blockchain transactional data.

In various implementations, the orchestration module 306 and/or analysis module 101 determines whether the stored rules are consistent with the cryptocurrency market data present in the data about the second-domain value. In various implementations, the orchestration module 306 and/or analysis module 101 proceeds to 1418 only if the stored rules are consistent with the data about the second-domain value.

At 1418, the orchestration module 306 and/or the analysis module 101 generates a payload based on the amount of second-domain value. In various implementations, to generate the payload, the orchestration module 306 and/or the analysis module 101 may process and package the second-domain value into a format usable by the blockchain transactional module 606. Control proceeds to 1420. At 1420, the orchestration module 306 and/or the analysis module 101 sends the payload to the blockchain transactional platform API 612 via the orchestration platform API 308, the shared system resources 302, the communications interface 306, the network 206, the communications interface 610, and the shared system resources 602. Control proceeds to 1422. At 1422, the blockchain transactional platform API 612 sends the payload to the blockchain transactional module 606, and the blockchain transactional module 606 automatically initiates a digital transfer of the amount of second-domain value to the loan associated with the user.

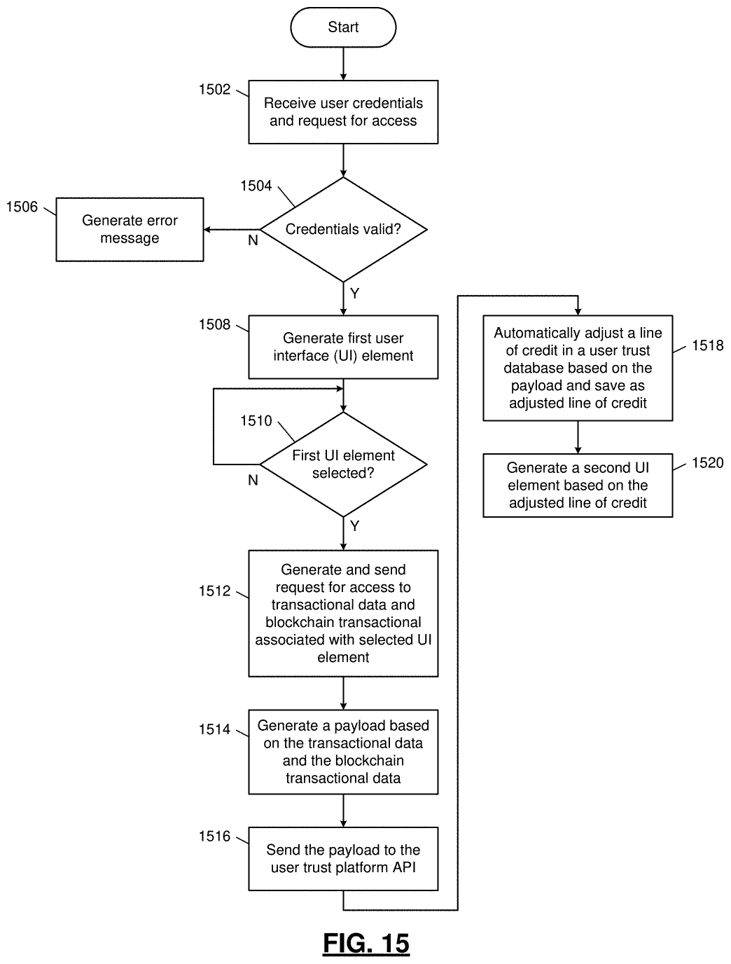

FIG. 15 is a flowchart of an example process for automatically orchestrating the transmission, reception, and processing of digital payloads between components of the system of platforms 100. At 1502, the user device 218 sends user credentials and a request for access to the orchestration platform API 308. The user credentials and the request for access are sent to the security layer 104 of the orchestration platform API 308. Control proceeds to 1504. At 1504, the security layer 104 parses the user credentials and determines whether the credentials are valid for access. If at 1504, the security layer 104 determines that the user credentials are not valid and do not grant access to components of the system of platforms 100, control proceeds to 1506, where the analysis module 101 and/or the orchestration module 306 generate an error message. In various implementations, the error message is generated on a user interface, which may be accessed by the user device 218 and output to a screen of the user device 218.

If at 1504, the security layer 104 determines that the user credentials are valid and grant access to one or more components of the system of platforms 100, control proceeds to 1508. At 1508, the analysis module 101 and/or the orchestration module 306 generates a user interface element. In various implementations, the user interface element corresponds to operations that may be performed using and/or data that may be accessed through the one or more components of the system of platforms 100 that the user credential provides valid access to. In various implementations, the user interface element may be accessed through and displayed on the user device 218. Control proceeds to 1310.

At 1510, the orchestration module 306 and/or the analysis module 101 determines whether the user interface element has been selected. For example, the user interface element may be selected by the user touching the user interface element as rendered on a touchscreen of the user device 218, or by the user selecting the user interface element rendered on a screen of the user device 218 using a user input device (such as a keyboard and/or mouse). If at 1510, the orchestration module 306 and/or the analysis module 101 does not detect that the user interface element has been selected, control proceeds back to 1510 to await the selection of the user interface element. If at 1510, the orchestration module 306 and/or the analysis module 101 determines that the user interface element has been selected control proceeds to 1512.

At 1512, the orchestration module 306 and/or the analysis module 101 generates a request for access corresponding to the selected user interface element. In various implementations, the user interface element may correspond to a request for access to transactional data associated with the user, and the request for access may include a request for transactional data associated with the user. In various implementations, the transactional data may include a data payload indicative of a first-domain value stored in the transactional database 408. In various implementations, the first-domain may be denominations of a fiat currency, and the first-domain value may be an amount of fiat currency present in the user's account with a financial institution. In various implementations, the request for access may include the user's credentials. In various implementations, the orchestration module 306 and/or the analysis module 101 may send the request for access to the digital transactional platform API 412 through the orchestration platform API 308, the shared system resources 302, the communications interface 306, the network 206, the communications interface 410, and/or the shared system resources 402.

The orchestration module 306 and/or the analysis module 101 may generate a second request for access associated with the selected user interface element. In various implementations, the user interface element may correspond to a request for access to blockchain transactional data associated with the user, and the second request for access may include a request for blockchain transactional data associated with the user. In various implementations, the blockchain transactional data may include a data payload indicative of a second-domain value stored on the distributed ledger 204 and/or the secondary mesh network 208. In various implementations, the second-domain may be denominations of a cryptocurrency, and the second-domain value may be an amount of cryptocurrency associated with a user's cryptocurrency wallet address. In various implementations, the second request for access may include the user's credentials. In various implementations, the orchestration module 306 and/or the analysis module 101 may send the second request for access to the blockchain transactional platform API 612 through the orchestration platform API 308, the shared system resources 302, the communications interface 306, the network 206, the communications interface 610, and/or the shared system resources 602.

After receiving the request for access, the digital transactional platform API 412 determines whether the user credentials contained in the request for access grant access to the transactional data. If the digital transactional platform API 412 determines that the user credentials grant access to the transactional data, the digital transactional platform API 412 retrieves the transactional data from the transactional database 408 and sends the retrieved transactional data to the orchestration platform API 308. The orchestration platform API 308 then receives the transactional data. In various implementations, the orchestration platform API 308 sends the transactional data to the orchestration module 306 and/or the analysis module 101.

After receiving the second request for access, the blockchain transactional platform API 612 determines whether the user credentials contained in the request for access grant access to the blockchain transactional data contained in the blockchain transactional database 608. In various implementations, the blockchain transactional data may include the amount of second-domain value associated with the user's cryptocurrency wallet address. If the digital transactional platform API 612 determines that the user credentials grant access to the blockchain transactional data, the blockchain transactional platform API 612 retrieves the blockchain transactional data from the transactional database 608 and sends the retrieved blockchain transactional data to the orchestration platform API 308. The orchestration platform API 308 then receives the transactional data. In various implementations, the orchestration platform API 308 sends the transactional data to the orchestration module 306 and/or the analysis module 101. The orchestration platform API 308 then receives the blockchain transactional data and sends the blockchain transactional data to the orchestration module 306 and/or the analysis module 101.

In various implementations, in addition to or instead of sending the second request for access to the blockchain transactional platform API 612, the orchestration module 306 and/or the analysis module 101 may access the distributed ledger 204 and/or the secondary mesh network 208 directly to determine the blockchain transactional data (e.g., in some examples, the amount of second-domain value associated with the user's cryptocurrency wallet address). After the orchestration module 306 and/or the analysis module 101 receives the blockchain transactional data and/or retrieves the blockchain transactional data, control proceeds to 1514.

At 1514, the orchestration module 306 and/or the analysis module 101 generates a payload based on the transactional data and the blockchain transactional data. In various implementations, the orchestration module 306 and/or the analysis module 101 retrieves additional data about the financial profile of the user. In various implementations, the orchestration module 306 and/or analysis module 101 processes and packages the transactional data, the blockchain transactional data, and/or the retrieved additional data into input vectors for use by any of the algorithms and/or models previously described with respect to the orchestration module 306 and/or analysis module 101. The orchestration module 306 and/or analysis module 101 provides the input vectors to one or more of the algorithms and/or models previously described with respect to the orchestration module 306 and/or analysis module 101 to automatically generate the payload. In various implementations, the payload contains instructions readable by the user trust module 506 to adjust a variable line of credit associated with the user. Control proceeds to 1516.

At 1516, the orchestration module 306 and/or the analysis module 101 sends the payload to the user trust platform API 512 via the orchestration platform API 308, the shared system resources 302, the communications interface 306, the network 206, the communications interface 510, and the shared system resources 502. Control proceeds to 1518. At 1518, the user trust platform API 512 sends the payload to the user trust module 506. The user trust module 506 automatically adjusts the line of credit associated with the user stored in the user trust database 508 based on the payload. Control proceeds to 1520. At 1520, in various implementations, the user trust module 506 generates a user interface element based on the adjusted line of credit. For example, the user trust module 506 transforms the user interface element to display the adjusted line of credit. In various implementations, the orchestration module 306 and/or the analysis module 101 may access the adjusted line of credit through the orchestration platform API 308, the shared system resources 302, the communications interface 306, the network 206, the communications interface 510, the shared system resources 502, and the user trust platform API 512. Based on the adjusted line of credit, the orchestration module 306 and/or the analysis module 101 may generate a second user interface element displaying the adjusted line of credit. In various implementations, the user device 218 may access the user interface elements.

FIG. 16 is a flowchart of an example process for automatically orchestrating the transmission, reception, and processing of digital payloads between components of the system of platforms 100. At 1602, the user device 218 sends user credentials and a request for access to the orchestration platform API 308. The user credentials and the request for access are sent to the security layer 104 of the orchestration platform API 308. Control proceeds to 1604. At 1604, the security layer 104 parses the user credentials and determines whether the credentials are valid for access. If at 1604, the security layer 104 determines that the user credentials are not valid and do not grant access to components of the system of platforms 100, control proceeds to 1606, where the analysis module 101 and/or the orchestration module 306 generate an error message. In various implementations, the error message is generated on a user interface, which may be accessed by the user device 218 and output to a screen of the user device 218.

If at 1604, the security layer 104 determines that the user credentials are valid and grant access to one or more components of the system of platforms 100, control proceeds to 1608. At 1608, the analysis module 101 and/or the orchestration module 306 generates a user interface element. In various implementations, the user interface element corresponds to operations that may be performed using and/or data that may be accessed through the one or more components of the system of platforms 100 that the user credential provides valid access to. In various implementations, the user interface element may be accessed through and displayed on the user device 218. Control proceeds to 1610.

At 1610, the orchestration module 306 and/or the analysis module 101 determines whether the user interface element has been selected. For example, the user interface element may be selected by the user touching the user interface element as rendered on a touchscreen of the user device 218, or by the user selecting the user interface element rendered on a screen of the user device 218 using a user input device (such as a keyboard and/or mouse). If at 1610, the orchestration module 306 and/or the analysis module 101 does not detect that the user interface element has been selected, control proceeds back to 1610 to await the selection of the user interface element. If at 1610, the orchestration module 306 and/or the analysis module 101 determines that the user interface element has been selected control proceeds to 1612.

At 1612, the orchestration module 306 and/or the analysis module 101 generates a request for access corresponding to the selected user interface element. In various implementations, the user interface element may correspond to a request for access to user trust data associated with the user. In various implementations, the user trust data may indicate an amount of first-domain value outstanding in a loan associated with the user. In various implementations, the request for access may include the user's credentials. In various implementations, the orchestration module 306 and/or the analysis module 101 may send the request for access to the user trust platform API 512 through the orchestration platform API 308, the shared system resources 302, the communications interface 306, the network 206, the communications interface 510, and the shared system resources 502. Control proceeds to 1614.

At 1614, the orchestration module 306 and/or the analysis module 101 generates a second request for access corresponding to the selected user interface element. In various implementations, the user interface element may correspond to a request for access to transactional data associated with the user, and the second request for access may include a request for transactional data associated with the user. In various implementations, the transactional data may include a data payload indicative of a first-domain value stored in the transactional database 408. In various implementations, the first-domain may be denominations of a fiat currency, and the first-domain value may be an amount of fiat currency present in the user's account with a financial institution. In various implementations, the request for access may include the user's credentials. In various implementations, the orchestration module 306 and/or the analysis module 101 may send the request for access to the digital transactional platform API 412 through the orchestration platform API 308, the shared system resources 302, the communications interface 306, the network 206, the communications interface 410, and/or the shared system resources 402.

After receiving the request for access, the digital transactional platform API 412 determines whether the user credentials contained in the request for access grant access to the transactional data. If the digital transactional platform API 412 determines that the user credentials grant access to the transactional data, the digital transactional platform API 412 retrieves the transactional data from the transactional database 408 and sends the retrieved transactional data to the orchestration platform API 308. Control proceeds to 1616.

At 1616, the orchestration module 306 and/or the analysis module 101 may generate a third request for access associated with the selected user interface element. In various implementations, the user interface element may correspond to a request for access to blockchain transactional data associated with the user, and the third request for access may include a request for transactional data associated with the user. In various implementations, the transactional data may include a data payload indicative of a second-domain value stored on the distributed ledger 204 and/or the secondary mesh network 208. In various implementations, the second-domain may be denominations of a cryptocurrency, and the second-domain value may be an amount of cryptocurrency associated with a user's cryptocurrency wallet address. In various implementations, the third request for access may include the user's credentials.

In various implementations, the orchestration module 306 and/or the analysis module 101 may send the third request for access to the blockchain transactional platform API 612 through the orchestration platform API 308, the shared system resources 302, the communications interface 306, the network 206, the communications interface 610, and/or the shared system resources 602. After receiving the third request for access, the blockchain transactional platform API 612 determines whether the user credentials contained in the request for access grant access to the blockchain transactional data contained in the blockchain transactional database 608. In various implementations, the blockchain transactional data may include the amount of second-domain value associated with the user's cryptocurrency wallet address.

If the digital transactional platform API 612 determines that the user credentials grant access to the blockchain transactional data, the blockchain transactional platform API 612 retrieves the blockchain transactional data from the transactional database 608 and sends the retrieved blockchain transactional data to the orchestration platform API 308. Control proceeds to 714, where the orchestration platform API 308 receives the transactional data. Control proceeds to 1618.

At 1618, the orchestration platform API 308 sends the user trust data, the transactional data, and the blockchain transactional data to the orchestration module 306 and/or the analysis module 101. In various implementations, in addition to or instead of receiving the blockchain transactional data from the blockchain transactional platform API 612, the orchestration module 306 and/or the analysis module 101 may access the distributed ledger 204 and/or the secondary mesh network 208 directly to determine the blockchain transactional data (e.g., in some examples, the amount of second-domain value associated with the user's cryptocurrency wallet address). After receiving the user trust data, the transactional data, and the blockchain transactional data, the orchestration module 306 and/or analysis module 101 parses and packages the user trust data, the transactional data, and the blockchain transactional data as input vectors for one of the trained machine learning models previously described with respect to the analysis module 101. The orchestration module 306 and/or analysis module 101 then provides the input vectors to the trained machine learning model. Control proceeds to 1620.

At 1620, the trained machine learning model of the orchestration module 306 and/or analysis module 101 automatically generates financial metrics using the input vectors. In various implementations, the financial metrics may be indicative of fiat currency and/or cryptocurrency usage trends within the user's account with the financial institution, the user's loan account, and/or the user's cryptocurrency wallet address. Control proceeds to 1622. At 1622, the orchestration module 306 and/or the analysis module 101 may generate a second user interface element. In various implementations, the second user interface element may be based on the financial metrics. In various implementations, the second user interface elements may output the financial metrics to a screen of the user device 218 via the orchestration platform API 308, the shared system resources 302, the communications interface 306, and the network 206.

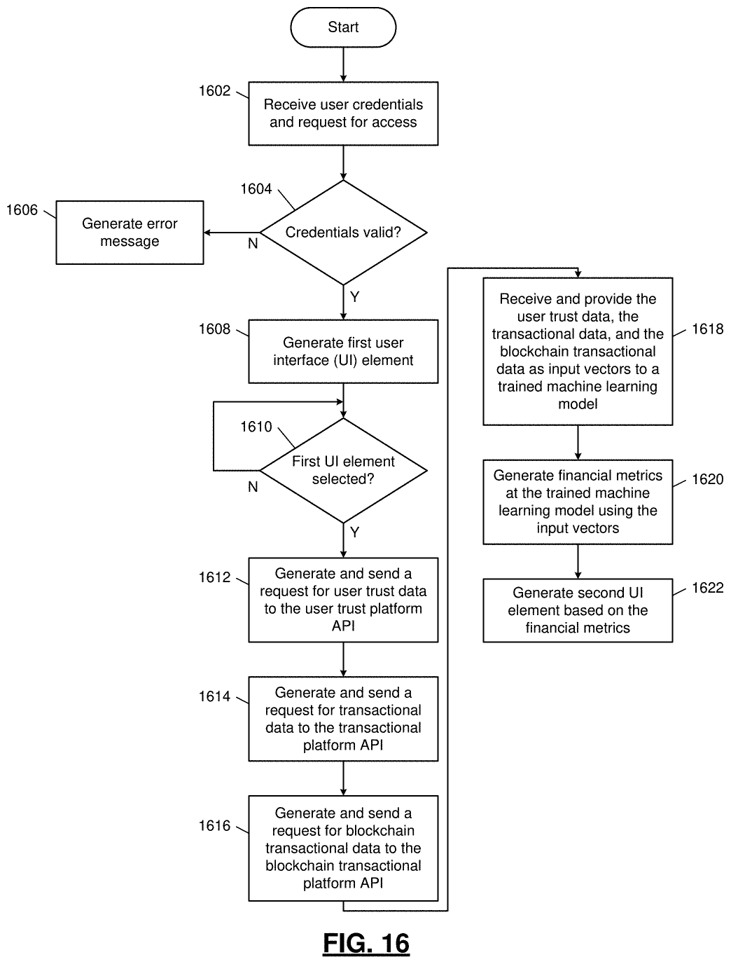

FIG. 17 is a flowchart of an example process for automatically orchestrating the transmission, reception, and processing of digital payloads between components of the system of platforms 100. At 1702, the user device 218 sends user credentials and a request for access to the orchestration platform API 308. The user credentials and the request for access are sent to the security layer 104 of the orchestration platform API 308. Control proceeds to 1704. At 1704, the security layer 104 parses the user credentials and determines whether the credentials are valid for access. If at 1704, the security layer 104 determines that the user credentials are not valid and do not grant access to components of the system of platforms 100, control proceeds to 1706, where the analysis module 101 and/or the orchestration module 306 generate an error message. In various implementations, the error message is generated on a user interface, which may be accessed by the user device 218 and output to a screen of the user device 218.

If at 1704, the security layer 104 determines that the user credentials are valid and grant access to one or more components of the system of platforms 100, control proceeds to 1708. At 1708, the analysis module 101 and/or the orchestration module 306 generates a user interface element. In various implementations, the user interface element corresponds to operations that may be performed using and/or data that may be accessed through the one or more components of the system of platforms 100 that the user credential provides valid access to. In various implementations, the user interface element may be accessed through and displayed on the user device 218. Control proceeds to 1710.

At 1710, the orchestration module 306 and/or the analysis module 101 determines whether the user interface element has been selected. For example, the user interface element may be selected by the user touching the user interface element as rendered on a touchscreen of the user device 218, or by the user selecting the user interface element rendered on a screen of the user device 218 using a user input device (such as a keyboard and/or mouse). If at 1710, the orchestration module 306 and/or the analysis module 101 does not detect that the user interface element has been selected, control proceeds back to 1710 to await the selection of the user interface element. If at 1710, the orchestration module 306 and/or the analysis module 101 determines that the user interface element has been selected control proceeds to 1712.

At 1712, the orchestration module 306 and/or the analysis module 101 generates a request for access corresponding to the selected user interface element. In various implementations, the user interface element may correspond to a request for access to user trust data associated with the user. In various implementations, the user trust data may indicate an amount of first-domain value outstanding in a loan associated with the user. In various implementations, the request for access may include the user's credentials. In various implementations, the orchestration module 306 and/or the analysis module 101 may send the request for access to the user trust platform API 512 through the orchestration platform API 308, the shared system resources 302, the communications interface 306, the network 206, the communications interface 510, and the shared system resources 502. Control proceeds to 1714.

At 1714, the orchestration module 306 and/or the analysis module 101 generates a second request for access corresponding to the selected user interface element. In various implementations, the user interface element may correspond to a request for access to transactional data associated with the user, and the second request for access may include a request for transactional data associated with the user. In various implementations, the transactional data may include a data payload indicative of a first-domain value stored in the transactional database 408. In various implementations, the first-domain may be denominations of a fiat currency, and the first-domain value may be an amount of fiat currency present in the user's account with a financial institution. In various implementations, the request for access may include the user's credentials. In various implementations, the orchestration module 306 and/or the analysis module 101 may send the request for access to the digital transactional platform API 412 through the orchestration platform API 308, the shared system resources 302, the communications interface 306, the network 206, the communications interface 410, and/or the shared system resources 402.

After receiving the request for access, the digital transactional platform API 412 determines whether the user credentials contained in the request for access grant access to the transactional data. If the digital transactional platform API 412 determines that the user credentials grant access to the transactional data, the digital transactional platform API 412 retrieves the transactional data from the transactional database 408 and sends the retrieved transactional data to the orchestration platform API 308. Control proceeds to 1716.

At 1716, the orchestration module 306 and/or the analysis module 101 may generate a third request for access associated with the selected user interface element. In various implementations, the user interface element may correspond to a request for access to blockchain transactional data associated with the user, and the third request for access may include a request for transactional data associated with the user. In various implementations, the transactional data may include a data payload indicative of a second-domain value stored on the distributed ledger 204 and/or the secondary mesh network 208. In various implementations, the second-domain may be denominations of a cryptocurrency, and the second-domain value may be an amount of cryptocurrency associated with a user's cryptocurrency wallet address. In various implementations, the third request for access may include the user's credentials.

In various implementations, the orchestration module 306 and/or the analysis module 101 may send the third request for access to the blockchain transactional platform API 612 through the orchestration platform API 308, the shared system resources 302, the communications interface 306, the network 206, the communications interface 610, and/or the shared system resources 602. After receiving the third request for access, the blockchain transactional platform API 612 determines whether the user credentials contained in the request for access grant access to the blockchain transactional data contained in the blockchain transactional database 608. In various implementations, the blockchain transactional data may include the amount of second-domain value associated with the user's cryptocurrency wallet address.

If the digital transactional platform API 612 determines that the user credentials grant access to the blockchain transactional data, the blockchain transactional platform API 612 retrieves the blockchain transactional data from the transactional database 608 and sends the retrieved blockchain transactional data to the orchestration platform API 308. Control proceeds to 714, where the orchestration platform API 308 receives the transactional data. Control proceeds to 1718.

At 1718, the orchestration platform API 308 sends the user trust data, the transactional data, and the blockchain transactional data to the orchestration module 306 and/or the analysis module 101. In various implementations, in addition to or instead of receiving the blockchain transactional data from the blockchain transactional platform API 612, the orchestration module 306 and/or the analysis module 101 may access the distributed ledger 204 and/or the secondary mesh network 208 directly to determine the blockchain transactional data (e.g., in some examples, the amount of second-domain value associated with the user's cryptocurrency wallet address). After receiving the user trust data, the transactional data, and the blockchain transactional data, the orchestration module 306 and/or analysis module 101 parses and packages the user trust data, the transactional data, and the blockchain transactional data as input vectors for one of the trained machine learning models previously described with respect to the analysis module 101. The orchestration module 306 and/or analysis module 101 then provides the input vectors to the trained machine learning model. Control proceeds to 1720.

At 1720, the orchestration module 306 and/or analysis module 101 calculates second-domain value price volatility data. In various implementations, the second-domain value price volatility data may be a statistical measure of the dispersion of returns for a given second-domain value asset or market index. In various implementations, the volatility data may be the calculated standard deviation or variance between returns from the same second-domain value asset or market index. After the orchestration module 306 and/or analysis module 101 calculates the second-domain value price volatility data, the orchestration module 306 and/or analysis module 101 saves the calculated second-domain value price volatility data to one or more of the libraries and/or data stores of the analysis module 101. Control proceeds to 1722. At 1722, the orchestration module 306 and/or analysis module 101 parses and packages the user trust data, the transactional data, the blockchain transactional data, and the second-domain value price volatility data as input vectors suitable for one or more of the algorithms and/or models previously described with respect to the analysis module 101. Control proceeds to 1724.

At 1724, the orchestration module 306 and/or analysis module 101 provides the input vectors to one or more of the algorithms and/or models to automatically generate first metrics. In various implementations, the first metrics may be related to a portion of the second-domain value that is correlated to the user's cryptocurrency wallet address. In various implementations, the portion of the second-domain value may be reserved as collateral for the user's loan. Control proceeds to 1726. At 1726, the orchestration module 306 and/or analysis module 101 provides the input vectors to one or more of the algorithms and/or models to automatically generate second metrics. In various implementations, the second metrics may indicate a percentage for a first financial option. In various implementations, the second metrics may indicate a percentage price reduction at which a loss of the second-domain value asset is capped. Control proceeds to 1728.

At 1728, the orchestration module 306 and/or analysis module 101 provides the input vectors to one or more of the algorithms and/or models to automatically generate third metrics. In various implementations, the third metrics may be related to a percentage for a second financial option. In various implementations, the second metrics may indicate a percentage price increase at which a price increase of the second-domain value asset is capped. Control proceeds to 1730. At 1730, the orchestration module 306 and/or the analysis module 101 transforms the user interface to output the first metrics, the second metrics, and the third metrics. In various implementations, the user interface may be accessed and displayed on a screen of the user device 218 via the orchestration platform API 308, the shared system resources, the communications interface 306, and the network 206.

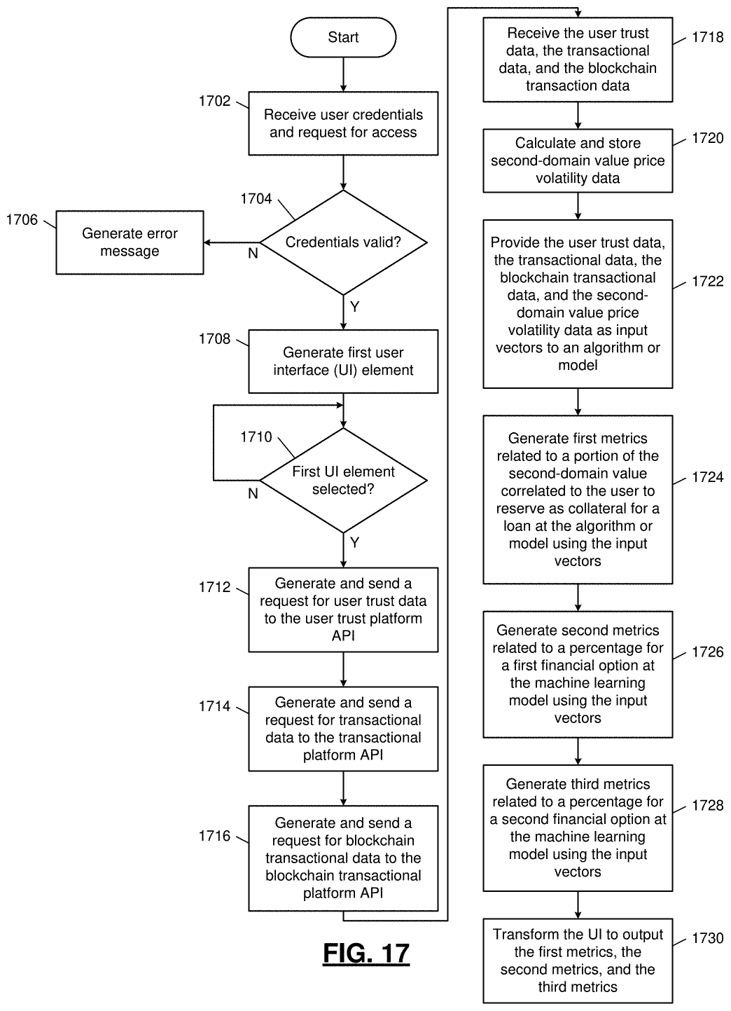

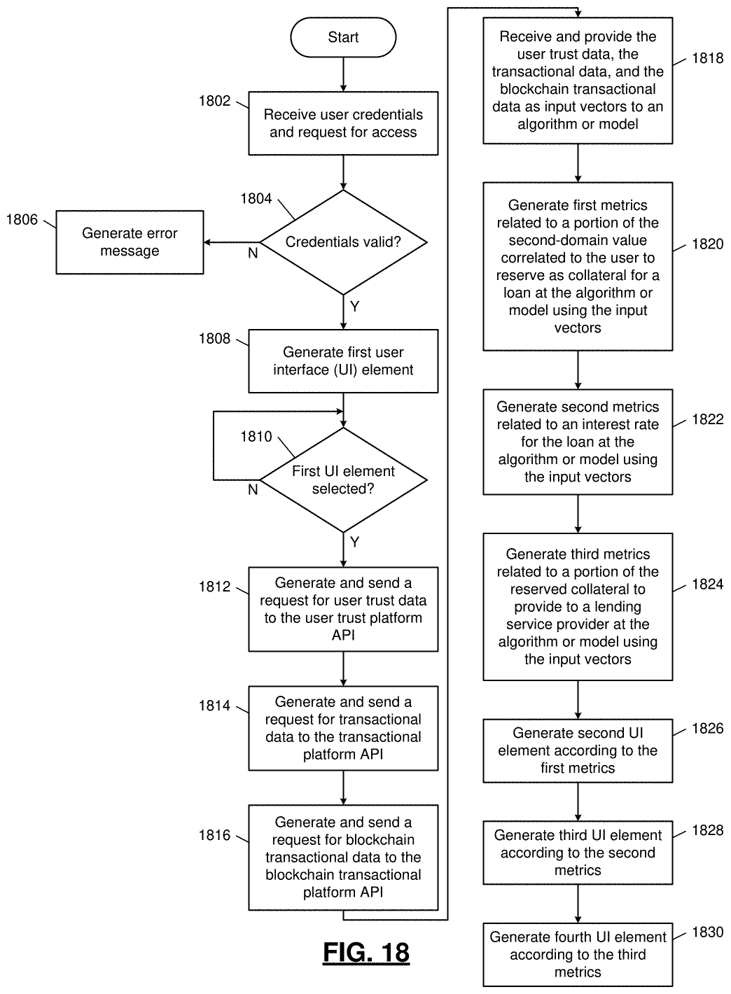

FIG. 18 is a flowchart of an example process for automatically orchestrating the transmission, reception, and processing of digital payloads between components of the system of platforms 100. At 1802, the user device 218 sends user credentials and a request for access to the orchestration platform API 308. The user credentials and the request for access are sent to the security layer 104 of the orchestration platform API 308. Control proceeds to 1804. At 1804, the security layer 104 parses the user credentials and determines whether the credentials are valid for access. If at 1804, the security layer 104 determines that the user credentials are not valid and do not grant access to components of the system of platforms 100, control proceeds to 1806, where the analysis module 101 and/or the orchestration module 306 generate an error message. In various implementations, the error message is generated on a user interface, which may be accessed by the user device 218 and output to a screen of the user device 218.

If at 1804, the security layer 104 determines that the user credentials are valid and grant access to one or more components of the system of platforms 100, control proceeds to 1808. At 1808, the analysis module 101 and/or the orchestration module 306 generates a user interface element. In various implementations, the user interface element corresponds to operations that may be performed using and/or data that may be accessed through the one or more components of the system of platforms 100 that the user credential provides valid access to. In various implementations, the user interface element may be accessed through and displayed on the user device 218. Control proceeds to 1810.

At 1810, the orchestration module 306 and/or the analysis module 101 determines whether the user interface element has been selected. For example, the user interface element may be selected by the user touching the user interface element as rendered on a touchscreen of the user device 218, or by the user selecting the user interface element rendered on a screen of the user device 218 using a user input device (such as a keyboard and/or mouse). If at 1810, the orchestration module 306 and/or the analysis module 101 does not detect that the user interface element has been selected, control proceeds back to 1810 to await the selection of the user interface element. If at 1810, the orchestration module 306 and/or the analysis module 101 determines that the user interface element has been selected control proceeds to 1812.

At 1812, the orchestration module 306 and/or the analysis module 101 generates a request for access corresponding to the selected user interface element. In various implementations, the user interface element may correspond to a request for access to user trust data associated with the user. In various implementations, the user trust data may indicate an amount of first-domain value outstanding in a loan associated with the user. In various implementations, the request for access may include the user's credentials. In various implementations, the orchestration module 306 and/or the analysis module 101 may send the request for access to the user trust platform API 512 through the orchestration platform API 308, the shared system resources 302, the communications interface 306, the network 206, the communications interface 510, and the shared system resources 502. Control proceeds to 1814.

At 1814, the orchestration module 306 and/or the analysis module 101 generates a second request for access corresponding to the selected user interface element. In various implementations, the user interface element may correspond to a request for access to transactional data associated with the user, and the second request for access may include a request for transactional data associated with the user. In various implementations, the transactional data may include a data payload indicative of a first-domain value stored in the transactional database 408. In various implementations, the first-domain may be denominations of a fiat currency, and the first-domain value may be an amount of fiat currency present in the user's account with a financial institution. In various implementations, the request for access may include the user's credentials. In various implementations, the orchestration module 306 and/or the analysis module 101 may send the request for access to the digital transactional platform API 412 through the orchestration platform API 308, the shared system resources 302, the communications interface 306, the network 206, the communications interface 410, and/or the shared system resources 402.

After receiving the request for access, the digital transactional platform API 412 determines whether the user credentials contained in the request for access grant access to the transactional data. If the digital transactional platform API 412 determines that the user credentials grant access to the transactional data, the digital transactional platform API 412 retrieves the transactional data from the transactional database 408 and sends the retrieved transactional data to the orchestration platform API 308. Control proceeds to 1816.

At 1816, the orchestration module 306 and/or the analysis module 101 may generate a third request for access associated with the selected user interface element. In various implementations, the user interface element may correspond to a request for access to blockchain transactional data associated with the user, and the third request for access may include a request for transactional data associated with the user. In various implementations, the transactional data may include a data payload indicative of a second-domain value stored on the distributed ledger 204 and/or the secondary mesh network 208. In various implementations, the second-domain may be denominations of a cryptocurrency, and the second-domain value may be an amount of cryptocurrency associated with a user's cryptocurrency wallet address. In various implementations, the third request for access may include the user's credentials.

In various implementations, the orchestration module 306 and/or the analysis module 101 may send the third request for access to the blockchain transactional platform API 612 through the orchestration platform API 308, the shared system resources 302, the communications interface 306, the network 206, the communications interface 610, and/or the shared system resources 602. After receiving the third request for access, the blockchain transactional platform API 612 determines whether the user credentials contained in the request for access grant access to the blockchain transactional data contained in the blockchain transactional database 608. In various implementations, the blockchain transactional data may include the amount of second-domain value associated with the user's cryptocurrency wallet address.

If the digital transactional platform API 612 determines that the user credentials grant access to the blockchain transactional data, the blockchain transactional platform API 612 retrieves the blockchain transactional data from the transactional database 608 and sends the retrieved blockchain transactional data to the orchestration platform API 308. Control proceeds to 714, where the orchestration platform API 308 receives the transactional data. Control proceeds to 1818.

At 1818, the orchestration platform API 308 sends the user trust data, the transactional data, and the blockchain transactional data to the orchestration module 306 and/or the analysis module 101. In various implementations, in addition to or instead of receiving the blockchain transactional data from the blockchain transactional platform API 612, the orchestration module 306 and/or the analysis module 101 may access the distributed ledger 204 and/or the secondary mesh network 208 directly to determine the blockchain transactional data (e.g., in some examples, the amount of second-domain value associated with the user's cryptocurrency wallet address). After receiving the user trust data, the transactional data, and the blockchain transactional data, the orchestration module 306 and/or analysis module 101 parses and packages the user trust data, the transactional data, and the blockchain transactional data as input vectors for one of the trained machine learning models previously described with respect to the orchestration module 306 and/or analysis module 101. The orchestration module 306 and/or analysis module 101 then provides the input vectors to one or more algorithms and/or models previously described with respect to the analysis module 101. Control proceeds to 1820.

At 1820, the orchestration module 306 and/or analysis module 101 provides the input vectors to one or more algorithms and/or models to automatically generate first metrics. In various implementations, the first metrics may be related to a portion of the second-domain value correlated to the user to reserve as collateral for the user's loan. Control proceeds to 1822. At 1822, the orchestration module 306 and/or analysis module 101 provides the input vectors to one or more algorithms and/or models to automatically generate second metrics. In various implementations, the second metrics may be related to an interest rate for the user's loan. Control proceeds to 1824. At 1824, the orchestration module 306 and/or analysis module 101 provides the input vectors to one or more algorithms and/or models to automatically generate third metrics. In various implementations, the third metrics may be related to a portion of the reserved collateral to be provided and/or transferred to the loan service provider. Control proceeds to 1826.

At 1826, the orchestration module 308 and/or the analysis module 101 generates a second user interface element according to the first metrics. In various implementations, the second user interface element may display the first metrics. In various implementations, the second user interface element may be displayed on the display of the user device 218. In various implementations, the user device 218 may access the second user interface element via the network 206, the communications interface 306, the shared system resources 302, and the orchestration platform API 308. Control proceeds to 1828.

At 1828, the orchestration module 308 and/or the analysis module 101 generates a third user interface element according to the second metrics. In various implementations, the third user interface element may display the second metrics. In various implementations, the third user interface element may be displayed on the display of the user device 218. In various implementations, the user device 218 may access the third user interface element via the network 206, the communications interface 306, the shared system resources 302, and the orchestration platform API 308. Control proceeds to 1830.

At 1830, the orchestration module 308 and/or the analysis module 101 generates a fourth user interface element according to the third metrics. In various implementations, the fourth user interface element may display the third metrics. In various implementations, the fourth user interface element may be displayed on the display of the user device 218. In various implementations, the user device 218 may access the fourth user interface element via the network 206, the communications interface 306, the shared system resources 302, and the orchestration platform API 308.

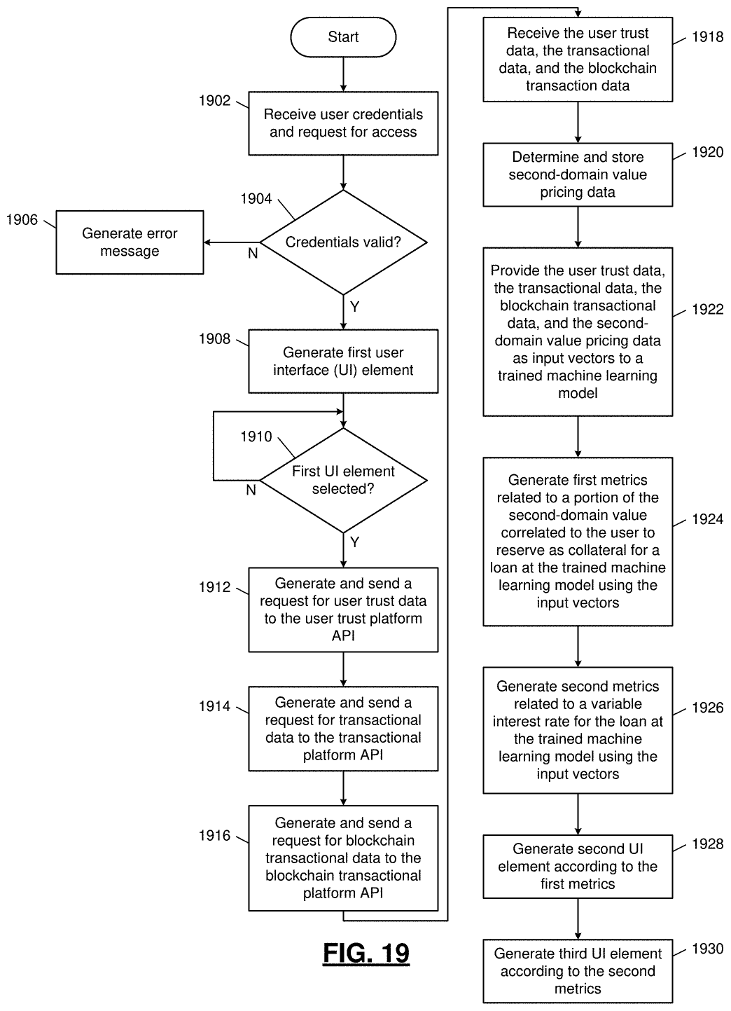

FIG. 19 is a flowchart of an example process for automatically orchestrating the transmission, reception, and processing of digital payloads between components of the system of platforms 100. At 1902, the user device 218 sends user credentials and a request for access to the orchestration platform API 308. The user credentials and the request for access are sent to the security layer 104 of the orchestration platform API 308. Control proceeds to 1904. At 1904, the security layer 104 parses the user credentials and determines whether the credentials are valid for access. If at 1904, the security layer 104 determines that the user credentials are not valid and do not grant access to components of the system of platforms 100, control proceeds to 1906, where the analysis module 101 and/or the orchestration module 306 generate an error message. In various implementations, the error message is generated on a user interface, which may be accessed by the user device 218 and output to a screen of the user device 218.

If at 1904, the security layer 104 determines that the user credentials are valid and grant access to one or more components of the system of platforms 100, control proceeds to 1908. At 1908, the analysis module 101 and/or the orchestration module 306 generates a user interface element. In various implementations, the user interface element corresponds to operations that may be performed using and/or data that may be accessed through the one or more components of the system of platforms 100 that the user credential provides valid access to. In various implementations, the user interface element may be accessed through and displayed on the user device 218. Control proceeds to 1910.

At 1910, the orchestration module 306 and/or the analysis module 101 determines whether the user interface element has been selected. For example, the user interface element may be selected by the user touching the user interface element as rendered on a touchscreen of the user device 218, or by the user selecting the user interface element rendered on a screen of the user device 218 using a user input device (such as a keyboard and/or mouse). If at 1910, the orchestration module 306 and/or the analysis module 101 does not detect that the user interface element has been selected, control proceeds back to 1910 to await the selection of the user interface element. If at 1910, the orchestration module 306 and/or the analysis module 101 determines that the user interface element has been selected control proceeds to 1912.

At 1912, the orchestration module 306 and/or the analysis module 101 generates a request for access corresponding to the selected user interface element. In various implementations, the user interface element may correspond to a request for access to user trust data associated with the user. In various implementations, the user trust data may indicate an amount of first-domain value outstanding in a loan associated with the user. In various implementations, the request for access may include the user's credentials. In various implementations, the orchestration module 306 and/or the analysis module 101 may send the request for access to the user trust platform API 512 through the orchestration platform API 308, the shared system resources 302, the communications interface 306, the network 206, the communications interface 510, and the shared system resources 502. Control proceeds to 1914.

At 1914, the orchestration module 306 and/or the analysis module 101 generates a second request for access corresponding to the selected user interface element. In various implementations, the user interface element may correspond to a request for access to transactional data associated with the user, and the second request for access may include a request for transactional data associated with the user. In various implementations, the transactional data may include a data payload indicative of a first-domain value stored in the transactional database 408. In various implementations, the first-domain may be denominations of a fiat currency, and the first-domain value may be an amount of fiat currency present in the user's account with a financial institution. In various implementations, the request for access may include the user's credentials. In various implementations, the orchestration module 306 and/or the analysis module 101 may send the request for access to the digital transactional platform API 412 through the orchestration platform API 308, the shared system resources 302, the communications interface 306, the network 206, the communications interface 410, and/or the shared system resources 402.

After receiving the request for access, the digital transactional platform API 412 determines whether the user credentials contained in the request for access grant access to the transactional data. If the digital transactional platform API 412 determines that the user credentials grant access to the transactional data, the digital transactional platform API 412 retrieves the transactional data from the transactional database 408 and sends the retrieved transactional data to the orchestration platform API 308. Control proceeds to 1916.

At 1916, the orchestration module 306 and/or the analysis module 101 may generate a third request for access associated with the selected user interface element. In various implementations, the user interface element may correspond to a request for access to blockchain transactional data associated with the user, and the third request for access may include a request for transactional data associated with the user. In various implementations, the transactional data may include a data payload indicative of a second-domain value stored on the distributed ledger 204 and/or the secondary mesh network 208. In various implementations, the second-domain may be denominations of a cryptocurrency, and the second-domain value may be an amount of cryptocurrency associated with a user's cryptocurrency wallet address. In various implementations, the third request for access may include the user's credentials.

In various implementations, the orchestration module 306 and/or the analysis module 101 may send the third request for access to the blockchain transactional platform API 612 through the orchestration platform API 308, the shared system resources 302, the communications interface 306, the network 206, the communications interface 610, and/or the shared system resources 602. After receiving the third request for access, the blockchain transactional platform API 612 determines whether the user credentials contained in the request for access grant access to the blockchain transactional data contained in the blockchain transactional database 608. In various implementations, the blockchain transactional data may include the amount of second-domain value associated with the user's cryptocurrency wallet address.

If the digital transactional platform API 612 determines that the user credentials grant access to the blockchain transactional data, the blockchain transactional platform API 612 retrieves the blockchain transactional data from the transactional database 608 and sends the retrieved blockchain transactional data to the orchestration platform API 308. Control proceeds to 714, where the orchestration platform API 308 receives the transactional data. Control proceeds to 1918.

At 1918, the orchestration platform API 308 sends the user trust data, the transactional data, and the blockchain transactional data to the orchestration module 306 and/or the analysis module 101. In various implementations, in addition to or instead of receiving the blockchain transactional data from the blockchain transactional platform API 612, the orchestration module 306 and/or the orchestration module 306 and/or analysis module 101 may access the distributed ledger 204 and/or the secondary mesh network 208 directly to determine the blockchain transactional data (e.g., in some examples, the amount of second-domain value associated with the user's cryptocurrency wallet address). Control proceeds to 1920. At 1920, the orchestration module 306 and/or analysis module 101 determines and stores second-domain value pricing data.

In various implementations, the orchestration module 306 and/or analysis module 101 may calculate the second-domain value pricing data by accessing the distributed ledger 204 and/or the second mesh network 208 directly via the orchestration platform API 308, the shared system resources 302, the communications interface 306, and the network 206. In various implementations, the blockchain transactional module 606 may calculate the second-domain value pricing data by accessing the distributed ledger 204 and/or the second mesh network 208 via the blockchain transactional platform API 612, the shared system resources 602, the communications interface 610, and the network 206. The blockchain transactional module 606 may send the second-domain value pricing data to the orchestration module 306 and/or analysis module 101 via the blockchain transactional platform API 612, the shared system resources 602, the communications interface 610, the network 206, the communications interface 306, the shared system resources 302, and the orchestration platform API 308. In various implementations, the orchestration module 306 and/or analysis module 101 may store the second-domain value pricing data in any of the libraries and data stores previously described with respect to the analysis module 101. Control proceeds to 1922.

At 1922, the orchestration module 306 and/or analysis module 101 parses and packages the user trust data, the transactional data, the blockchain transactional data, and the second-domain value pricing data as input vectors for one of the trained machine learning models previously described with respect to the analysis module 101. The orchestration module 306 and/or analysis module 101 then provides the input vectors to one or more algorithms and/or models previously described with respect to the analysis module 101. Control proceeds to 1924.

At 1924, the orchestration module 306 and/or analysis module 101 provides the input vectors to one or more algorithms and/or models to automatically generate first metrics. In various implementations, the first metrics may be related to a portion of the second-domain value correlated to the user to reserve as collateral for the user's loan. Control proceeds to 1926. At 1926, the orchestration module 306 and/or analysis module 101 provides the input vectors to one or more algorithms and/or models to automatically generate second metrics. In various implementations, the second metrics may be related to a variable interest rate for the user's loan. Control proceeds to 1928.

At 1928, the orchestration module 308 and/or the analysis module 101 generates a second user interface element according to the first metrics. In various implementations, the second user interface element may display the first metrics. In various implementations, the second user interface element may be displayed on the display of the user device 218. In various implementations, the user device 218 may access the second user interface element via the network 206, the communications interface 306, the shared system resources 302, and the orchestration platform API 308. Control proceeds to 1930.

At 1930, the orchestration module 308 and/or the analysis module 101 generates a third user interface element according to the second metrics. In various implementations, the third user interface element may display the second metrics. In various implementations, the third user interface element may be displayed on the display of the user device 218. In various implementations, the user device 218 may access the third user interface element via the network 206, the communications interface 306, the shared system resources 302, and the orchestration platform API 308.

FIG. 20 is a flowchart of an example process for automatically orchestrating the transmission, reception, and processing of digital payloads between components of the system of platforms 100. At 2002, the user device 218 sends user credentials and a request for access to the orchestration platform API 308. The user credentials and the request for access are sent to the security layer 104 of the orchestration platform API 308. Control proceeds to 2004. At 1904, the security layer 104 parses the user credentials and determines whether the credentials are valid for access. If at 2004, the security layer 104 determines that the user credentials are not valid and do not grant access to components of the system of platforms 100, control proceeds to 1906, where the analysis module 101 and/or the orchestration module 306 generate an error message. In various implementations, the error message is generated on a user interface, which may be accessed by the user device 218 and output to a screen of the user device 218.

If at 2004, the security layer 104 determines that the user credentials are valid and grant access to one or more components of the system of platforms 100, control proceeds to 2008. At 2008, the analysis module 101 and/or the orchestration module 306 generates a user interface element. In various implementations, the user interface element corresponds to operations that may be performed using and/or data that may be accessed through the one or more components of the system of platforms 100 that the user credential provides valid access to. In various implementations, the user interface element may be accessed through and displayed on the user device 218. Control proceeds to 2010.

At 2010, the orchestration module 306 and/or the analysis module 101 determines whether the user interface element has been selected. For example, the user interface element may be selected by the user touching the user interface element as rendered on a touchscreen of the user device 218, or by the user selecting the user interface element rendered on a screen of the user device 218 using a user input device (such as a keyboard and/or mouse). If at 2010, the orchestration module 306 and/or the analysis module 101 does not detect that the user interface element has been selected, control proceeds back to 2010 to await the selection of the user interface element. If at 2010, the orchestration module 306 and/or the analysis module 101 determines that the user interface element has been selected control proceeds to 2012.

At 2012, the orchestration module 306 and/or the analysis module 101 generates a request for access corresponding to the selected user interface element. In various implementations, the user interface element may correspond to a request for access to user trust data associated with the user. In various implementations, the user trust data may indicate an amount of first-domain value outstanding in a loan associated with the user. In various implementations, the request for access may include the user's credentials. In various implementations, the orchestration module 306 and/or the analysis module 101 may send the request for access to the user trust platform API 512 through the orchestration platform API 308, the shared system resources 302, the communications interface 306, the network 206, the communications interface 510, and the shared system resources 502. Control proceeds to 2014.

At 2014, the orchestration module 306 and/or the analysis module 101 generates a second request for access corresponding to the selected user interface element. In various implementations, the user interface element may correspond to a request for access to transactional data associated with the user, and the second request for access may include a request for transactional data associated with the user. In various implementations, the transactional data may include a data payload indicative of a first-domain value stored in the transactional database 408. In various implementations, the first-domain may be denominations of a fiat currency, and the first-domain value may be an amount of fiat currency present in the user's account with a financial institution. In various implementations, the request for access may include the user's credentials. In various implementations, the orchestration module 306 and/or the analysis module 101 may send the request for access to the digital transactional platform API 412 through the orchestration platform API 308, the shared system resources 302, the communications interface 306, the network 206, the communications interface 410, and/or the shared system resources 402.

After receiving the request for access, the digital transactional platform API 412 determines whether the user credentials contained in the request for access grant access to the transactional data. If the digital transactional platform API 412 determines that the user credentials grant access to the transactional data, the digital transactional platform API 412 retrieves the transactional data from the transactional database 408 and sends the retrieved transactional data to the orchestration platform API 308. Control proceeds to 2016.

At 2016, the orchestration module 306 and/or the analysis module 101 may generate a third request for access associated with the selected user interface element. In various implementations, the user interface element may correspond to a request for access to blockchain transactional data associated with the user, and the third request for access may include a request for transactional data associated with the user. In various implementations, the transactional data may include a data payload indicative of a second-domain value stored on the distributed ledger 204 and/or the secondary mesh network 208. In various implementations, the second-domain may be denominations of a cryptocurrency, and the second-domain value may be an amount of cryptocurrency associated with a user's cryptocurrency wallet address. In various implementations, the third request for access may include the user's credentials.

In various implementations, the orchestration module 306 and/or the analysis module 101 may send the third request for access to the blockchain transactional platform API 612 through the orchestration platform API 308, the shared system resources 302, the communications interface 306, the network 206, the communications interface 610, and/or the shared system resources 602. After receiving the third request for access, the blockchain transactional platform API 612 determines whether the user credentials contained in the request for access grant access to the blockchain transactional data contained in the blockchain transactional database 608. In various implementations, the blockchain transactional data may include the amount of second-domain value associated with the user's cryptocurrency wallet address.

If the digital transactional platform API 612 determines that the user credentials grant access to the blockchain transactional data, the blockchain transactional platform API 612 retrieves the blockchain transactional data from the transactional database 608 and sends the retrieved blockchain transactional data to the orchestration platform API 308. Control proceeds to 714, where the orchestration platform API 308 receives the transactional data. Control proceeds to 2018.

At 2018, the orchestration platform API 308 sends the user trust data, the transactional data, and the blockchain transactional data to the orchestration module 306 and/or the analysis module 101. In various implementations, in addition to or instead of receiving the blockchain transactional data from the blockchain transactional platform API 612, the orchestration module 306 and/or the analysis module 101 may access the distributed ledger 204 and/or the secondary mesh network 208 directly to determine the blockchain transactional data (e.g., in some examples, the amount of second-domain value associated with the user's cryptocurrency wallet address). Control proceeds to 2020. At 2020, the orchestration module 306 and/or analysis module 101 determines and stores second-domain value pricing data.

In various implementations, the orchestration module 306 and/or analysis module 101 may calculate the second-domain value pricing data by accessing the distributed ledger 204 and/or the second mesh network 208 directly via the orchestration platform API 308, the shared system resources 302, the communications interface 306, and the network 206. In various implementations, the blockchain transactional module 606 may calculate the second-domain value pricing data by accessing the distributed ledger 204 and/or the second mesh network 208 via the blockchain transactional platform API 612, the shared system resources 602, the communications interface 610, and the network 206. The blockchain transactional module 606 may send the second-domain value pricing data to the orchestration module 306 and/or analysis module 101 via the blockchain transactional platform API 612, the shared system resources 602, the communications interface 610, the network 206, the communications interface 306, the shared system resources 302, and the orchestration platform API 308. In various implementations, the orchestration module 306 and/or analysis module 101 may store the second-domain value pricing data in any of the libraries and data stores previously described with respect to the analysis module 101. Control proceeds to 2022.

At 2022, the orchestration module 306 and/or analysis module 101 parses and packages the user trust data, the transactional data, the blockchain transactional data, and the second-domain value pricing data as input vectors for one of the trained machine learning models previously described with respect to the analysis module 101. The orchestration module 306 and/or analysis module 101 then provides the input vectors to one or more algorithms and/or models previously described with respect to the analysis module 101. Control proceeds to 2024.

At 2024, the orchestration module 306 and/or analysis module 101 provides the input vectors to one or more algorithms and/or models to automatically generate metrics. In various implementations, the metrics may be related to a variable interest rate for the user's loan. In various implementations, the orchestration module 306 and/or the analysis module 101 may generate a payload based on the metrics. In various implementations, the payload may be in a format usable by the user trust module. In various implementations, the orchestration module 306 and/or the analysis module 101 may automatically send the payload to the user trust module 506 via the orchestration platform API 308, the shared system resources 302, the communications interface 306, the network 206, the communications interface 510, the shared system resources 502, and the user trust platform API 512. In various implementations, the user trust module 506 may automatically adjust the interest rate of the loan associated with the user based on the payload. Control proceeds to 2026.

At 2026, the orchestration module 308 and/or the analysis module 101 generates a second user interface element according to the metrics. In various implementations, the second user interface element may display the first metrics. In various implementations, the second user interface element may be displayed on the display of the user device 218. In various implementations, the user device 218 may access the second user interface element via the network 206, the communications interface 306, the shared system resources 302, and the orchestration platform API 308.

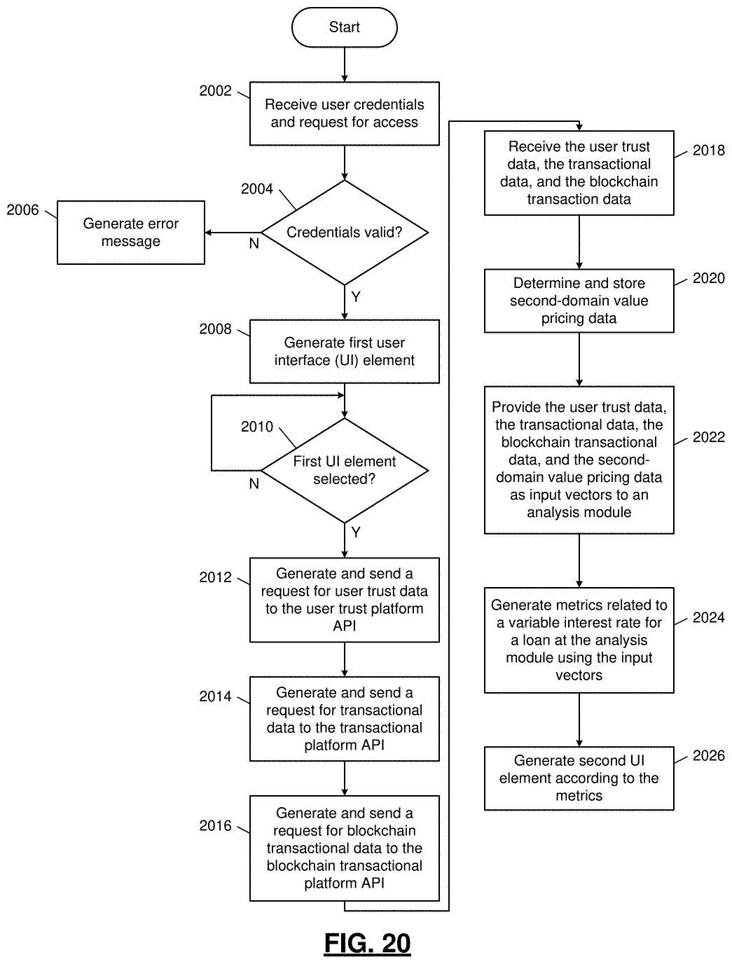

FIG. 21 is a flowchart of an example process for automatically orchestrating the transmission, reception, and processing of digital payloads between components of the system of platforms 100. At 2102, the orchestration module 306 and/or the analysis module 101 generates and sends a request for user trust data to the user trust platform API 512. In various implementations, the orchestration module 306 and/or the analysis module 101 may generate the request in response to the user selecting a user interface element on the user interface. In various implementations, the user interface may be accessed by the user device 218, and the user may select the user interface element on the display of the user device 218. After the user selects the user interface element, the orchestration module 306 and/or the analysis module 101 generates and sends the request for user trust data to the user trust platform API 512 via the shared system resources 302, the communications interface 306, the network 206, the communications interface 510, and the shared system resources 502.

After receiving the request for user trust data, the user trust platform API 512 checks user credentials present in the request for user trust data. If the user trust platform API 512 determines that the user credentials are valid for access to the user trust data, the user trust platform API 512 passes the request for user trust data to the user trust module 506, and the user trust module 506 retrieves the user trust data stored in the user trust database 508. In various implementations, the user trust data includes an amount of first-domain value remaining in a loan associated with the user. In various implementations, the user trust data includes an amortization table associated with the loan. Control proceeds to 2104.

At 2104, the orchestration module 306 and/or the analysis module 101 generates and sends a second request for blockchain transactional data to the blockchain transactional platform API 612. In various implementations, the orchestration module 306 and/or the analysis module 101 may generate the second request in response to the user selecting a user interface element on the user interface. In various implementations, the user interface may be accessed by the user device 218, and the user may select the user interface element on the display of the user device 218. After the user selects the user interface element, the orchestration module 306 and/or the analysis module 101 generates and sends the second request for user trust data to the blockchain transactional platform API 612 via the shared system resources 302, the communications interface 306, the network 206, the communications interface 610, and the shared system resources 602.

After receiving the second request, the blockchain transaction platform API 612 may determine whether the user credentials present in the second request are valid and grant access to the blockchain transactional data present in the blockchain transactional database 608. If the user credentials are valid, the blockchain transactional platform API 612 sends the second request to the blockchain transactional module 606. After the blockchain transactional module 606 receives the second request, the blockchain transactional module 606 retrieves the blockchain transactional data from the blockchain transactional database 608. In various implementations, the blockchain transactional data may include an amount of second-domain value associated with a cryptocurrency wallet address of the user. Control proceeds to 2106.

At 2106, the orchestration module 306 and/or the analysis module 101 receives the user trust data and the blockchain transactional data. In various implementations, the user trust module 506 automatically sends the user trust data to the orchestration module 306 and/or the analysis module 101 via the user trust platform API 512, the shared system resources 502, the communications interface 510, the network 206, the communications interface 306, the shared system resources 302, and the orchestration platform API 308. In various implementations, the blockchain transactional module 606 automatically sends the blockchain transactional data to the orchestration module 306 and/or the analysis module 101 via the blockchain transactional platform API 612, the shared system resources 602, the communications interface 610, the network 206, the communications interface 306, the shared system resources 302, and the orchestration platform API 308.

In various implementations, in addition to or instead of receiving the blockchain transactional data from the blockchain transactional module 606, the orchestration module 306 and/or the analysis module 101 may access the distributed ledger 204 and/or the secondary mesh network 208 via the orchestration platform API 308, the shared system resources 302, the communications interface 306, and the network 206 to automatically determine the blockchain transactional data. Control proceeds to 2108.

At 2108, the orchestration module 306 and/or analysis module 101 parses the user trust data to determine a first amount. In various implementations, the first amount corresponds to a loan digital transfer amount. In various implementations, the loan digital transfer amount corresponds to a first-domain value payment amount required to satisfy the loan repayment terms. Control proceeds to 2110. At 2110, the orchestration module 306 and/or analysis module 101 parses the blockchain transactional data to determine a second amount. In various implementations, the second amount corresponds to an amount of second-domain value related to the user. In various implementations, the second amount may correspond to an amount of second-domain value associated with the user's cryptocurrency wallet address. Control proceeds to 2112.

At 2112, the orchestration module 306 and/or analysis module 101 determines whether the second amount covers the first amount. In various implementations, the second amount covers the first amount if the amount of second-domain value related to the user is greater than the loan digital transfer. In various implementations, if the loan digital transfer occurs at a point in the future, the orchestration module 306 and/or analysis module 101 may predict whether the amount of second-domain value related to the user is likely to be greater than the loan digital transfer at the point in the future. In various implementations, the orchestration module 306 and/or analysis module 101 may provide the first amount, the second amount, and/or cryptocurrency market data to any of the algorithms and/or models previously described with respect to the analysis module 101 to determine whether the second amount covers the first amount. If at 2112, the orchestration module 306 and/or analysis module 101 determines that the second amount does not cover the first amount, control proceeds to 2114, where the orchestration module 306 and/or the analysis module 101 generates an error message. In various implementations, the error message may be output to the user interface and rendered on a display of the user device 218.

If at 2112, the orchestration module 306 and/or analysis module 101 determines that the second amount covers the first, control proceeds to 2116. At 2116, the orchestration module 306 and/or the analysis module 101 generates a payload. In various implementations, the payload may include instructions in a format readable by the blockchain transactional module 605. In various implementations, the payload may include instructions for the blockchain transactional module 605 to initiate a second-domain value digital transfer from the cryptocurrency wallet address associated with the user to the lending service provider. After the payload is generated, the orchestration module 306 and/or the analysis module 101 sends the payload to the blockchain transactional platform API 612 via the orchestration platform API 308, the shared system resources 302, the communications interface 306, the network 206, the communications interface 610, and the shared system resources 602. Control proceeds to 2118.

At 2118, the blockchain transactional platform API 612 determines whether the payload has been received. If the payload has not been received, control proceeds to 2120, where the blockchain transactional platform API 612 continues to wait for the payload and proceeds back to 2118. If at 2118 the blockchain transactional platform API 612 receives the payload, the blockchain transactional platform API 612 initiates the second-domain value digital transfer from the user to the lending service provider. In various implementations, the payload contains an amount of second-domain value assets to transfer from the cryptocurrency wallet address associated with the user to the lending service provider. In various implementations, the blockchain transactional platform API 612 sends the payload to the blockchain transactional module 606, and the blockchain transactional module 606 initiates the digital transfer to the loan service provider. Control proceeds to 2124.

At 2124, the user trust module 506 determines whether the digital transfer from the user's cryptocurrency wallet address is received. In various implementations, the user trust module 506 may monitor the distributed ledger 204 and/or the secondary mesh network 208 for the digital transfer from the cryptocurrency wallet address associated with the user to a cryptocurrency wallet address associated with the loan service provider. In various implementations, the user trust module 506 may monitor the distributed ledger 204 and/or the secondary mesh network 208 via the user trust platform API 512, the shared system resources 502, the communications interface 510, and the network 206. If at 2124, the user trust module 506 does not detect the digital transfer, control proceeds to 2126, where the user trust module 506 continues to monitor for the digital transfer and control proceeds back to 2124. If at 2124, the user trust module 506 detects the digital transfer, control proceeds to 2128. At 2128, the user trust module 506 updates the loan amount in the user trust database 508 according to a market price of the digital transfer. Control proceeds to 2130. At 2130, the user trust module 506 updates the amortization table in the user trust database 508 according to the market price of the digital transfer.

### Cryptocurrency Payment and Distribution Platform

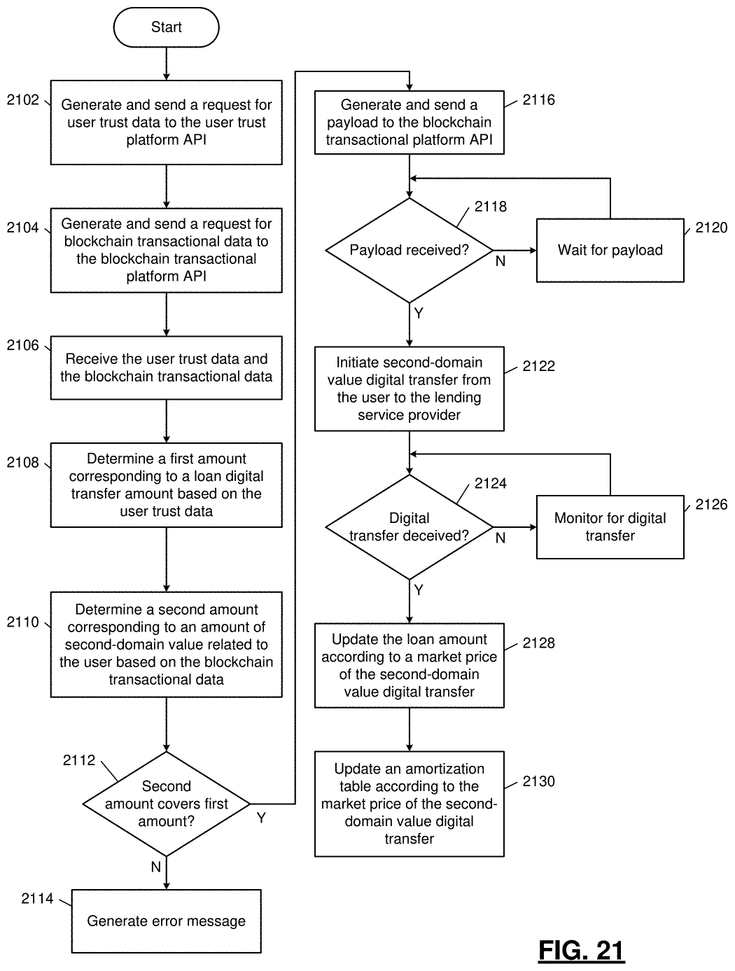

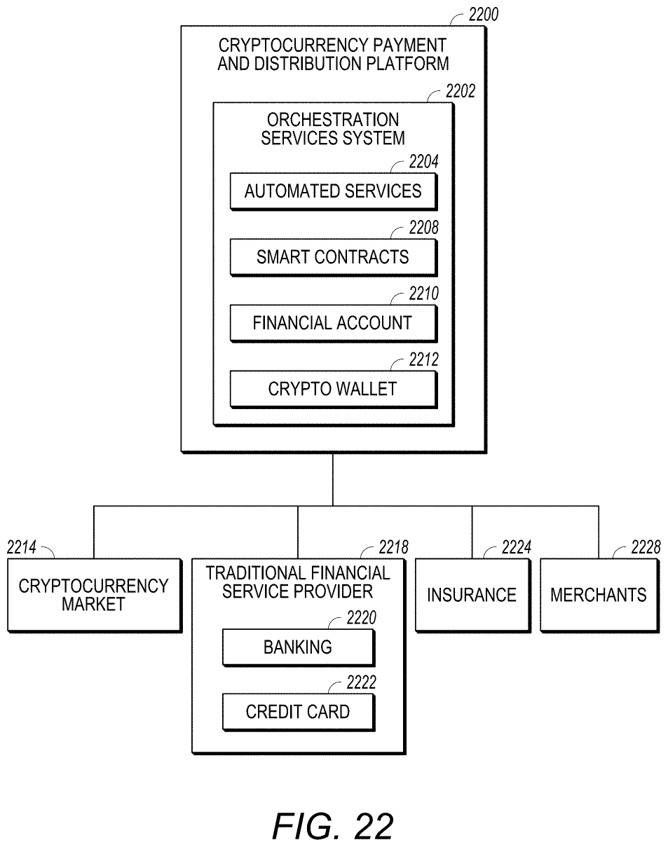

Referring to FIG. 22, a cryptocurrency payment and distribution platform 2200 provides banks, financial service providers 2218, insurers 2224, retail and other merchants 2228 or individuals the ability to accept payment and provide distributions, rewards and other consumer incentives in the form of fiat currency and/or cryptocurrency, or some blending or mixing of fiat currency and cryptocurrency in a single payment or distribution. This may allow such entities, such as merchants or individuals, to continue to accept payment in fiat currency while enjoying the benefits of traditional fiat banking systems and service providers 2218, such as robust payment and credit platforms, but with the expanded ability to accept purchases and sales that are denominated for at least one of the counterparties in cryptocurrency, including automated cryptocurrency trades that are triggered, at least in part, by traditional fiat currency banking or merchant activities, as well as trades that involve borrowing fiat currency using cryptocurrency balances as collateral. The platform 2200 as described herein provides users the ability to diversify their assets, for example by maintaining minimal or optimal balances of local fiat currency at their local bank to mitigate risk. As such, cryptocurrency may be transferred only when needed for financial expenditures.

In embodiments, the platform 2200 may allow users who have balances in cryptocurrency to be able to spend it in real time, whenever, and wherever they want, which currently is not possible today. Government regulatory agencies have been concerned about losing control and about keeping bad actors, such as money launderers, out of the financial system. The platform of the present disclosure addresses this problem by requiring the users to maintain a bank account and not just a cryptocurrency account.

The platform 2200 may include an orchestration services system 2202, including automated services 2204 that may utilize smart contracts 2208, and other mechanisms and services as part of managing a wallet, such as a cryptocurrency wallet 2212 using the native interfaces (including application programming interfaces) and systems of the cryptocurrency wallet 2212 and also managing a traditional financial account 2210, such as a bank account 2220 (checking, debit, savings, or other), credit card account 2222, or money services business account, among others, using the native interfaces (including application programming interfaces) and systems of the traditional financial account. The platform may be further operated by, linked to, integrated with, or otherwise associated with cryptocurrency trading platforms, platforms of traditional finance entities, including but not limited to banks and credit card companies, insurers, retail or other merchants, or some other financial or transactional entity.

In embodiments, the platform 2200 may include an orchestration services system 2202 that may perform and optionally automated a variety of tasks or workflows involved in orchestration of transactions across the cryptocurrency wallet 2212 environment and the traditional financial services environment, such as collection of marketplace information (such as exchange rates among currencies and cryptocurrencies, interest rates, and the like), collection of account information (such as account balances, settings, preferences, and parameters for rule-based processing (such as thresholds, ranges and the like)), intelligent order matching (e.g., of a purchase or sale of goods or services to a cryptocurrency balance transfer and/or fiat currency transfer), analytics tasks (such as a set of analytics on marketplace data and/or account data to provide a recommendation as to how a transaction should be denominated (such as in fiat currency, cryptocurrency or the like, or as a loan of fiat currency against a cryptocurrency balance)), data integration tasks and services (such as extraction, transformation, loading, normalization or other tasks required to enable the orchestration services system 2202 to interact with the native application programming interfaces or other interfaces of the respective cryptocurrency wallet and financial services systems), automation tasks (such as automation of transaction execution, account reconciliation, reporting, or the like) and/or any other suitable tasks on behalf of the platform 2200. The orchestration services system 2202 may include machine learning, artificial intelligence, expert system, robotic process automation, and other capabilities, including use of neural networks, rule-based systems, model-based systems, and hybrids or combinations thereof, which may be trained, such as on tagged or labeled data sets (such as for classification or recognition tasks), on outcomes (such as financial outcomes, user satisfaction outcomes, or the like), and/or using supervised, semi-supervised, or deep learning methods. In embodiments, the orchestration services system 2202 may include a machine learning system that trains machine learned models that are used by the various systems of the platform 2200 to perform intelligence tasks, including predictions and forecasts, classifications, process control, monitoring of conditions, prescriptive analytics, and the like. In embodiments, the platform 2200 may include an artificial intelligence system that performs various AI tasks, such as automated decision making, and the like. In embodiments, the platform 2200 may include an analytics system that performs different analytics across cryptocurrency, banking 2220, insurance 2224, retail merchants 2228, or other market data to identify insights related to the states of a cryptocurrency market 2214 and fiat currency markets, accounts, balances, and the like. For example, in embodiments, the analytics system may analyze a current valuation of a cryptocurrency, an account balance, such as a cryptocurrency wallet, or the like with respect to a planned purchase, planned financial distribution, credit offering and the like to determine whether the planned financial activity should be in cryptocurrency, fiat currency or some blending or mixing of crypto and fiat currencies. In embodiments, the analytics system may perform the analytics in real-time as data is ingested from the various data sources to update one or more states of a financial marketplace or account. In embodiments, the intelligent orchestration services system 2202 may include an orchestration automation system 2204 that learns behaviors of a financial market and/or of respective users and automates one or more tasks on behalf of the users based on the learned behaviors. In some of these embodiments, the orchestration automation system 2204 may configure intelligent agents on behalf of a financial marketplace such as a bank, credit card company, broker, insurer, retailer, merchant, or the like. The automation system may configure machine-learned models and/or AI logic that operate to generate outputs, such as ones that govern actions or provide inputs to other systems, given a set of conditions. In embodiments, the orchestration automation system 2204 may receive training data sets of financial interactions by experts and configure the machine-learned models and/or AI logic based on the training data sets. In embodiments, the orchestration services system 2202 may include a natural language processing system that receives text/speech and determines a context of the text and/or generates text in response to a request to generate text.

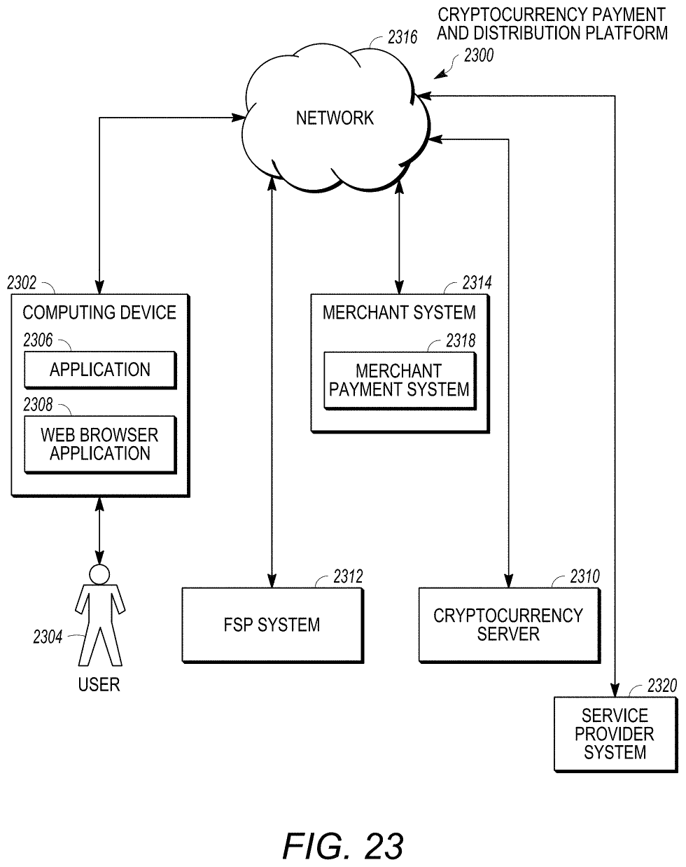

Referring to FIG. 23, in embodiments, the platform 2200 may be configured for secure storage of cryptocurrency consistent with disclosed embodiments. As shown, the 2200 may include a computing device 2302 associated with a user 2304. The computing device 2302 may be configured to execute, among other programs, an application 2306 for cryptocurrency transactions. The platform 2200 may further include a cryptocurrency server 2310, a financial service provider (FSP) system 2312 and a merchant system 2314. As shown in FIG. 23, the computing device 2302, cryptocurrency server 2310, FSP system 2312 and merchant system 2314 may be communicatively coupled by a network 2316. While only one computing device 2302, cryptocurrency server 2310, FSP system 2312 and merchant system 2314 and network 2316 are depicted in FIG. 23, it will be understood that the platform 2200 may include more than one of any of these components. More generally, the components and arrangement of the components included in the platform 2200 may vary. Thus, the platform 2200 may include other components that perform or assist in the performance of one or more processes consistent with the disclosed embodiments.

In embodiments, the computing device 2302 may be one or more computing devices configured to perform operations consistent with the application 2306.

In embodiments, the application 2306 may be one or more software applications configured to perform operations consistent with connecting to the cryptocurrency server 2310, the FSP system 2312 and merchant system 2314 via the network 2316. For example, the application 2306 may be configured to place an order for transferring fiat currency (e.g., U.S. dollars) with the FSP system 2312, an order for buying and selling cryptocurrency with the cryptocurrency server 2310, and an order for buying a product with the merchant system 2314. In one example embodiment, the application 2306 may enable the user to convert cryptocurrency to fiat currency and/or convert fiat currency to cryptocurrency.

In an example embodiment, the computing device 2302 may include a web browser application 2308. The web browser application 2308 may be one or more software applications configured to perform operations consistent with providing and displaying web pages, such as web pages associated with merchants and service providers. The web pages may include account login fields, transaction fields, shopping carts, dynamic information (i.e., information targeted to a specific user), or some other type of information.

In embodiments, the cryptocurrency server 2310 may be one or more computing devices configured to perform operations consistent with storing cryptocurrency and performing cryptocurrency transactions. The cryptocurrency server 2310 may be further configured to perform operations consistent with receiving data from the application 2206 and transmitting signals to the application 2306. The signals may be configured to cause the application 2206 to display an account balance (or wallet balance, such as a digital cryptocurrency wallet) to the user or information sufficient to place a cryptocurrency order. Alternatively, or additionally, the cryptocurrency server 2310 may be further configured to perform operations consistent with receiving information from the application 2306 and to place an order. The cryptocurrency server 2310 may also receive data from other sources and generate predictions about future demand for a cryptocurrency.

In embodiments, the FSP system 2312 may be associated with a financial service entity that provides, maintains, manages, or otherwise offers financial services. For example, the financial service entity may be a bank, credit card issuer, or any other type of financial service entity that generates, provides, manages, and/or maintains financial service accounts for one or more customers. Financial service accounts may include, for example, credit card accounts, loan accounts, checking accounts, savings accounts, reward or loyalty program accounts, and/or any other type of financial service account known to those skilled in the art. The FSP system 2312 may be one or more computing devices configured to perform operations consistent with maintaining financial service accounts, including a financial service account associated with a user 2304. The FSP system 2312 may be further configured to authenticate financial transactions associated with such financial service accounts. In particular, the FSP system 2312 may be configured to authenticate financial transactions associated with a financial service account associated with a user 2304. In some embodiments, the FSP system 2312 may be further configured to maintain, such as using a database and related elements, a set of cryptocurrency accounts and/or wallets held by its users. The FSP system 2312 may communicate with the cryptocurrency server 2310 (and/or the application 2306) based on the information stored in the database. In some embodiments, the FSP system 2312 may be further configured to generate content for a display device included in, or connected to, a computing device 2302, such as through a mobile banking or other application on a computing device 2302 (e.g., application 2306), such as a smart phone or other computing device. Alternatively, or additionally, the FSP system 2312 may be configured to provide content through one or more web pages or online portals that are accessible by the computing device 2302 over the network 2316. In an example embodiment, the FSP system 2312 may receive information from or transmit information to the cryptocurrency server 2310. The disclosed embodiments are not limited to any particular configuration of FSP system 2312.

While the cryptocurrency server 2310 and the FSP system 2312 are shown separately, in some embodiments the cryptocurrency server 2310 may include or be otherwise related to the FSP system 2312. For example, in some embodiments the facility of the cryptocurrency server 2310 may be provided instead by the FSP system 2312, or vice versa. Alternatively, or additionally, in some embodiments, the cryptocurrency server 2310 may be included in, and/or be otherwise related to, any other entity in the platform 2200 and/or a third party not shown in the platform 2200. Alternatively, or additionally, the cryptocurrency server 2310 may be a standalone server. The cryptocurrency server 2310 may take other forms as well.

In embodiments, the merchant system 2314 may be one or more computing devices configured to perform operations consistent with providing web pages that are accessible by the computing device 2302 over the network 2316. For example, the web pages may be provided at the computing device 2302 through a web browser application 2308. In some embodiments, the merchant system 2314 may be associated with a merchant that provides goods or services. Further, in some embodiments, the web pages may be online retail web pages through which a user 2304 may engage in transactions to purchase the merchant's goods or services. Other web pages are possible as well. The disclosed embodiments are not limited to any particular configuration of merchant system 2314.

In some embodiments, the merchant system 2314 may include a merchant payment system 2318. The merchant payment system 2318 may be one or more computing devices configured to perform operations consistent with providing, such as within the web pages provided by the merchant system 2314 and/or within another interface such as a point-of-sale and/or in-store checkout system, a merchant-provided payment process through which a user 2304 may engage in transactions to purchase the merchant's goods or services. In some embodiments, the merchant payment system 2318 may be provided by the merchant in connection with one or more financial service providers, such as the financial service provider associated with the FSP system 2312 or another financial service provider. The payment process may, for example, be the same as or similar to MasterPass™, PayPal®, or Visa® Checkout. Other payment processes are possible as well.

In embodiments, the network 2316 may be any type of network configured to provide communication between components of the platform 2200. For example, the network 2316 may be any type of network (including infrastructure) that provides communications, exchanges information, and/or facilitates the exchange of information, such as the Internet, a Local Area Network, Wide Area Network, wireless network (e.g., WiFi™ or Bluetooth™), near field communication (NFC), optical code scanner, virtual private network, or other suitable connection(s) that enables the sending and receiving of information between the components of the platform 2200. In other embodiments, one or more components of the platform 2200 may communicate directly through a dedicated communication link(s), which may include dedicated physical links, virtual links, or a combination thereof. It is to be understood that the configuration and boundaries of the functional building blocks of the platform 2200 have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

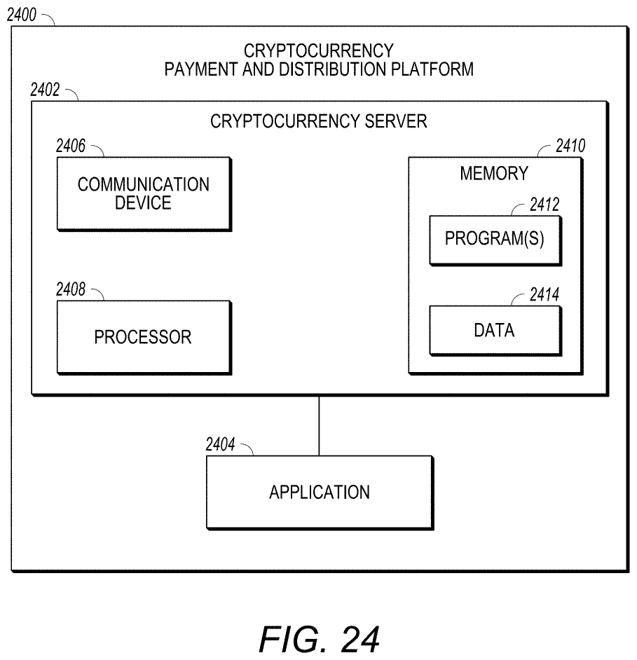

Referring to FIG. 24, in embodiments the cryptocurrency system 2400 may include a cryptocurrency server 2402 and a cryptocurrency application 2404. The cryptocurrency server 2402 may include a communication device 2406, one or more processor(s) 2408, and memory 2410 including one or more programs 2412 and data 2414. The cryptocurrency server 2402 may be configured to perform operations consistent with providing cryptocurrency application 2404.

In embodiments, the cryptocurrency server 2402 may take the form of a server, general purpose computer, mainframe computer, or any combination of these components. Other implementations consistent with disclosed embodiments are possible as well. The application 2404 may take the form of one or more software applications stored on a computing device, such as a cryptocurrency application 2306 stored on a computing device 2302 as described herein.

In embodiments, the communication device 2406 may be configured to communicate with one or more computing devices, such as the computing device 2302. In some embodiments, the communication device 2406 may be configured to communicate with the computing device(s) through the application 2404. The cryptocurrency server 2402 may, for example, be configured to provide to the application 2404 one or more signals through the communication device 2406. As another example, the cryptocurrency server 2402 may be configured to receive from the application 2404 data relating to a cryptocurrency transaction through the communication device 2406. The communication device 2406 may be configured to communicate other information as well.

In embodiments, the communication device 2406 may be further configured to communicate with one or more FSP systems, such as the FSP system 2312 described herein. In some embodiments, the FSP system may provide transaction data such as indicating parameters of a cryptocurrency buy or sale transaction, a loan transaction, or the like. The communication device 2406 may be configured to communicate with the FSP system(s) in other manners. The communication device 2406 may be configured to communicate with other components as well.

In embodiments, the processor(s) 2408 may include one or more known processing devices, such as a microprocessor from the Core™, Pentium™ or Xeon™ family manufactured by Intel®, the Turion™ family manufactured by AMD™, the “Ax” (i.e., A6 or A8 processors) or “Sx” (i.e. S1, . . . processors) family manufactured by Apple™, or any of various processors manufactured by Sun Microsystems, for example. The disclosed embodiments are not limited to any type of processor(s) otherwise configured to meet the computing demands required of different components of the cryptocurrency system 2400.

In embodiments, memory 2410 may include one or more storage devices configured to store instructions used by the processor(s) 2408 to perform functions related to disclosed embodiments. For example, memory 2410 may be configured with one or more software instructions, such as program(s) 2412, that may perform one or more analyses based on data provided by the cryptocurrency application 2404 to determine whether a web page or other data element is or may be associated with illicit activity. For example, the program(s) may access a set of white lists, a set of blacklists (such as of entities or individuals designated as being banned from undertaking certain activities by law or regulation) and/or a set of pattern recognizers (such as a set of neural network or other artificial intelligence systems that are trained to recognize illicit content), or the like. In certain embodiments, memory 2410 may store sets of instructions for carrying out the processes described below. Other instructions are possible as well. In general, instructions may be executed by the processor(s) 2408 to perform one or more processes consistent with disclosed embodiments.

The components of the cryptocurrency system 2400 may be implemented in hardware, software, or a combination of both hardware and software, as will be apparent to those skilled in the art. For example, although one or more components of the cryptocurrency system 2400 may be implemented as computer processing instructions, all or a portion of the functionality of the platform 2200 may be implemented instead in dedicated electronics hardware.

In some embodiments, the cryptocurrency system 2400 may also be communicatively connected to one or more database(s) (not shown). Alternatively, such database(s) may be located remotely from the cryptocurrency system 2400. The cryptocurrency system 2400 may be communicatively connected to such database(s) through a network, such as the network 2316 described herein. Such database(s) may include one or more memory devices that store information and are accessed and/or managed through the cryptocurrency system 2400. By way of example, such database(s) may include Oracle™ databases, Sybase™ databases, or other relational databases or non-relational databases, such as distributed databases, Hadoop sequence files, HBase, or Cassandra. Such database(s) may include computing components (e.g., database management system, database server, etc.) configured to receive and process requests for data stored in memory devices of the database(s) and to provide data from the database(s). Data may also be stored in blockchain-based data storage systems, including distributed ledgers.

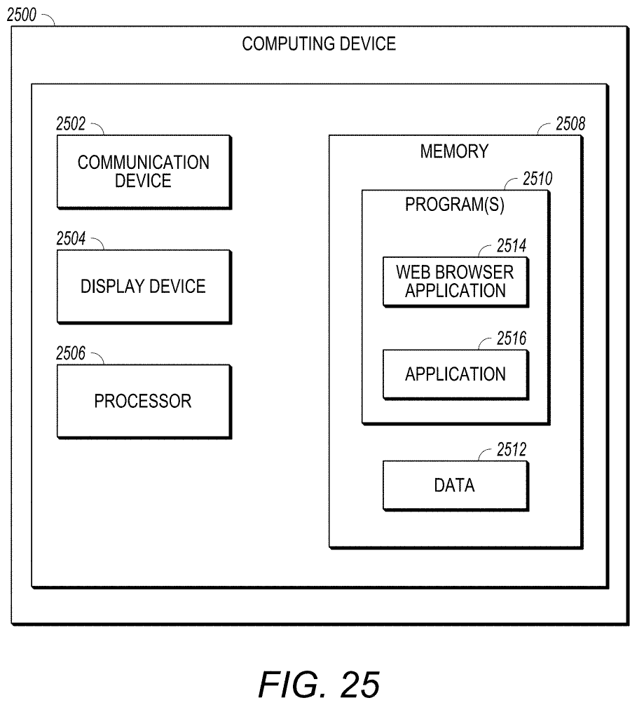

FIG. 25 shows a block diagram of an exemplary computing device 2500, consistent with disclosed embodiments. As shown, the computing device 2500 may include a communication device 2502, display device 2504, processor(s) 2506, and memory 2508 including program(s) 2510 and data 2512. Program(s) 2510 may include, among others, a web browser application 2514 and browser extension application 2516.

In some embodiments, the computing device 2500 may take the form of a desktop or mobile computing device, such as a desktop computer, laptop computer, smartphone, tablet, or any combination of these components. Alternatively, the computing device 2500 may be configured as any wearable item, including a smart watch, jewelry, smart glasses, or any other device suitable for carrying or wearing on a user's person. Other implementations consistent with disclosed embodiments are possible as well. The computing device 2500 may, for example, be the same as or similar to the computing device 2302 described herein.

In embodiments, the communication device 2502 may be configured to communicate with a cryptocurrency server, such as the cryptocurrency servers 2310 and 2402 described herein. In some embodiments, the communication device 2502 may be further configured to communicate with one or more merchant systems, such as the merchant system 2314 described herein, one or more FSP systems, such as the FSP system 2312 described herein, and/or one or more service provider systems, such as the service provider system 2320. The communication device 2502 may be configured to communicate with other components as well.

In embodiments, the communication device 2502 may be configured to provide communication over a network, such as the network 2316 described herein. To this end, the communication device 2502 may include, for example, one or more digital and/or analog devices that allow the computing device 2500 to communicate with and/or detect other components, such as a network controller and/or wireless adaptor for communicating over the Internet. Other implementations consistent with disclosed embodiments are possible as well.

In embodiments, the display device 2504 may be any display device configured to display interfaces on the computing device 2500. The interfaces may include, for example, web pages provided by the computing device 2500 through the web browser application 2208. In some embodiments, the display device 2504 may include a screen for displaying a graphical and/or text-based user interface, including but not limited to, liquid crystal displays (LCD), light emitting diode (LED) screens, organic light emitting diode (OLED) screens, and other known display devices. In some embodiments, the display device 2504 may also include one or more digital and/or analog devices that allow a user to interact with the computing device 2500, such as a touch-sensitive area, keyboard, buttons, or microphones. Other display devices are possible as well. The disclosed embodiments are not limited to any type of display devices otherwise configured to display interfaces.

In embodiments, processor(s) 2506 may include one or more known processing devices, such as a microprocessor from the Core™, Pentium™ or Xeon™ family manufactured by Intel™ the Turion™ family manufactured by AMD™, the “Ax” or “Sx” family manufactured by Apple™ or any of various processors manufactured by Sun Microsystems, for example. Processor(s) 2506 may also include various architectures (e.g., x86 processor, ARM®, etc.). The disclosed embodiments are not limited to any type of processor(s) otherwise configured to meet the computing demands required of different components of the computing device 2500.

In embodiments, memory 2508 may include one or more storage devices configured to store instructions used by processor(s) 2506 to perform functions related to disclosed embodiments. For example, memory 2508 may be configured with one or more software instructions, such as program(s) 2510, that may perform one or more operations when executed by the processor(s) 2506. The disclosed embodiments are not limited to separate programs or computers configured to perform dedicated tasks. For example, memory 2508 may include a single program 2510 that performs the functions of computing device 2500, or program(s) 2510 may comprise multiple programs. Memory 2508 may also store data 2512 that is used by program(s) 2510. In certain embodiments, memory 2508 may store sets of instructions for carrying out the processes described below. Other instructions are possible as well. In general, instructions may be executed by the processor(s) 2506 to perform one or more processes consistent with disclosed embodiments.

In some embodiments, the program(s) 2510 may include a web browser application 2514. The web browser application 2514 may be executable by processor(s) 2506 to perform operations including, for example, providing web pages for display. The web pages may be provided, for example, via display device 2504. In some embodiments, the web pages may be associated with a merchant system, such as the merchant system 2314 described herein. The web browser application 2514 may be executable by processor(s) 2506 to perform other operations as well.

In some embodiments, the program(s) 2510 may further include an application 2516. An application 2516 may, for example, be the same as similar to applications 2306 and 2404 described herein. An application 2516 may be executable by processor(s) 2506 to perform various operations including, for example, facilitate transfer of money or cryptocurrency transactions. Other instructions are possible as well. In general, instructions may be executed by the processor(s) 2506 to perform one or more processes consistent with disclosed embodiments.

The components of the computing device 2500 may be implemented in hardware, software, or a combination of both hardware and software, as will be apparent to those skilled in the art. For example, although one or more components of the computing device 2500 may be implemented as computer processing instructions, all or a portion of the functionality of computing device 2500 may be implemented instead in dedicated electronics hardware.

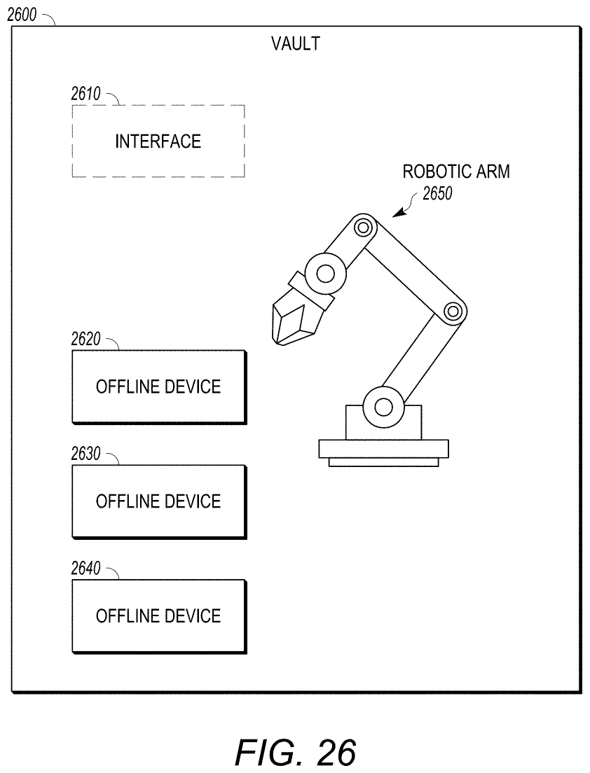

In one example embodiment, the cryptocurrency server 2310 or 2402 may include a cloud wallet for storage of cryptocurrency. The cryptocurrency server 2402 can include an interface for connection to offline devices storing cryptocurrency. The interface can be a part of the communication device 2406. These offline devices can be stored in a vault for security reasons. FIG. 26 shows an example vault storing offline devices. In this example embodiment, the vault 2600 can be a secure storage location and house a plurality of offline devices 2620-2640. Each offline device can store cryptocurrency wallets thereon and can be connected to the interface 2610. By connecting the offline device to the interface 2610, the offline device can enable the cryptocurrency server 2402 to receive access to the cryptocurrency wallets. In one example embodiment, the vault 2600 can include a robotic arm 2650. The robotic arm 2650 can retrieve the offline devices 2620-2640 and connect them to the interface 2650.

In one example embodiment, the cryptocurrency server can include a predictive model (or artificial intelligence module) which can instruct the robotic arm to retrieve a particular offline device and connect the device to the interface 2610. The predictive model can make the determination based on a variety of factors. For example, the predictive model can have access to past transaction data, market trends, current user balances, orders placed by users, and other data. Based on this data, the predictive model can predict a future demand for a cryptocurrency. For example, the predictive model can determine that at a time in future there will a demand for selling a specific amount of cryptocurrency. The predictive model can also determine that the cloud wallets do not have sufficient funds to cover the required sale amount. As such, the predictive model can instruct the robotic arm to retrieve a sufficient number of offline devices and connect them to the interface prior to the time in future when the demand exceeds. The predictive model can make this determination based on the data entries stored in association with each offline device. These data entries can be stored on, e.g., memory 2410. For example, the predictive model can select the offline devices based on how much cryptocurrency is stored on each device. Alternatively, each device can store an equal amount of cryptocurrency and the predictive model can select a number of the devices to meet the shortage.

In one example embodiment, the predictive model can manage a balance of cryptocurrency to avoid excessive storage of cryptocurrencies on cloud wallets. This can minimize the risk of any hacking or system attacks. For example, the predictive model can determine a current demand and a future demand for a cryptocurrency. Based on the current demand and the future demand, the predictive model can determine whether there is or there will be an excessive amount of cryptocurrency stored on the cloud wallets. Based on this determination, the predictive model can schedule for the robotic arm to move offline devices to the interface to store excessive cryptocurrency balance on the offline devices.

In embodiments, once an end user is enrolled in a cryptocurrency checking account (and/or saving account, money market account, deposit account, credit card account, debit card account, or any other account for holding assets) and in the mobile app associated with the platform 2200, they may be presented with balances and payment options for currency (e.g., United States Dollars or “USD”), for cryptocurrency (e.g., Bitcoin or Ethereum), for a combination thereof and/or for a loan of one using the other as collateral. The end users may be able to then decide, in a pre- or post-transaction step, what form of currency they want to use to make a payment. The platform's 2200 artificial intelligence model may present the user with various options or recommendations, such as based on a model, on a set of rules, or based on training, for example based on historical data and outcomes and based on current data and trends, as collected from marketplace data and/or account data, such as via APIs, via other interfaces and/or from communications among the entities involved. The various options for users present many optimization opportunities, which may be undertaken using a set of rules or a model (optionally embodied by a smart contract that facilitates transaction execution upon ingesting applicable data sets) or by an artificial intelligence system of the various types described herein. In one example embodiment, a set of default options may be provided for an account (e.g., for certain transaction types, merchant types, and the like). In embodiments, this may be implemented to any form of payment (e.g., POS, Wire, ACH, Check, ATM withdrawal, credit card payment, and so forth). For example, if USD is selected by a user, such as in a checkout system, the user may transact using that form of currency (i.e., make a payment using USD). However, if the user selects Bitcoin as the means by which to finance the transaction, the system may trigger an automated redemption request of a commensurate amount (based on a current exchange rate as determined by pinging an appropriate source of exchange rate information) of Bitcoin held in the user's Bitcoin wallet. When the user selects Bitcoin and completes the transaction, the platform redeems the Bitcoin for USD. Once the redemption of Bitcoin has been completed, a USD equivalent of the redeemed Bitcoin will be deposited back with the originating bank or the third-party financier. The corresponding payment transferred by conventional payment processing channels, such as by either a bank or third-party financier, to the merchant or other counterparty's account. Redemption and payment transfer may be timed in various orders and sequences by the orchestration services; for example, a transfer to a merchant may be made in advance of redemption, vice versa, or simultaneously. An intelligent agent or other aspect of orchestration services may optimize the timing, such as based on generation of a forecast of exchange rate, of user behavior or the like. For example, if Bitcoin is predicted to rise in price, redemption may be delayed for a period of time to reduce the impact of the transaction on the user's account balance. Thus, in effect, users can use Bitcoin to make purchases while the mechanics of the transaction among merchants, banks and other financial services providers still use fiat currency, thereby avoiding the complexity of programming entirely new workflows to address complexities of cryptocurrency wallets, smart contracts and/or blockchain interfaces. The merchant or receiving party may still receive the payment in fiat currency. In doing so, the platform 2200 solves the problem of the merchant not being able to receive payments in cryptocurrencies.

In embodiments, the platform 2200 may use a Layer 2 or second layer protocol, including but not limited to the Lightning protocol, to account for a plurality of transactions before such transactions are recorded to the blockchain for final settlement. For example, a plurality of platform 2200 users may conduct merchant transactions that are ultimately to be settled using a cryptocurrency balance, such as Bitcoin, and these transactions may be noted using Layer 2 or Layer 3 protocols to record that the transactions are occurring, but the final disposition of recording the transactions to the blockchain for final settlement may be done in a single event, such as finalizing a full day of transactions at the end of the business day. This may reduce computing capacity requirements, increase transaction processing speed (e.g., because each individual transaction does not need to be recorded to the blockchain in real-time), and reduce costs associated with the processing.

In embodiments, the platform's 2200 artificial intelligence model, as described herein, may suggest advantageous ratios of cryptocurrency and fiat currency to be used for each transaction, such as based on a model and/or using learning on historical data sets representing cryptocurrency and fiat currency marketplace information, such as prices, volumes, interest rates, exchange rates, and the like. The model can be trained using past transaction data as well as current trends in the market and geolocation data. The artificial intelligence model may also recommend, using similar data, that the user borrow fiat currency using a cryptocurrency account balance as collateral. Recommendations may be based in part on user profiles, expressed preferences, and/or rules or settings (such as minimum balance amounts, maximum amount thresholds, credit limits, and the like).

The platform 2200 disclosed herein has never been contemplated by banks, technology companies, or cryptocurrency companies because of the challenges for banks to interact with cryptocurrency for customers, including regulatory prohibitions and technical challenges. In some instances, a symbiotic relationship between banks and cryptocurrency companies has never been contemplated.

In an example, if the currency balance in the user's fiat account (e.g., a checking account holding USD) is greater than the cryptocurrency balance, a Bitcoin payment transaction can be fulfilled using the actual fiat money the merchant accepts. This decision can be guided by the system's artificial intelligence engine, which is capable of determining the appropriate ratios for fiat currency and cryptocurrency to be used for each transaction. The bank may charge a fee, such as between 2-3%, for this transaction, such as to cover fees for the redemption and margin.

In one example, if the user authorizes a transaction greater than the balance available in the user's checking account, the bank may contact a third-party financier to provide the funds for the transaction. The decision to contact the third-party financier may be guided by the system's predictive models. The third-party financier can facilitate the transaction and be paid back upon the redemption or selling of the Bitcoin. The third-party financier may charge fees, such as of around 5-7%, to enable this transaction. The third-party financier may have a fiat account at the bank that is linked to the user. The bank itself may also provide the linked account. The amount of fiat that could be spent above what is actually in the user's checking account may be determined by an algorithm that understands a user's bitcoin balance and ability to redeem that for fiat currency at a discounted rate to minimize price volatility in the redemption/settlement process.

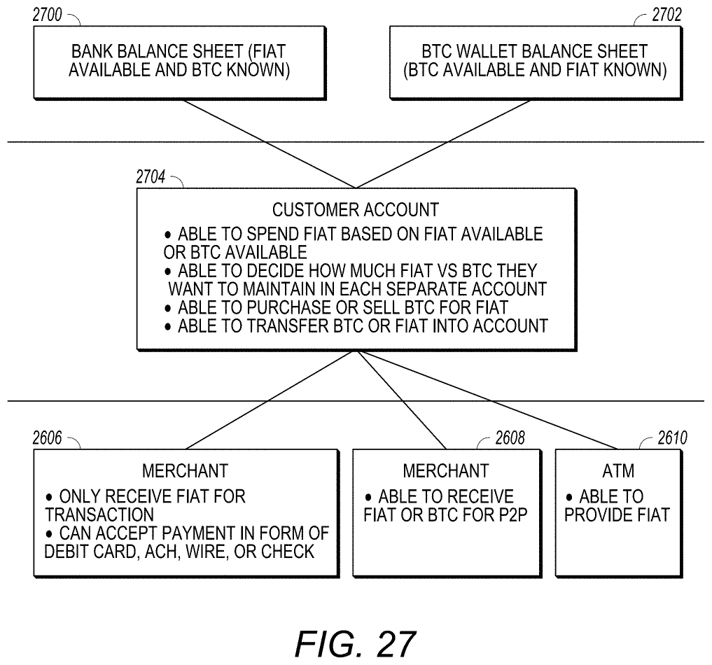

In embodiments, and as shown in FIG. 27, the platform infrastructure may include a payment system. In this example embodiment, the platform may be in communication with a bank, a third-party financier, a user, a merchant an ATM machine 2710, or some other entity. The bank may maintain a fiat money balance 2700 for the user and the third-party financier can have access to a user's digital wallet 2702 and transfer/receive fiat money to/from the bank and customer account 2704. In some embodiments, an entity separate from the third-party financier may hold the user's cryptocurrency wallet and the third-party financier may receive/send cryptocurrency from/to the wallet holder. The user, for example using an application of a client device or a debit card, may facilitate a payment using a combination of the fiat currency balance maintained in the user's account 2704 and a cryptocurrency balance maintained in the user's wallet. The user may also initiate a payment to a merchant 2706, for example using a wearable debit card, such as a ring, or withdraw money from an ATM machine 2710. The payment or withdrawal may be financed by the fiat currency balance maintained in the user's account or the cryptocurrency balance maintained in the user's wallet. More specifically, the merchant may receive fiat currency for a transaction, and the user may finance the payment using cryptocurrency. The merchant may also receive a debit card, an ACH, wire transfer or check payment from the user. The user may facilitate the payment using a smart card, a client device or other means.

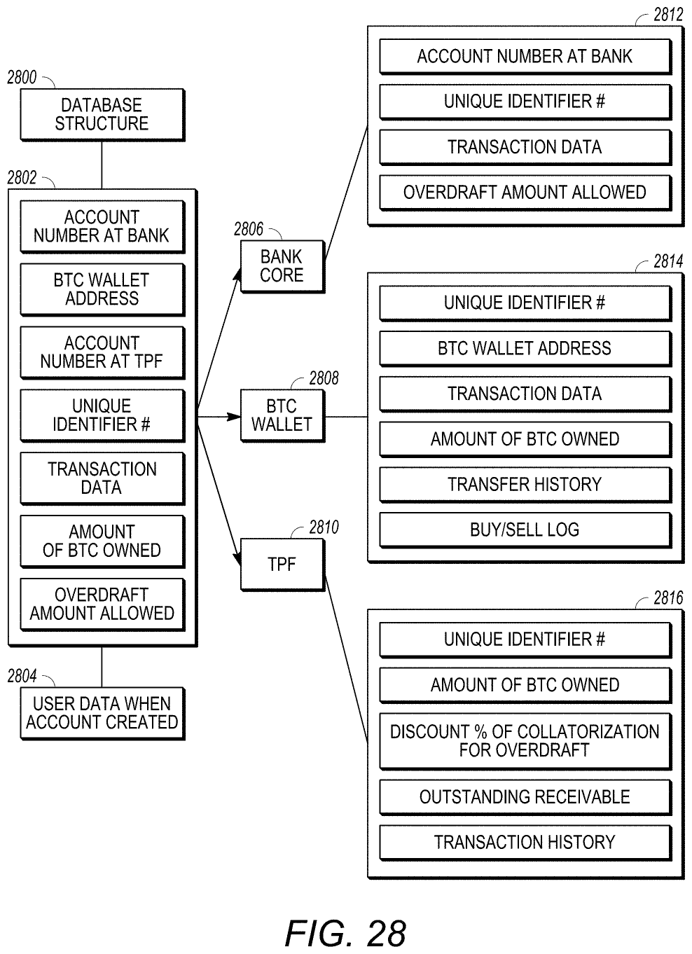

Referring to FIG. 28, an example database structure 2800 is shown for storing information by various entities to facilitate the transaction in conjunction with the platform, as described herein. In this example embodiment, the bank 2806 may store an account number 2812, a unique identifier associated with the user 2804, transaction data, and an indication of whether an overdraft protection may be allowed (or how it is implemented) 2802. The entity maintaining the cryptocurrency wallet 2808 may store the unique identifier 2814, a digital wallet address, transaction data, an amount for each transaction, a transfer history and a buy/sell log. The third-party financier 2810 may store the unique identifier 2816, an amount of cryptocurrency owned, a discount rate of collateralization for overdraft (collateralization for the cryptocurrency allowance or an amount of fiat a user can spend beyond the actual fiat the user owns based on the algorithms used to determine how much cryptocurrency at any given point a user can spend), and outstanding receivables and a transaction history. One of ordinary skill in the art recognizes that these entities may maintain other information which can facilitate transactions. Additionally, one of ordinary skill in the art recognizes that although this example embodiment describes three separate entities facilitating the payment using a combination of fiat currency and cryptocurrency, other implementations in which two or more of these entities are combined are also possible.

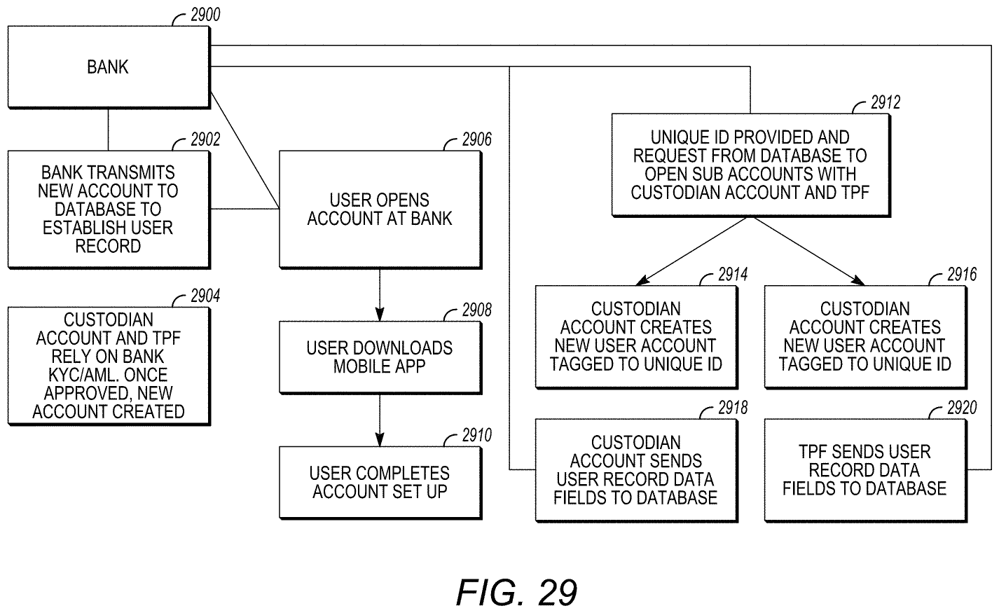

FIG. 29 shows an example flow chart for account creation using the platform according to an example embodiment. The flow chart shows one example algorithm that may be used to create the various accounts needed on behalf of a user that are then linked together. In this example embodiment, the user may initiate an account creation process 2906 with a bank 2900, which simultaneously triggers creation of an account with each of the bank 2900, third-party financier and the cryptocurrency wallet holder, where the bank 2900 or other party transmits the new account data to a database to establish the user record 2902. For example, a user may download an application 2908 associated with a bank 2900 and initiate the process of creating an account 2906 for the user at the application, for example by clicking on a sign up for an account button. The bank may receive the user's information, such as name, address, social security number, etc., and approve the user's request for creating an account. The Bitcoin wallet, custodian, and/or third-party financier may rely on the anti-money laundering and know-your-customer verification processes as part of creating a new account 2904. The bank 2900 may generate a unique ID for the user. Subsequently, the bank may transmit the relevant information including the unique ID to a third-party financier and a wallet holder or other custodian so that they create respective accounts for the user 2912. Upon receiving the information, each of the third-party financier and the wallet holder and/or custodian may create an account in association with the unique ID, or plurality of accounts and IDs, for the user 2914 and 2916, for example a cryptocurrency wallet and financing account, and transmit information relating to the accounts back to the bank 2900 and provide user record data fields to a database associated with the bank 2900 and/or platform 2200.

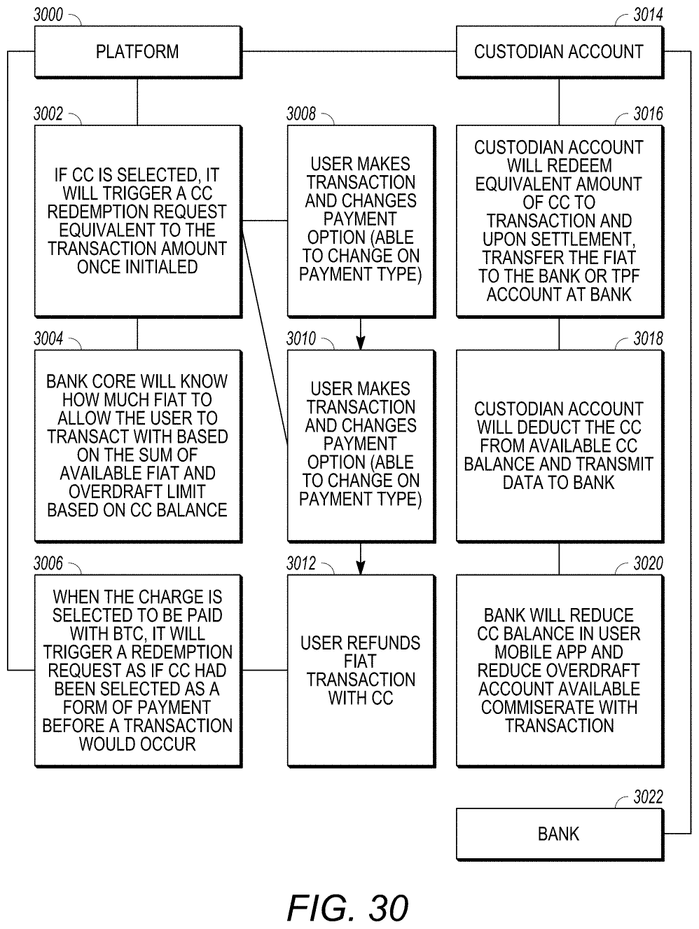

Referring to FIG. 30, an example flow chart is shown for algorithms that may be used to transmit data inputs and API calls associated with the platform 2200 and 4100, as described herein. This figure relates to a transaction in which the default payment option is payment by a cryptocurrency. In this example embodiment, in an application of a user's client device, the user can select cryptocurrency as the default payment 4108. Once the user requests a payment, for example swiping a debit card, the bank may trigger a cryptocurrency redemption request to the cryptocurrency wallet holder 4102. The bank can determine the cryptocurrency transaction amount based on various factors 4104. For example, the amount can be based on the cryptocurrency balance of the user's cryptocurrency account. If the user's balance falls below a threshold (as dynamically determined by a machine learning model), the bank may adjust the amount based on an outcome of the machine learning model. When the charge is selected to be paid with a cryptocurrency, such as Bitcoin, this may trigger a redemption request as if cryptocurrency had been selected as a form of payment before a transaction would occur 4106. Following this, the user may refund a fiat-based transaction with cryptocurrency 4112. In embodiments, a Bitcoin wallet and/or a cryptocurrency custodian 4114 may redeem an equivalent amount of cryptocurrency for the transaction upon settlement and transfer of the fiat currency to the bank 4122 or third-party financier or other account 4116. The Bitcoin wallet and/or a cryptocurrency custodian may deduct the cryptocurrency from an available cryptocurrency balance and transmit related data to the bank 4118, whereupon the bank 4122 may reduce the cryptocurrency balance in the user's mobile application and reduce the overdraft amount available by an amount commiserate with the transaction 4120.

The bank may finance the rest of the payment using fiat currency stored in the user's checking account. In this example, the fiat currency may be provided by either the bank or the third-party financier in a linked account at the bank to the user. As another example, if the balance of the cryptocurrency wallet exceeds another threshold amount, the transaction amount can be equal to the fiat currency amount for the transaction.

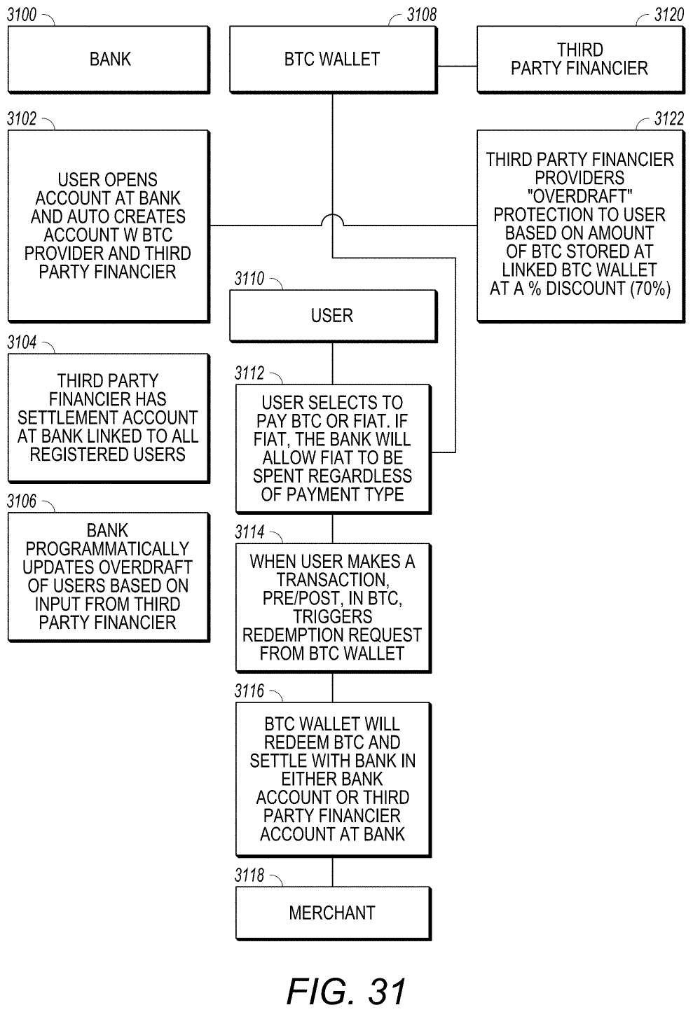

FIG. 31 shows an example flow chart for a payment transaction using the platform 2200 according to an example embodiment. In this example embodiment, a user may open an account with a bank, which may in turn trigger opening accounts with a third-party financier and a wallet holder. The user may initiate a fiat currency payment transaction funded by a cryptocurrency on the user's application. This transaction may be initiated by the user's client device, debit card or wearable debit card. The request may be received at the user's bank. The bank may relay the request to the third-party financier and the user's wallet holder. In response, the wallet holder may transfer an amount of cryptocurrency to an account of the third-party financier. Upon receipt of the cryptocurrency, the third-party financier may transfer a sum of fiat currency to an account associated with the bank. Upon receipt of the funds, the bank may authorize the payment. Still referring to FIG. 31, in an example, a bank 3100 may receive a request from a user 3110 to open an account which also automatically creates an account in a Bitcoin wallet 2208 and/or cryptocurrency custodian account and/or a third-party financier 3102. The third-party financier 3120 may have a settlement account at the bank 3100 that is linked to registered users 3104. The bank may programmatically update overdrafts of user based in part on input from the third-party financier 3106. Bitcoin wallet 3108 and/or cryptocurrency custodian account associated with the user 3110 may allow the user to select to pay in Bitcoin or some other cryptocurrency type or to pay in fiat currency. If fiat currency is selected the bank 3100 may allow the fiat currency to be spent by the user 3110 regardless of a payment type 3112. When the user makes a transaction in a cryptocurrency, this may trigger a redemption request from the Bitcoin wallet 2208 and/or cryptocurrency custodian account 3114. The Bitcoin wallet 2208 and/or cryptocurrency custodian account may redeem the Bitcoin, or other cryptocurrency type, and settle with the bank 3100 in either a bank account and/or a third-party financier 3120 account at a bank, or some other account type 3116. The merchant may receive the currency selected for the purchase of a good or service or other transaction type as an outcome of this process 3118. A third-party financier may provide overdraft protection to the user 3110 based at least in part on the amount of cryptocurrency, such as Bitcoin, that is stored at the linked Bitcoin wallet 2208 and/or cryptocurrency custodian account 3122. The amount of overdraft protection provided may be at a percentage discount relative to the balance held by the Bitcoin wallet 2208 and/or cryptocurrency custodian account.

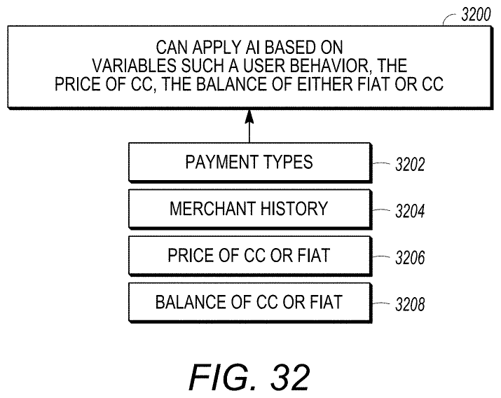

Referring to FIG. 32, machine learning processes 3200 are shown that may be incorporated in the platform, as described herein. For example, the system may include a predictive model for making predictions based on variables such as user behavior, payment types available 3202, merchant data, such as merchant history 3204, the price of cryptocurrency 3206, and/or the balance of either fiat or cryptocurrency 3208. In one example, the predictive model may determine a payment type. For example, based upon the users' transaction history, the predictive model may recognize that certain types of payments should be paid with fiat currency and other types should be paid with cryptocurrency; for example, a wire transfer may be cryptocurrency-funded whereas a peer-to-peer payment could be fiat currency-based. The system may auto-swap the currency selection based on the predictions of the model or prompt the user to confirm. As another example, based upon the users' previously defined payment selections for certain merchants, the platform may automatically adjust and/or predict the user's selection for certain transactions before or after a purchase is made. As another example, the system may consider the user's location in predicting the combination of fiat currency and cryptocurrency to use when making a payment. For example, the system may determine that a user is at a gas station and the preference is fiat currency at gas stations. The system may auto adjust the transaction or prompt the user to confirm. In another example, the platform may consider the relative value of cryptocurrency and fiat currency and determine the ratio of each used to fund a transaction. For example, the system may determine that a relative value of a currency type has gone up, and thus, would fund a transaction with the currency that has increased in value to best maximize the value for the user. In particular, if cryptocurrency exchange rates are lower than the past three months' averages, it may suggest using fiat currency or vice versa. The system may also suggest refunding previous fiat transactions with cryptocurrency based on the increase in value of cryptocurrency to reduce the true net cost of the transaction. In another example, the platform may consider the current balances a user has in either cryptocurrency or fiat currency and automatically adjust to whatever form of payment should be used for a transaction to minimize transaction fees or negative balances. The platform may also take into considerations all other factors such as the price of cryptocurrency, the merchant history, and preferred payment methods to best optimize a transaction.

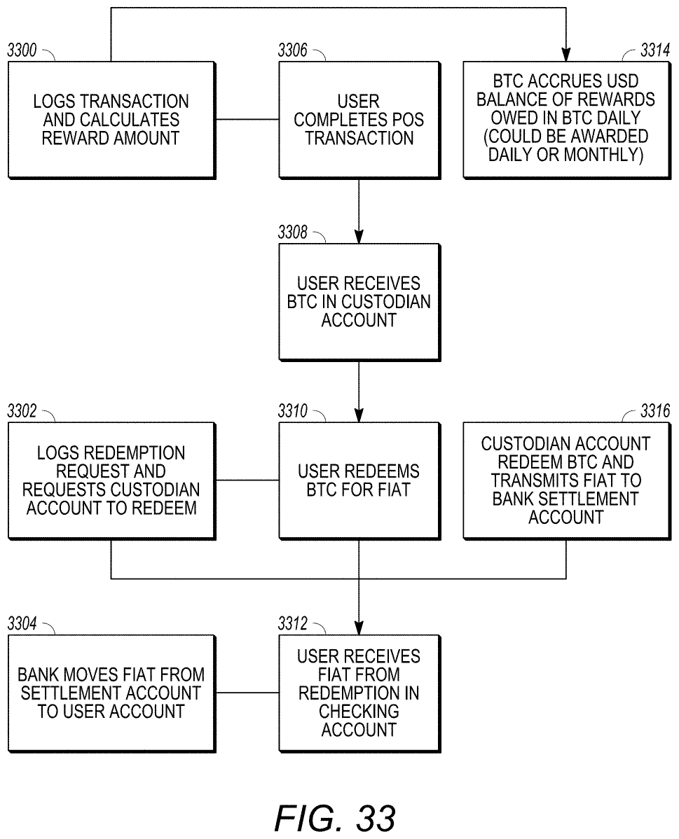

FIG. 33 shows an example flow chart using the platform 2200 to pay for a transaction using a cryptocurrency accrued in the form of a reward. In this example, a user may use the user's debit card (or client device) in various purchase transactions. The bank may calculate a reward amount owed to a user based on a transaction amount or type and instruct a third-party financier to transfer an amount of cryptocurrency equal to the reward amount owed to the user. As a result, the user may receive rewards in the form of a cryptocurrency stored in a digital wallet associated with the user. Subsequently, the user may submit a request for redemption of the cryptocurrency on an application associated with a bank. In response, the bank may transmit a signal to the wallet holder to transmit an amount of cryptocurrency to an account of a third-party financier. Upon receipt of the cryptocurrency from the user, the third-party financier can transfer to an account associated with the bank a cash amount equivalent to the cryptocurrency received by the third-party financier. In response, the bank may transfer the cash amount to the user's account or facilitate a payment on behalf of the user. Still referring to FIG. 33, in an example, the platform 2200 may log a transaction and calculate a reward amount 3300 that is associated with an action taken by a user, including but not limited to a purchase. The user may complete a transaction at a point-of-sale 3306, which may be an in-store purchase in a brick-and-mortar merchant establishment, an online merchant establishment, or some other transaction location. Bitcoin, or some other type of cryptocurrency, may accrue as a means of reward owed the user, for example that which has accrued on the basis of purchases made at merchants using fiat currency and/or cryptocurrency 3314. The user may receive Bitcoin or some other type of cryptocurrency in a Bitcoin wallet and/or cryptocurrency custodian account 3308. The platform 2200 may log a redemption request at some point following the reward and submit a redemption request to the Bitcoin wallet and/or cryptocurrency custodian account 3302. The user may then redeem Bitcoin or some other type of cryptocurrency for a fiat currency amount 3310. The Bitcoin wallet and/or cryptocurrency custodian account may then redeem the Bitcoin or other cryptocurrency and transmit the fiat currency to a bank settlement account, or some other type of account 3316. The bank may move the fiat from the settlement or other account to an account associated with the user 3304. The user may then receive fiat currency from the redemption in a checking account, savings account, or some other type of financial account that is associated with the user 3312.

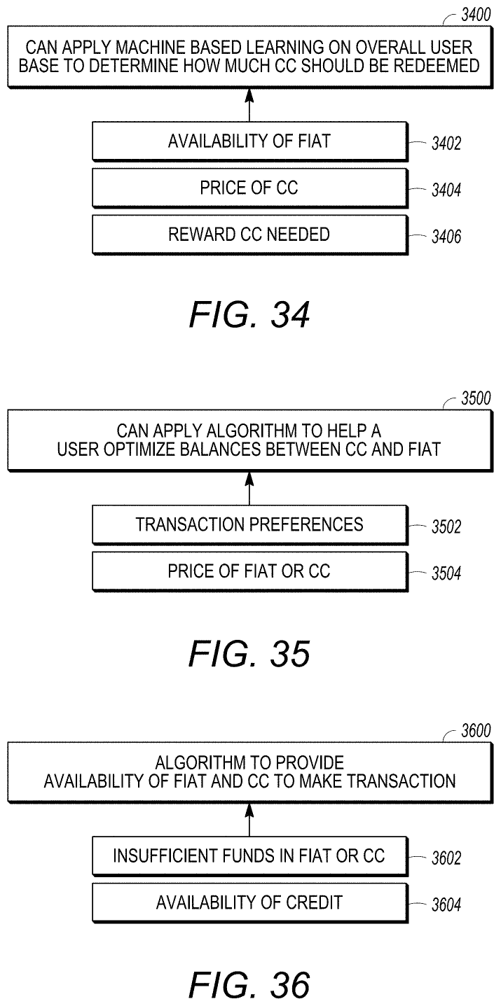

FIG. 34 shows an example flow chart in which a machine learning model 3400 of the platform 2200 may be used to determine how much cryptocurrency needs to be used for a given transaction. In an example, the platform may use machine learning to evaluate a user's transaction history of cryptocurrency and factor in the price of cryptocurrency 3404 as well as its current trends to determine how much cryptocurrency should be redeemed in a particular transaction. In another example, the platform may use machine learning 3400 to determine fiat funding requirements for a future period of time, and thus, cutting down on the potential settlement time, cryptocurrency price risk, and fiat availability. As another example, the platform may use machine learning 3400 to factor in the availability of fiat currency 3402 and/or current price of cryptocurrency 3404 and/or the price trend of cryptocurrency to determine if it could optimize the price of cryptocurrency and either redeem user's cryptocurrency to fund a fiat transaction or provide a third-party funder or bank fiat in lieu of an actual cryptocurrency redemption in order to maximize or monetize the value of the cryptocurrency owned. As another example, the platform may use machine learning to factor in how much cryptocurrency would be needed in a given time period to determine how much cryptocurrency it will likely need to reward users based on point-of-sale transaction history. The platform may then factor the need against the expected redemption and the current price of cryptocurrency to determine how to best maximize the value of the cryptocurrency and rather to hold, transfer, or redeem cryptocurrency to meet fiat and cryptocurrency rewards needs.

FIG. 35 shows an example flow chart for using the platform 2200 to optimize balances between cryptocurrency and fiat currency. In an example, the platform may use an algorithm 3500 to determine a user's purchase behavior trends including the amount spent and the fiat or cryptocurrency preference 3502 as well as the price of fiat or cryptocurrency 3504 to optimize the balances a customer maintains in cryptocurrency or fiat. For example, if the algorithm 3500 determines that Tuesdays have a much lower average total spend and the price of cryptocurrency is rising, it may auto-optimize balances of fiat and cryptocurrency to enable the user to maximize the increasing value of cryptocurrency and a minimal need for fiat availability. In another example, the platform 2200 may use an algorithm 3500 to determine a user's average transaction history in comparison to the increasing or decreasing value of cryptocurrency to optimize the balances in either form (fiat or cryptocurrency) of currency, thus enabling the user to protect against volatility in either currency while minimizing the likelihood of transaction fees based on the availability of cryptocurrency or fiat in the user's wallet.

FIG. 36 shows example processes including algorithms 3600 used by the platform 2200 to provide availability of fiat and/or cryptocurrency to facilitate a transaction. In an example, the platform may use an algorithm to provide a total “available” balance and/or credit 3604 to a user for transactions regardless of the default or selected form (fiat or cryptocurrency) of payment. For example, a user may have selected fiat and only has and insufficient amount 3602, for example $1,000 available on a purchase that requires $2,000. If the user has available cryptocurrency in excess of the difference, the system may enable the user to spend both forms of currency; first using the available fiat and then triggering a redemption request of cryptocurrency to cover the rest of the transaction. In another example, the system can use an algorithm that can combine the available fiat, available cryptocurrency, and available fiat credit extended to user and to best optimize the price of a transaction. The algorithm may be set to default to maximize or provide the user with a prompt to confirm the decision. The algorithm may consider the price of the cryptocurrency, the cost of different forms of transactions, and the cost of available credit to determine the optimal composition of the needed payment amount to enable the transaction.

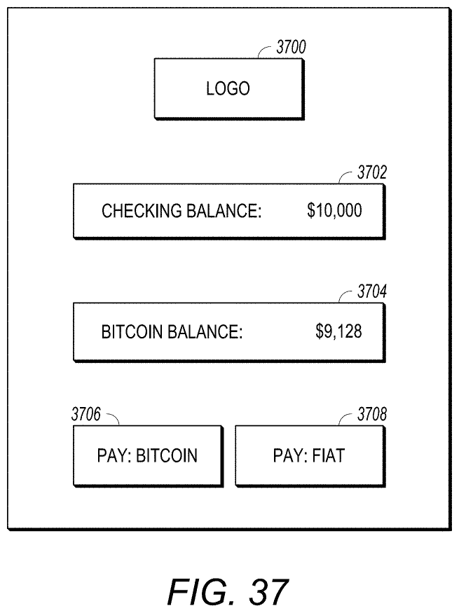

FIG. 37 an example of a page of a user interface for an application of a client device capable of interacting with the platform, as described herein. In this example embodiment, upon logging in, the user may see a logo 3700, such as a bank logo, a balance of a checking account 3702 holding fiat currency (or any other type of account doing same), and the user's balance in a cryptocurrency wallet 3704. The checking account balance may be provided by a bank and the cryptocurrency balance may be provided by a third-party financier or a wallet holder. The user may further be provided with an option (or button) to pay for a transaction using the checking account balance using fiat currency 3708 and another option (or button) to pay for the transaction using the cryptocurrency balance 3706.

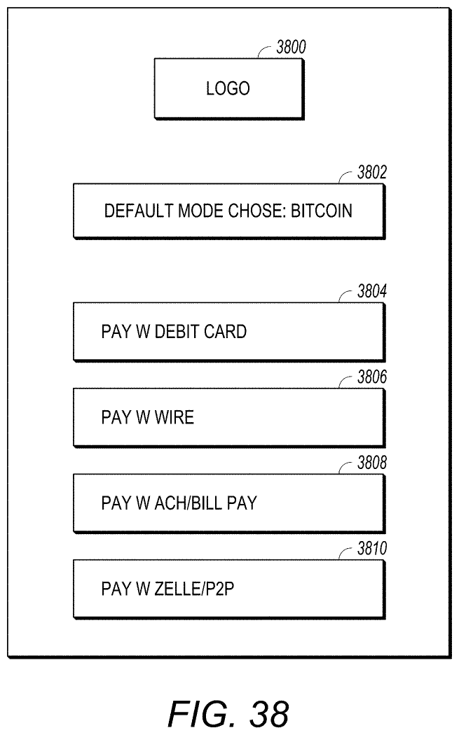

FIG. 38 shows an example of a page of a user interface for an application of a client device capable of interacting with the platform 2200, as described herein. In this example embodiment, the user may have selected an option for making a payment, and as a result, the page displayed may present the user a logo 3800, such as a bank logo, and allow the user to select a payment option 3802, such as paying in Bitcoin, or some other cryptocurrency, or fiat currency. For example, a button may be provided for initiating a payment with a debit card 3804, a wire payment 3806, a peer-to-peer means of payment 3810, and/or an ACH/Bill payment 3808, which may be originated from the bank. The user may also initiate a payment with a third-party payment application. Additionally, there may be an option for payment using a cryptocurrency. The cryptocurrency balance may be maintained with a third-party financier or a cryptocurrency wallet holder. In an example embodiment, the option for payment with a cryptocurrency may be selected as the default option.

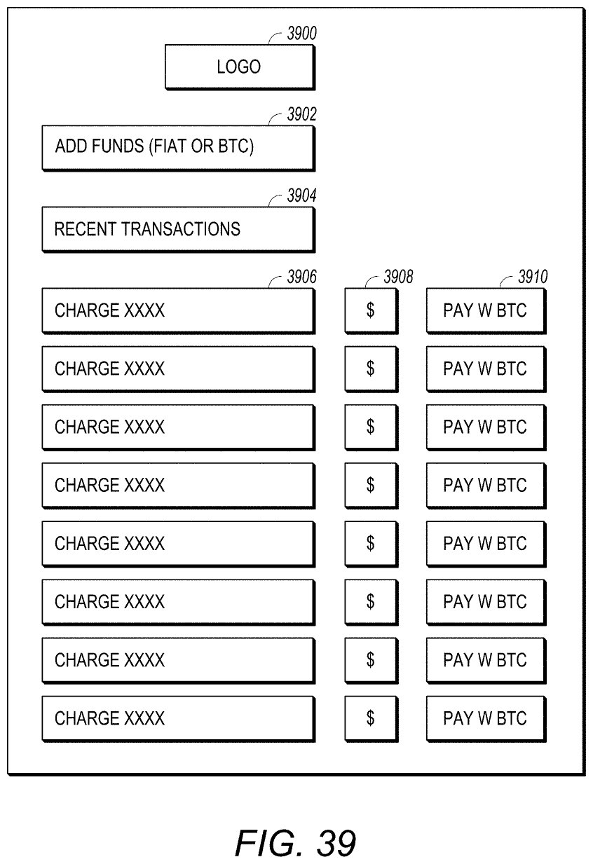

FIG. 39 provides an example of a page of a user interface for an application of a client device capable of interacting with the platform, as described herein. In this example embodiment, the user may see a logo 3900, such as a bank logo, and be provided with an option for adding funds 3902 or cryptocurrency to the user's account or wallet. For example, the user may instruct the bank to withdraw funds from a saving account located at another financial institution and add the funds to the user's account at the bank. In another example, the user may instruct a third-party financier (or a wallet holder and/or exchange) to add funds to the user's cryptocurrency wallet in exchange for a US dollar withdrawal from the user's account. In another example, the user may facilitate a wallet-to-wallet transfer using this option. This may be from another wallet the user owns at a different exchange, for example, or from another individual who has a cryptocurrency wallet and wants to transfer cryptocurrency directly to a user. The page may have a button that enables the user to receive access to previous payments posted on the account 3904. The payments may include both fiat currency payments and cryptocurrency payments. The user may also facilitate various payment transactions using various assets, such as fiat currency or cryptocurrency 3910, and indicating the party(ies) to be charged 3906 and the associated amounts to be charged 3908.

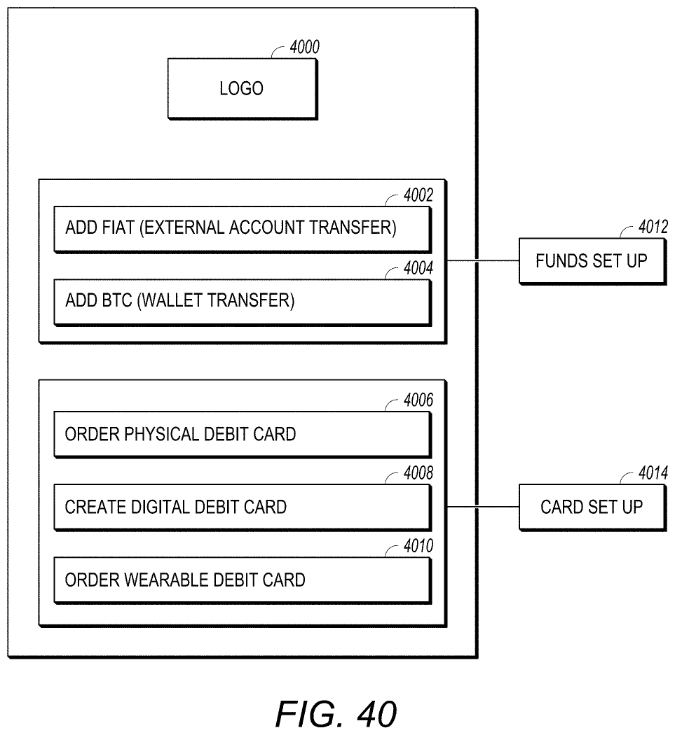

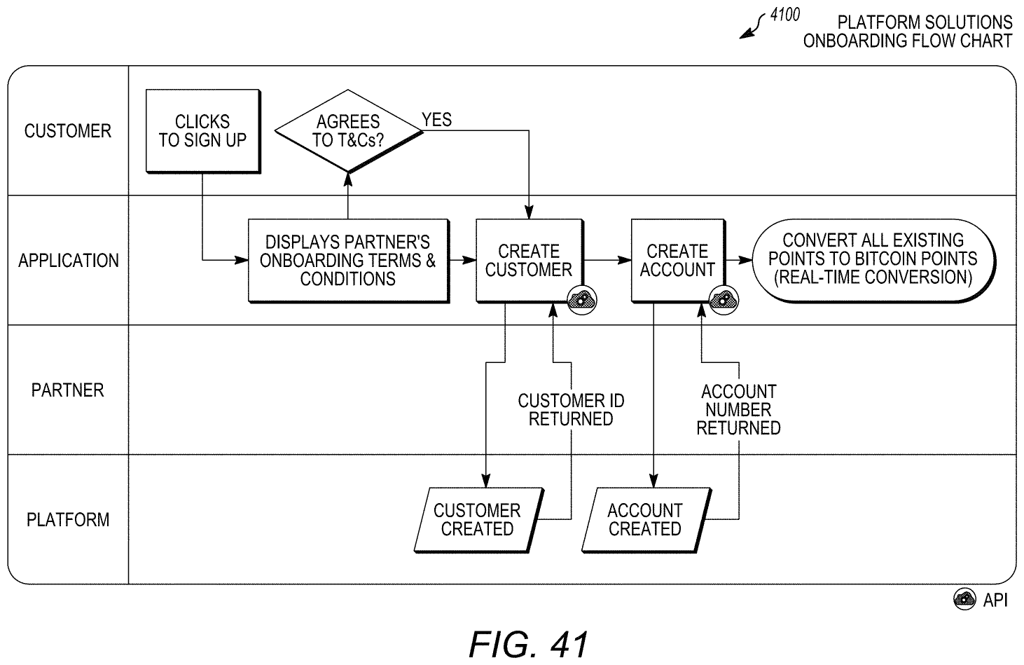

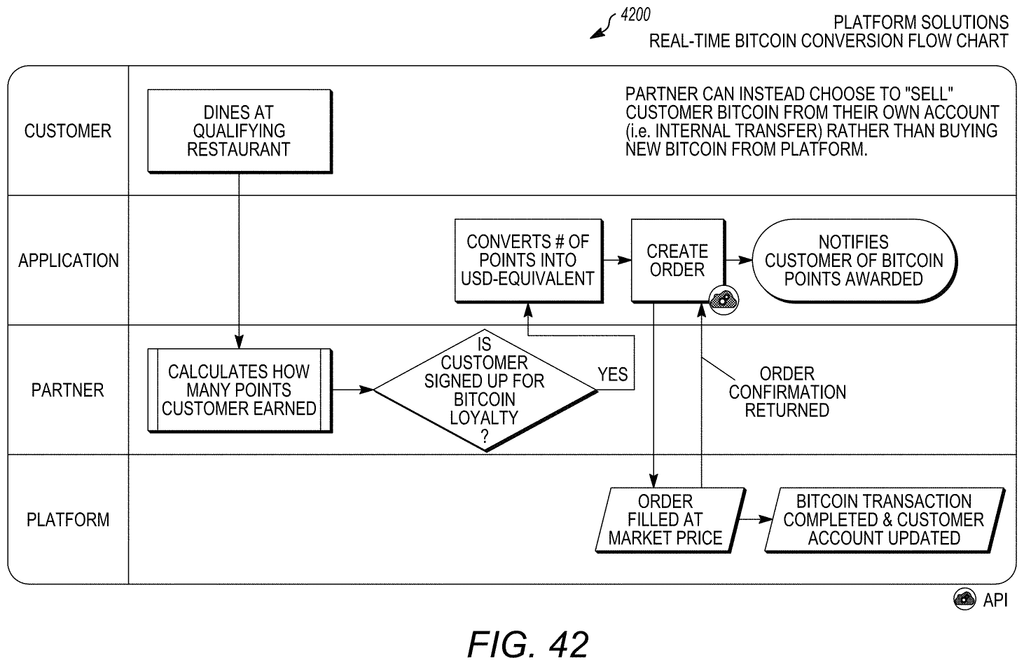

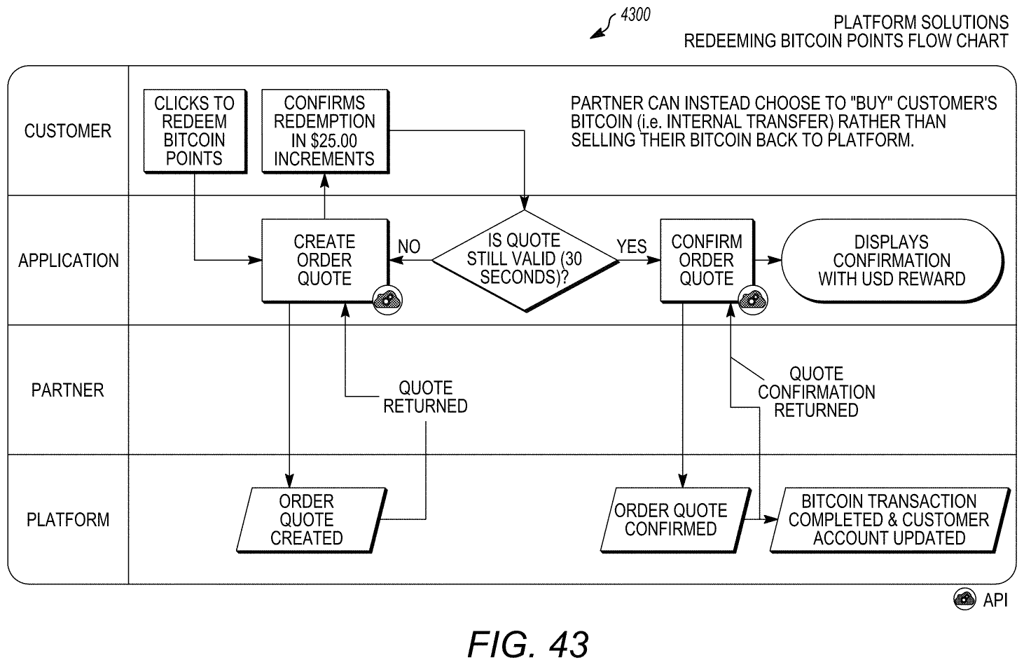

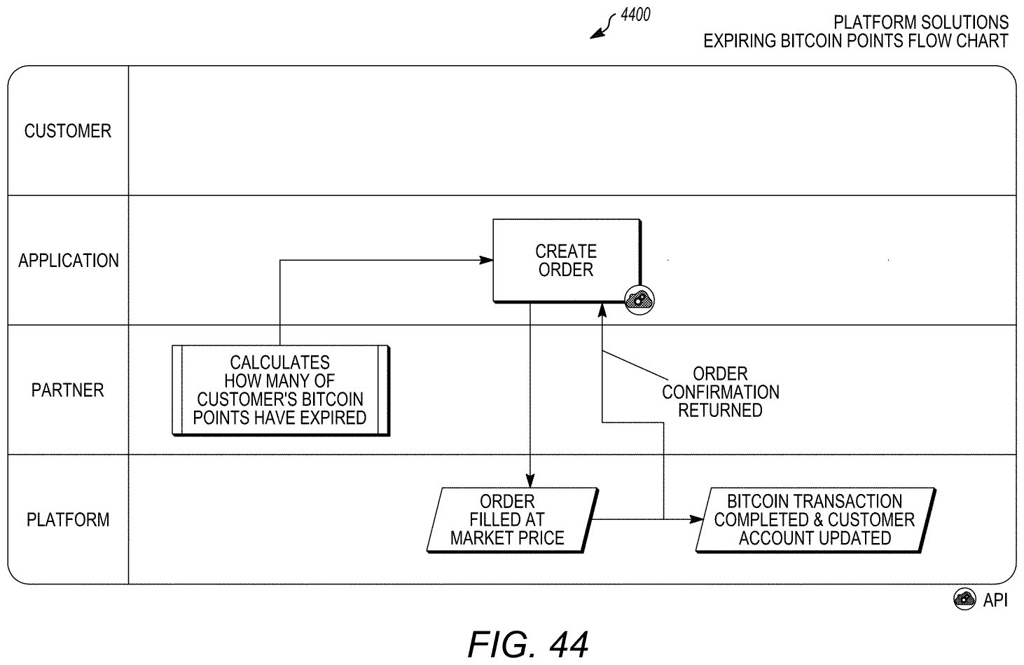

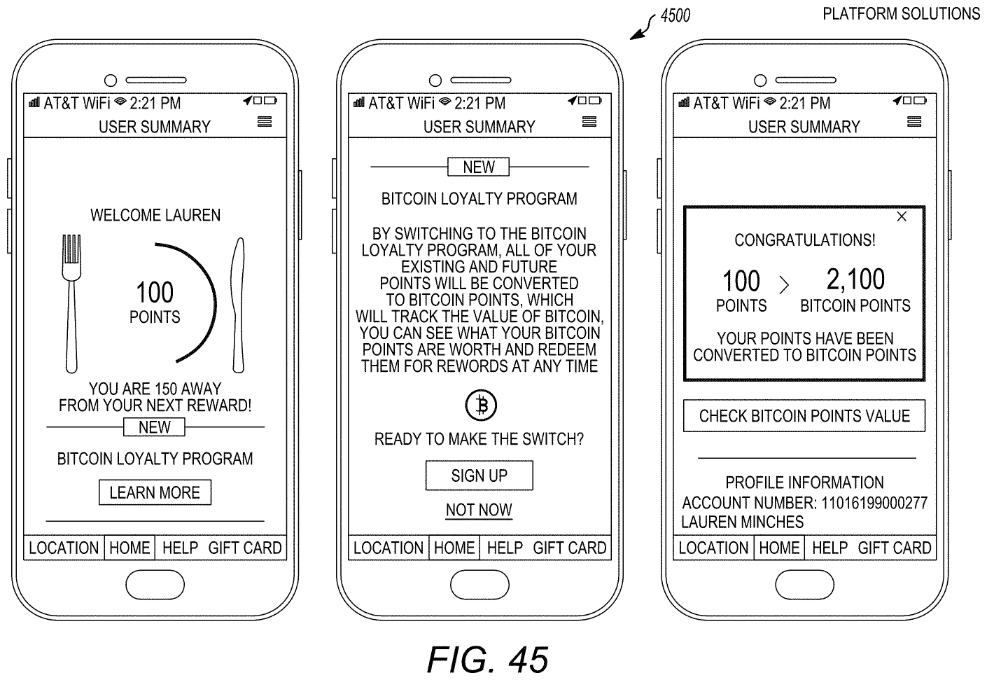

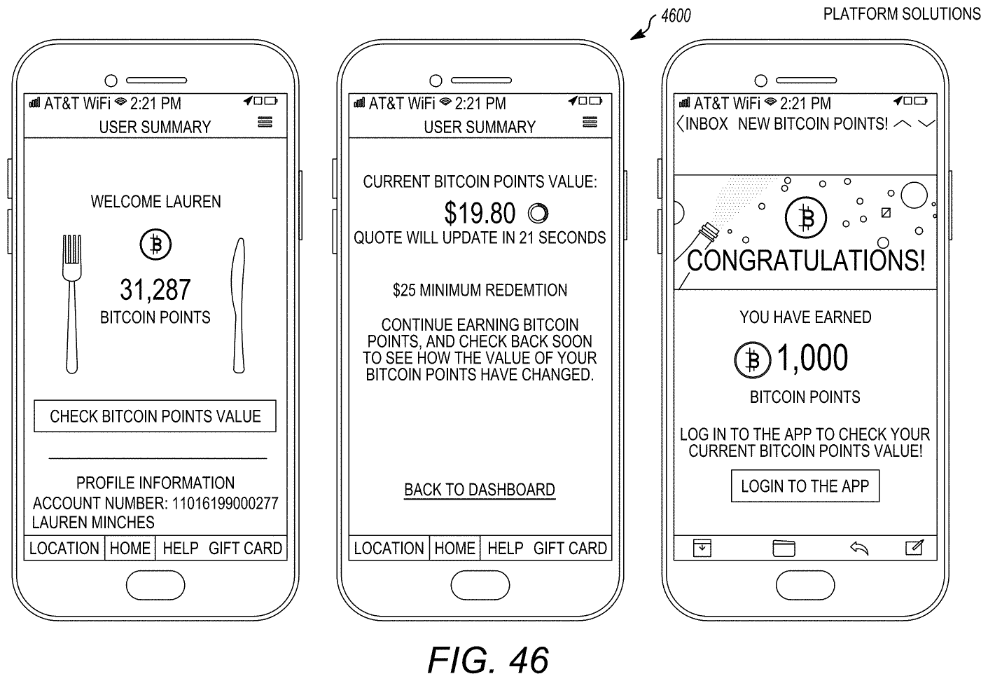

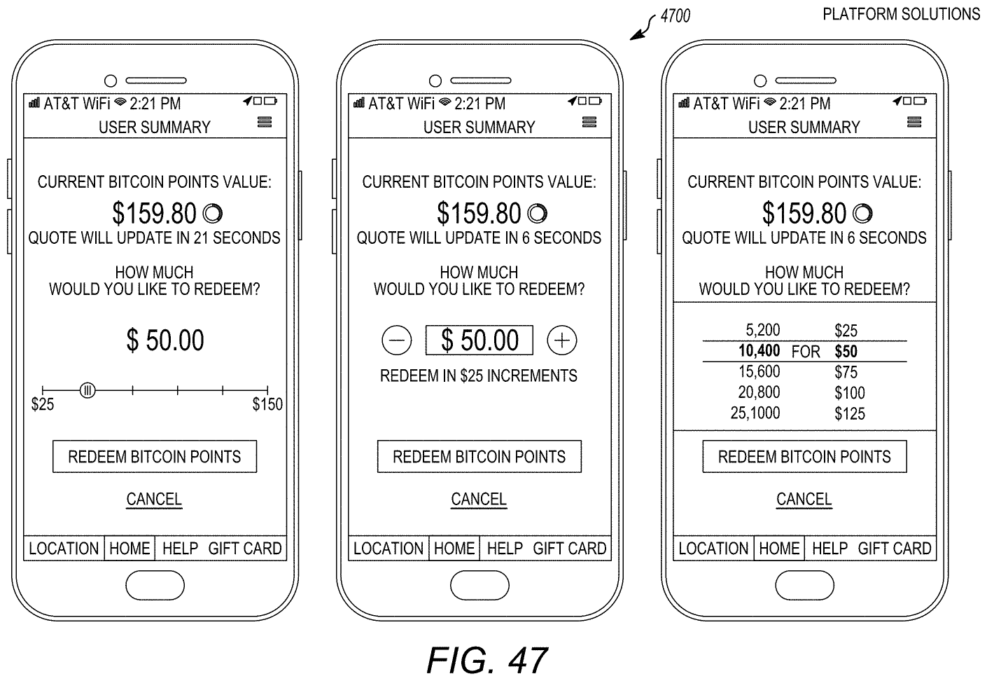

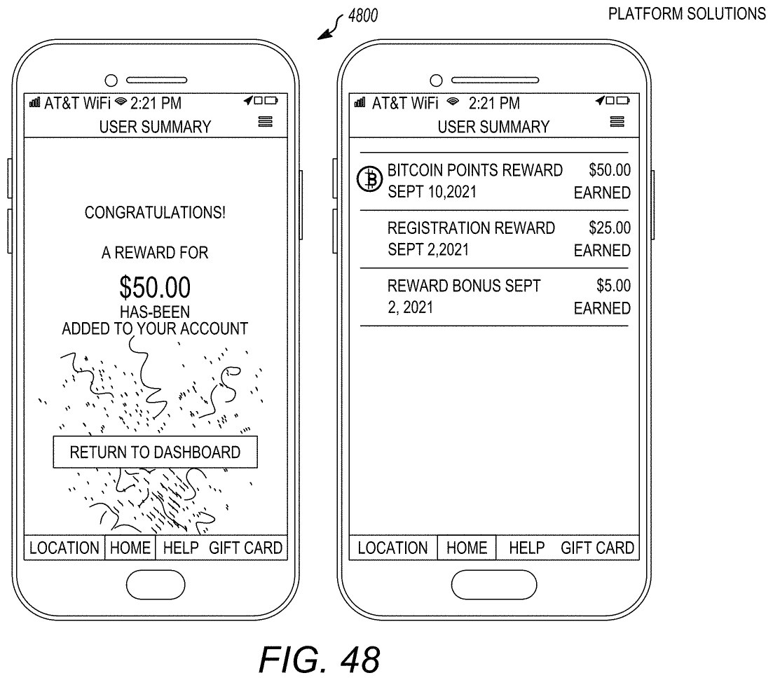

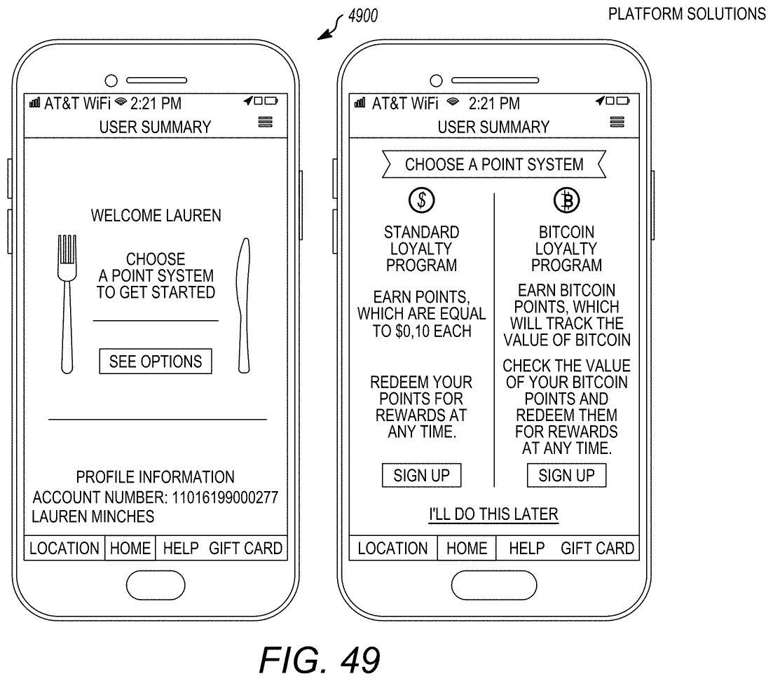

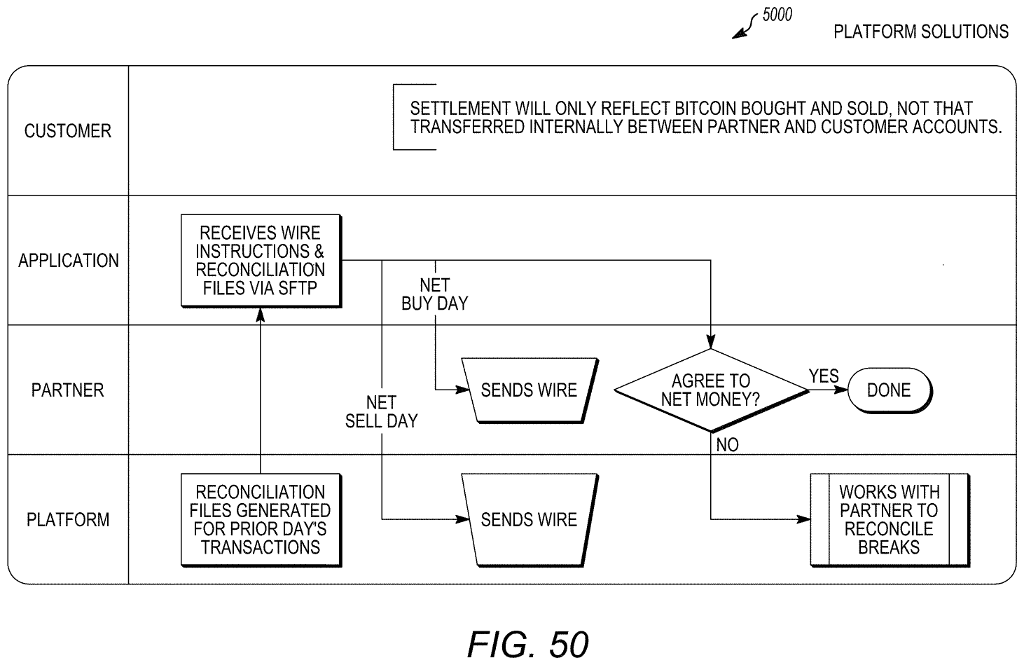

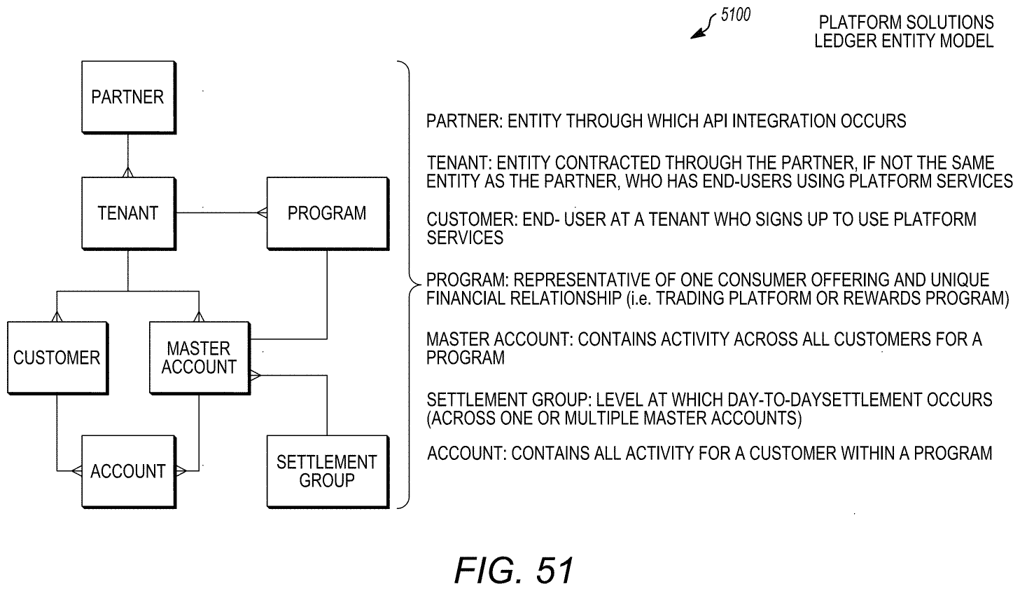

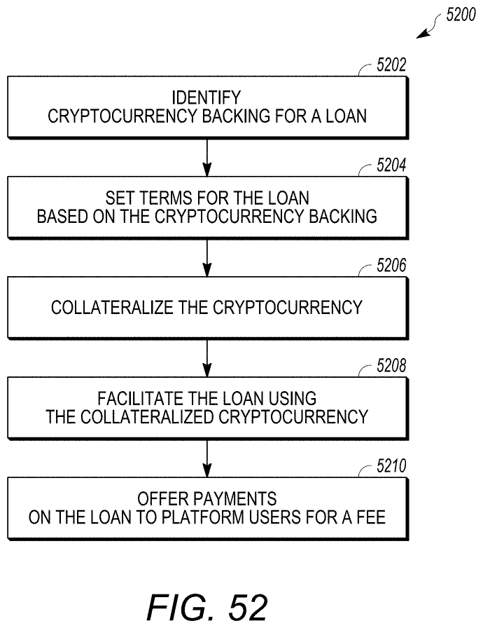

FIG. 40 shows an example of a page of a user interface for an application of a client device capable of interacting with the platform, as described herein. In this example embodiment, the user may see a logo 4000, such as a bank logo, and may be provided with an option for funding the user's accounts 4012. For example, the user may add fiat currency 4002 to the user's checking account by using an external account transfer. As another example, the user may add a cryptocurrency 4004 to the user's wallet, such as using a wallet-to-wallet transfer. The user may be provided with a link to set up a card associated with their account 4014, and options to order a physical care 4006, create a digital debit card 4008, order a wearable debit or credit card 4010, or perform some other type of card set up action. The user may also ask for a replacement card, a digital debit card or order a wearable debit card. The wearable debit card may include an RFID chip. The wearable debit card may be inserted in a ring or other device.

In embodiments, the platform 2200 may offer a cryptocurrency savings plan (the “crypto savings plan”) which allows an employee, contractor, partner, wage earner or other party (hereinafter “employee”) to allocate a portion of their fiat currency earnings, salary, bonuses, tips, wages, and the like into a fiat currency account, and to programmatically purchase cryptocurrency using such funds, to hold purchased cryptocurrency in an account opened and maintained with the platform 2200 (the “cryptocurrency account”), and ultimately to sell cryptocurrency through the platform 2200. The platform 2200 may also provide a website, mobile application or other interface (the “interface”) through which an employee can enroll for the crypto savings plan, view their cryptocurrency balances and transactions and initiate sell orders as further described herein. The proceeds of sold cryptocurrency may be credited back to the fiat currency account and may be withdrawn from the fiat currency account to other external accounts maintained with third parties, such as third-party financial providers, including banks. The crypto savings plan may, in various embodiments, block an employee from directly purchasing cryptocurrency (apart from purchases made in connection with the crypto savings plan) or may allow an employee to deposit cryptocurrency to a cryptocurrency account from other sources, or withdraw or transfer cryptocurrency, including to other accounts held with the platform 2200.

In embodiments, to enable the crypto savings plan, an employee may open and maintain a deposit account (the “fiat currency account”) with a bank, such as a regulated financial service provider. The employee may also authorize the bank to debit their fiat currency account and transfer their external deposits to the platform 2200 on a recurring basis (the “recurring transfers”) to fund the cryptocurrency purchases. The platform 2200 may function as a program partner with the bank, however the bank may not perform cryptocurrency custody or execution services, and such services may be performed exclusively by the platform 2200.

In an example embodiment, to use a crypto savings plan, an employee may provide various representations and/or warranties, such as that they: (a) are an individual at least 18 years of age (or at least the age of majority in the state in which they reside); (b) have not been suspended or previously removed from a crypto savings plan; (c) are legally allowed to purchase, own, and sell cryptocurrency; (d) do not reside outside of the U.S. and reside in a state or territory where the crypto savings plan is available; and (e) are not identified as a “Specially Designated National” by the U.S. Department of the Treasury's Office of Foreign Assets Control (“OFAC”) and are not placed on the Commerce Department's Denied Persons List. Employees may also agree to receive communications relating to their cryptocurrency account electronically (including through the Interface, email, and secure message) in a manner compliant with electronic signature-based consent.

In embodiments, to provide the crypto savings plan, the platform 2200 may coordinate with a bank. The employee may agree that the bank may share their personal information (including information about transactions on their accounts with the bank) with the platform 2200 and the platform 2200 may share the employee's personal information (including information about transactions on accounts with the platform 2200) with the bank as necessary to provide the crypto savings plan. The employee may also agree that the platform may share personal information (such as the fact that the employee uses the crypto savings plan) with their employer and their employer may share their personal information (such as the status of employment) with the platform 2200 as necessary to properly bill the employer for the employee's use of the crypto savings plan. In addition, the platform 2200 may disclose personal information (including transaction information) to third parties that perform services related to the crypto savings plan for the platform, including affiliates.

In embodiments, an employee may use the crypto savings plan to programmatically purchase cryptocurrency with fiat currency deposited to the employee's fiat currency account (“standing orders”) and to initiate orders through the interface to sell cryptocurrency (“sell orders”). By instructing the platform 2200 to initiate standing orders on the employee's behalf and by initiating sell orders, the employee (a) agrees to be bound by the transaction, including the obligation to pay an associated reference rate and/or receive the associated sale proceeds; and (b) accept the risks associated with such transactions. An employee may not be able to cancel any order initiated (whether a standing order or a sell order) once initiated. An employee may be permitted to fund standing orders directly from the employee's earnings source (i.e., their employer) by direct depositing a portion of the employee's earnings into the fiat currency account. However, if the employee makes other non-earnings deposits to their fiat currency account, the platform 2200 may be authorized to and will initiate standing orders on the employee's behalf with such funds.

In embodiments, when the platform 2200 initiates a standing order on an employee's behalf, the “transaction total” may reflect the total fiat currency amount transferred to the platform by a bank for the employee's standing order. This amount equals the amount deposited from external sources to the employee's fiat currency account. The transaction total may be used to purchase cryptocurrency for the employee's cryptocurrency account at the applicable reference rate. Each time the platform 2200 receives a recurring transfer from a bank, the platform 2200 may be obligated to execute a standing order on the employee's behalf If the employee withdraws their authorization for recurring transfers, then the platform will no longer execute standing orders on behalf of the employee. A “buy” transaction, as used herein, refers to a sale of cryptocurrency from the platform 2200 or platform affiliate to an employee in connection with a standing order at the applicable reference rate. Once the platform 2200 has executed a standing order, a transaction receipt may be generated for the employee. Settlement of a standing order may not occur until cryptocurrency has been delivered to an employee's cryptocurrency account. An employee may not own cryptocurrency associated with a standing order prior to settlement of a transaction. During this period, the employee is owed cryptocurrency by the platform 2200 and the employee's cryptocurrency account may show a pending amount (“pending balance”) of cryptocurrency. Because the employee's pending balance reflects cryptocurrency they do not yet own, it is not part of the employee's settled balance, however it may be reflected in balance amounts shown to the employee through the interface. In an embodiment, the platform 2200 may allow an employee to place a sell order using their pending balance, subject to certain limits. A transaction may settle when cryptocurrency has been delivered to the employee's cryptocurrency account. When the transaction settles, the employee will no longer have a pending balance for such transaction and the settled cryptocurrency may be reflected as part of the employee's settled balance.

In embodiments, when an employee sells cryptocurrency, the “transaction total” may reflect the fiat currency amount of cryptocurrency that the employee wishes to sell. The cryptocurrency may be sold at the applicable price displayed in the interface at the time the employee initiates a sell order, and the fiat currency proceeds (the “sale proceeds”) may be credited by the bank to the employee's fiat currency account. For example, if an employee wishes to sell $2600 worth of cryptocurrency, then an amount of cryptocurrency will be sold to generate $2600 worth of sale proceeds that will be credited to the employee's fiat currency account. Sale proceeds credited to the employee's fiat currency account may not be used to fund standing orders.

In embodiments, an employee may place an order to sell some or all of the cryptocurrency associated with their cryptocurrency balance through the interface. Because the market value of cryptocurrency fluctuates, the price presented for the employee's sell order may only be available for a limited period before expiring. If the employee still wants to complete a sell order after the price expires, the platform 2200 may provide the employee with an updated price before the employee places their order. If an employee attempts to place a sell order for all or substantially all of the fiat currency value of their cryptocurrency balance, the platform may require the employee to sell their entire cryptocurrency balance. Once a sell order is accepted, a transaction receipt may be made available to the employee.

In embodiments, an employee may not receive sale proceeds associated with a sell order until a bank credits such proceeds to the employee's fiat currency account. Until such time, the employee may be owed the sale proceeds and their fiat currency account may or may not show a pending credit. The employee's cryptocurrency balance may be structured such that it does not reflect any cryptocurrency associated with a sell order. If there is a delay with delivery of sale proceeds, the platform may contact or alert the employee of the delay and inform of a new expected timeframe.

In embodiments, the platform 2200 may decline to fulfill an employee's order, for example, in the event that an employee's fiat currency account is unable to receive sale proceeds such as if their fiat currency account has been frozen by a bank.

In an example, the “reference rate,” as used herein, may be the CME CF Cryptocurrency Reference Rate (BRR) as of 4:00 p.m. London Time. This is the rate at which an employee's standing orders may be executed on the day the platform 2200 receives a recurring transfer from a bank. The reference rate at which standing orders are executed may differ from the price at which sell orders are executed. The “price,” as used herein, may be the price in fiat currency, such as U.S. dollars, presented in the interface at any given time in connection with a proposed sell order. The price may be based in part on (a) the market price of cryptocurrency at the time, which is typically related to the price of cryptocurrency on large United States exchanges, plus (b) a “spread,” which is intended to compensate the platform 2200 for price movement and average expected execution costs to the platform. The price may be different than any price that employee may see on any cryptocurrency exchange or trading venue. The spread may differ based on volatility, the amount of time the specific price is available to trade, and/or the volume of cryptocurrency that an employee is attempting to buy or sell, among other factors.

In embodiments, a “transaction receipt” may be provided for each transaction and may include, among other information, a confirmation number, the date, and the reference rate or price (as applicable).

In embodiments, the platform 2200 may provide the crypto savings plan through employers (“employer sponsors”) that sponsor crypto savings plans for their employees. If an employee's employment with their employer sponsor is terminated and the cryptocurrency account is not closed, the platform 2200 may assess transaction fees for the fulfillment of orders through the crypto savings plan.

In embodiments, in addition to executing standing orders and sell orders, the platform 2200 may hold cryptocurrency an employee owns in connection with the crypto savings plan (the “settled balance”) on the employee's behalf in their cryptocurrency account.

In embodiments, the platform 2200 may hold an employee's settled balance “in trust” and for the employee's benefit and hold the settled balance in one or more omnibus accounts on, for example, a decentralized peer-to-peer network used to transfer cryptocurrency together with cryptocurrency owned by other users of the crypto savings plan.

In embodiments, the platform 2200 management of crypto savings plans may include an orchestration services system 2202, including automated services 2204 that may utilize smart contracts 2208, and other mechanisms and services as part of managing a wallet, such as a cryptocurrency wallet 2212 using the native interfaces (including application programming interfaces) and systems of the cryptocurrency wallet 2212 and also managing a traditional financial account 2210, such as a bank account 2220 (checking, debit, savings, or other), credit card account 2222, or money services business account, among others, using the native interfaces (including application programming interfaces) and systems of the traditional financial account.

The orchestration services system 2202 may perform and optionally automated a variety of tasks or workflows involved in orchestration of transactions across the crypto savings plan environment and the traditional financial services environment, such as collection of marketplace information (such as exchange rates among currencies and cryptocurrencies, interest rates, and the like), collection of account information (such as account balances, settings, preferences, and parameters for rule-based processing (such as thresholds, ranges and the like)), intelligent order matching (e.g., of a cryptocurrency balance transfer and/or fiat currency transfer), analytics tasks (such as a set of analytics on marketplace data and/or account data to provide a recommendation as to how an order should be denominated (such as in fiat currency, cryptocurrency or the like), data integration tasks and services (such as extraction, transformation, loading, normalization or other tasks required to enable the orchestration services system 2202 to interact with the native application programming interfaces or other interfaces of the respective cryptocurrency systems, wallets, exchanges, and financial services systems), automation tasks (such as automation of transaction execution, account reconciliation, reporting, or the like) and/or any other suitable tasks on behalf of the platform 2200.

The orchestration services system 2202 associated with the platform's 2200 crypto savings plan management may include machine learning, artificial intelligence, expert system, robotic process automation, and other capabilities, including use of neural networks, rule-based systems, model-based systems, and hybrids or combinations thereof, which may be trained, such as on tagged or labeled data sets (such as for classification or recognition tasks), on outcomes (such as financial outcomes, user satisfaction outcomes, or the like), and/or using supervised, semi-supervised, or deep learning methods.

In embodiments, the orchestration services system 2202 may include a machine learning system that trains machine learned models that are used by the various systems of the platform 2200 to perform intelligence tasks, including predictions and forecasts, classifications, process control, monitoring of conditions, prescriptive analytics, and the like. In embodiments, the platform 2200 may include an artificial intelligence system that performs various AI tasks, such as automated decision making, and the like. In embodiments, the platform 2200 may include an analytics system that performs different analytics across cryptocurrency, banking 2220, or other market data to identify insights related to the states of a cryptocurrency market 2214 and fiat currency markets, accounts, balances, and the like. For example, in embodiments, the analytics system may analyze a current valuation of a cryptocurrency, an account balance, such as a crypto savings plan balance, fiat currency account balance, cryptocurrency account balance, or the like with respect to a planned purchase, transaction and the like to determine whether a planned order should be in cryptocurrency, fiat currency or some blending or mixing of crypto and fiat currencies. In embodiments, the analytics system may perform the analytics in real-time as data is ingested from the various data sources to update one or more states of a financial marketplace or crypto savings account.

In embodiments, the intelligent orchestration services system 2202 may include an orchestration automation system 2204 that learns behaviors of a financial market and/or of respective users, employees and the like, and automates one or more tasks on behalf of the users based on the learned behaviors. In some of these embodiments, the orchestration automation system 2204 may configure intelligent agents on behalf of a financial marketplace such as a bank, employer, employee, group of employees (e.g., a union or other workers' organization), or the like. The automation system may configure machine-learned models and/or AI logic that operate to generate outputs, such as ones that govern actions or provide inputs to other systems, given a set of conditions. In embodiments, the orchestration automation system 2204 may receive training data sets of financial interactions by experts and configure the machine-learned models and/or AI logic based on the training data sets. In embodiments, the orchestration services system 2202 may include a natural language processing system that receives text/speech and determines a context of the text and/or generates text in response to a request to generate text.

In embodiments, machine learning processes 3200 may be incorporated in the platform 2200, as described herein. For example, the system may include a predictive model for making crypto savings plan recommendations and/or predictions based on variables such as user behavior, payment types available 3202, the price of cryptocurrency 3206, and/or the account balance of either fiat or cryptocurrency 3208. In one example, the predictive model may determine a recommended order type (e.g., purchase X % Bitcoin). This may be, for example, based upon an employee's transaction history, the predictive model may recognize that certain orders would be best balanced for the employee with fiat currency and cryptocurrency at a particular ratio. The system may auto-swap an order's currency selection based on the predictions of the model or prompt the employee to confirm. As another example, based upon an employee's previously defined order selections, the platform may automatically adjust and/or predict the employee's selection for certain order before they are made. As another example, the system may consider the employee's characteristics, such as age, employment type, employment duration and the like in predicting the combination of fiat currency and cryptocurrency to use when placing an order. For example, the system may determine that a user that is in the early stages of their career, with a solid employment history, may prefer orders having a greater percentage of cryptocurrency purchases than an older employee, or an employee with a history of periods of unemployment. The system may auto adjust the orders or prompt the user to confirm a recommendation. In another example, the platform may consider the relative value of cryptocurrency and fiat currency and determine the ratio of each used to fund an order. For example, if cryptocurrency valuations indicate a downward trajectory in the past three months' averages, it may suggest orders having a greater percentage of fiat currency or vice versa. In another example, the platform may consider the current balances a user has, based on prior orders, in either cryptocurrency or fiat currency and automatically adjust to whatever form of currency should be used for a given order.

Task 5202 identifies a cryptocurrency backing for a loan. For example, a potential borrower of the loan may indicate an amount of cryptocurrency to be used for backing the loan using the platform 2200.

Task 5204 sets terms for the loan based on the cryptocurrency backing. For example, the platform 2200 may set an interest rate, a term, and a maximum loan amount based on the amount and type of cryptocurrency identified by task 5202.

Task 5206 collateralizes the cryptocurrency. For example, the platform 2200 may coordinate with the borrower to move the cryptocurrency to a collateral holding account to restrict the sale of the collateralized cryptocurrency by the borrower until specific terms of the loan are satisfied. In some embodiments, the collateral holding account is owned by the operator of the platform 2200. In some embodiments, the collateral holding account is owned or controlled by a loan issuer who is not the operator. As will be appreciated by those with ordinary skill in the art, securing peer-to-peer loans with cryptocurrency collateral is non-routine and unconventional.

Task 5208 facilitates the loan using the collateralized cryptocurrency. In some embodiments, the platform 2200 facilitates funding from a loan issuer, such as a third party bank, to the borrower. In some embodiments, the operator of the platform 2200 directly sends funds to the borrower from funds raised by other users of the platform 2200, from the issuer, from the third party bank, or from funds owned by the operator. The specific mechanism used and the source of funds may vary based on local regulations governing the operator, the borrower, and the other users. In some embodiments, the loans are based on securities registered with regulatory agencies governing such securities. For example, the other users of the platform 2200 may be investors purchasing securities whose security purchases become the source of funds for the loans that are made on a peer-to-peer basis.

Task 5210 offers the payments from the borrower on the loan to platform users for a fee. For example, the operator of the platform 2200 may make a public offering of notes. In some embodiments, the notes are offered on a continuous basis for sale by the operator on its own behalf. In some embodiments, the notes are associated with a variable portfolio of loans collateralized by cryptocurrency with an aggregate principal amount equal to the aggregate principal amount of notes outstanding at any time.

In some embodiments, a registered security is sold only to the customers of the issuer, where the customers are allowed to buy a security and then earn an enhanced yield or a high yield effectively through a digital currency. For example, the investor users of the platform 2200 may use digital currency loans, such as a bitcoin backed loan, to generate yield. Accordingly, non-routine digital lending capabilities origination may be combined with a high yield product for investors.

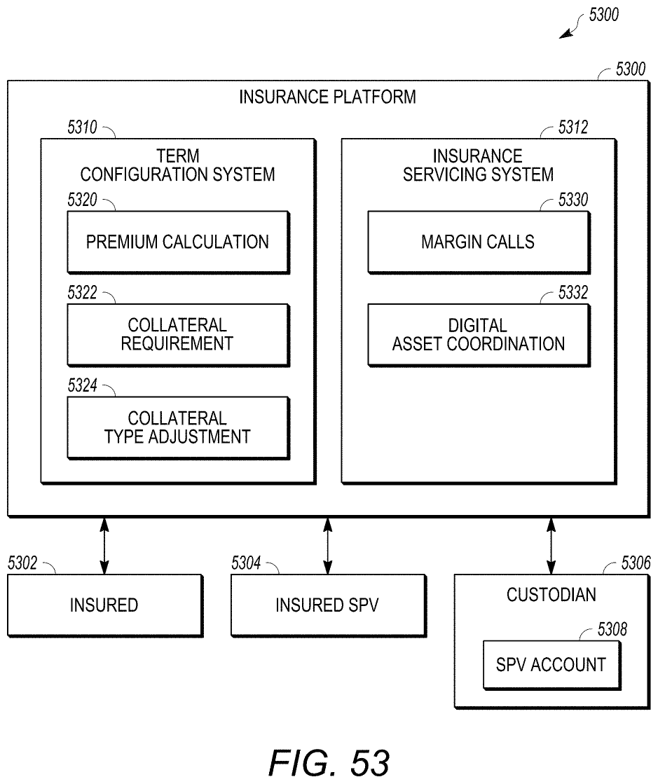

FIG. 53 shows a simplified diagram of an example of an insurance system 5300 associated with the platform 2200. In some embodiments, insurance system 5300 is associated with insurance 2224. In the example provided, insurance system 5300 coordinates liability insurance for company directors and officers. Directors and officers (D&O) liability coverage is essential for emerging growth and mature companies. Directors and officers of a company can be held personally liable for certain decisions made in the course of managing the organization. Many directors will be unwilling to sit on the Board of Directors without protection from this personal liability. Rates for D&O coverage for those in the digital asset are well-above comparable risks in other industries. In some cases, potential insureds have had difficulty obtaining coverage at any price.

The insurance system 5300 coordinates smaller premium payments while requiring comparatively larger collateral requirements. In some embodiments, payments of claims are made from the posted collateral and there is an insurance carrier that is legally obligated in the event that the collateral is insufficient to pay a claim. The insurance platform 5300 operator may act as a collateral service and/or under a loan servicing agreement. For example, a third party bank may use the operator as the collateral service or the operator may get paid in to service the insurance transaction.

In the example illustrated, insurance system 5300 includes an insurance platform 5301, an insured 5302, an insured special purpose vehicle (SPV) 5304, a custodian 5306, and an SPV account 5308. In the example provided, the insured 5302 is a cryptocurrency company insuring a director or officer beneficiary. In some embodiments, the insured 5302 is the director or officer and a cryptocurrency company pays the premium and posts the collateral for the insured 5302.

The insured SPV 5304 may be a subsidiary of the insured (the “insured SPV”) and may own the collateral in an insured SPV account 5308 in the name of the insured SPV. The account may be held by the custodian 5306 pursuant to a custody agreement to be entered into between the Insured SPV and the custodian and an account control agreement among the insured, insured SPV, the custodian, and a reinsurer. In some embodiments, the operator of the insurance platform 5300 is the custodian.

The insurance platform 5301 includes a term configuration system 5310 and an insurance servicing system 5312. The term configuration system 5310 includes artificial intelligence/machine learning components for premium calculation 5320, collateral requirement 5322, and collateral type risk adjustment 5324.

The premium calculation 5320 component trains on risk data and other outcome data to determine the periodic costs to be paid by the insured to maintain the policy. In some embodiments, the premiums may be paid in fiat currency or in cryptocurrency. For example, insureds with long positions in cryptocurrency may pay the premiums in fiat currency.

The collateral requirement 5322 component calculates the amount of collateral required for backing the payout limit of the policy. In the example provided, the policy is over collateralized at about 1.7 times the policy limit. If there is no claim, the insured pays only the premium. If there is a claim then the insured pays out the claim.

In some embodiments, the collateral requirement 5322 component correlates the risk in these companies and the value of the bitcoin. In some embodiments, the collateral requirement 5322 component offers different levels of over collateralization such that some companies with large cryptocurrency positions may over collateralize at, for example, two and a half or three times the policy limit. A larger over collateralization reduces the risk for the insurer and the reinsure, allowing lower rates. The lowered risk of making margin calls further permits lower rates.

The collateral type risk adjustment 5324 component may utilize artificial intelligence and machine learning algorithms for correlation between claim risk and the downside of cryptocurrency volatility to adjust the collateral requirement and set margin bounds. In some embodiments, the insurance policy is based at least in part on underwriting that involves assessment of the correlation between claim risk and volatility of a cryptocurrency.

In some embodiments, initial collateralization is 2200% of the policy limit, assuming a 40% haircut on cryptocurrency and no haircut on cash. In some embodiments, upper and lower margin bounds are 2225% and 90%, respectively. For example, if the value of the collateral account drops below the Lower Margin Bound, a margin call will be issued. Sufficient funds must be received within a predefined time (e.g., by the end of the next business day) from when the margin call is issued to return the collateralization level to the Initial Collateralization Level. The insured may request collateral back if the collateralization level breaches the Upper Margin Bound. The amount of initial collateralization may vary based on the asset collateralized. For example, the collateral requirement for a $10 M policy may be $10 M in US dollars, $16.7 M in Bitcoin, or $13.3 M in Bitcoin plus $2 M in US dollars.

The insurance servicing system 5312 includes components a margin calls component 5330 and a digital asset coordination component 5332. The margin calls component 5330 and the digital asset coordination component 5332 may coordinate services that are similar to a loan servicing agreement. For example, the margin calls component 5330 may monitor the value of the collateral and make margin calls in response to the value of the collateral dropping below the margin lower bound. In some embodiments, the margin lower bound is 90% of the policy limit. The margin calls component 5330 monitors for receipt of additional funds to meet the margin call. If sufficient funds are not received, the margin calls component 5330 may initiate liquidation of the cryptocurrency into fiat currency.

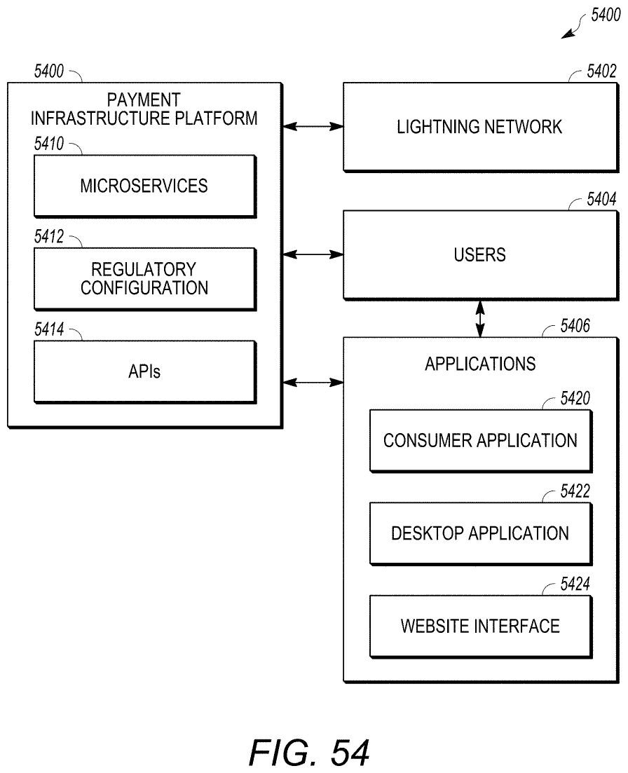

FIG. 54 shows a simplified diagram of an example of a cryptocurrency micro transaction system 5400 associated with the platform 2200. Payments APIs that let people easily access bitcoin or other cryptocurrencies as a payment rail by hooking directly into the cryptocurrency protocol without intermediaries.

Cryptocurrency micro transaction system 5400 coordinates interactions between a cryptocurrency payment infrastructure platform 5402, a rapid cryptocurrency layer (e.g., the Lightning network) 5402, users 5404, and applications 5406. Cryptocurrency micro transaction system 5400 includes microservices 5410, a regulatory configuration 5412 component, and APIs 5414. In the example provided, applications 5406 include a consumer application 5420, a desktop application 5422, and a website interface 5424.

In some embodiments, the operator of the payment infrastructure platform 5400 is a payments infrastructure company. Microservices 5410 interact to define the architecture of the payment infrastructure platform 5400. For example, one microservice is an underlying translation service that easily translates between pounds, euros and bitcoin. In the example provided, each microservice of the microservices 5410 is independently scalable to meet the demands on any particular microservice. In the example provided, the microservices 5410 are cryptocurrency protocol agnostic. For example, although Bitcoin is provided as an example, the microservices are configured to interact and be modified to interact with existing and yet developed cryptocurrencies. For example, the microservices 5410 may support even a newly released cryptocurrency by, for example, scanning a QR code so that the microservices may interoperate between the protocols and technologies.

The regulatory configuration 5412 component controls aspects of the payment infrastructure platform 5400 based on regulation and compliance with local laws. In some embodiments, the regulatory configuration 5412 component is a regulations and compliance control engine that may enact different rules (e.g., spending rules) on a country-by-country basis. In some embodiments, the regulatory configuration component 5412 is a microservice of the microservices 5412.

The APIs 5414 are configured to enable third party development of applications for easy access to cryptocurrencies as a payment rail. In some embodiment, APIs 5414 permit applications to indicate the country or local region for control of the regulatory configuration 5412 engine.

The Lightning network 5402 protocol delays on-chain transactions in a trade for instant transaction off-chain. Cryptocurrencies such as Bitcoin on chain are secure, but are not well suited for in-person or as a peer-to-peer payment rail because of how long it takes to confirm a block. In the example provided, the cryptocurrency is Bitcoin and the rapid transaction system is the Lightning network. In some embodiments, the payment infrastructure platform 5400 has architecture to facilitate use of the Bitcoin as an open-source monetary system, and allows people and businesses to access this monetary system more easily. The APIs 5414 and endpoints are configured to permit access to that network as a rail and to leverage its unique attributes. In some embodiment, interaction based on the Lightning protocol enables instant fulfillment and instantly cleared and settled payments across the world.

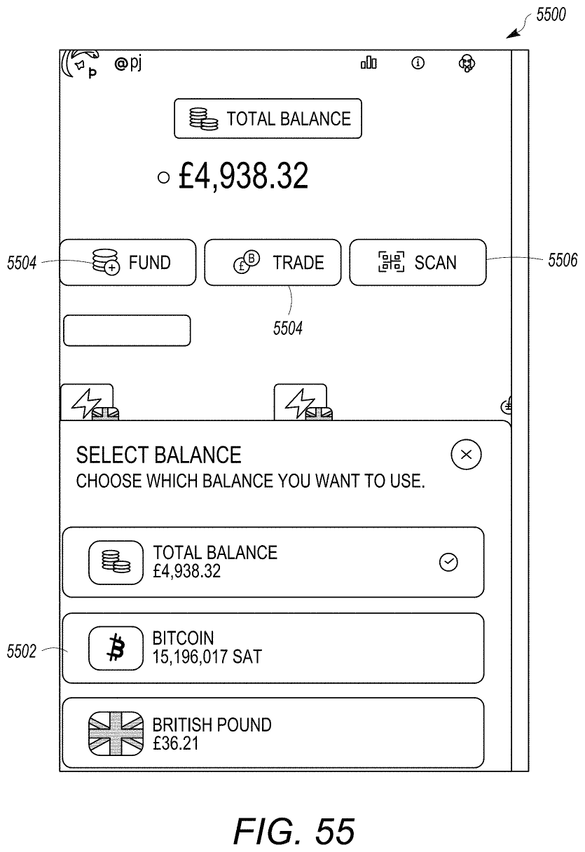

FIG. 55 shows an example of a main user interface 5500 for use with the payment infrastructure platform 5400. For example, the main user interface 5500 may be part of consumer application 5420 developed for mobile electronic devices using the APIs 5414. The consumer application 5420 allows consumers to move Bitcoin to fiat easily and to be able to spend on the rail with Bitcoin.

In the example provided, the consumer application 5420 permits the recipient of the currency to control the type of currency received. For example, the recipient may have concerns about volatility, capital gains exposure, etc. that cause the recipient to prefer one type of currency over another. In some embodiments, the consumer application has a recipient-controlled denomination of payment that is selectable between cryptocurrency and other currencies.

In some embodiments, the desktop application 5422 or website interface 5424 are a web focused application that let small and medium sized enterprises (SMEs) access bitcoin and use it as a payment rail. For example, the web focused application may allow users to choose Bitcoin as one payment option in addition to other payment types, such as credit card payments.

In some embodiments, the web-focused application reduces conventional inefficiencies in the digital world around small-value transactions. For example, a conventional digital newspaper may require multiple dollar recurring subscriptions to read content because facilitation of conventional transactions may cost 20-30 cents per transaction. By using cryptocurrency and hooking directly into the protocol with no intermediaries, the payment infrastructure platform 5400 enables microtransactions at 10 cents or even 1 cent. In some embodiments, businesses using Bitcoin as a rail can access the web-focused application without any prior business relationship.

In addition to enabling microtransactions, the desktop focused application may enable enhanced privacy for users. For example, the conventional recurring subscription by credit card may require the user to disclose identity information, such as a name, an email address, and an address. Use of the web-focused application may further reduce the time to complete transactions by reducing the interaction to one or several mouse clicks. Reducing the time to completion benefits the website by reducing user attrition due to disinterest in spending the time to complete conventional transactions. In some embodiments, the cryptocurrency enables instant delivery of the money, which eliminates charge backs and limits or eliminates fraud risk for the business. Without the risk of non-payment, the business may release the content immediately in response to receiving the payment. In some embodiments, the small transaction size permits the business to incentivize the consumer to give personal information (e.g., email, name, address, etc.) for discounts on the content.

The main user interface 5500 includes a balance type selector 5502, a funding selector 5504, a trade selector 5506, and a code scan selector 5508. The balance type selector 5502 selects between various account currency types. For example, the balance type selector 5502 may permit the user to use a fiat currency bank account, a cryptocurrency wallet, or other accounts with different currency types as the source or destination for transaction funds. The funding selector 5504 permits the user to add funding to the selected account. For example, the user may add British Pounds to a fiat currency account associated with British Pounds. The trade selector 5506 permits the user to trade currency between types. The code scan selector 5508 permits the user to scan a bar or QR code to provide information about a desired transaction.

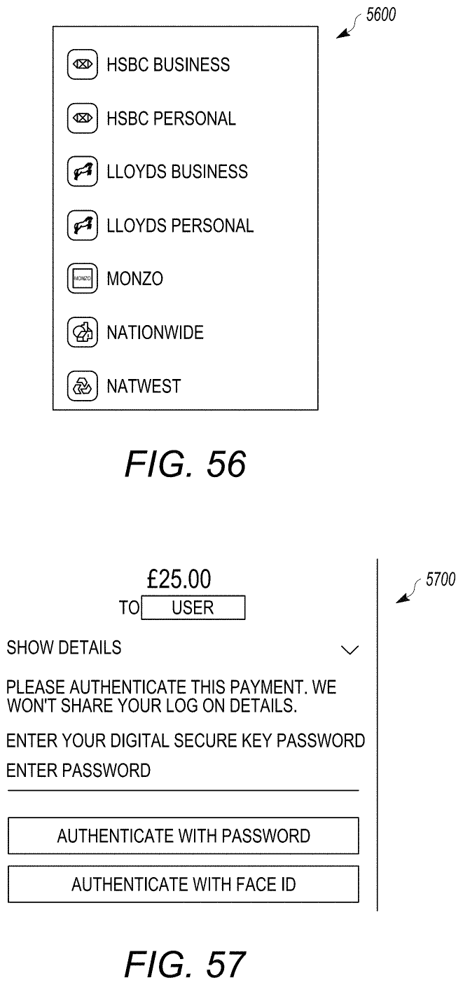

FIG. 56 shows an example of a bank account interface 5600 for a user to create a bank account within the consumer application 5420. For example, the consumer application may access multiple banks with a unified/single API.

FIG. 57 shows an example of a payment authentication interface 5700 for the user to authenticate a payment within the consumer application 5420. For example, the user may authenticate the payment with a password or by approving facial recognition using a camera.

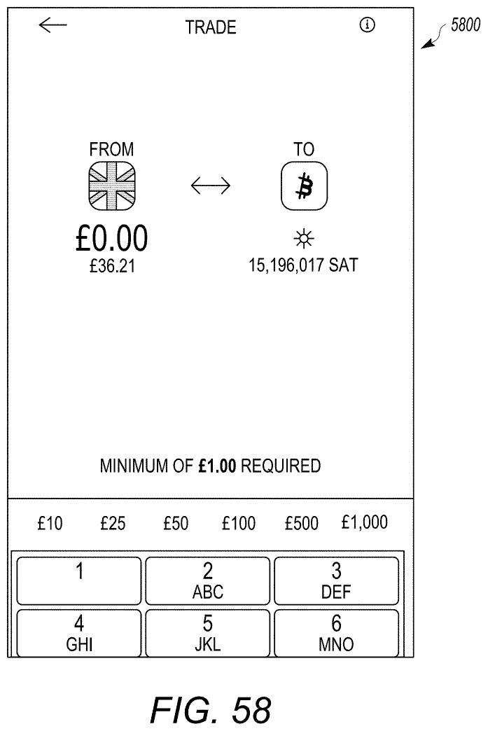

FIG. 58 shows an example of a trading interface 5800 of the consumer application 5420. For example, the consumer application may display the trading interface 5800 in response to user selection of the trade selector 5506. In the example provided, the user is purchasing Bitcoin with British Pounds.

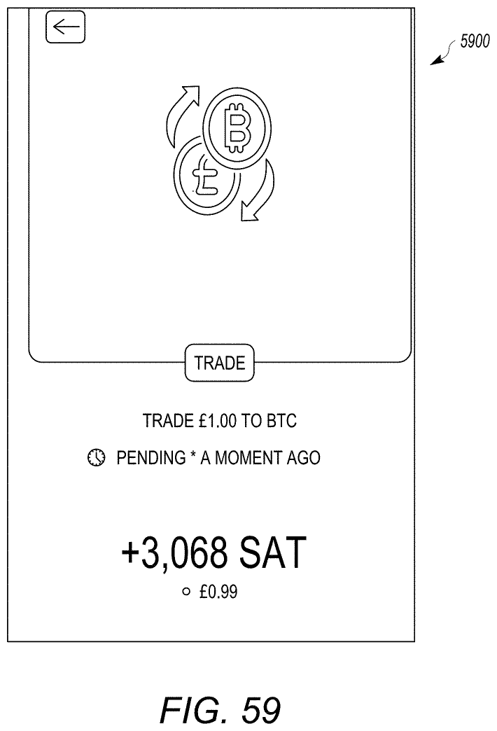

FIG. 59 shows an example of a trade confirmation interface 5900 of the consumer application 5420. For example, the consumer application 5420 may display the trade confirmation interface 5900 in response to user interaction with the trading interface 5800.

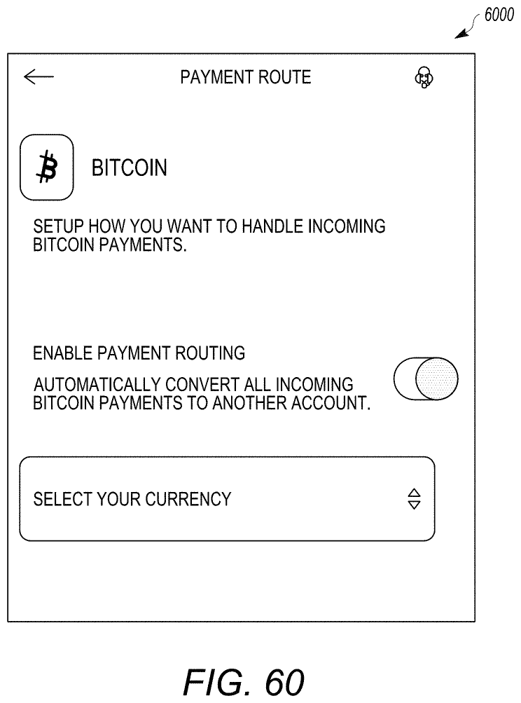

FIG. 60 shows an example of a payment route interface 6000 of the consumer application 5420. The payment route interface 6000 may set an automatic conversion to a specified currency in response to receiving a cryptocurrency payment. For example, if a user selects British Pounds in the payment route interface 6000, then the consumer application 5420 will automatically convert all incoming receipts of cryptocurrency to British Pounds.

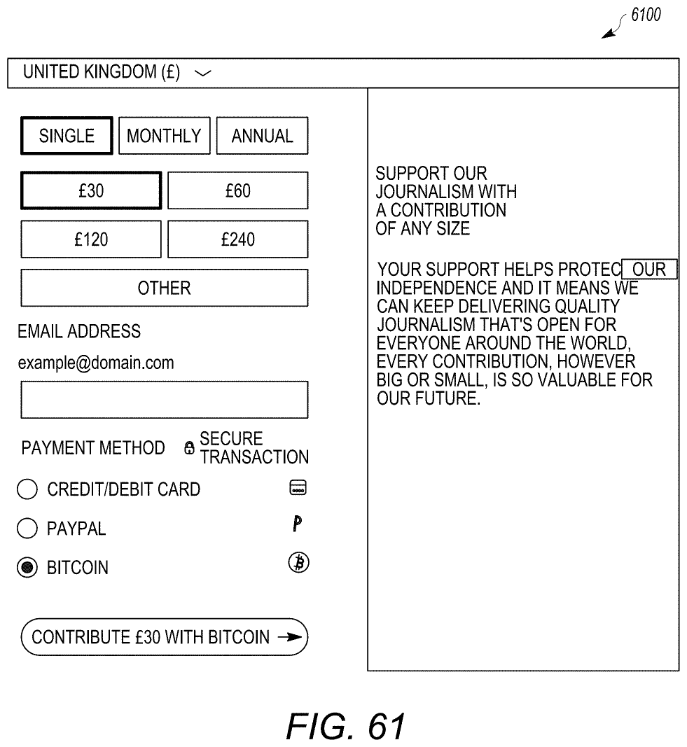

FIG. 61 shows an example of a donation interface 6100 of the website interface 5424. Conventional donation requests on websites often obscure large parts of the screen and take a lot of time to complete. In some embodiments, the donation interface 6100 leverages a payments SDK to open up a new donation channel for Bitcoin users around the globe. In the example provided, the Bitcoin option is a selectable radio button within the payment methods section of the donation interface. In response to user selection of the donate button while the Bitcoin selector is selected, the donation interface 6100 executes a URL re-direct to the payment infrastructure platform domain.

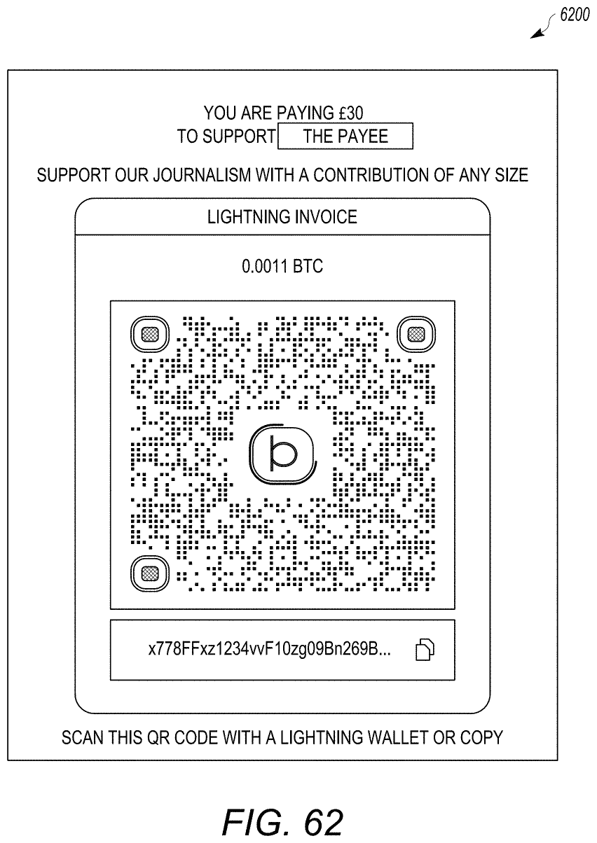

FIG. 62 shows an example of a scan code interface 6200. Scan code interface 6200 may be used to communicate the transaction information to a Lighting application, for example. Accordingly, the transfer may interact with other applications without the need for both parties to the transaction to install the consumer application 5420.

Benefits of the payment infrastructure platform 5400 are readily apparent. For example, a business can keep all currency in fiat on a balance sheet while accessing the benefits of cryptocurrency rails as payment mechanisms. The APIs permit use by existing applications, such as social networks, game, marketplaces, etc. that can leverage with their existing user bases. For example, a wellness network may enable purchases of individual exercise demonstrations inexpensively to monetize users in other countries to unlock monetary benefits without having to change the user experience.

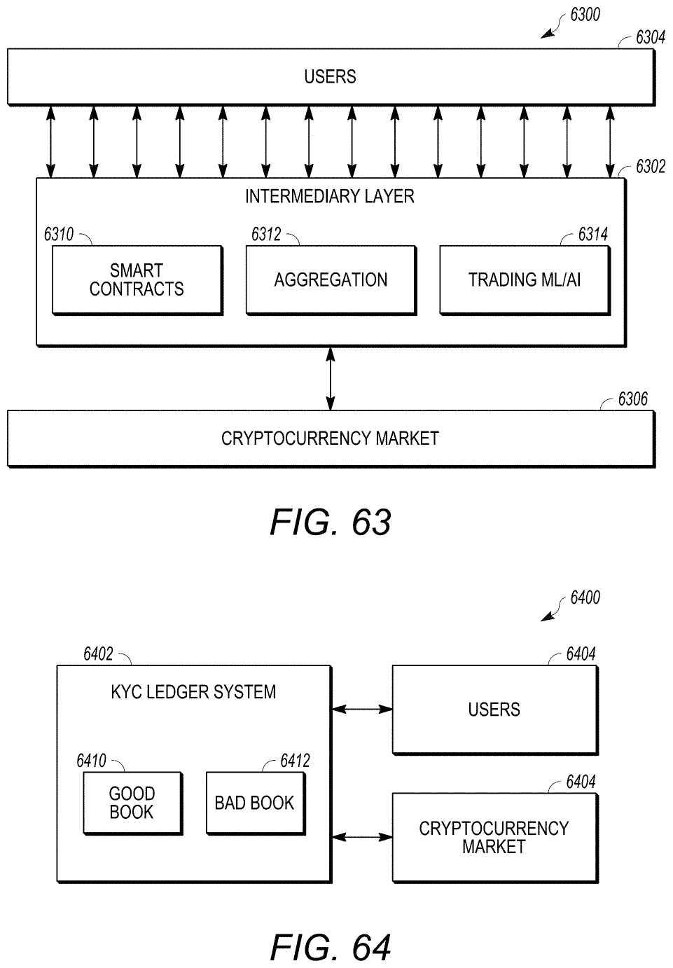

FIG. 63 shows an example of a cryptocurrency intermediary transaction system 6300. In some embodiments, the cryptocurrency intermediary transaction system is executed by the platform 2200. The cryptocurrency intermediary transaction system 6300 includes an intermediary layer 6302 facilitating transactions between users 6304 and a cryptocurrency market 6306. The intermediary transaction system 6300 may be used, for example, to interact with cryptocurrency markets where transactions are slow, have high volatility, or have highly variable liquidity.

The users 6304 may be the users 2304 or may be other users without departing from the scope of the present disclosure. In some embodiments, the users 6304 are making payments using cryptocurrency and/or receiving payments in cryptocurrency. The cryptocurrency market 6306 is a place where the cryptocurrency is typically exchanged for other currency.

The intermediary layer 6302 sends and receives the cryptocurrency to and from the users 6304. In some embodiments, these receipts and payments may be frequent and small in magnitude. Rather than immediately carrying through the receipts and payments to the cryptocurrency market, the intermediary layer utilizes various machine learning techniques to make fewer and potentially larger transactions with the cryptocurrency market 6306. In the embodiment provided, the intermediary layer 6302 includes a smart contracts system 6310, an aggregation system 6312, and a trading machine learning/artificial intelligence (ML/AI) system 6314.

The smart contracts system 6310 executes smart contracts with the users 6124. The smart contracts define conditions that trigger actions when met. For example, a smart contract may define the availability of cryptocurrency at the intermediary layer 6302 as a condition that will trigger the action. In some embodiments, the action may be fiat currency transfer from a cryptocurrency seller of the users 6302 to a cryptocurrency buyer of the users 6302. In some embodiments, the smart contract may define the completion of a batch processed transfer from the cryptocurrency market 6306 to the intermediary layer as the condition for transfer of a subset of the batch processed cryptocurrency to the users 6304.

The aggregation system 6312 aggregates the smaller and more frequent user transfers of cryptocurrency into a larger and less frequent transaction with the cryptocurrency market 6306. In some embodiments, the aggregation system 6312 transfers ownership of cryptocurrency between buying and selling users 6304 and only transacts with the cryptocurrency market 6306 for the net difference.

The trading ML/AI system 6314 evaluates whether conditions are favorable to accumulate or shed positions in cryptocurrency. For example, the trading ML/AI system 6314 may utilize various trend prediction algorithms to determine that future prices of the cryptocurrency may be more advantageous for the transaction, such as delaying sales of the cryptocurrency to the cryptocurrency market 6306 when the trading ML/AI system 6314 determines that prices for the cryptocurrency will rise in the short term. In some embodiments, the ML/AI system 6312 causes the intermediary layer 6302 to maintain a float of cryptocurrency based on the algorithms.

FIG. 64 shows an example of a cryptocurrency know your customer (KYC) system 6400. For example, the cryptocurrency KYC system 6400 may be maintained by the platform 2200. The cryptocurrency KYC system 6400 provides KYC services for users to help identify bad actors or illegal funds with which many businesses and individuals may not want to interact. The cryptocurrency KYC system 6400 includes a KYC ledger system 6402, users 6404, and a cryptocurrency market 6404. Rather than users 6404 directly interacting with the cryptocurrency market 6404, potential transactions pass through the KYC ledger system 6402 to confirm that the participants and/or funds in the transaction have known criminal ties. In some embodiments, the transactions take place directly between the users 6404 and the cryptocurrency market 6404 after clearance by the KYC ledger system 6402.

In the example provided, the KYC ledger system 6402 includes a good book 6410 and a bad book 6412. The good book 6410 stores information indicating ownership by known good actors and the bad book 6412 stores information indicating ownership by known bad actors. For example, good actors may voluntarily provide identifying information to facilitate future transactions or KYC ledger system 6402 may scour public information to match known public transactions with transactions and account information on a Bitcoin block chain. Bad actor information, for example, may be collected by law enforcement or moved from the good book 6410 after the KYC ledger system 6402 discovers specific events. For example, a person on the good book 6410 may move to the bad book 6412 in response to legal convictions for selling contraband. Accordingly, businesses and individuals may actively attempt to avoid trading cryptocurrency with known bad actors.

### General Terminology

Without limitation, services include a financial service (e.g., a loan transaction service), a data collection service (e.g., a data collection service for collecting and monitoring data), a blockchain service (e.g., a blockchain service to maintain secure data), data integration services (e.g., a data integration service to aggregate data), smart contract services (e.g., a smart contract service to determine aspects of smart contracts), software services (e.g., a software service to extract data related to the third-party ecosystem entities, such as a regulated bank, insurer, merchant and the like as described herein), publishing services (e.g., a publishing services to publish data), microservices (e.g., having a set of application programming interfaces that facilitate connection among the microservices), valuation services (e.g., that use a valuation model to set a value for collateral based on information), artificial intelligence services, market value data collection services, including cryptocurrency marketplace data collection services (e.g., that monitor and report on marketplace information), asset identification services (e.g., for identifying a set of assets for which a financial institution has custody), identity management services (e.g., by which a financial institution verifies identities and credentials, including “know-your-customer” and anti-money laundering verification processes), and the like, and/or similar functional terminology. Example services to perform one or more functions herein include computing devices; servers; networked devices; user interfaces; inter-device interfaces such as communication protocols, shared information and/or information storage, and/or application programming interfaces (APIs). One or more aspects or components of services herein may be distributed across a number of devices, and/or may consolidated, in whole or part, on a given device. In embodiments, aspects or components of services herein may be implemented at least in part through circuits, such as, in non-limiting examples, a data collection service implemented at least in part as a data collection circuit structed to collect and monitor data, a blockchain service implemented at least in part as a blockchain circuit structured to maintain secure data, data integration services implemented at least in part as a data integration circuit structured to aggregate data, smart contract services implemented at least in part as a smart contract circuit structed to determine aspects of smart contracts, software services implemented at least in part as a software service circuit structured to extract data related to the ecosystem entities, publishing services implemented at least in part as a publishing services circuit structured to publish data, microservice service implemented at least in part as a microservice circuit structured to interconnect a plurality of service circuits, valuation service implemented at least in part as valuation services circuit structured to access a valuation model to set a value for collateral based on data, artificial intelligence service implemented at least in part as an artificial intelligence services circuit, market value data collection service implemented at least in part as market value data collection service circuit structured to monitor and report on marketplace information, including cryptocurrency marketplace data, asset identification services implemented at least in part as an asset identification service circuit for identifying a set of assets for which a financial institution is responsible for taking custody, identity management services implemented at least in part as an identity management service circuit enabling a financial institution to verify identities and credentials, and the like. Accordingly, the benefits of the present disclosure may be applied in a wide variety of fiat and cryptocurrency-related systems, and any such systems may be considered with respect to items and services herein, while in certain embodiments a given system may not be considered with respect to items and services herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Among the considerations that one of skill in the art may contemplate to determine a configuration for a particular service include: the distribution and access devices available to one or more parties to a particular transaction; jurisdictional limitations on the storage, type, and communication of certain types of information; requirements or desired aspects of security and verification of information communication for the service; the response time of information gathering, inter-party communications, and determinations to be made by algorithms, machine learning components, and/or artificial intelligence components of the service; cost considerations of the service, including capital expenses and operating costs, as well as which party or entity will bear the costs and availability to recover costs such as through subscriptions, service fees, or the like; the amount of information to be stored and/or communicated to support the service; and/or the processing or computing power to be used to support the service.

The terms items and services (and similar terms) as used herein should be understood broadly. Without limitation to any other aspect or description of the present disclosure, items and service include any items and service, including, without limitation, items and services used as a reward, used as collateral, become the subject of a negotiation, and the like, such as, without limitation, an application for a loan or insurance, collateral for a loan, or the like, such as a product, a service, an offering, a solution, a physical product, software, a level of service, quality of service, a financial instrument, a debt, an item of collateral, performance of a service, or other items. Without limitation to any other aspect or description of the present disclosure, items and service include any items and service, including, without limitation, items and services as applied to physical items, a financial item, and the like. Accordingly, the benefits of the present disclosure may be applied in a wide variety of systems, and any such systems may be considered with respect to items and services herein, while in certain embodiments a given system may not be considered with respect to items and services herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system.

The term marketplace information, market value and similar terms as used herein should be understood broadly. Without limitation to any other aspect or description of the present disclosure, marketplace information and market value describe a status or value of an asset, collateral, currency, or service at a defined point or period in time. Market value may refer to the expected value placed on fiat and/or cryptocurrency, an item in a marketplace or auction setting, or pricing or financial data for items that are similar to the item, asset, or collateral in at least one public marketplace. Valuation services may include market value data collection, including but not limited to fiat and cryptocurrency market data, services that monitor and report on marketplace information relevant to the value (e.g., market value, currency value) of collateral, the issuer, a set of bonds, and a set of assets. a set of subsidized loans, a party, and the like. Market and/or currency values may be dynamic in nature because they depend on an assortment of factors, from economic climate to the dynamics of demand and supply. Market and/or currency value may be affected by, and marketplace information may include, demand, underlying current value of an item, a condition of an entity, a contractual status of an entity, a tax status of an entity, a credit status of an entity, a credit rating of an entity, a set of credentials of an entity, a location of an entity, and the like. In certain embodiments, a market value may include information such as a volatility of a value, a sensitivity of a value (e.g., relative to other parameters having an uncertainty associated therewith), and/or a specific value of the valuated object to a particular party (e.g., an object may have more value as possessed by a first party than as possessed by a second party).

The term financial condition and similar terms as used herein should be understood broadly. Without limitation to any other aspect or description of the present disclosure, financial condition describes a current status of an entity's assets, liabilities, and equity positions at a defined point or period in time. The financial condition may be memorialized in a financial statement or other manifestation. The financial condition may further include an assessment of the ability of the entity to survive future risk scenarios or meet future or maturing obligations. Financial condition may be based on a set of attributes of the entity selected from among a publicly stated valuation of the entity, a set of property owned by the entity as indicated by public records, a valuation of a set of property owned by the entity, a bankruptcy condition of an entity, a foreclosure status of an entity, a contractual default status of an entity, a regulatory status of an entity, a tax status of an entity, a credit report of an entity, a credit rating of an entity, a set of credentials of an entity, a set of behavior of an entity, a location of an entity, and the like. A financial condition may also describe a requirement or threshold for a transaction, an agreement or loan. Certain conditions may not be a financial condition. For example, a cryptocurrency balance alone may be a clue as to the financial condition of a consumer but may not be the financial condition on its own. One of skill in the art, having the benefit of the disclosure herein and knowledge about a contemplated system ordinarily available to that person, can readily determine which aspects of the present disclosure include and/or will benefit from a financial condition. Certain considerations for the person of skill in the art, in determining whether the term financial condition is referring to a current status of an entity's assets, liabilities, currency balances, and equity positions at a defined point or period in time and/or for a given purpose include: the reporting of more than one financial data point, the ratio of a loan to value of collateral, including but not limited to cryptocurrency used as collateral, the ratio of the collateral to the loan, the gross transaction/loan amount, the credit scores of the borrower and the lender, and other considerations. While specific examples of financial conditions are described herein for purposes of illustration, any embodiment benefitting from the disclosures herein, and any considerations understood to one of skill in the art having the benefit of the disclosures herein are specifically contemplated within the scope of the present disclosure.

The term interest rate and similar terms, as used herein should be understood broadly. Without limitation to any other aspect or description of the present disclosure, interest rate includes an amount of interest due per period, as a proportion of an amount lent, deposited, or borrowed. The total interest on an amount lent or borrowed may depend on the principal sum, the interest rate, the compounding frequency, and the length of time over which it is lent, deposited, or borrowed. Typically, interest rate is expressed as an annual percentage but can be defined for any time period. The interest rate may relate to the amount a bank or other lender charges to borrow its money, or the rate a bank or other entity pays its savers for keeping money in an account. Interest rate may be variable or fixed. For example, an interest rate may vary in accordance with a government or other stakeholder directive, the currency of the principal sum lent or borrowed, a cryptocurrency balance held by a borrower, the term to maturity of the investment, the perceived default probability of the borrower, supply and demand in the market, the amount of collateral, the status of an economy, or special features like call provisions. In certain embodiments, an interest rate may be a relative rate (e.g., relative to a prime rate, an inflation index, a cryptocurrency holding, etc.). In certain embodiments, an interest rate may further consider costs or fees applied (e.g., “points”) to adjust the interest rate. One of skill in the art, having the benefit of the disclosure herein and knowledge about interest rates, can readily determine the characteristics of an interest rate for a particular embodiment. Certain considerations for the person of skill in the art, or embodiments of the present disclosure with respect to an interest rate include, without limitation: the currency of the principal sum, variables for setting an interest rate, criteria for modifying an interest rate, the anticipated transaction type (loan, bond or debt), the specific type of collateral, the ratio of the loan to value, the ratio of the collateral to the loan, the gross transaction/loan amount, the amount of the principal sum, the appropriate lifespans of transactions and/or collateral for a particular industry, the likelihood that a lender will sell and/or consolidate a loan before the term, and the like. While specific examples of interest rates are described herein for purposes of illustration, any embodiment benefitting from the disclosures herein, and any considerations understood to one of skill in the art having the benefit of the disclosures herein are specifically contemplated within the scope of the present disclosure.

The term valuation services (and similar terms) as used herein should be understood broadly. Without limitation to any other aspect or description of the present disclosure, a valuation service includes any service that sets a value for a good or service. Valuation services may use a valuation model to set a value for collateral based on information from data collection and monitoring services. Smart contract services may process output from the set of valuation services and assign items of collateral sufficient to provide security for a loan and/or apportion value for an item of collateral among a set of lenders and/or transactions. Valuation services may include artificial intelligence services that may iteratively improve the valuation model based on outcome data relating to transactions in collateral. Valuation services may include market value data and cryptocurrency data collection services that may monitor and report on marketplace information relevant to the value of collateral. One of skill in the art, having the benefit of the disclosure herein and knowledge about a contemplated system ordinarily available to that person, can readily determine which aspects of the present disclosure will benefit a particular system and how to combine processes and systems from the present disclosure to enhance operations of the contemplated system and/or to provide a valuation service. Certain considerations for the person of skill in the art, in determining whether a contemplated system is a valuation service and/or whether aspects of the present disclosure can benefit or enhance the contemplated system include, without limitation: perform real-time alterations to a loan based on a value of a collateral and/or a cryptocurrency holding; utilize marketplace data to execute a collateral-backed smart contract; the tendency of the collateral to have a volatile value, be used, and/or be moved; and the like. While specific examples of valuation services and considerations are described herein for purposes of illustration, any system benefitting from the disclosures herein, and any considerations understood to one of skill in the art having the benefit of the disclosures herein, are specifically contemplated within the scope of the present disclosure.

The term collateral and collateral attributes (and similar terms) as used herein should be understood broadly. Collateral attributes may be measured in absolute or relative terms, and/or may include qualitative (e.g., categorical descriptions) or quantitative descriptions. Some collateral attributes, even for a given component of the collateral, may have distinct values depending upon the party of interest (e.g., a party that values an aspect of the collateral more highly than another party, for example a particular cryptocurrency type) and/or depending upon the type of transaction (e.g., the collateral may be more valuable or appropriate for a first type of loan than for a second type of loan). Certain attributes associated with collateral may not be collateral attributes as described herein depending upon the purpose of the collateral attributes herein. One of skill in the art, having the benefit of the disclosure herein and knowledge about contemplated collateral attributes ordinarily available to that person, can readily determine which aspects of the present disclosure will benefit a particular collateral attribute. Certain considerations for the person of skill in the art, in determining whether a contemplated attribute is a collateral attribute and/or whether aspects of the present disclosure can benefit or enhance the contemplated system include, without limitation: the source of the attribute and the source of the value of the attribute (e.g. does the attribute and attribute value comes from a reputable source), the volatility of the attribute (e.g. does the attribute values for the collateral fluctuate, is the attribute a new attribute for the collateral), relative differences in attribute values for similar collateral, exceptional values for attributes (e.g., some attribute values may be high, such as, in the 98th percentile or very low, such as in the 2nd percentile, compared to similar class of collateral), the fungibility of the collateral, the type of transaction related to the collateral, and/or the purpose of the utilization of collateral for a particular party or transaction. While specific examples of collateral attributes and considerations are described herein for purposes of illustration, any system benefitting from the disclosures herein, and any considerations understood to one of skill in the art having the benefit of the disclosures herein, are specifically contemplated within the scope of the present disclosure.

The term blockchain services (and similar terms) as used herein should be understood broadly. Without limitation to any other aspect or description of the present disclosure, blockchain services include any service related to the processing, recordation, and/or updating of a blockchain, and may include services for processing blocks, computing hash values, generating new blocks in a blockchain, appending a block to the blockchain, creating a fork in the blockchain, merging of forks in the blockchain, verifying previous computations, updating a shared ledger, updating a distributed ledger, generating cryptographic keys, verifying transactions, maintaining a blockchain, updating a blockchain, verifying a blockchain, generating random numbers. The services may be performed by execution of computer readable instructions on local computers and/or by remote servers and computers. Certain services may not be considered blockchain services individually but may be considered blockchain services based on the final use of the service and/or in a particular embodiment—for example, a computing a hash value may be performed in a context outside of a blockchain such in the context of secure communication. Some initial services may be invoked without first being applied to blockchains, but further actions or services in conjunction with the initial services may associate the initial service with aspects of blockchains. For example, a random number may be periodically generated and stored in memory; the random numbers may initially not be generated for blockchain purposes but may be used for blockchains. Accordingly, the benefits of the present disclosure may be applied in a wide variety of services, and any such services may be considered blockchain services herein, while in certain embodiments a given service may not be considered a blockchain service herein. One of skill in the art, having the benefit of the disclosure herein and knowledge about a contemplated blockchain service ordinarily available to that person, can readily determine which aspects of the present disclosure can be configured to implement, and/or will benefit, a particular blockchain service. Certain considerations for the person of skill in the art, in determining whether a contemplated service is a blockchain service and/or whether aspects of the present disclosure can benefit or enhance the contemplated system include, without limitation: the application of the service, the source of the service (e.g., if the service is associated with a known or verifiable blockchain service provider), responsiveness of the service (e.g., some blockchain services may have an expected completion time, and/or may be determined through utilization), cost of the service, the amount of data requested for the service, and/or the amount of data generated by the service (blocks of blockchain or keys associated with blockchains may be a specific size or a specific range of sizes). While specific examples of blockchain services and considerations are described herein for purposes of illustration, any system benefitting from the disclosures herein, and any considerations understood to one of skill in the art having the benefit of the disclosures herein, are specifically contemplated within the scope of the present disclosure.

The term blockchain (and variations such as cryptocurrency ledger, and the like) as used herein may be understood broadly to describe a cryptocurrency ledger that records, administrates, or otherwise processes online transactions. A blockchain may be public, private, or a combination thereof, without limitation. A blockchain may also be used to represent a set of digital transactions, agreement, terms, or other digital value. Without limitation to any other aspect or description of the present disclosure, in the former case, a blockchain may also be used in conjunction with investment applications, token-trading applications, and/or digital/cryptocurrency-based marketplaces. A blockchain can also be associated with rendering consideration, such as providing goods, services, items, fees, access to a restricted area or event, data, or other valuable benefit. Blockchains in various forms may be included where discussing a unit of consideration, collateral, currency, cryptocurrency, or any other form of value. One of skill in the art, having the benefit of the disclosure herein and knowledge ordinarily available about a contemplated system, can readily determine the value symbolized or represented by a blockchain. While specific examples of blockchains are described herein for purposes of illustration, any embodiment benefitting from the disclosures herein, and any considerations understood to one of skill in the art having the benefit of the disclosures herein, are specifically contemplated within the scope of the present disclosure.

The terms ledger and distributed ledger (and similar terms) as used herein should be understood broadly. Without limitation to any other aspect or description of the present disclosure, a ledger may be a document, file, computer file, database, book, and the like which maintains a record of transactions. Ledgers may be physical or digital. Ledgers may include records related to sales, accounts, purchases, transactions, assets, liabilities, incomes, expenses, capital, and the like. Ledgers may provide a history of transactions that may be associated with time. Ledgers may be centralized or decentralized/distributed. A centralized ledger may be a document that is controlled, updated, or viewable by one or more selected entities or a clearinghouse and wherein changes or updates to the ledger are governed or controlled by the entity or clearinghouse. A distributed ledger may be a ledger that is distributed across a plurality of entities, participants or regions which may independently, concurrently, or consensually, update, or modify their copies of the ledger. Ledgers and distributed ledgers may include security measures and cryptographic functions for signing, concealing, or verifying content. In the case of distributed ledgers, blockchain technology may be used. In the case of distributed ledgers implemented using blockchain, the ledger may be Merkle trees comprising a linked list of nodes in which each node contains hashed or encrypted transactional data of the previous nodes. Certain records of transactions may not be considered ledgers. A file, computer file, database, or book may or may not be a ledger depending on what data it stores, how the data is organized, maintained, or secured. For example, a list of transactions may not be considered a ledger if it cannot be trusted or verified, and/or if it is based on inconsistent, fraudulent, or incomplete data. Data in ledgers may be organized in any format such as tables, lists, binary streams of data, or the like which may depend on convenience, source of data, type of data, environment, applications, and the like. A ledger that is shared among various entities may not be a distributed ledger, but the distinction of distributed may be based on which entities are authorized to make changes to the ledger and/or how the changes are shared and processed among the different entities. Accordingly, the benefits of the present disclosure may be applied in a wide variety of data, and any such data may be considered ledgers herein, while in certain embodiments a given data may not be considered a ledger herein. One of skill in the art, having the benefit of the disclosure herein and knowledge about contemplated ledgers and distributed ledger ordinarily available to that person, can readily determine which aspects of the present disclosure can be used to implement, and/or will benefit a particular ledger. Certain considerations for the person of skill in the art, in determining whether a contemplated data is a ledger and/or whether aspects of the present disclosure can benefit or enhance the contemplated ledger include, without limitation: the security of the data in the ledger (can the data be tampered or modified), the time associated with making changes to the data in the ledger, cost of making changes (computationally and monetarily), detail of data, organization of data (does the data need to be processed for use in an application), who controls the ledger (can the party be trusted or relied to manage the ledger), confidentiality of the data (who can see or track the data in the ledger), size of the infrastructure, communication requirements (distributed ledgers may require a communication interface or specific infrastructure), resiliency. While specific examples of blockchain services and considerations are described herein for purposes of illustration, any system benefitting from the disclosures herein, and any considerations understood to one of skill in the art having the benefit of the disclosures herein, are specifically contemplated within the scope of the present disclosure.

The term loan (and similar terms) as used herein should be understood broadly. Without limitation to any other aspect or description of the present disclosure, a loan may be an agreement related to an asset that is borrowed, and that is expected to be returned in kind (e.g., money borrowed, and money returned) or as an agreed transaction (e.g., a first good or service is borrowed, and money, a second good or service, or a combination, is returned). Assets may be money, property, time, physical objects, virtual objects, services, a right (e.g., a ticket, a license, or other rights), a depreciation amount, a credit (e.g., a tax credit, an emissions credit, etc.), an agreed assumption of a risk or liability, and/or any combination thereof. A loan may be based on a formal or informal agreement between a borrower and a lender wherein a lender may provide an asset to the borrower for a predefined amount of time, a variable period of time, or indefinitely. Lenders and borrowers may be individuals, entities, corporations, governments, groups of people, organizations, and the like. Loan types may include mortgage loans, personal loans, secured loans, unsecured loans, concessional loans, commercial loans, microloans, and the like. The agreement between the borrower and the lender may specify terms of the loan. The borrower may be required to return an asset or repay with a different asset than was borrowed. In some cases, a loan may require interest to be repaid on the borrowed asset. Borrowers and lenders may be intermediaries between other entities and may never possess or use the asset. In some embodiments, a loan may not be associated with direct transfer of goods but may be associated with usage rights or shared usage rights. In certain embodiments, the agreement between the borrower and the lender may be executed between the borrower and the lender, and/or executed between an intermediary (e.g., a beneficiary of a loan right such as through a sale of the loan). In certain embodiment, the agreement between the borrower and the lender may be executed through services herein, such as through a smart contract service that determines at least a portion of the terms and conditions of the loans, and in certain embodiments may commit the borrower and/or the lender to the terms of the agreement, which may be a smart contract. In certain embodiments, the smart contract service may populate the terms of the agreement and present them to the borrower and/or lender for execution. In certain embodiments, the smart contract service may automatically commit one of the borrower or the lender to the terms (at least as an offer) and may present the offer to the other one of the borrower or the lender for execution. In certain embodiments, a loan agreement may include multiple borrowers and/or multiple lenders, for example where a set of loans includes a number of beneficiaries of payment on the set of loans, and/or a number of borrowers on the set of loans. In certain embodiments, the risks and/or obligations of the set of loans may be individualized (e.g., each borrower and/or lender is related to specific loans of the set of loans), apportioned (e.g., a default on a particular loan has an associated loss apportioned between the lenders), and/or combinations of these (e.g., one or more subsets of the set of loans is treated individually and/or apportioned).

Accordingly, the benefits of the present disclosure may be applied in a wide variety of agreements, and any such agreement may be considered a loan herein, while in certain embodiments a given agreement may not be considered a loan herein. One of skill in the art, having the benefit of the disclosure herein and knowledge about contemplated loans ordinarily available to that person, can readily determine which aspects of the present disclosure implement a loan, utilize a loan, or benefit a particular loan transaction. Certain considerations for the person of skill in the art, in determining whether a contemplated data is a loan and/or whether aspects of the present disclosure can benefit or enhance the contemplated loan include, without limitation: the value of the assets involved, the ability of the borrower to return or repay the loan, the types of assets involved (e.g., whether the asset is consumed through utilization), the repayment time frame associated with the loan, the interest on the loan, how the agreement of the loan was arranged, formality of the agreement, detail of the agreement, the detail of the agreements of the loan, the collateral attributes associated with the loan, and/or the ordinary business expectations of any of the foregoing in a particular context. While specific examples of loans and considerations are described herein for purposes of illustration, any system benefitting from the disclosures herein, and any considerations understood to one of skill in the art having the benefit of the disclosures herein, are specifically contemplated within the scope of the present disclosure.

The term loan-related event(s) (and similar terms, including loan-related events) as used herein should be understood broadly. Without limitation to any other aspect or description of the present disclosure, a loan related events may include any event related to terms of the loan or events triggered by the agreement associated with the loan. Loan-related events may include default on loan, breach of contract, fulfillment, repayment, payment, change in interest, late fee assessment, refund assessment, distribution, and the like. Loan-related events may be triggered by explicit agreement terms; for example—an agreement may specify a rise in interest rate after a time period has elapsed from the beginning of the loan; the rise in interest rate triggered by the agreement may be a loan related event. Loan-related events may be triggered implicitly by related loan agreement terms. In certain embodiments, any occurrence that may be considered relevant to assumptions of the loan agreement, and/or expectations of the parties to the loan agreement, may be considered an occurrence of an event. Loan related events may be related to tasks or requirements that need to be completed by the lender, borrower, or a third party. Certain events may be considered loan-related events in certain embodiments and/or in certain contexts, but may not be considered a loan-related event in another embodiment or context. Many events may be associated with loans but may be caused by external triggers not associated with a loan. However, in certain embodiments, an externally triggered event (e.g., a cryptocurrency price change related to collateral) may be loan-related events. Accordingly, the benefits of the present disclosure may be applied in a wide variety of events, and any such event may be considered a loan related event herein, while in certain embodiments given events may not be considered a loan related event herein. One of skill in the art, having the benefit of the disclosure herein and knowledge about a contemplated system ordinarily available to that person, can readily determine which aspects of the present disclosure may be considered a loan-related event for the contemplated system and/or for particular transactions supported by the system. Certain considerations for the person of skill in the art, in determining whether a contemplated data is a loan related event and/or whether aspects of the present disclosure can benefit or enhance the contemplated transaction system include, without limitation: the impact of the related event on the loan (events that cause default or termination of the loan may have higher impact), the cost (capital and/or operating) associated with the event, the cost (capital and/or operating) associated with monitoring for an occurrence of the event, the entities responsible for responding to the event, a time period and/or response time associated with the event (e.g., time required to complete the event and time that is allotted from the time the event is triggered to when processing or detection of the event is desired to occur), the entity responsible for the event, the data required for processing the event (e.g., confidential information may have different safeguards or restrictions), the availability of mitigating actions if an undetected event occurs, and/or the remedies available to an at-risk party if the event occurs without detection. While specific examples of loan-related events and considerations are described herein for purposes of illustration, any system benefitting from the disclosures herein, and any considerations understood to one of skill in the art having the benefit of the disclosures herein, are specifically contemplated within the scope of the present disclosure.

The terms loan-terms, loan terms, terms for a loan, terms and conditions, and the like as used herein should be understood broadly (“loan terms”). Without limitation to any other aspect or description of the present disclosure, loan terms may relate to conditions, rules, limitations, contract obligations, and the like related to the timing, repayment, origination, and other enforceable conditions agreed to by the borrower and the lender of the loan. Loan terms may be specified in a formal contract between a borrower and the lender. Loan terms may specify aspects of an interest rate, collateral, foreclose conditions, consequence of debt, payment options, payment schedule, a covenant, and the like. Loan terms may be negotiable or may change during the life of a loan. Loan terms may be change or be affected by outside parameters such as market prices, bond prices, conditions associated with a lender or borrower, and the like. Accordingly, the benefits of the present disclosure may be applied in a wide variety of loan aspects, and any such aspect may be considered a loan term herein, while in certain embodiments given aspects may not be considered loan terms herein. One of skill in the art, having the benefit of the disclosure herein and knowledge about a contemplated system ordinarily available to that person, can readily determine which aspects of the present disclosure are loan terms for the contemplated system.

Certain considerations for the person of skill in the art, in determining whether a contemplated data is a loan term and/or whether aspects of the present disclosure can benefit or enhance the contemplated loan include, without limitation: the enforceability of the terms (can the conditions be enforced by the lender or the lender or the borrower), the cost of enforcing the terms (amount of time, or effort required ensure the conditions are being followed), the complexity of the terms (how easily can they be followed or understood by the parties involved, are the terms error prone or easily misunderstood), entities responsible for the terms, fairness of the terms, stability of the terms (how often do they change), observability of the terms (can the terms be verified by a another party), favorability of the terms to one party (do the terms favor the borrower or the lender), risk associated with the loan (terms may depend on the probability that the loan may not be repaid), characteristics of the borrower or lender (their ability to meet the terms), and/or ordinary expectations for the loan and/or related industry.

While specific examples of loan terms are described herein for purposes of illustration, any system benefitting from the disclosures herein, and any considerations understood to one of skill in the art having the benefit of the disclosures herein, are specifically contemplated within the scope of the present disclosure.

The term loan conditions, loan-conditions, conditions for a loan, terms and conditions, and the like as used herein should be understood broadly (“loan conditions”). Without limitation to any other aspect or description of the present disclosure, loan conditions may relate to rules, limits, and/or obligations related to a loan. Loan conditions may relate to rules or necessary obligations for obtaining a loan, for maintaining a loan, for applying for a loan, for transferring a loan, and the like. Loan conditions may include principal amount of debt, a balance of debt, a fixed interest rate, a variable interest rate, a payment amount, a payment schedule, a balloon payment schedule, a specification of collateral, a specification of substitutability of collateral, treatment of collateral, access to collateral, a party, a guarantee, a guarantor, a security, a personal guarantee, a lien, a duration, a covenant, a foreclose condition, a default condition, conditions related to other debts of the borrower, and a consequence of default. Accordingly, the benefits of the present disclosure may be applied in a wide variety of loan aspects, and any such aspect may be considered loan conditions herein, while in certain embodiments given aspects may not be considered loan conditions herein. One of skill in the art, having the benefit of the disclosure herein and knowledge about a contemplated system ordinarily available to that person, can readily determine which aspects of the present disclosure are loan conditions for the contemplated system. Certain considerations for the person of skill in the art, in determining whether a contemplated data is a loan condition and/or whether aspects of the present disclosure can benefit or enhance the contemplated loan include, without limitation: the enforceability of the condition (can the conditions be enforced by the lender or the lender or the borrower), the cost of enforcing the condition (amount of time, or effort required ensure the conditions are being followed), the complexity of the condition (how easily can they be followed or understood by the parties involved, are the conditions error prone or easily misunderstood), entities responsible for the conditions, fairness of the conditions, observability of the conditions (can the conditions be verified by a another party), favorability of the conditions to one party (do the conditions favor the borrower or the lender), risk associated with the loan (conditions may depend on the probability that the loan may not be repaid), and/or ordinary expectations for the loan and/or related industry.

While specific examples of loan conditions are described herein for purposes of illustration, any system benefitting from the disclosures herein, and any considerations understood to one of skill in the art having the benefit of the disclosures herein, are specifically contemplated within the scope of the present disclosure.

The term loan-related action (and other related terms such as loan-related event and loan-related activity) are used herein and may be understood broadly to describe one or multiple actions, events or activities relating to a transaction that includes a loan within the transaction. The action, event or activity may occur in many different contexts of loans, such as lending, refinancing, consolidation, factoring, brokering, foreclosure, administration, negotiating, collecting, procuring, enforcing and data processing (e.g., data collection), or combinations thereof, without limitation. A loan-related action may be used in the form of a noun (e.g. a notice of default has been communicated to the borrower with formal notice, which could be considered a loan-related action). A loan-related action, event, or activity may refer to a single instance, or may characterize a group of actions, events, or activities. For example, a single action such as providing a specific notice to a borrower of an overdue payment may be considered a loan-related action. Similarly, a group of actions from start to finish relating to a default may also be considered a single loan-related action. Appraisal, inspection, funding, and recording, without limitation, may all also be considered loan-related actions that have occurred, as well as events relating to the loan, and may also be loan-related events. Similarly, these activities of completing these actions may also be considered loan-related activities (e.g. appraising, inspecting, funding, recording, etc.), without limitation. In certain embodiments, a smart contract or robotic process automation system may perform loan-related actions, loan-related events, or loan-related activities for one or more of the parties, and process appropriate tasks for completion of the same. In some cases the smart contract may not complete a loan-related action, and depending upon such outcome this may enable an automated action or may trigger other conditions or terms. One of skill in the art, having the benefit of the disclosure herein and knowledge about loan-related actions, events, and activities can readily determine the purposes and use of this term in various forms and embodiments as described throughout the present disclosure.

The term loan-related action, events, and activities, as noted herein, may also more specifically be used to describe a context for payment of a loan. Typically, in transactions involving loans, without limitation, a loan is repaid on a payment schedule. Various actions may be taken to provide a borrower with information to pay back the loan, as well as actions for a lender to receive payment for the loan and the type of currency to be used, such as fiat or cryptocurrency. For example, if a borrower makes a payment on the loan, a loan-related action for payment of the loan may occur. Without limitation, such a payment may comprise several actions that may occur with respect to the payment on the loan, such as: currency selection and/or conversion, the payment being tendered to the lender, the loan ledger or accounting reflecting that a payment has been made, a receipt provided to the borrower of the payment made, and the next payment being requested of the borrower. In some circumstances, a smart contract or process automation system may initiate, administrate, or process such loan-related actions for payment of the loan, which without limitation, may including providing notice to the lender, researching and collecting payment history, providing a receipt to the borrower, providing notice of the next payment due to the borrower, or other actions associated with payment of the loan. One of skill in the art, having the benefit of the disclosure herein and knowledge about loan-related actions for payment of a loan, or other forms of the term and its various forms, can readily determine the purposes and use of this term in the context of an event or other various embodiments and contexts disclosed herein.

The term loan collateral, collateral, item of collateral, collateral item, and the like as used herein should be understood broadly. Without limitation to any other aspect or description of the present disclosure, a loan collateral may relate to any asset or property that a borrower promises to a lender as backup in exchange for a loan, and/or as security for the loan. Collateral may be any item of value that is accepted as an alternate form of repayment in case of default on a loan. Collateral may include any number of physical or virtual items such as a cryptocurrency, a physical good, a consumable item, a precious metal, an item of jewelry, a gemstone, an item of intellectual property, an intellectual property right, a contractual right, an antique, a fixture, an item of equipment, an item of personal property and the like. Collateral may include more than one item or types of items.

A collateral item may describe an asset, a property, a value, or other item defined as a security for a loan or a transaction. A set of collateral items may be defined, and within that set substitution, removal or addition of collateral items may be affected. If a set or plurality of collateral items is defined, substitution, removal or addition of collateral items may be affected, such as substituting, removing, or adding a collateral item to or from a set of collateral items. Without limitation to any other aspect or description of the present disclosure, a collateral item or set of collateral items may also be used in conjunction with other terms to an agreement or loan, such as a representation, a warranty, an indemnity, a covenant, a balance of debt, a fixed interest rate, a variable interest rate, a payment amount, a payment schedule, a balloon payment schedule, a specification of collateral, a specification of substitutability of collateral, a security, a personal guarantee, a lien, a duration, a foreclose condition, a default condition, and a consequence of default. In certain embodiments, a smart contract may calculate whether a borrower has satisfied conditions or covenants and in cases where the borrower has not satisfied such conditions or covenants, may enable automated action, or trigger another conditions or terms that may affect the status, ownership, or transfer of a collateral item, or initiate the substitution, removal, or addition of collateral items to a set of collateral for a loan. One of skill in the art, having the benefit of the disclosure herein and knowledge about collateral items, can readily determine the purposes and use of collateral items in various embodiments and contexts disclosed herein, including the substitution, removal, and addition thereof.

While specific examples of loan collateral are described herein for purposes of illustration, any system benefitting from the disclosures herein, and any considerations understood to one of skill in the art having the benefit of the disclosures herein, are specifically contemplated within the scope of the present disclosure.

The terms value, valuation, valuation model (and similar terms) as used herein should be understood broadly to describe an approach to evaluate and determine the estimated value for collateral. Without limitation to any other aspect or description of the present disclosure, a valuation model may be used in conjunction with: collateral (e.g. a secured property), artificial intelligence services (e.g. to improve a valuation model), data collection and monitoring services (e.g. to set a valuation amount), valuation services (e.g. the process of informing, using, and/or improving a valuation model), and/or outcomes relating to transactions in collateral (e.g. as a basis of improving the valuation model). “Jurisdiction-specific valuation model” is also used as a valuation model used in a specific geographic/jurisdictional area or region; wherein, the jurisdiction can be specific to jurisdiction of the lender, the borrower, the delivery of funds, the payment of the loan or the collateral of the loan, or combinations thereof. In certain embodiments, a jurisdiction-specific valuation model considers jurisdictional effects on a valuation of collateral, including at least: rights and obligations for borrowers and lenders in the relevant jurisdiction(s); jurisdictional effects on the ability to move, import, export, substitute, and/or liquidate the collateral; jurisdictional effects on the timing between default and foreclosure or collection of collateral; and/or jurisdictional effects on the volatility and/or sensitivity of collateral value determinations. In certain embodiments, a geolocation-specific valuation model considers geolocation effects on a valuation of the collateral, which may include a similar list of considerations relative jurisdictional effects (although the jurisdictional location(s) may be distinct from the geolocation(s)), but may also include additional effects, such as: weather-related effects; distance of the collateral from monitoring, maintenance, or seizure services; and/or proximity of risk phenomenon (e.g., fault lines, industrial locations, a nuclear plant, etc.). A valuation model may utilize a valuation of offset collateral (e.g., a similar item of collateral, a generic value such as a market value of similar or fungible collateral, and/or a value of an item that correlates with a value of the collateral) as a part of the valuation of the collateral. In certain embodiments, an artificial intelligence circuit includes one or more machine learning and/or artificial intelligence algorithms, to improve a valuation model, including, for example, utilizing information over time between multiple transactions involving similar or offset collateral, and/or utilizing outcome information (e.g., where loan transactions are completed successfully or unsuccessfully, and/or in response to collateral seizure or liquidation events that demonstrate real-world collateral valuation determinations) from the same or other transactions to iteratively improve the valuation model. In certain embodiments, an artificial intelligence circuit is trained on a collateral valuation data set, for example previously determined valuations and/or through interactions with a trainer (e.g., a human, accounting valuations, and/or other valuation data). In certain embodiments, the valuation model and/or parameters of the valuation model (e.g., assumptions, calibration values, etc.) may be determined and/or negotiated as a part of the terms and conditions of the transaction (e.g., a loan, a set of loans, and/or a subset of the set of loans). One of skill in the art, having the benefit of the disclosure herein and knowledge ordinarily available about a contemplated system, can readily determine which aspects of the present disclosure will benefit a particular application for a valuation model, and how to choose or combine valuation models to implement an embodiment of a valuation model. Certain considerations for the person of skill in the art, or embodiments of the present disclosure in choosing an appropriate valuation model, include, without limitation: the legal considerations of a valuation model given the jurisdiction of the collateral; the data available for a given collateral; the anticipated transaction/loan type(s); the specific type of collateral; the ratio of the loan to value; the ratio of the collateral to the loan; the gross transaction/loan amount; the credit scores of the borrower; accounting practices for the loan type and/or related industry; uncertainties related to any of the foregoing; and/or sensitivities related to any of the foregoing. While specific examples of valuation models and considerations are described herein for purposes of illustration, any embodiment benefitting from the disclosures herein, and any considerations understood to one of skill in the art having the benefit of the disclosures herein, are specifically contemplated within the scope of the present disclosure

The term market value data, or marketplace information, or cryptocurrency marketplace information (and other forms or variations) as used herein may be understood broadly to describe data or information relating to the valuation of a property, asset, collateral, or other valuable items which may be used as the subject of a loan, collateral, or transaction. Market value data or marketplace information may change from time to time, and may be estimated, calculated, or objectively or subjectively determined from various sources of information. Market value data or marketplace information may be related directly to an item of collateral or to an off-set item of collateral. Market value data or marketplace information may include financial data, market ratings, product ratings, customer data, market research to understand customer needs or preferences, competitive intelligence re. competitors, suppliers, and the like, entities sales, transactions, customer acquisition cost, customer lifetime value, brand awareness, churn rate, and the like. The term may occur in many different contexts of contracts or loans, such as lending, refinancing, consolidation, factoring, brokering, foreclosure, and data processing (e.g. data collection), or combinations thereof, without limitation. Market value data or marketplace information may be used as a noun to identify a single figure or a plurality of figures or data. For example, market value data or marketplace information or cryptocurrency marketplace information may be used by a lender to determine if a property or asset will serve as collateral for a secured loan, or may alternatively be used in the determination of foreclosure if a loan is in default, without limitation to these circumstances in use of the term. Marketplace value data or marketplace information may also be used to determine loan-to-value figures or calculations. In certain embodiments, a collection service, smart contract circuit, and/or robotic process automation system may estimate or calculate market value data or marketplace information from one or more sources of data or information. In some cases, market data value or marketplace information, depending upon the data/information contained therein, may enable automated action, or trigger other conditions or terms. One of skill in the art, having the benefit of the disclosure herein and knowledge ordinarily available about a contemplated system and available relevant marketplace information, can readily determine the purposes and use of this term in various forms, embodiments and contexts disclosed herein.

The terms refinance, refinancing activity(ies), refinancing interactions, refinancing outcomes, and similar terms, as used herein should be understood broadly. Without limitation to any other aspect or description of the present disclosure refinance and refinancing activities include replacing an existing mortgage, loan, bond, debt transaction, or the like with a new mortgage, loan, bond, or debt transaction that pays off or ends the previous financial arrangement. In certain embodiments, any change to terms and conditions of a loan, and/or any material change to terms and conditions of a loan, may be considered a refinancing activity. In certain embodiments, a refinancing activity is considered only those changes to a loan agreement that result in a different financial outcome for the loan agreement. Typically, the new loan should be advantageous to the borrower or issuer, and/or mutually agreeable (e.g., improving a raw financial outcome of one, and a security or other outcome for the other). Refinancing may be done to reduce interest rates, lower regular payments, change the loan term, change the collateral associated with the loan, consolidate debt into a single loan, restructure debt, change a type of loan (e.g. variable rate to fixed rate), pay off a loan that is due, in response to an improved credit score, to enlarge the loan, and/or in response to a change in market conditions (e.g. interest rates, value of collateral, and the like).

Refinancing activity may include initiating an offer to refinance, initiating a request to refinance, configuring a refinancing interest rate, configuring a refinancing payment schedule, configuring a refinancing balance in a response to the amount or terms of the refinanced loan, configuring collateral for a refinancing including changes in collateral used, changes in terms and conditions for the collateral, a change in the amount of collateral and the like, managing use of proceeds of a refinancing, removing or placing a lien on different items of collateral as appropriate given changes in terms and conditions as part of a refinancing, verifying title for a new or existing item of collateral to be used to secure the refinanced loan, managing an inspection process title for a new or existing item of collateral to be used to secure the refinanced loan, populating an application to refinance a loan, negotiating terms and conditions for a refinanced loan and closing a refinancing. Refinance and refinancing activities may be disclosed in the context of data collection and monitoring services that collect a training set of interactions between entities for a set of loan refinancing activities. Refinance and refinancing activities may be disclosed in the context of an artificial intelligence system that is trained using the collected training set of interactions that includes both refinancing activities and outcomes. The trained artificial intelligence may then be used to recommend a refinance activity, a currency type, such as a cryptocurrency, evaluate a refinance activity, make a prediction around an expected outcome of refinancing activity, and the like. Refinance and refinancing activities may be disclosed in the context of smart contract systems which may automate a subset of the interactions and activities of refinancing. In an example, a smart contract system may automatically adjust an interest rate for a loan based on information collected, such as a cryptocurrency valuation. The interest rate may be adjusted based on rules, thresholds, model parameters that determine, or recommend, an interest rate for refinancing a loan based on interest rates available to the lender from secondary lenders, risk factors of the borrower (including predicted risk based on one or more predictive models using artificial intelligence), marketing factors (such as competing interest rates offered by other lenders), and the like. Outcomes and events of a refinancing activity may be recorded in a distributed ledger. Based on the outcome of a refinance activity, a smart contract for the refinance loan may be automatically reconfigured to define the terms and conditions for the new loan such as a principal amount of debt, a balance of debt, a fixed interest rate, a variable interest rate, a payment amount, a payment schedule, a balloon payment schedule, a specification of collateral, a specification of substitutability of collateral, a party, a guarantee, a guarantor, a security, a personal guarantee, a lien, a duration, a covenant, a foreclose condition, a default condition, and a consequence of default.

The terms consolidate, consolidation activity(ies), loan consolidation, debt consolidation, consolidation plan, and similar terms, as used herein should be understood broadly. Without limitation to any other aspect or description of the present disclosure consolidate, consolidation activity(ies), loan consolidation, debt consolidation, or consolidation plan are related to the use of a single large loan to pay off several smaller loans, and/or the use of one or more of a set of loans to pay off at least a portion of one or more of a second set of loans. In embodiments, loan consolidation may be secured (i.e., backed by collateral) or unsecured. Loans may be consolidated to obtain a lower interest rate than one or more of the current loans, to reduce total monthly loan payments, and/or to bring a debtor into compliance on the consolidated loans or other debt obligations of the debtor. Loans that may be classified as candidates for consolidation may be determined based on a model that processes attributes of entities involved in the set of loans including identity of a party, interest rate, payment balance, payment terms, payment schedule, type of loan, type of collateral, financial condition of party, payment status, condition of collateral, and value of collateral. Consolidation activities may include managing at least one of identification of loans from a set of candidate loans, preparation of a consolidation offer, preparation of a consolidation plan, preparation of content communicating a consolidation offer, scheduling a consolidation offer, communicating a consolidation offer, negotiating a modification of a consolidation offer, preparing a consolidation agreement, executing a consolidation agreement, modifying collateral for a set of loans, handling an application workflow for consolidation, managing an inspection, managing an assessment, setting an interest rate, deferring a payment requirement, setting a payment schedule, and closing a consolidation agreement. In embodiments, there may be systems, circuits, and/or services configured to create, configure (such as using one or more templates or libraries), modify, set, or otherwise handle (such as in a user interface) various rules, thresholds, conditional procedures, workflows, model parameters, and the like to determine, or recommend, a consolidation action or plan for a lending transaction or a set of loans based on one or more events, conditions, states, actions, or the like. In embodiments, a consolidation plan may be based on various factors, such as the status of payments, interest rates of the set of loans, prevailing interest rates in a platform marketplace or external marketplace, the status of the borrowers of a set of loans, the status of collateral or assets, risk factors of the borrower, the lender, one or more guarantors, market risk factors and the like. Consolidation and consolidation activities may be disclosed in the context of data collection and monitoring services that collect a training set of interactions between entities for a set of loan consolidation activities. consolidation and consolidation activities may be disclosed in the context of an artificial intelligence system that is trained using the collected training set of interactions that includes both consolidation activities and outcomes associated with those activities. The trained artificial intelligence may then be used to recommend a consolidation activity, evaluate a consolidation activity, make a prediction around an expected outcome of consolidation activity, and the like based models including status of debt, condition of collateral or assets used to secure or back a set of loans, the state of a business or business operation (e.g., receivables, payables, or the like), conditions of parties (such as net worth, wealth, debt, location, and other conditions), behaviors of parties (such as behaviors indicating preferences, behaviors indicating debt preferences), and others. Debt consolidation, loan consolidation and associated consolidation activities may be disclosed in the context of smart contract systems which may automate a subset of the interactions and activities of consolidation. In embodiments, consolidation may include consolidation with respect to terms and conditions of sets of loans, selection of appropriate loans, configuration of payment terms for consolidated loans, configuration of payoff plans for pre-existing loans, communications to encourage consolidation, and the like. In embodiments, the artificial intelligence of a smart contract may automatically recommend or set rules, thresholds, actions, parameters and the like (optionally by learning to do so based on a training set of outcomes over time), resulting in a recommended consolidation plan, which may specify a series of actions required to accomplish a recommended or desired outcome of consolidation (such as within a range of acceptable outcomes), which may be automated and may involve conditional execution of steps based on monitored conditions and/or smart contract terms, which may be created, configured, and/or accounted for by the consolidation plan. Consolidation plans may be determined and executed based at least one part on market factors (such as competing interest rates offered by other lenders, values of collateral, and the like) as well as regulatory and/or compliance factors. Consolidation plans may be generated and/or executed for creation of new consolidated loans, for secondary loans related to consolidated loans, for modifications of existing loans related to consolidation, for refinancing terms of a consolidated loan, for foreclosure situations (e.g., changing from secured loan rates to unsecured loan rates), for bankruptcy or insolvency situations, for situations involving market changes (e.g., changes in prevailing interest rates) and others. consolidation.

Certain of the activities related to loans, collateral, entities, and the like may apply to a wide variety of loans and may not apply explicitly to consolidation activities. The categorization of the activities as consolidation activities may be based on the context of the loan for which the activities are taking place. However, one of skill in the art, having the benefit of the disclosure herein and knowledge ordinarily available about a contemplated system can readily determine which aspects of the present disclosure will benefit from a particular application of a consolidation activity, how to choose or combine consolidation activities, how to implement selected services, circuits, and/or systems described herein to perform certain loan consolidation operations, and the like. While specific examples of consolidation and consolidation activities are described herein for purposes of illustration, any embodiment benefitting from the disclosures herein, and any considerations understood to one of skill in the art having the benefit of the disclosures herein, are specifically contemplated within the scope of the present disclosure.

The term smart contract services (and similar terms) as used herein should be understood broadly. Without limitation to any other aspect or description of the present disclosure, a smart contract service includes any service or application that manages a smart contract or a smart lending contract. For example, the smart contract service may specify terms and conditions of a smart contract, such as in a rules database, or process output from a set of valuation services and assign items of collateral sufficient to provide security for a loan. Smart contract services may automatically execute a set of rules or conditions that embody the smart contract, wherein the execution may be based on or take advantage of collected data. Smart contract services may automatically initiate a demand for payment of a loan, automatically initiate a process, automatically initiate an action to claim substitute or backup collateral or transfer ownership of collateral, automatically initiate an inspection process, automatically change a payment, or interest rate term that is based on the collateral, and may also configure smart contracts to automatically undertake a loan-related action. Smart contracts may govern at least one of loan terms and conditions, loan-related events, and loan-related activities. Smart contracts may be agreements that are encoded as computer protocols and may facilitate, verify, or enforce the negotiation or performance of a smart contract. Smart contracts may or may not be one or more of partially or fully self-executing, or partially or fully self-enforcing.

Certain processes may not be considered to be smart-contract related individually, but may be considered smart-contract related in an aggregated system—for example automatically undertaking a loan-related action may not be smart contract-related in one instance, but in another instance, may be governed by terms of a smart contract. Accordingly, the benefits of the present disclosure may be applied in a wide variety of processes systems, and any such processes or systems may be considered a smart contract or smart contract service herein, while in certain embodiments a given service may not be considered a smart contract service herein.

The term smart contract (and other forms or variations) as used herein may be understood broadly to describe a method, system, connected resource or wide area network offering one or more resources useful to assist or perform actions, tasks or things by embodiments disclosed herein. A smart contract may be a set of steps or a process to negotiate, administrate, restructure, or implement an agreement or loan between parties. A smart contract may also be implemented as an application, website, FTP site, server, appliance or other connected component or Internet related system that renders resources to negotiate, administrate, restructure, or implement an agreement or loan between parties. A smart contract may be a self-contained system, or may be part of a larger system or component that may also be a smart contract. For example, a smart contract may refer to a loan or an agreement itself, conditions or terms, or may refer to a system to implement such a loan or agreement. In certain embodiments, a smart contract circuit or robotic process automation system may incorporate or be incorporated into automatic robotic process automation system to perform one or more purposes or tasks, whether part of a loan or transaction process, or otherwise. One of skill in the art, having the benefit of the disclosure herein and knowledge ordinarily available about a contemplated system can readily determine the purposes and use of this term as it relates to a smart contract in various forms, embodiments and contexts disclosed herein.

The term data collection services (and similar terms) as used herein should be understood broadly. Without limitation to any other aspect or description of the present disclosure, a data collection service includes any service that collects data or information, including any circuit, controller, device, or application that may store, transmit, transfer, share, process, organize, compare, report on and/or aggregate data. The data collection service may include data collection devices (e.g., sensors) and/or may be in communication with data collection devices. The data collection service may monitor entities, such as to identify data or information for collection. The data collection service may be event-driven, run on a periodic basis, or retrieve data from an application at particular points in the application's execution. Certain processes may not be considered to be a data collection service individually, but may be considered a data collection service in an aggregated system—for example, a networked storage device may be a component of a data collection service in one instance, but in another instance, may have stand-alone functionality. Accordingly, the benefits of the present disclosure may be applied in a wide variety of processes systems, and any such processes or systems may be considered a data collection service herein, while in certain embodiments a given service may not be considered a data collection service herein. One of skill in the art, having the benefit of the disclosure herein and knowledge about a contemplated system ordinarily available to that person, can readily determine which aspects of the present disclosure will benefit a particular system and how to combine processes and systems from the present disclosure implement a data collection service and/or to enhance operations of the contemplated system. Certain considerations for the person of skill in the art, in determining whether a contemplated system is a data collection service and/or whether aspects of the present disclosure can benefit or enhance the contemplated system include, without limitation: ability to modify a business rule on the fly and alter a data collection protocol; perform real-time monitoring of events; connection of a device for data collection to a monitoring infrastructure, execution of computer readable instructions that cause a processor to log or track events; use of an automated inspection system; occurrence of sales at a networked point-of-sale; need for data from one or more distributed sensors or cameras; and the like. While specific examples of data collection services and considerations are described herein for purposes of illustration, any system benefitting from the disclosures herein, and any considerations understood to one of skill in the art having the benefit of the disclosures herein, are specifically contemplated within the scope of the present disclosure.

The term data integration services (and similar terms) as used herein should be understood broadly. Without limitation to any other aspect or description of the present disclosure, a data integration service includes any service that integrates data or information, including any device or application that may extract, transform, load, normalize, compress, decompress, encode, decode, and otherwise process data packets, signals, and other information. The data integration service may monitor entities, such as to identify data or information for integration. The data integration service may integrate data regardless of required frequency, communication protocol, or business rules needed for intricate integration patterns. Accordingly, the benefits of the present disclosure may be applied in a wide variety of processes systems, and any such processes or systems may be considered a data integration service herein, while in certain embodiments a given service may not be considered a data integration service herein. One of skill in the art, having the benefit of the disclosure herein and knowledge about a contemplated system ordinarily available to that person, can readily determine which aspects of the present disclosure will benefit a particular system and how to combine processes and systems from the present disclosure to implement a data integration service and/or enhance operations of the contemplated system. Certain considerations for the person of skill in the art, in determining whether a contemplated system is a data integration service and/or whether aspects of the present disclosure can benefit or enhance the contemplated system include, without limitation: ability to modify a business rule on the fly and alter a data integration protocol; communication with third party databases to pull in data to integrate with; synchronization of data across disparate platforms; connection to a central data warehouse; data storage capacity, processing capacity, and/or communication capacity distributed throughout the system; the connection of separate, automated workflows; and the like. While specific examples of data integration services and considerations are described herein for purposes of illustration, any system benefitting from the disclosures herein, and any considerations understood to one of skill in the art having the benefit of the disclosures herein, are specifically contemplated within the scope of the present disclosure.

The term computational services (and similar terms) as used herein should be understood broadly. Without limitation to any other aspect or description of the present disclosure, computational services may be included as a part of one or more services, platforms, or microservices, such as blockchain services, data collection services, data integration services, valuation services, smart contract services, data monitoring services, data mining, and/or any service that facilitates collection, access, processing, transformation, analysis, storage, visualization, or sharing of data. Certain processes may not be considered to be a computational service. For example, a process may not be considered a computational service depending on the sorts of rules governing the service, an end product of the service, or the intent of the service. Accordingly, the benefits of the present disclosure may be applied in a wide variety of processes systems, and any such processes or systems may be considered a computational service herein, while in certain embodiments a given service may not be considered a computational service herein. One of skill in the art, having the benefit of the disclosure herein and knowledge about a contemplated system ordinarily available to that person, can readily determine which aspects of the present disclosure will benefit a particular system and how to combine processes and systems from the present disclosure to implement one or more computational service, and/or to enhance operations of the contemplated system. Certain considerations for the person of skill in the art, in determining whether a contemplated system is a computational service and/or whether aspects of the present disclosure can benefit or enhance the contemplated system include, without limitation: agreement-based access to the service; mediate an exchange between different services; provides on demand computational power to a web service; accomplishes one or more of monitoring, collection, access, processing, transformation, analysis, storage, integration, visualization, mining, or sharing of data. While specific examples of computational services and considerations are described herein for purposes of illustration, any system benefitting from the disclosures herein, and any considerations understood to one of skill in the art having the benefit of the disclosures herein, are specifically contemplated within the scope of the present disclosure.

The term financial data as used herein may be understood broadly to describe a collection of financial information about an asset, collateral, currency, including cryptocurrency, or other item or items. Financial data may include revenues, expenses, assets, liabilities, equity, bond ratings, default, return on assets (ROA), return on investment (ROI), past performance, expected future performance, earnings per share (EPS), internal rate of return (IRR), earnings announcements, ratios, statistical analysis of any of the foregoing (e.g. moving averages), and the like. Without limitation to any other aspect or description of the present disclosure, financial data may also be used in conjunction with pricing data and market value data. Financial data may satisfy one or more conditions, or may trigger application of one or more rules of a smart contract. Financial data may be used in conjunction with other forms of data such as market value data, pricing data, accounting data, access data, asset and facility data, worker data, event data, underwriting data, claims data or other forms of data. One of skill in the art, having the benefit of the disclosure herein and knowledge about financial data, can readily determine the purposes and use of pricing data in various embodiments and contexts disclosed herein.

The term party as used herein may be understood broadly to describe a member of an agreement, such as an individual, partnership, corporation, limited liability company or other legal organization. For example, a party may be a primary lender, a secondary lender, a lending syndicate, a corporate lender, a government lender, a bank lender, a secured lender, a bond issuer, a bond purchaser, an unsecured lender, a guarantor, a provider of security, a borrower, a debtor, an underwriter, an inspector, an assessor, an auditor, a valuation professional, a government official, an accountant or other entities having rights or obligations to an agreement, transaction or loan. A party may characterize a different term, such as transaction as in the term multi-party transaction, where multiple parties are involved in a transaction, or the like, without limitation. A party may have representatives that represent or act on its behalf. In certain embodiments, the term party may reference a potential party or a prospective party—for example, an intended lender or borrower interacting with a system, that may not yet be committed to an actual agreement during the interactions with the system. Without limitation to any other aspect or description of the present disclosure, an party may also be used in conjunction with other related parties or terms to an agreement or loan, such as a representation, a warranty, an indemnity, a covenant, a balance of debt, a fixed interest rate, a variable interest rate, a payment amount, a payment schedule, a balloon payment schedule, a specification of collateral, a specification of substitutability of collateral, an entity, a guarantee, a guarantor, a security, a personal guarantee, a lien, a duration, a foreclose condition, a default condition, and a consequence of default. A party may have a set of attributes such as: an identity, a creditworthiness, an activity, a behavior, a business practice, a status of performance of a contract, information about accounts receivable, information about accounts payable, information about the value of collateral, and other types of information, without limitation. In certain embodiments, a smart contract may calculate whether a party has satisfied conditions or covenants and in cases where the party has not satisfied such conditions or covenants, may enable automated action, or trigger other conditions or terms. One of skill in the art, having the benefit of the disclosure herein and knowledge about parties, can readily determine the purposes and use of parties in various embodiments and contexts disclosed herein.

The term party attribute, entity attribute, or party/entity attribute as used herein may be understood broadly to describe a value, characteristic, or status of a party or entity. For example, attributes of a party or entity may be, without limitation: value, quality, location, net worth, price, physical condition, health condition, security, safety, ownership, identity, creditworthiness, activity, behavior, business practice, status of performance of a contract, information about accounts receivable, information about accounts payable, information about the value of collateral, and other types of information, and the like. In certain embodiments, a smart contract may calculate values, status or conditions associated with attributes of a party or entity, and in cases where the party or entity has not satisfied such conditions or covenants, may enable automated action, or trigger other conditions or terms. One of skill in the art, having the benefit of the disclosure herein and knowledge about attributes of a party or entity, can readily determine the purposes and use of these attributes in various embodiments and contexts disclosed herein.

The term lender as used herein may be understood broadly to describe a party to an agreement offering an asset for lending, proceeds of a loan, and may include an individual, partnership, corporation, limited liability company, or other legal organization. For example, a lender may be a primary lender, a secondary lender, a lending syndicate, a corporate lender, a government lender, a bank lender, a secured lender, an unsecured lender, or other party having rights or obligations to an agreement, transaction or loan offering a loan to a borrower, without limitation. A lender may have representatives that represent or act on its behalf. Without limitation to any other aspect or description of the present disclosure, an party may also be used in conjunction with other related parties or terms to an agreement or loan, such as a borrower, a guarantor, a representation, a warranty, an indemnity, a covenant, a balance of debt, a fixed interest rate, a variable interest rate, a payment amount, a payment schedule, a balloon payment schedule, a specification of collateral, a specification of substitutability of collateral, a security, a personal guarantee, a lien, a duration, a foreclose condition, a default condition, and a consequence of default. In certain embodiments, a smart contract may calculate whether a lender has satisfied conditions or covenants and in cases where the lender has not satisfied such conditions or covenants, may enable automated action, a notification or alert, or trigger other conditions or terms. One of skill in the art, having the benefit of the disclosure herein and knowledge about a lender, can readily determine the purposes and use of a lender in various embodiments and contexts disclosed herein.

The terms classify, classifying, classification, categorization, categorizing, categorize (and similar terms) as used herein should be understood broadly. Without limitation to any other aspect or description of the present disclosure, classifying a condition or item may include actions to sort the condition or item into a group or category based on some aspect, attribute, or characteristic of the condition or item where the condition or item is common or similar for all the items placed in that classification, despite divergent classifications or categories based on other aspects or conditions at the time. Classification may include recognition of one or more parameters, features, characteristics, or phenomena associated with a condition or parameter of an item, entity, person, process, item, financial construct, or the like. Conditions classified by a condition classifying system may include a default condition, a foreclosure condition, a condition indicating violation of a covenant, a financial risk condition, a behavioral risk condition, a contractual performance condition, a policy risk condition, a financial health condition, a physical defect condition, a physical health condition, an entity risk condition, and/or an entity health condition. A classification model may automatically classify or categorize items, currencies, entities, process, items, financial constructs or the like based on data received from a variety of sources. The classification model may classify items based on a single attribute or a combination of attributes, and/or may utilize data regarding the items to be classified and a model. The classification model may classify individual items, entities, financial constructs, or groups of the same. A bond may be classified based on the type of bond ((e.g., municipal bonds, corporate bonds, performance bonds, and the like), rate of return, bond rating (3rd party indicator of bond quality with respect to bond issuer's financial strength, and/or ability to bap bond's principal and interest, and the like. Lenders or bond issuers may be classified based on the type of lender or issuer, permitted attributes (e.g., based on income, wealth, location (domestic or foreign), various risk factors, status of issuers, and the like. Borrowers may be classified based on permitted attributes (e.g., income, wealth, total assets, location, credit history), risk factors, current status (e.g., employed, a student), behaviors of parties (such as behaviors indicating preferences, reliability, and the like), and the like. A condition classifying system may classify a student recipient of a loan based on progress of the student toward a degree, the student's grades or standing in their classes, students' status at the school (matriculated, on probation and the like), the participation of a student in a non-profit activity, a deferment status of the student, and the participation of the student in a public interest activity. Conditions classified by a condition classifying system may include a state of a set of collateral for a loan or a state of an entity relevant to a guarantee for a loan. Conditions classified by a condition classifying system may include a medical condition of a borrower, guarantor, subsidizer, or the like. Conditions classified by a condition classifying system may include compliance with at least one of a law, a regulation, or a policy related to a lending transaction or lending institute. Conditions classified by a condition classifying system may include a condition of an issuer for a bond, a condition of a bond, a rating of a loan-related entity, and the like. Conditions classified by a condition classifying system may include an identify of a machine, a component, or an operational mode. Conditions classified by a condition classifying system may include a state or context (such as a state of a machine, a process, a workflow, a marketplace, including a cryptocurrency marketplace, a storage system, a network, a data collector, or the like). A condition classifying system may classify a process involving a state or context (e.g., a data storage process, a network coding process, a network selection process, a data marketplace process, a power generation process, a manufacturing process, a refining process, a digging process, a boring process, and/or other process described herein. A condition classifying system may classify a set of loan refinancing actions based on a predicted outcome of the set of loan refinancing actions. A condition classifying system may classify a set of loans as candidates for consolidation based on attributes such as identity of a party, an interest rate, a payment balance, payment terms, payment schedule, a type of loan, a type of collateral, a financial condition of party, a payment status, a condition of collateral, a value of collateral, and the like. A condition classifying system may classify the entities involved in a set of factoring loans, bond issuance activities, mortgage loans, and the like. A condition classifying system may classify a set of entities based on projected outcomes from various loan management activities. A condition classifying system may classify a condition of a set of issuers based on information from Internet of Things data collection and monitoring services, a set of parameters associated with an issuer, a set of social network monitoring and analytic services, and the like. A condition classifying system may classify a set of loan collection actions, loan consolidation actions, loan negotiation actions, loan refinancing actions and the like based on a set of projected outcomes for those activities and entities.

The term insuring (and similar terms) as used herein should be understood broadly. Without limitation to any other aspect or description of the present disclosure, insuring includes any insuring, including, without limitation, providing insurance for a loan, providing evidence of insurance for an asset related to a loan, a first entity accepting a risk or liability for another entity, and the like. Insuring, or insurance, may be a mechanism through which a holder of the insurance is provided protection from a financial loss, such as in a form of risk management against the risk of a contingent or uncertain loss. The insuring mechanism may provide for an insurance, determine the need for an insurance, determine evidence of insurance, and the like, such as related to an asset, transaction for an asset, loan for an asset, security, and the like. An entity which provides insurance may be known as an insurer, insurance company, insurance carrier, underwriter, and the like. For instance, a mechanism for insuring may provide a financial entity with a mechanism to determine evidence of insurance for an asset related to a loan. In a non-limiting example, an insurance service circuit may be structured to determine an evidence condition of insurance for an asset based on a plurality of insurance information components with respect to a financial entity configured to determine a loan condition for an asset. In certain embodiments, components may be considered insuring for some purposes but not for other purposes—for example, a blockchain and smart contract platform may be used to manage aspects of a loan transaction such as for identity and confidentiality but may alternately be used to aggregate identity and behavior information for insurance underwriting. Accordingly, the benefits of the present disclosure may be applied in a wide variety of systems, and any such systems may be considered insuring herein, while in certain embodiments a given system may not be considered insuring herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is insuring and/or whether aspects of the present disclosure can benefit or enhance the contemplated system include, without limitation: insurance facilities such as branches, offices, storage facilities, data centers, underwriting operations and others; insurance claims, such as for business interruption insurance, product liability insurance, insurance on goods, facilities, or equipment, flood insurance, insurance for contract-related risks, and many others, as well as claims data relating to product liability, general liability, workers compensation, injury and other liability claims and claims data relating to contracts, such as supply contract performance claims, product delivery requirements, contract claims, claims for damages, claims to redeem points or rewards, claims of access rights, warranty claims, indemnification claims, energy production requirements, delivery requirements, timing requirements, milestones, key performance indicators and others; insurance-related lending; an insurance service, an insurance brokerage service, a life insurance service, a health insurance service, a retirement insurance service, a property insurance service, a casualty insurance service, a finance and insurance service, a reinsurance service; a blockchain and smart contract platform for aggregating identity and behavior information for insurance underwriting; identities of applicants for insurance, identities of parties that may be willing to offer insurance, information regarding risks that may be insured (of any type, without limitation, such as property, life, travel, infringement, health, home, commercial liability, product liability, auto, fire, flood, casualty, retirement, unemployment; distributed ledger may be used to facilitate offering and underwriting of microinsurance, such as for defined risks related to defined activities for defined time periods that are narrower than for typical insurance policies; providing insurance for a loan, providing evidence of insurance for property related to a loan; and the like.

The term payment (and similar terms) as used herein should be understood broadly. Without limitation to any other aspect or description of the present disclosure, a payment includes any payment including, without limitation, an action or process of paying (e.g., a payment to a loan) or of being paid (e.g., a payment from insurance), an amount paid or payable (e.g., a payment of $1000 being made), a repayment (e.g., to pay back a loan), a mode of payment (e.g., use of loyalty programs, rewards points, or particular currencies, including fiat and cryptocurrencies) and the like. Certain components may not be considered payments individually but may be considered payments in an aggregated system—for example, submitting an amount of money may not be considered a payment as such, but when applied to a payment to satisfy the requirement of a loan may be considered a payment (or repayment). For instance, a data collection circuit may provide lenders a mechanism to monitor repayments of a loan. In a non-limiting example, the data collection circuit may be structured to monitor the payments of a plurality of loan components with respect to a financial loan contract configured to determine a loan condition for an asset. In certain embodiments, a payment may be considered a payment for some purposes but not for other purposes—for example, a payment to a financial entity may be for a repayment amount to pay back the loan, or it may be to satisfy a collateral obligation in a loan default condition. Additionally, in certain embodiments, otherwise similar looking systems may be differentiated in determining whether such system are related to a payment, and/or which type of payment. For example, funds, including cryptocurrency, may be applied to reserve an accommodation or to satisfy the delivery of services after the accommodation has been satisfied. Accordingly, the benefits of the present disclosure may be applied in a wide variety of systems, and any such systems may be considered a payment herein, while in certain embodiments a given system may not be considered a payment herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is a payment and/or whether aspects of the present disclosure can benefit or enhance the contemplated system include, without limitation, deferring a required payment; deferring a payment requirement; payment of a loan; a payment amount; a payment schedule; a balloon payment schedule; payment performance and satisfaction; modes of payment; and the like.

The term interface, regulated interface, market interface, cryptocurrency market interface, and the like as used herein may be understood broadly to describe a component by which interaction or communication is achieved, such as a component of a computer, which may be embodied in software, hardware, or a combination thereof. For example, an interface may serve a number of different purposes or be configured for different applications or contexts, such as, without limitation: an application programming interface, a graphic user interface, user interface, software interface, marketplace interface, demand aggregation interface, crowdsourcing interface, secure access control interface, network interface, data integration interface or a cloud computing interface, or combinations thereof. An interface may serve to act as a way to enter, receive or display data, within the scope of lending, refinancing, collection, consolidation, factoring, brokering or foreclosure, without limitation. An interface may serve as an interface for another interface. Without limitation to any other aspect or description of the present disclosure, an interface may be used in conjunction with applications, processes, modules, services, layers, devices, components, machines, products, sub-systems, interfaces, connections, or as part of a system. In certain embodiments, an interface may be embodied in software, hardware, or a combination thereof, as well as stored on a medium or in memory. One of skill in the art, having the benefit of the disclosure herein and knowledge about an interface, can readily determine the purposes and use of an interface in various embodiments and contexts disclosed herein.

The term graphical user interface as used herein may be understood as a type of interface to allow a user to interact with a system, computer, or other interfaces, in which interaction or communication is achieved through graphical devices or representations. A graphical user interface may be a component of a computer, which may be embodied in computer readable instructions, hardware, or a combination thereof. A graphical user interface may serve a number of different purposes or be configured for different applications or contexts. Such an interface may serve to act as a way to receive or display data using visual representation, stimulus or interactive data, without limitation. A graphical user interface may serve as an interface for another graphical user interface or other interfaces. Without limitation to any other aspect or description of the present disclosure, a graphical user interface may be used in conjunction with applications, processes, modules, services, layers, devices, components, machines, products, sub-systems, interfaces, connections, or as part of a system. In certain embodiments, a graphical user interface may be embodied in computer readable instructions, hardware, or a combination thereof, as well as stored on a medium or in memory. Graphical user interfaces may be configured for any input types, including keyboards, a mouse, a touch screen, and the like. Graphical user interfaces may be configured for any desired user interaction environments, including for example a dedicated application, a web page interface, or combinations of these. One of skill in the art, having the benefit of the disclosure herein and knowledge about a graphical user interface, can readily determine the purposes and use of a graphical user interface in various embodiments and contexts disclosed herein.

The term user interface as used herein may be understood as a type of interface to allow a user to interact with a system, computer, or other apparatus, in which interaction or communication is achieved through graphical devices or representations. A user interface may be a component of a computer, which may be embodied in software, hardware, or a combination thereof. The user interface may be stored on a medium or in memory. User interfaces may include drop-down menus, tables, forms, or the like with default, templated, recommended, or pre-configured conditions. In certain embodiments, a user interface may include voice interaction. Without limitation to any other aspect or description of the present disclosure, a user interface may be used in conjunction with applications, circuits, controllers, processes, modules, services, layers, devices, components, machines, products, sub-systems, interfaces, connections, or as part of a system. User interfaces may serve a number of different purposes or be configured for different applications or contexts. For example, a lender-side user interface may include features to view a plurality of customer profiles but may be restricted from making certain changes. A debtor-side user interface may include features to view details and make changes to a user account. A 3rd party neutral-side interface (e.g., a 3rd party not having an interest in an underlying transaction, such as a regulator, auditor, etc.) may have features that enable a view of company oversight and anonymized user data without the ability to manipulate any data and may have scheduled access depending upon the 3rd party and the purpose for the access. A 3rd party interested-side interface (e.g., a 3rd party that may have an interest in an underlying transaction, such as a collector, debtor advocate, investigator, partial owner, etc.) may include features enabling a view of particular user data with restrictions on making changes. Many more features of these user interfaces may be available to implements embodiments of the systems and/or procedures described throughout the present disclosure. Accordingly, the benefits of the present disclosure may be applied in a wide variety of processes and systems, and any such processes or systems may be considered a service herein. One of skill in the art, having the benefit of the disclosure herein and knowledge about a user interface, can readily determine the purposes and use of a user interface in various embodiments and contexts disclosed herein. Certain considerations for the person of skill in the art, in determining whether a contemplated interface is a user interface and/or whether aspects of the present disclosure can benefit or enhance the contemplated system include, without limitation: configurable views, ability to restrict manipulation or views, report functions, ability to manipulate user profile and data, implement regulatory requirements, provide the desired user features for borrowers, lenders, and 3rd parties, and the like.

Interfaces and dashboards as used herein may further be understood broadly to describe a component by which interaction or communication is achieved, such as a component of a computer, which may be embodied in software, hardware, or a combination thereof. Interfaces and dashboards may acquire, receive, present, or otherwise administrate an item, service, offering or other aspects of a transaction or loan. For example, interfaces and dashboards may serve a number of different purposes or be configured for different applications or contexts, such as, without limitation: an application programming interface, a graphic user interface, user interface, software interface, marketplace interface, demand aggregation interface, crowdsourcing interface, secure access control interface, network interface, data integration interface or a cloud computing interface, or combinations thereof. An interface or dashboard may serve to act as a way to receive or display data, within the context of lending, refinancing, collection, consolidation, factoring, brokering or foreclosure, without limitation. An interface or dashboard may serve as an interface or dashboard for another interface or dashboard. Application programming interfaces may include, be enabled by, integrate with, or interface with a real time operating system. Without limitation to any other aspect or description of the present disclosure, an interface may be used in conjunction with applications, circuits, controllers, processes, modules, services, layers, devices, components, machines, products, sub-systems, interfaces, connections, or as part of a system. In certain embodiments, an interface or dashboard may be embodied in computer readable instructions, hardware, or a combination thereof, as well as stored on a medium or in memory. One of skill in the art, having the benefit of the disclosure herein and knowledge ordinarily available about a contemplated system, can readily determine the purposes and use of interfaces and/or dashboards in various embodiments and contexts disclosed herein.

The term “reward” as used herein includes a loyalty award, bonus, prize, incentive (and variations) as used herein may be understood broadly to describe a thing or consideration received or provided in response to an action or stimulus. Rewards can be of a financial type, or non-financial type, without limitation. A specific type of reward may also serve a number of different purposes or be configured for different applications or contexts, such as, without limitation: a reward event, claims for rewards, rewards for consumer loyalty rewards for consumer purchases, monetary rewards, rewards captured as a data set, rewards points, and other forms of rewards. Rewards may be triggered, allocated, generated for innovation, provided for the submission of evidence, requested, offered, selected, administrated, managed, configured, allocated, conveyed, identified, without limitation, as well as other actions. Systems may be used to perform the aforementioned actions. Rewards in various forms may be included where discussing a particular behavior, or encouragement of a particular behavior, without limitation. In certain embodiments herein, a reward may be used as a specific incentive (e.g., rewarding a particular person that responds to a crowdsourcing request) or as a general incentive (e.g., providing a reward responsive to a successful crowdsourcing request, in addition to or alternatively to a reward to the particular person that responded). One of skill in the art, having the benefit of the disclosure herein and knowledge about a reward, can readily determine the value of a reward implemented in an embodiment. While specific examples of rewards are described herein for purposes of illustration, any embodiment benefitting from the disclosures herein, and any considerations understood to one of skill in the art having the benefit of the disclosures herein, are specifically contemplated within the scope of the present disclosure.

The term allocation of reward (and variations) as used herein may be understood broadly to describe a thing or consideration allocated or provided as consideration, or provided for a purpose. The allocation of rewards can be of a financial type, including but not limited to fiat and/or cryptocurrency, or non-financial type, without limitation. A specific type of allocation of reward may also serve a number of different purposes or be configured for different applications or contexts, such as, without limitation: a reward event, claims for rewards, monetary rewards, rewards captured as a data set, rewards points, and other forms of rewards. Thus, an allocation of rewards may be provided as a consideration within the context of a loan or agreement. Systems may be used to allocate rewards. The allocation of rewards in various forms may be included where discussing a particular behavior, or encouragement of a particular behavior, without limitation. An allocation of a reward may include an actual dispensation of the award, and/or a recordation of the reward. The allocation of rewards may be performed by a smart contract circuit or a robotic processing automation system. One of skill in the art, having the benefit of the disclosure herein and knowledge ordinarily available about a contemplated system, can readily determine the value of the allocation of rewards in an embodiment. While specific examples of the allocation of rewards are described herein for purposes of illustration, any embodiment benefitting from the disclosures herein, and any considerations understood to one of skill in the art having the benefit of the disclosures herein, are specifically contemplated within the scope of the present disclosure.

The term “artificial intelligence” (AI, machine learning/artificial intelligence, ML/AI, and the like) as used herein should be understood broadly. Without limitation to any other aspect of the present disclosure, an AI solution includes a coordinated group of AI related aspects to perform one or more tasks or operations as set forth throughout the present disclosure. An example AI solution includes one or more AI components, including any AI components set forth herein, including at least a neural network, an expert system, and/or a machine learning component. The example AI solution may include as an aspect the types of components of the solution, such as a heuristic AI component, a model-based AI component, a neural network of a selected type (e.g., recursive, convolutional, perceptron, etc.), and/or an AI component of any type having a selected processing capability (e.g., signal processing, speech processing, text recognition, etc.). Without limitation to any other aspect of the present disclosure, a given AI solution may be formed from the number and type of AI components of the AI solution, the connectivity of the AI components (e.g., to each other, to inputs from a system including or interacting with the AI solution, and/or to outputs to the system including or interacting with the AI solution). The given AI solution may additionally be formed from the connection of the AI components to each other within the AI solution, and to boundary elements (e.g., inputs, outputs, stored intermediary data, etc.) in communication with the AI solution. The given AI solution may additionally be formed from a configuration of each of the AI components of the AI solution, where the configuration may include aspects such as: model calibrations for an AI component; connectivity and/or flow between AI components (e.g., serial and/or parallel coupling, feedback loops, logic junctions, etc.); the number, selected input data, and/or input data processing of inputs to an AI component; a depth and/or complexity of a neural network or other components; a training data description of an AI component (e.g., training data parameters such as content, amount of training data, statistical description of valid training data, etc.); and/or a selection and/or hybrid description of a type for an AI component. An AI solution includes a selection of AI elements, flow connectivity of those AI elements, and/or configuration of those AI elements.

One of skill in the art, having the benefit of the present disclosure, can readily determine an AI solution for a given system, and/or configure operations to perform a selection and/or configuration operation for an AI solution for a given system. Certain considerations to determining an AI solution, and/or configuring operations to perform a selection and/or configuration operation for an AI solution include, without limitation: an availability of AI components and/or component types for a given implementation; an availability of supporting infrastructure to implement given AI components (e.g., data input values available, including data quality, level of service, resolution, sampling rate, etc.; availability of suitable training data for a given AI solution; availability of expert inputs, such as for an expert system and/or to develop a model training data set; regulatory and/or policy based considerations including permitted action by the AI solution, requirements for acquisition and/or retention of sensitive data, difficult to obtain data, and/or expensive data); operational considerations for a system including or interacting with the AI solution, including response time specifications, safety considerations, liability considerations, etc.; available computing resources such as processing capability, network communication capability, and/or memory storage capability (e.g., to support initial data, training data, input data such as cached, buffered, or stored input data, iterative improvement state data, output data such as cached, buffered, or stored output data, and/or intermediate data storage, such as data to support ongoing calculations, historical data, and/or accumulation data); the types of tasks to be performed by the AI solution, and the suitability of AI components for those tasks, sensitivity of AI components performing the tasks (e.g., variability of the output space relative to a disturbance size of the input space); the interactions of AI components within the entire AI solution (e.g., a low capability rationality AI component may be coupled with a higher capability AI component that may provide high sensitivity and/or unbounded response to inputs); and/or model implementation considerations (e.g., requirements to re-calibrate, aging constraints of a model, etc.).

A selected and/or configured AI solution may be used with any of the systems, procedures, and/or aspects of embodiments as set forth throughout the present disclosure. For example, a system utilizing an expert system may include the expert system as all or a part of a selected, configured AI solution. In another example, a system utilizing a neural network, and/or a combination of neural networks, may include the neural network(s) as all or a part of a selected, configured AI solution. The described aspects of an AI solution, including the selection and configuration of the AI solution, are non-limiting illustrations.

As used herein, “currency” should be understood to encompass fiat currency issued or regulated by governments, cryptocurrencies, tokens of value, tickets, loyalty points, rewards points, coupons, and other elements that represent or may be exchanged for value.

External data sources may include behavioral data sources, such as automated agent behavioral data sources (such as tracking and reporting on behavior of automated agents that are used for conversation and dialog management, agents used for control functions for machines and systems, agents used for purchasing and sales, agents used for data collection, agents used for advertising, and others), human behavioral data sources (such as data sources tracking online behavior, mobility behavior, energy consumption behavior, energy production behavior, network utilization behavior, compute and processing behavior, resource consumption behavior, resource production behavior, purchasing behavior, attention behavior, social behavior, and others), and entity behavioral data sources (such as behavior of business organizations and other entities, such as purchasing behavior, consumption behavior, production behavior, market activity, merger and acquisition behavior, transaction behavior, location behavior, and others). The IoT, social and behavioral data from and about sensors, machines, humans, entities, and automated agents may collectively be used to populate expert systems, machine learning systems, and other intelligent systems and engines described throughout this disclosure, such as being provided as inputs to deep learning systems and being provided as feedback or outcomes for purposes of training, supervision, and iterative improvement of systems for prediction, forecasting, classification, automation and control. The data may be organized as a stream of events. The data may be stored in a distributed ledger or other distributed system. The data may be stored in a knowledge graph where nodes represent entities and links represent relationships. The external data sources may be queried via various database query functions. The external data sources may be accessed via APIs, brokers, connectors, protocols like REST and SOAP, and other data ingestion and extraction techniques. Data may be enriched with metadata and may be subject to transformation and loading into suitable forms for consumption by the engines, such as by cleansing, normalization, de-duplication, and the like.

In embodiments, data handling layers may include a financial, currency and transactional monitoring systems layer, a financial and transactional entity-oriented data storage systems layer (referred to in some cases herein for convenience simply as a data storage layer), an adaptive intelligent systems layer and a financial and transactional management application platform layer. Each of the data handling layers may include a variety of services, programs, applications, workflows, systems, components, and modules, as further described herein and in the documents incorporated herein by reference. In embodiments, each of the data handling layers (and optionally the transactional, financial and marketplace enablement system as a whole) is configured such that one or more of its elements can be accessed as a service by other layers or by other systems (e.g., being configured as a platform-as-a-service deployed on a set of cloud infrastructure components in a microservices architecture). For example, a data handling layer may have a set of application programming interfaces, such as application programming interfaces (APIs), brokers, services, connectors, wired or wireless communication links, ports, human-accessible interfaces, software interfaces or the like by which data may be exchanged between the data handling layer and other layers, systems or sub-systems of the cryptocurrency payment and distribution platform, as well as with other systems, such as financial entities or external systems, such as cloud-based or on-premises enterprise systems (e.g., accounting systems, resource management systems, CRM systems, supply chain management systems and many others. Each of the data handling layers may include a set of services (e.g., microservices), for data handling, including facilities for data extraction, transformation and loading; data cleansing and deduplication facilities; data normalization facilities; data synchronization facilities; data security facilities; computational facilities (e.g., for performing pre-defined calculation operations on data streams and providing an output stream); compression and de-compression facilities; analytic facilities (such as providing automated production of data visualizations) and others.

In embodiments, each data handling layer may have a set of application programming interfaces for automating data exchange with each of the other data handling layers. These may include data integration capabilities, such as for extracting, transforming, loading, normalizing, compression, decompressing, encoding, decoding, and otherwise processing data packets, signals, and other information as it exchanged among the layers and/or the applications, such as transforming data from one format or protocol to another as needed in order for one layer to consume output from another. In embodiments, the data handling layers are configured in a topology that facilitates shared data collection and distribution across multiple applications and uses within the transactional, financial and marketplace enablement system by the financial and transactional monitoring systems layer. The financial and transactional monitoring systems layer may include, integrate with, and/or cooperate with various data collection and management systems, referred to for convenience in some cases as data collection systems, for collecting and organizing data collected from or about financial and transactional entities, as well as data collected from or about the various data handling layers or services or components thereof. In embodiments, the monitoring systems layer may facilitate alignment, such as time-synchronization, normalization, or the like of data that is collected with respect to one or more entities.

In embodiments, data handling layers may be configured in a topology that facilitates shared or common data storage across multiple applications by financial and transactional entities. For example, various data collected about financial entities, as well as data produced by the other data handling layers, may be stored in the data storage layer, such that any of the services, applications, programs, or the like of the various data handling layers can access a common data source (which may comprise a single logical data source that is distributed across disparate physical and/or virtual storage locations). This may facilitate a dramatic reduction in the amount of data storage required to handle the enormous amount of data produced by or about entities. For example, prediction may be used with respect to resupply of currency or other items. In embodiments, the data storage systems layer may provide an extremely rich environment for collection of data that can be used for extraction of features or inputs for intelligence systems, such as expert systems, artificial intelligence systems, process automation systems, machine learning systems, deep learning systems, supervised learning systems, or other intelligent systems as disclosed throughout this disclosure and the documents incorporated herein by reference. As a result, each application in the cryptocurrency payment and distribution platform and each adaptive intelligent system can benefit from the data collected or produced by or for each of the others. A wide range of data types may be stored in the storage layer using various storage media and data storage types and formats, including, without limitation: asset and facility data (such as asset identity data, transactional data, event data, state data, workflow data, maintenance data, pricing data, ownership data, transferability data, and many other types of data relating to an asset (which may be a physical asset, digital asset, a currency asset, virtual asset, financial asset, securities asset, or other asset); event data (including process events, transaction events, exchange events, pricing events, promotion events, discount events, rebate events, reward events, point utilization events, financial events, and many others); claims data (such as relating to insurance claims, such as for director's and officer's insurance, and many others; accounting data (such as data relating to debits, credits, costs, prices, profits, margins, rates of return, valuation, write-offs, and many others); underwriting data (such as data relating to identities of prospective and actual parties involved insurance and other transactions, actuarial data, data relating to probability of occurrence and/or extent of risk associated with activities, data relating to observed activities and other data used to underwrite or estimate risk); pricing data (including spot market pricing, forward market pricing, pricing discount information, promotional pricing, and other information relating to the cost or price of items in any of the platform-operated marketplaces and/or external marketplaces); as well as other types of data not shown, as well as data relating to outputs of banking, and many others.

In embodiments, data handling and adaptive intelligent systems may include a set of data processing, artificial intelligence, and computational systems as described herein. For example, the adaptive intelligent system of the cryptocurrency payment and distribution platform may manage and provision available network resources for both a financial analytics application and for a financial automated control application. As described in more detail throughout this disclosure and the documents incorporated herein by reference, a wide variety of adaptations may be provided on behalf of the various services and capabilities across the various layers 3308, including ones based on application requirements, quality of service, budgets, costs, pricing, risk factors, operational objectives, efficiency objectives, optimization parameters, returns on investment, profitability, uptime/downtime, worker utilization, and many others.

The cryptocurrency payment and distribution platform may include financial and transactional management applications, referred to in some cases herein for convenience as the financial and transactional management application platform layer, may include a set of financial and transactional processes, workflows, activities, events and applications that enable an operator to manage more than one aspect of an financial, currency or transactional environment or entity in a common application environment, such as one that takes advantage of common data storage in the data storage layer, common data collection or monitoring in a financial and transactional monitoring systems layer and/or adaptive intelligence layer. Outputs from the applications in the financial and transactional management application platform layer may be provided to the other data handing layers. These may include, without limitation, state and status information for various objects, entities, processes, flows and the like; object information, such as identity, attribute and parameter information for various classes of objects of various data types; event and change information, such as for workflows, dynamic systems, processes, procedures, protocols, algorithms, and other flows, including timing information; outcome information, such as indications of success and failure, indications of process or milestone completion, indications of correct or incorrect predictions, indications of correct or incorrect labeling or classification, and success metrics (including relating to yield, engagement, return on investment, profitability, efficiency, and the like) among others. Outputs from each application may be stored in a data storage layer, distributed for processing by the data collection layer, and used by the adaptive intelligent system. The cross-application nature of the cryptocurrency payment and distribution platform thus facilitates convenient organization of all of the necessary infrastructure elements for adding intelligence to any given application, such as by supplying machine learning on outcomes across applications, providing enrichment of automation of a given application via machine learning based on outcomes from other applications (or other elements of the platform), and allowing application developers to focus on application-native processes while benefiting from other capabilities of the platform.

In embodiments, criteria may include conformance or adherence to governance principles and policies, including but not limited to banking or other financial regulations related to currency, currency transactions, cryptocurrency and the like. There may be policies regarding what input data sources may be used to train the AI solution. There may be policies regarding what input sources may be used during operation. For example, input data sources may be reviewed for potential bias, appropriate representation (either demographically or of the problem space), scope, and the like. There may be criteria regarding accreditation or approval of the solution by a regulatory body, certification organization, internal IT review, and the like. There may be policies and procedures that must be in place or implemented with respect to security (e.g., physical security of the system, cybersecurity, transaction security, and the like).

In embodiments, data handling layers of the cryptocurrency payment and distribution platform may be configured in a topology that facilitates shared adaptation capabilities, which may be provided, managed, mediated and the like by one or more of a set of services, components, programs, systems, or capabilities of the adaptive intelligent systems layer of the cryptocurrency payment and distribution platform, referred to in some cases herein for convenience as the adaptive intelligent systems layer. The adaptive intelligent systems layer may include a set of data processing, artificial intelligence, and computational systems as described herein. Thus, use of various resources, such as computing resources, data storage resources (including local storage on devices, storage resources in or on financial entities or environments), network storage resources, cloud-based storage resources, database resources and others, networking resources (including cellular network spectrum, wireless network resources, fixed network resources and others), and others may be optimized in a coordinated or shared way on behalf of an operator, enterprise, or the like, such as for the benefit of multiple applications, programs, workflows, or the like. For example, the adaptive intelligent system layer of the cryptocurrency payment and distribution platform may manage and provision available network resources for both a financial analytics application and for a financial control application (among many other possibilities).

Outputs from each application associated with the cryptocurrency payment and distribution platform may be stored in the data storage layer of the platform, distributed for processing by the data collection layer, and used by the adaptive intelligent system layer. The cross-application nature of the financial and transactional management application platform layer may thus facilitate convenient organization of all of the necessary infrastructure elements for adding intelligence to any given application, such as by supplying machine learning on outcomes across applications, providing enrichment of automation of a given application via machine learning based on outcomes from other applications (or other elements of the platform), and allowing application developers to focus on application-native processes while benefiting from other capabilities of the platform.

The cryptocurrency payment and distribution platform may include a set of systems, applications, processes, modules, services, layers, devices, components, machines, products, sub-systems, interfaces, connections, and other elements working in coordination to enable intelligent management of a set of financial and transactional entities that may occur, operate, transact or the like within, or own, operate, support or enable, one or more platform-operated marketplaces or external marketplaces, including but not limited to cryptocurrency marketplaces, or that may otherwise be part of, integrated with, linked to, or operated on by the platform. Platform-operated marketplaces and external marketplaces may include a wide variety of marketplaces for currency exchanges and related transactions. Financial and transactional entities may include any of the wide variety of assets, systems, devices, machines, facilities, individuals or other entities mentioned throughout this disclosure or in the documents incorporated herein by reference, such as, without limitation: financial machines and their components (e.g., automated teller machines, point-of-sale machines, vending machines, kiosks, smart-card-enabled machines, and many others); financial and transactional processes (such as lending processes, software processes (including applications, programs, services, and others), production processes, banking processes (e.g., lending processes, underwriting processes, investing processes, and many others), financial service processes, diagnostic processes, security processes, safety processes and many others; and operating facilities (such as currency production facilities, storage facilities, vaults, bank branches, office buildings, banking facilities, financial services facilities, cryptocurrency mining facilities, data centers, trading floors, high frequency trading operations, and many others), which may include, without limitation, among many others, storage and financial services facilities; insurance facilities (such as branches, offices, storage facilities, data centers, underwriting operations and others); and banking facilities (such as for commercial banking, investing, consumer banking, lending and many other banking activities).

The cryptocurrency payment and distribution platform may include a dashboard, plurality of dashboards, or other user interfaces for an operator of a platform-operated marketplace or application, using the various enabling capabilities of the data handling platform described throughout this disclosure. The operator may use the user interface or dashboard to undertake a series of steps to perform or undertake an algorithm to create a financial and/or cryptocurrency offering. In embodiments, one or more of the steps of an algorithm to create an offering, such as a contingent financial offering, within the dashboard may include identifying offering data, which may come from a platform-operated marketplace or an external marketplace, such as a cryptocurrency marketplace, such as via a demand aggregation interface presented to one or more consumers within one of them, or may be entered via a user interface of or at a site or application that is created for demand aggregation for offerings, such as via solicitation of consumer interest or consumer commitments (such as commitments entered into by smart contracts as part of a consumer loyalty reward program) based on specification of various possible parameters and contingencies for such offerings. The dashboard may be configured with interface elements (including application programming elements) that allow an offering to be managed in a platform-operated marketplace, such as by linking to the set of environments where various components of the offering, such as descriptions of goods and services, prices, access rights and the like are specified, offered or maintained, which may include using APIs for backend ticketing systems, e-commerce systems, ordering systems, fulfillment systems, and the like. In the dashboard, a component may configure one or more parameters or contingencies (e.g., via interactions with a user), such as comprising or describing the conditions (of the type described herein) for the offering, such as by defining a set of conditions that trigger the commitment by a consumer to partake of the offering, that trigger the right to an allocation of the offering, or the like. The user interface of the dashboard may include a set of drop down menus, tables, forms, or the like with default, templated, recommended, or pre-configured conditions, parameters, contingencies and the like, such as ones that are appropriate for various types of offerings.

The cryptocurrency payment and distribution platform may include a lending enablement system and wherein a platform-oriented marketplace may comprise a lending platform. The lending enablement system may include a set of systems, applications, processes, modules, services, layers, devices, components, machines, products, sub-systems, interfaces, connections, and other elements working in coordination (such as by data integration and organization in a services oriented architecture) to enable intelligent management of a set of entities, such as financial services entities, that may occur, operate, transact or the like within, or own, operate, support or enable, one or more applications, services, solutions, programs or the like of the lending platform or external marketplaces that involve lending transactions or lending-related entities, or that may otherwise be part of, integrated with, linked to, or operated on by the platform. References to a set of services herein should be understood, except where context indicates otherwise, these and other various systems, applications, processes, modules, services, layers, devices, components, machines, products, sub-systems, interfaces, connections, and other types of elements. A set may include multiple members or a single member. As with other embodiments of the system, the system may have various data handling layers, with components, modules, systems, services, components, functions, and other elements described in connection with other embodiments described throughout this disclosure and the documents incorporated herein by reference. This may include various adaptive intelligent systems, monitoring systems, data collection systems, and data storage systems, as well as a set of application programming interfaces of, to, and/or among each of those systems and/or the various other elements of the platform. In embodiments, the application programming interfaces data integration technologies for extracting, transforming, cleansing, normalizing, deduplicating, loading and the like as data is moved among various services using various protocols and formats; and various ports, portals, connectors, gateways, wired connections, sockets, virtual private networks, containers, secure channels and other connections configured among elements on a one-to-one, one-to-many, or many-to-one basis, such as in unicast, broadcast and multi-cast transmission.

In the context of a lending enablement system of the cryptocurrency payment and distribution platform, and set of lending solutions, entities may include any of the wide variety of assets, systems, devices, machines, facilities, individuals or other entities mentioned throughout this disclosure or in the documents incorporated herein by reference, such as, without limitation: machines and their components (e.g., cryptocurrency that is the subject of a loan or collateral for a loan); financial and transactional processes (such as lending processes, inspection processes, collateral tracking processes, valuation processes, credit checking processes, creditworthiness processes, syndication processes, interest rate-setting processes, software processes (including applications, programs, services, and others), production processes, collection processes, banking processes (e.g., lending processes, underwriting processes, investing processes, and many others), financial service processes, diagnostic processes, security processes, safety processes, assessment processes, payment processes, valuation processes, issuance processes, factoring processes, consolidation processes, syndication processes, collection processes, verification processes, collateral monitoring processes, and many others); wearable and portable devices (such as mobile phones, tablets, dedicated portable devices for financial applications, data collectors (including mobile data collectors), and banking facilities (such as for commercial banking, investing, consumer banking, lending and many other banking activities) and others. In embodiments, entities may include external marketplaces, such as financial, commodities, e-commerce, advertising, and other marketplaces (including current and futures markets), such as marketplaces within which transactions occur, such that monitoring of the marketplaces and entities within them may provide lending-relevant information, such as with respect to the price or value of items, the liquidity of items, the characteristics of items, the rate of depreciation of items, or the like. For example, for various entities that may comprise collateral or assets, including but not limited to cryptocurrency, for asset-backed lending, a monitoring system layer may monitor not only the collateral or assets, and may also collect data, such as via data collection systems of various types, as described herein, with respect to the value, price, or other condition of the collateral, fiat and/or cryptocurrency or assets, such as by determining market conditions for collateral, fiat and/or cryptocurrency or assets that have similar specifications, or the like. In embodiments, an adaptive intelligent systems layer may include a clustering system, such as one that groups or clusters entities, including collateral, parties, assets, or the like by similarity of attributes, such as a k-means clustering system, self-organizing map system, or other system as described herein and in the documents incorporated herein by reference. The clustering system may organize collections of collateral, collections of assets, collections of parties, and collections of loans, for example, such that they may be monitored and analyzed based on common attributes, such as to enable performance of a subset of transactions to be used to predict performance of others, which in turn may be used for underwriting, pricing, fraud detection, or other applications. Aggregation of data for a set of collateral or set of assets, such as a collection of cryptocurrencies, digital wallets or the like, owned by an entity may allow real time portfolio valuation and larger scale lending, including via smart contracts that automatically adjust interest rates and other terms and conditions based on the individual or aggregated value of collateral or assets based on real time condition monitoring and real-time market data collection and integration. Transactions, party information, changes in terms and conditions, and other information may be stored in a blockchain, including loan transactions and information (such as condition information for collateral or assets and marketplace data) about the collateral or assets. The smart contract may be configured to require a party to confirm condition information and/or market value information, such as by representations and warranties that are supported or verified by the monitoring system layers (which may flag fraud in a fraud detection system). A lending model may be used to value cryptocurrency or other collateral or assets, to determine eligibility for lending based on the condition and/or value cryptocurrency or other collateral or assets, to set pricing (e.g., interest rates), to adjust terms and conditions, and the like. The lending model may be created by a set of experts, such as using analytics solutions on past lending transactions. The lending model may be populated by data from monitoring system layers and data collection systems, may pull data from storage systems, and the like. The lending model may be used to configure parameters of a smart contract, such that smart contract terms and conditions automatically adjust based on adjustments in the lending model. The lending model may be configured to be improved by artificial intelligence, such as by training it on a set of outcomes, such as outcomes from lending transactions (e.g., payment outcomes, default outcomes, performance outcomes, and the like), outcomes on cryptocurrency or other collateral or assets (such as prices or value patterns of collateral or assets over time), outcomes on entities (such as defaults, foreclosures, performance results, on time payments, late payments, bankruptcies, and the like), and others. Training may be used to adjust and improve model parameters and performance, including for classification of collateral or assets, prediction of value of cryptocurrency or other collateral or assets, prediction of defaults, prediction of performance, and the like. In embodiments, configuration or handling of smart contracts for lending on cryptocurrency or other collateral or assets may be learned and automated in a process automation system, such as by training to create smart contracts, configure parameters of smart contracts, confirm title to cryptocurrency or other collateral or assets, set terms and conditions of smart contracts, initiate security interests on cryptocurrency or other collateral for smart contracts, monitor status or performance of smart contracts, terminate or initiate termination for default of smart contracts, close smart contracts, foreclose on cryptocurrency or other collateral or assets, transfer title, or the like, such as by using monitoring system layers to monitor expert entities, such as human managers, as they undertake a training set of similar tasks and actions in the creation, configuration, title confirmation, initiation of security interests, monitoring, termination, closing, foreclosing, and the like for a training set of smart contracts. Once the system is trained, it may efficiently create the ability to provide lending at scale across a wide range of entities, cryptocurrencies or other assets that may serve as collateral, that may provide guarantees or security, or the like, thereby making loans more readily available for a wider range of situations, entities, and collateral.

In embodiments the cryptocurrency payment and distribution platform may include a controller, a reporting circuit, and a market value monitoring circuit which also determines a collateral condition, such as a cryptocurrency holding. The controller may further include a secure access user interface which receives access control instructions from banks, lenders, insurers or some other entity. The access control instructions may be provided to a secure access control circuit which provides instructions to blockchain service circuit which interprets access control features and provides access to a, bank, a lender, or insurer, or other party. The blockchain service circuit may store the collateral data and a unique collateral ID as blockchain data.

The cryptocurrency payment and distribution platform may include a blockchain service circuit structured to interface with a distributed ledger. The data collection circuit of the cryptocurrency payment and distribution platform may be structured to receive data related to a plurality of items of collateral or data related to environments of the plurality of items of collateral, such as digital wallets holding cryptocurrency. The valuation circuit associated with the cryptocurrency payment and distribution platform may be structured to determine a value for each of the plurality of items of collateral based on a valuation model and the received data. The smart contract services circuit may be structured to interpret a smart lending contract for a loan, and to modify the smart lending contract by assigning, based on the determined value for each of the plurality of items of collateral, at least a portion of the plurality of items of collateral as security for the loan such that the determined value of the of the plurality of items of collateral is sufficient to provide security for the loan. The blockchain service circuit may be further structured to record the assigned at least a portion of items of collateral to an entry in the distributed ledger, wherein the entry is used to record events relevant to the loan. Each of the blockchain service circuit, the data collection circuit, the valuation circuit, and the smart contract circuit may further include a corresponding application programming interface (API) component structured to facilitate communication among the circuits of the system.

Modifying the smart lending contract associated with the cryptocurrency payment and distribution platform may further include specifying terms and conditions that govern an item selected from the list consisting of: a loan term, a loan condition, a loan-related event, and a loan-related activity. The terms and conditions may each include at least one member selected from the group consisting of: a principal amount of the loan, a balance of the loan, a fixed interest rate, a variable interest rate description, a payment amount, a payment schedule, a balloon payment schedule, a collateral specification, a collateral substitution description, a description of at least one of the parties, a guarantee description, a guarantor description, a security description, a personal guarantee, a lien, a foreclosure condition, a default condition, a consequence of default, a covenant related to any one of the foregoing, and a duration of any one of the foregoing. A loan may include at least one loan type selected from the loan types consisting of: an auto loan, an inventory loan, a capital equipment loan, a bond for performance, a capital improvement loan, a building loan, a loan backed by an account receivable, an invoice finance arrangement, a factoring arrangement, a pay day loan, a refund anticipation loan, a student loan, a syndicated loan, a title loan, a home loan, a venture debt loan, a loan of intellectual property, a loan of a contractual claim, a working capital loan, a small business loan, a farm loan, a municipal bond, and a subsidized loan.

The artificial intelligence circuit associated with the cryptocurrency payment and distribution platform may include at least one system such as a machine learning system, a model-based system, a rule-based system, a deep learning system, a hybrid system, a neural network, a convolutional neural network, a feed forward neural network, a feedback neural network a self-organizing map, a fuzzy logic system, a random walk system, a random forest system, a probabilistic system, a Bayesian system, a simulation system, and the like.

A financial management circuit associated with the cryptocurrency payment and distribution platform may be structured to communicate the interpreted assets and authenticated identifiers to the blockchain service circuit for storage in the blockchain structure as asset control features, wherein the asset control features are recorded in the distributed ledger configuration as asset events. A data collection circuit may be structured to monitor the interpretation of the plurality of assets, authentication of the plurality of identifiers, and the recording of asset events, where the data collection circuit may be communicatively coupled with the cryptocurrency payment and distribution platform. A smart contract circuit may be structured to manage the custody of assets, including but not limited to fiat and/or cryptocurrency holdings, where an asset event related to the plurality of assets may be managed by the smart contract circuit based on terms and conditions embodied in a smart contract configuration and based on data collected by the data collection service circuit. In embodiments, the asset identification service circuit, identity management service circuit, blockchain service circuit, and the financial management circuit may include a corresponding application programming interface (API) component structured to facilitate communication among the circuits of the cryptocurrency payment and distribution platform, such as where the corresponding API components of the circuits further include user interfaces structured to interact with users of the cryptocurrency payment and distribution platform.

The background description is presented simply for context, and is not necessarily well-understood, routine, or conventional. Further, the background description is not an admission of what does or does not qualify as prior art. In fact, some or all of the background description may be work attributable to the named inventors that is otherwise unknown in the art. Physical (such as spatial and/or electrical) and functional relationships between elements (for example, between modules, circuit elements, semiconductor layers, etc.) are described using various terms. Unless explicitly described as being “direct,” when a relationship between first and second elements is described, that relationship encompasses both (i) a direct relationship where no other intervening elements are present between the first and second elements and (ii) an indirect relationship where one or more intervening elements are present between the first and second elements. Example relationship terms include “adjoining,” “transmitting,” “receiving,” “connected,” “engaged,” “coupled,” “adjacent,” “next to,” “on top of,” “above,” “below,” “abutting,” and “disposed.” The detailed description includes specific examples for illustration only, and not to limit the disclosure or its applicability. The examples are not intended to be an exhaustive list, but instead simply demonstrate possession by the inventors of the full scope of the currently presented and envisioned future claims. Variations, combinations, and equivalents of the examples are within the scope of the disclosure. No language in the specification should be construed as indicating that any non-claimed element is essential or critical to the practice of the disclosure. The term “exemplary” simply means “example” and does not indicate a best or preferred example. The term “set” does not necessarily exclude the empty set—in other words, in some circumstances a “set” may have zero elements. The term “non-empty set” may be used to indicate exclusion of the empty set—that is, a non-empty set must have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements. The phrase “at least one of A, B, and C” should be construed to mean a logical (A OR B OR C), using a non-exclusive logical OR, and should not be construed to mean “at least one of A, at least one of B, and at least one of C.” The use of the terms “a,” “an,” “the,” and similar referents in the context of describing the disclosure and claims encompasses both the singular and the plural, unless contradicted explicitly or by context. Unless otherwise specified, the terms “comprising,” “having,” “with,” “including,” and “containing,” and their variants, are open-ended terms, meaning “including, but not limited to.” Each publication referenced in this disclosure, including foreign and domestic patent applications and patents, is hereby incorporated by reference in its entirety. Although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of multiple embodiments remain within the scope of this disclosure. One or more elements (for example, steps within a method, instructions, actions, or operations) may be executed in a different order (and/or concurrently) without altering the principles of the present disclosure. Unless technically infeasible, elements described as being in series may be implemented partially or fully in parallel. Similarly, unless technically infeasible, elements described as being in parallel may be implemented partially or fully in series. While the disclosure describes structures corresponding to claimed elements, those elements do not necessarily invoke a means plus function interpretation unless they explicitly use the signifier “means for.”

While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. In the drawings, reference numbers may be reused to identify identical elements or may simply identify elements that implement similar functionality. Numbering or other labeling of instructions or method steps is done for convenient reference, not to indicate a fixed order. In the drawings, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. As just one example, for information sent from element A to element B, element B may send requests and/or acknowledgements to element A. Unless otherwise indicated, recitations of ranges of values are merely intended to serve as a shorthand way of referring individually to each separate value falling within the range, and each separate value is hereby incorporated into the specification as if it were individually recited.

A special-purpose system includes hardware and/or software and may be described in terms of an apparatus, a method, or a computer-readable medium. In various embodiments, functionality may be apportioned differently between software and hardware. For example, some functionality may be implemented by hardware in one embodiment and by software in another embodiment. Further, software may be encoded by hardware structures, and hardware may be defined by software, such as in software-defined networking or software-defined radio. In this application, including the claims, the term module refers to a special-purpose system. The module may be implemented by one or more special-purpose systems. The one or more special-purpose systems may also implement some or all of the other modules. In this application, including the claims, the term module may be replaced with the terms controller or circuit. In this application, including the claims, the term platform refers to one or more modules that offer a set of functions. In this application, including the claims, the term system may be used interchangeably with module or with the term special-purpose system. The special-purpose system may be directed or controlled by an operator. The special-purpose system may be hosted by one or more of assets owned by the operator, assets leased by the operator, and third-party assets. The assets may be referred to as a private, community, or hybrid cloud computing network or cloud computing environment. For example, the special-purpose system may be partially or fully hosted by a third party offering software as a service (SaaS), platform as a service (PaaS), and/or infrastructure as a service (IaaS). The special-purpose system may be implemented using agile development and operations (DevOps) principles. In embodiments, some or all of the special-purpose system may be implemented in a multiple-environment architecture. For example, the multiple environments may include one or more production environments, one or more integration environments, one or more development environments, etc.

A special-purpose system may be partially or fully implemented using or by a mobile device. Examples of mobile devices include navigation devices, cell phones, smart phones, mobile phones, mobile personal digital assistants, palmtops, netbooks, pagers, electronic book readers, tablets, music players, etc. A special-purpose system may be partially or fully implemented using or by a network device. Examples of network devices include switches, routers, firewalls, gateways, hubs, base stations, access points, repeaters, head-ends, user equipment, cell sites, antennas, towers, etc. A special-purpose system may be partially or fully implemented using a computer having a variety of form factors and other characteristics. For example, the computer may be characterized as a personal computer, as a server, etc. The computer may be portable, as in the case of a laptop, netbook, etc. The computer may or may not have any output device, such as a monitor, line printer, liquid crystal display (LCD), light emitting diodes (LEDs), etc. The computer may or may not have any input device, such as a keyboard, mouse, touchpad, trackpad, computer vision system, barcode scanner, button array, etc. The computer may run a general-purpose operating system, such as the WINDOWS operating system from Microsoft Corporation, the MACOS operating system from Apple, Inc., or a variant of the LINUX operating system. Examples of servers include a file server, print server, domain server, internet server, intranet server, cloud server, infrastructure-as-a-service server, platform-as-a-service server, web server, secondary server, host server, distributed server, failover server, and backup server.

The term hardware encompasses components such as processing hardware, storage hardware, networking hardware, and other general-purpose and special-purpose components. Note that these are not mutually-exclusive categories. For example, processing hardware may integrate storage hardware and vice versa. Examples of a component are integrated circuits (ICs), application specific integrated circuit (ASICs), digital circuit elements, analog circuit elements, combinational logic circuits, gate arrays such as field programmable gate arrays (FPGAs), digital signal processors (DSPs), complex programmable logic devices (CPLDs), etc. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an artificial intelligence (AI) system-on-chip, a video processing system-on-chip, an organ-on-chip, a quantum algorithm system-on-chip, etc. The hardware may integrate and/or receive signals from sensors. The sensors may allow observation and measurement of conditions including temperature, pressure, wear, light, humidity, deformation, expansion, contraction, deflection, bending, stress, strain, load-bearing, shrinkage, power, energy, mass, location, temperature, humidity, pressure, viscosity, liquid flow, chemical/gas presence, sound, and air quality. A sensor may include image and/or video capture in visible and/or non-visible (such as thermal) wavelengths, such as a charge-coupled device (CCD) or complementary metal-oxide semiconductor (CMOS) sensor.

Examples of processing hardware include a central processing unit (CPU), a graphics processing unit (GPU), an approximate computing processor, a quantum computing processor, a parallel computing processor, a neural network processor, a signal processor, a digital processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an artificial intelligence (AI) co-processor.

The processor may enable execution of multiple threads. These multiple threads may correspond to different programs. In various embodiments, a single program may be implemented as multiple threads by the programmer or may be decomposed into multiple threads by the processing hardware. The threads may be executed simultaneously to enhance the performance of the processor and to facilitate simultaneous operations of the application. A processor may be implemented as a packaged semiconductor die. The die includes one or more processing cores and may include additional functional blocks, such as cache. In various embodiments, the processor may be implemented by multiple dies, which may be combined in a single package or packaged separately.

The networking hardware may include one or more interface circuits. In some examples, the interface circuit(s) may implement wired or wireless interfaces that connect, directly or indirectly, to one or more networks. Examples of networks include a cellular network, a local area network (LAN), a wireless personal area network (WPAN), a metropolitan area network (MAN), and/or a wide area network (WAN). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs). Examples of cellular networks include GSM, GPRS, 3G, 4G, 5G, LTE, and EVDO. The cellular network may be implemented using frequency division multiple access (FDMA) network or code division multiple access (CDMA) network. Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN include IEEE Standard 802.15.4, including the ZIGBEE standard from the ZigBee Alliance. Further examples of a WPAN include the BLUETOOTH wireless networking standard, including Core Specification versions 3.0, 4.0, 4.1, 4.2, 5.0, and 5.1 from the Bluetooth Special Interest Group (SIG). A WAN may also be referred to as a distributed communications system (DCS). One example of a WAN is the internet.

Storage hardware is or includes a computer-readable medium. The term computer-readable medium, as used in this disclosure, encompasses both nonvolatile storage and volatile storage, such as dynamic random access memory (DRAM). The term computer-readable medium only excludes transitory electrical or electromagnetic signals propagating through a medium (such as on a carrier wave). A computer-readable medium in this disclosure is therefore non-transitory, and may also be considered to be tangible.

Examples of storage implemented by the storage hardware include a database (such as a relational database or a NoSQL database), a data store, a data lake, a column store, a data warehouse. Example of storage hardware include nonvolatile memory devices, volatile memory devices, magnetic storage media, a storage area network (SAN), network-attached storage (NAS), optical storage media, printed media (such as bar codes and magnetic ink), and paper media (such as punch cards and paper tape). The storage hardware may include cache memory, which may be collocated with or integrated with processing hardware. Storage hardware may have read-only, write-once, or read/write properties. Storage hardware may be random access or sequential access. Storage hardware may be location-addressable, file-addressable, and/or content-addressable. Example of nonvolatile memory devices include flash memory (including NAND and NOR technologies), solid state drives (SSDs), an erasable programmable read-only memory device such as an electrically erasable programmable read-only memory (EEPROM) device, and a mask read-only memory device (ROM). Example of volatile memory devices include processor registers and random access memory (RAM), such as static RAM (SRAM), dynamic RAM (DRAM), synchronous DRAM (SDRAM), synchronous graphics RAM (SGRAM), and video RAM (VRAM). Example of magnetic storage media include analog magnetic tape, digital magnetic tape, and rotating hard disk drive (HDDs). Examples of optical storage media include a CD (such as a CD-R, CD-RW, or CD-ROM), a DVD, a Blu-ray disc, and an Ultra HD Blu-ray disc. Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether. Some or all features of hardware may be defined using a language for hardware description, such as IEEE Standard 1364-2005 (commonly called “Verilog”) and IEEE Standard 1076-2008 (commonly called “VHDL”). The hardware description language may be used to manufacture and/or program hardware. A special-purpose system may be distributed across multiple different software and hardware entities. Communication within a special-purpose system and between special-purpose systems may be performed using networking hardware. The distribution may vary across embodiments and may vary over time. For example, the distribution may vary based on demand, with additional hardware and/or software entities invoked to handle higher demand. In various embodiments, a load balancer may direct requests to one of multiple instantiations of the special purpose system. The hardware and/or software entities may be physically distinct and/or may share some hardware and/or software, such as in a virtualized environment. Multiple hardware entities may be referred to as a server rack, server farm, data center, etc.

Software includes instructions that are machine-readable and/or executable. Instructions may be logically grouped into programs, codes, methods, steps, actions, routines, functions, libraries, objects, classes, etc. Software may be stored by storage hardware or encoded in other hardware. Software encompasses (i) descriptive text to be parsed, such as HTML (hypertext markup language), XML (extensible markup language), and JSON (JavaScript Object Notation), (ii) assembly code, (iii) object code generated from source code by a compiler, (iv) source code for execution by an interpreter, (v) bytecode, (vi) source code for compilation and execution by a just-in-time compiler, etc. As examples only, source code may be written using syntax from languages including C, C++, JavaScript, Java, Python, R, etc. Software also includes data. However, data and instructions are not mutually-exclusive categories. In various embodiments, the instructions may be used as data in one or more operations. As another example, instructions may be derived from data. The functional blocks and flowchart elements in this disclosure serve as software specifications, which can be translated into software by the routine work of a skilled technician or programmer. Software may include and/or rely on firmware, processor microcode, an operating system (OS), a basic input/output system (BIOS), application programming interfaces (APIs), libraries such as dynamic-link libraries (DLLs), device drivers, hypervisors, user applications, background services, background applications, etc. Software includes native applications and web applications. For example, a web application may be served to a device through a browser using hypertext markup language 5th revision (HTML5). Software may include artificial intelligence systems, which may include machine learning or other computational intelligence. For example, artificial intelligence may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs. Examples of the models include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformer (GPT). Training a machine-learning model may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), computer vision (CV), classification, image recognition, etc.

Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. In a client-server model, some of the software executes on first hardware identified functionally as a server, while other of the software executes on second hardware identified functionally as a client. The identity of the client and server is not fixed: for some functionality, the first hardware may act as the server while for other functionality, the first hardware may act as the client. In different embodiments and in different scenarios, functionality may be shifted between the client and the server. In one dynamic example, some functionality normally performed by the second hardware is shifted to the first hardware when the second hardware has less capability. In various embodiments, the term “local” may be used in place of “client,” and the term “remote” may be used in place of “server.” Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model. Some or all of the software may be arranged logically into layers. In a layered architecture, a second layer may be logically placed between a first layer and a third layer. The first layer and the third layer would then generally interact with the second layer and not with each other. In various embodiments, this is not strictly enforced—that is, some direct communication may occur between the first and third layers.

What is claimed:

1. An integration system for a platform of platforms, comprising:
a user trust platform including:
a user trust database including user trust data associated with a user, and
a user trust programming interface configured to provide access to the user trust database;
a digital transactional platform including:
a transactional database including transactional data indicative of an amount of first-domain value correlated to the user, and
a digital transactional programming interface configured to provide access to the transactional database;
a blockchain transactional platform including:
a blockchain transactional database including blockchain transactional data indicative of an amount of second-domain value correlated to the user, and
a blockchain transactional programming interface configured to provide access to the blockchain transactional database; and
an orchestration platform including:
an orchestration module,
a analysis module,
a data services module configured to determine and store second-domain value pricing data, and
an orchestration platform programming interface configured to provide access to the orchestration module;
wherein the orchestration module is configured to:
retrieve user trust data from the user trust database through the user trust programming interface,
retrieve transactional data from the transactional database through the digital transactional programming interface,
retrieve blockchain transactional data from the blockchain transactional database through the blockchain transactional programming interface,
provide the user trust data, the transactional data, the blockchain transactional data, and the second-domain value pricing data to the analysis module to generate a variable interest rate for a loan.

2. The system of claim 1, wherein the orchestration module is configured to:
generate a user interface element on a user interface;
monitor the user interface element to determine if the user selects the user interface element; and
in response to the user selecting the user interface element, retrieve user trust data from the user trust database through the user trust programming interface.

3. The system of claim 1, wherein the blockchain transactional module is configured to:
access and parse a cryptocurrency wallet address on a distributed ledger to generate blockchain transactional data; and
send the generated blockchain transactional data to the blockchain transactional programming interface.

4. The system of claim 1, wherein the blockchain transactional module is configured to:
access and parse a cryptocurrency wallet address on a secondary mesh network to generate blockchain transactional data; and
send the generated blockchain transactional data to the blockchain transactional programming interface.

5. The system of claim 1, wherein the orchestration module is configured to access and parse a cryptocurrency wallet address to generate blockchain transactional data.

6. The system of claim 1, wherein the orchestration module is configured to access and parse a cryptocurrency wallet address on a distributed ledger to generate blockchain transactional data.

7. The system of claim 1, wherein the orchestration module is configured to access and parse a cryptocurrency wallet address on a secondary mesh network to generate blockchain transactional data.

8. The system of claim 1, wherein the analysis module is configured to:
generate input vectors from the user trust data, the transactional data, the blockchain transactional data, and the second-domain value pricing data; and
provide the input vectors to a trained machine learning model to generate the variable interest rate for the loan.

9. The system of claim 8, wherein the trained machine learning model is a neural network.

10. The system of claim 2, wherein the orchestration module is configured to:
generate a second user interface element based on the variable interest rate for the loan.

11. A computer-implemented method of automatically managing networked computer platforms, comprising:
retrieving, at an orchestration module, user trust data from a user trust database through a user trust programming interface, wherein:
the orchestration module is part of an orchestration platform, the orchestration platform includes an analysis module, a data services module, and an orchestration platform programming interface, the data services module is configured to determine and store second-domain value price volatility data, and the orchestration platform programming interface is configured to provide access to the orchestration module, and
the user trust database and the user trust programming interface are parts of a user trust platform, the user trust database includes the user trust data, the user trust data is associated with a user, and the user trust programming interface is configured to provide access to the user trust database;
retrieving transactional data from a transactional database through a digital transactional programming interface, wherein:
the transactional database and the digital transactional programming interface are parts of a digital transactional platform, the transactional database includes the transactional data, the transactional data indicates an amount of first-domain value correlated to the user, and the digital transactional programming interface is configured to provide access to the transactional database;
retrieving blockchain transactional data from the blockchain transactional database through the blockchain transactional programming interface, wherein:
the blockchain transactional database and the blockchain transactional programming interface are parts of a blockchain transactional platform, the blockchain transactional database includes the blockchain transactional data, the blockchain transactional data indicates an amount of second-domain value correlated to the user, and the blockchain transactional programming interface is configured to provide access to the blockchain transactional database; and
providing the user trust data, the transactional data, the blockchain transactional data, and the second-domain value price volatility data to the analysis module to generate a variable interest rate for a loan.

12. The method of claim 11, comprising:
generating, at an orchestration module, a user interface element on a user interface;
monitoring the user interface element to determine if the user selects the user interface element; and
in response to the user selecting the user interface element, retrieving, at the orchestration module, user trust data from the user trust database through the user trust programming interface.

13. The method of claim 11, comprising:
accessing, from the blockchain transactional module, a cryptocurrency wallet address on a distributed ledger;
parsing data from the cryptocurrency wallet address to generate blockchain transactional data; and
sending the generated blockchain transactional data to the blockchain transactional programming interface.

14. The method of claim 11, comprising:
accessing, from the blockchain transactional module, a cryptocurrency wallet address on a secondary mesh network;
parsing data from the cryptocurrency wallet address to generate blockchain transactional data; and
sending the generated blockchain transactional data to the blockchain transactional programming interface.

15. The method of claim 11, comprising:
accessing, from the orchestration module, a cryptocurrency wallet address; and
parsing data from the cryptocurrency wallet address to generate blockchain transactional data.

16. The method of claim 11, comprising:
accessing, from the orchestration module, a cryptocurrency wallet address on a distributed ledger; and
parsing data from the cryptocurrency wallet address to generate blockchain transactional data.

17. The method of claim 11, comprising:
accessing, from the orchestration module, a cryptocurrency wallet address on a secondary mesh network; and
parsing data from the cryptocurrency wallet address to generate blockchain transactional data.

18. The method of claim 11, comprising:
generating, at the analysis module, input vectors from the user trust data, the transactional data, the blockchain transactional data, and the second-domain value price volatility data; and
providing the input vectors to a trained machine learning model to generate the variable interest rate for the loan.

19. The method of claim 18, wherein the trained machine learning model is a neural network.

20. The method of claim 12, comprising:
generating, at the orchestration module, a second user interface element based on the variable interest rate for the loan.
